(19) United States
(12) Patent Application Publication
(10) Pub. No.: US 2026/0285439 A1
(43) Pub. Date: Sep. 24, 2026

(54) TWO WHEELED VEHICLE SUSPENSION INCLUDING A ROTARY RESISTIVE MECHANISM

(71) Applicant: YETI CYCLING, LLC, Golden, CO (US)

(72) Inventor: Peter ZAWISTOWSKI, Lakewood, CO (US)

(21) Appl. No.: 19/572,668

(22) Filed: Mar. 19, 2026

Related U.S. Application Data
(60) Provisional application No. 63/775,106, filed on Mar. 20, 2025.
(60) Provisional application No. 63/912,401, filed on Nov. 6, 2025.

(51) Int. Cl. B62K 25/20; B62K 25/16

(52) U.S. Cl. CPC B62K 25/20; B62K 25/16

(57) ABSTRACT

A two-wheeled vehicle suspension is provided. The two-wheeled vehicle suspension includes a suspended body, a kinematic joint between two linkage bodies defining an instantaneous velocity center (IVC) axis, a braking mechanism, and a rotary mechanism that applies torque about the IVC axis. When viewed from a plane defined by the IVC axis there is an intersection between projections of the rotary mechanism and the braking mechanism during at least a portion of a travel of the suspension.

### CROSS-REFERENCE TO RELATED APPLICATIONS

This application claims the benefit of priority under 35 U.S.C. § 119 (e) and 37 C.F.R. § 1.78 to provisional application No. 63/775,106 filed on Mar. 20, 2025, titled “TWO WHEELED VEHICLE SUSPENSION INCLUDING A ROTARY RESISTIVE MECHANISM” and to provisional application No. 63/912,401 filed on Nov. 6, 2025, titled “TWO WHEELED VEHICLE SUSPENSION INCLUDING A ROTARY RESISTIVE MECHANISM” all of which are hereby incorporated by reference herein in their entireties.

### FIELD OF INVENTION

The present disclosure relates to two-wheeled vehicle suspension systems, and more particularly to suspension systems that utilize a rotary resistive mechanism about an axis to resist relative motion between suspension members.

### BACKGROUND

Two-wheeled vehicles, such as bicycles, electric bicycles, e-bikes, eMTBs, pedelecs, and motorcycles, may include suspension systems that operatively couple a suspended body to one or more wheels. Suspension systems may be configured to improve rider comfort, traction, and vehicle handling by allowing controlled relative motion between the suspended body and the wheels in response to terrain irregularities and dynamic forces encountered during operation.

Conventional suspension systems for two-wheeled vehicles often employ linear resistance mechanisms, such as coil-over shocks or air shocks, that compress and extend along a linear axis as the suspension linkage moves. These linear resistance mechanisms may present packaging challenges for certain frame designs, particularly when accommodating accessories such as water bottles, storage bags, or other components within the frame structure. The linear nature of conventional resistance mechanisms may also impose constraints on frame geometry, aesthetics, and weight optimization.

Two-wheeled vehicles are available with various wheel sizes, including 12, 16, 20, 24, 26, 27.5, 29, 32, and 36 inch wheels, as well as 650B and 700 CC sizes. Larger wheel sizes may introduce additional packaging constraints to the design of a two-wheeled vehicle frame, with or without suspension. Larger wheels may result in longer rear center lengths, which can affect rear end stiffness and structural considerations. Space within the front triangle for suspension components and accessories may become more limited as larger wheels encroach on the frame structure.

Different categories of two-wheeled vehicles may have different priorities regarding suspension travel, weight, efficiency, and packaging. For example, road, cross country, and gravel categories may prioritize efficient power transfer and low weight over large magnitudes of suspension travel. Other categories may benefit from greater suspension travel and more sophisticated resistance mechanisms. The dynamic response of a suspension system to acceleration and deceleration forces, as well as the mechanical advantage over the resistance mechanism, may vary depending upon the suspension linkage configuration and the type of resistance mechanism employed.

### SUMMARY

In one embodiment, a two-wheeled vehicle suspension is provided. The two-wheeled vehicle suspension includes a suspended body, a kinematic joint between two linkage bodies defining an instantaneous velocity center (IVC) axis, a braking mechanism, and a rotary mechanism that applies torque about the IVC axis. When viewed from a plane defined by the IVC axis there is an intersection between projections of the rotary mechanism and the braking mechanism during at least a portion of a travel of the suspension.

Optionally, in some embodiments, the kinematic joint is operably connected to a rear wheel. The rear wheel defines a rear wheel axis.

Optionally, in some embodiments, the kinematic joint is operably connected to a front wheel. The front wheel defines a front wheel axis.

Optionally, in some embodiments, the two-wheeled vehicle suspension further includes a front wheel axis. The IVC axis is located rearward of the front wheel axis.

Optionally, in some embodiments, the kinematic joint defines a dynamic IVC DIVC[C] or a dynamic IVC DIVC[E].

Optionally, in some embodiments, the DIVC[C] includes a DIVC[A] or a DIVC[AD]. The DIVC[E] includes a DIVC[D] or the DIVC[AD]. As the suspension cycles, at least one of the DIVC[A], the DIVC[D], or the DIVC[AD] is stationary relative to the suspended body.

Optionally, in some embodiments, the DIVC[C] includes a DIVC[A] or a DIVC[AD]. The DIVC[E] includes a DIVC[D] or the DIVC[AD]. As the suspension cycles, at least one of the DIVC[A], the DIVC[D], or the DIVC[AD] migrates relative to the suspended body.

Optionally, in some embodiments, the IVC axis is not associated with a DIVC.

Optionally, in some embodiments, a cassette is operably connected to the rear wheel. There is an intersection between projections of the rotary mechanism and the cassette during at least the portion of the travel of the suspension.

In one embodiment, a two-wheeled vehicle suspension is provided. The two-wheeled vehicle suspension includes a plurality of linkage bodies including a suspended body, a plurality of kinematic joints each defining an instantaneous velocity center (IVC) axis, a wheel defining a wheel axis, a tire mounted to the wheel defining a tire outer diameter, and a rotary mechanism that applies torque about at least one of the IVC axes. When viewed from a plane defined by the wheel axis, projections of the kinematic joints are located within the tire outer diameter during at least a portion of a travel of the suspension.

Optionally, in some embodiments, a linkage body is a wheel carrier.

Optionally, in some embodiments, a linkage body is a brake carrier.

Optionally, in some embodiments, the wheel carrier is independent from a brake carrier.

Optionally, in some embodiments, there are at least four kinematic joints.

Optionally, in some embodiments, there are at least seven kinematic joints.

Optionally, in some embodiments, at least one of the kinematic joints defines a dynamic instantaneous velocity center (DIVC). As the suspension cycles, the DIVC is stationary relative to the suspended body.

Optionally, in some embodiments, an IVC is a DIVC. As the suspension cycles a DIVC migrates relative to the suspended body.

In one embodiment, a two-wheel vehicle suspension is provided. The two-wheel vehicle suspension includes a suspended body, a plurality of kinematic joints each defining an instantaneous velocity center (IVC) axis, a wheel defining a wheel axis, a tire mounted to the wheel defining a tire outer diameter, and a rotary fluid damper that applies torque about at least one of the IVC axes. When viewed from a plane defined by the wheel axis, projections of the kinematic joints are located within the tire outer diameter during at least a portion of a travel of the suspension.

Optionally, in some embodiments, at least one of the kinematic joints defines a dynamic instantaneous velocity center (DIVC). As the suspension cycles DIVC is stationary relative to the suspended body.

Optionally, in some embodiments, at least one of the kinematic joints defines a dynamic instantaneous velocity center (DIVC). As the suspension cycles DIVC migrates relative to the suspended body.

Optionally, in some embodiments, at least one of the kinematic joints defines a dynamic instantaneous velocity center (DIVC), and as the suspension cycles between an at least partially compressed state and an at least partially extended state, the DIVC migrates relative to the suspended body.

In one embodiment, a two-wheeled vehicle suspension is provided. The two-wheeled vehicle suspension includes a suspended body, a kinematic joint between two linkage bodies defining an IVC axis, a braking mechanism, a rotary mechanism that applies torque about the IVC axis, and a bore interface associated with the rotary mechanism. When viewed from a plane defined by the IVC axis there is an intersection between the projections of the bore interface and the braking mechanism during at least a portion of a travel of the suspension.

Optionally, in some embodiments, the braking mechanism includes a rotor.

Optionally, in some embodiments, the braking mechanism includes a caliper.

Optionally, in some embodiments, the kinematic joint is operably connected to a rear wheel, wherein the rear wheel defines a rear wheel axis.

Optionally, in some embodiments, the kinematic joint is operably connected to a front wheel, wherein the front wheel defines a front wheel axis.

Optionally, in some embodiments, the kinematic joint defines a DIVC.

Optionally, in some embodiments, the kinematic joint defines a DIVC[AD].

Optionally, in some embodiments, as the suspension cycles the DIVC[AD] is stationary when considering a reference frame where the suspended body is stationary.

Optionally, in some embodiments, as the suspension cycles the DIVC[AD] migrates when considering a reference frame where the suspended body is stationary.

Optionally, in some embodiments, the kinematic joint defines a DIVC[A].

Optionally, in some embodiments, as the suspension cycles the DIVC[A] is stationary when considering a reference frame where the suspended body is stationary.

Optionally, in some embodiments, as the suspension cycles the DIVC[A] migrates when considering a reference frame where the suspended body is stationary.

Optionally, in some embodiments, the IVC axis is not associated with a DIVC.

Optionally, in some embodiments, the kinematic joint defines a DIVC[D].

Optionally, in some embodiments, as the suspension cycles the DIVC[D] migrates when considering a reference frame where the suspended body is stationary.

Optionally, in some embodiments, as the suspension cycles the DIVC[D] is stationary when considering a reference frame where the suspended body is stationary.

Optionally, in some embodiments, the IVC axis is located rearward of the front wheel axis.

Optionally, in some embodiments, the IVC axis is located forward of the front wheel axis.

Optionally, in some embodiments, the two-wheeled vehicle suspension further includes a tire mounted to a wheel defining a tire outer diameter. When viewed from a plane defined by the IVC axis, all kinematic joint projections are located within the tire outer diameter during at least a portion of a travel of the suspension.

Optionally, in some embodiments, the two-wheeled vehicle suspension further includes a braking mechanism and a bore interface associated with the rotary mechanism. When viewed from a plane defined by the IVC axis there is an intersection between projections of the bore interface and the braking mechanism during at least a portion of a travel of the suspension.

Optionally, in some embodiments, a cassette is operably connected to the rear wheel, and there is an intersection between the projections of the bore interface and the cassette during at least a portion of a travel of the suspension.

Optionally, in some embodiments, the two-wheeled vehicle suspension further includes a braking mechanism and a bore interface associated with the rotary fluid damper. When viewed from a plane defined by the IVC axis there is an intersection between the projections of the bore interface and the braking mechanism during at least a portion of a travel of the suspension.

Optionally, in some embodiments, the rotary mechanism includes a damper.

Optionally, in some embodiments, a wheel is mounted to a wheel carrier body, and a travel range of the wheel carrier body is adjustable.

In one embodiment, a two-wheeled vehicle suspension is provided. The two-wheeled vehicle suspension includes a plurality of linkage bodies including a suspended body, a plurality of kinematic joints each defining an IVC axis, a wheel defining a wheel axis, a tire mounted to the wheel defining a tire outer diameter, and a rotary mechanism that applies torque about an IVC axis. When viewed from a plane defined by the wheel axis, all kinematic joint projections are located within the tire outer diameter during at least a portion of a travel of the suspension.

Optionally, in some embodiments, the wheel is a rear wheel, wherein the rear wheel defines a rear wheel axis.

Optionally, in some embodiments, the wheel is a front wheel, wherein the front wheel defines a front wheel axis.

Optionally, in some embodiments, a linkage body is a wheel carrier.

Optionally, in some embodiments, a linkage body is a brake carrier.

Optionally, in some embodiments, the wheel carrier is independent from a brake carrier.

Optionally, in some embodiments, the wheel carrier is also a brake carrier.

Optionally, in some embodiments, as the suspension cycles a DIVC[D] migrates when considering a reference frame where the suspended body is stationary.

Optionally, in some embodiments, as the suspension cycles a DIVC[D] is stationary when considering a reference frame where the suspended body is stationary.

Optionally, in some embodiments, as the suspension cycles a DIVC[A] migrates when considering a reference frame where the suspended body is stationary.

Optionally, in some embodiments, as the suspension cycles a DIVC[A] is stationary when considering a reference frame where the suspended body is stationary.

Optionally, in some embodiments, a travel range of the wheel carrier is adjustable.

Optionally, in some embodiments, there are two wheel carrier bodies that undergo identical kinematic motion, and are located on either side of the wheel respectively.

Optionally, in some embodiments, the rotary mechanism includes a spring.

Optionally, in some embodiments, the rotary mechanism includes a damper.

Optionally, in some embodiments, there are at least 4 kinematic joints.

Optionally, in some embodiments, there are at least 7 kinematic joints.

Optionally, in some embodiments, more than one joint defines the motion of a brake carrier body.

Optionally, in some embodiments, more than one joint defines the motion of a wheel carrier body.

Optionally, in some embodiments, a vertical wheel travel from an extended state to a compressed state is less than 150 mm.

In one embodiment, a two-wheel vehicle suspension is provided. The two-wheel vehicle suspension includes a wheel defining a wheel axis, a tire mounted to the wheel defining a tire outer diameter, and a rotary fluid damper that applies torque about an IVC axis. When viewed from a plane defined by the wheel axis, all kinematic joint projections are located within the tire outer diameter during at least a portion of a travel of the suspension.

Optionally, in some embodiments, the rotary fluid damper is modular.

Optionally, in some embodiments, the modular rotary fluid damper provides a fixed suspension travel.

Optionally, in some embodiments, the damper includes valves that act on fluid.

Optionally, in some embodiments, a damper valve is located on a rotor of the rotary mechanism.

Optionally, in some embodiments, a damper valve is located on a stator of the rotary mechanism.

Optionally, in some embodiments, damper valves are adjustable.

Optionally, in some embodiments, there is a compression damper valve and a rebound damper valve.

Optionally, in some embodiments, the rotary fluid damper further includes at least one component having a spring.

Optionally, in some embodiments, the spring has an elastomeric property.

Optionally, in some embodiments, the component includes a solid, continuous, or filled main body.

Optionally, in some embodiments, the component includes an at least partially hollow main body.

Optionally, in some embodiments, the component has a constant cross section.

Optionally, in some embodiments, an elastomer has a variable cross section.

Optionally, in some embodiments, an elastomer has a substantially constant spring rate.

Optionally, in some embodiments, an elastomer has a non-constant spring rate.

Optionally, in some embodiments, a spring rate of an elastomer is adjustable.

Optionally, in some embodiments, the elastomer is mechanically pre-loaded to adjust a spring rate.

Optionally, in some embodiments, an elastomer is replaced to adjust a spring rate.

Optionally, in some embodiments, the rotary fluid damper includes an additional elastomer to resist motion in a direction from an extended state to a compressed state.

Optionally, in some embodiments, the additional elastomer has a spring rate that is different from that of the component.

Optionally, in some embodiments, the rotary fluid damper includes an additional elastomer to resist motion in a direction from an extended state to an over-extended state.

Optionally, in some embodiments, the additional elastomer has a spring rate that is different from that of the component.

### BRIEF DESCRIPTION OF FIGURES

FIG. 1 is a drive-side view of a complete two-wheeled vehicle shown with embodiment 1 of the disclosed rear and front rotary suspension system in the extended state.

FIG. 2 is a drive-side view of a complete two-wheeled vehicle shown with embodiment 1 of the disclosed rear and front rotary suspension system in the compressed state.

FIG. 3 is an isometric view of a complete two-wheeled vehicle shown with embodiment 1 of the disclosed rear and front rotary suspension system in the extended state.

FIG. 4 is a rear view of a complete two-wheeled vehicle shown with embodiment 1 of the disclosed rear and front rotary suspension system in the extended state.

FIG. 5 is a front view of a complete two-wheeled vehicle shown with embodiment 1 of the disclosed rear and front rotary suspension system in the extended state.

FIG. 6 is a top view of a complete two-wheeled vehicle shown with embodiment 1 of the disclosed rear and front rotary suspension system in the extended state.

FIG. 7 is a drive-side view of the two-wheeled vehicle shown in FIG. 1 to FIG. 6 showing embodiment 1 of the disclosed rear and front rotary suspension system with parts removed for clarity. The system is shown in both the extended state (Solid) and the compressed state (Dotted).

FIG. 8 is a cropped and zoomed in drive-side view of the two-wheeled vehicle shown in FIG. 7 of embodiment 1 showing the rear portion of the disclosed rotary suspension system. The system is shown in both the extended state (Solid) and the compressed state (Dotted).

FIG. 9 is a cropped and zoomed in drive-side view of the two-wheeled vehicle shown in FIG. 7 of embodiment 1 showing the front portion of the disclosed rotary suspension system. The system is shown in both the extended state (Solid) and the compressed state (Dotted).

FIG. 10 is a drive-side view of the two-wheeled vehicle shown in FIG. 1 showing the frame and fork of embodiment 1 of the disclosed rear and front rotary suspension system with additional parts removed for clarity.

FIG. 11 is an isometric view of the two-wheeled vehicle shown in FIG. 1 showing the frame and fork of embodiment 1 of the disclosed rear and front rotary suspension system with additional parts removed for clarity.

FIG. 12 is a cropped isometric view of the two-wheeled vehicle shown in FIG. 1 showing embodiment 1 of the disclosed rear rotary suspension system with additional parts removed for clarity.

FIG. 13 is a cropped, exploded, isometric view of the two-wheeled vehicle shown in FIG. 1 showing embodiment 1 of the disclosed rear rotary suspension system assembly with additional parts added back in for clarity.

FIG. 14 shows the cross section line A-A via a cropped drive-side view of embodiment 1 of the disclosed rear rotary suspension system with various parts removed for clarity.

FIG. 15 shows cross section A-A of FIG. 14.

FIG. 16 shows the cross section line B-B via a top view of embodiment 1 of the disclosed rear rotary suspension system in the extended state with various parts removed for clarity.

FIG. 17 shows a cropped cross section B-B of FIG. 16 with the rear wheel axle (43), the rear hub flange interconnect (38), and the rear brake caliper (48) which is a component of a braking mechanism removed for clarity. This view shows a relationship between the rear wheel carrier and brake carrier caliper mounts [Non-Drive] [Embodiment-1] (61), the rear suspension pivot axis (12), and the rear suspension pivot aperture/bore [Non-Drive] (17).

FIG. 18 shows a cropped cross section B-B of FIG. 16 with the rear wheel axle (43) and the rear hub flange interconnect (38) removed for clarity. This view shows a relationship between the rear brake caliper (48), the rear suspension pivot axis (12), and the rear suspension pivot aperture [Non-Drive] (17).

FIG. 19 shows a cropped cross section B-B of FIG. 16 with the rear triangle (2) and the rear brake rotor (50) which is a component of a braking mechanism for clarity. This view shows the relationship between the rear brake rotor (50), the rear suspension pivot axis (12), and the rear suspension pivot aperture/bore [Non-Drive] (17).

FIG. 20 shows the cross section line C-C via a top view of embodiment 1 of the disclosed rear rotary suspension system in the extended state with various parts removed for clarity.

FIG. 21 shows a cropped cross section B-B of FIG. 20 with the rear wheel axle, the rear hub flange interconnect, and the rear brake caliper removed and the rear driven cassette (44) added for clarity. This view shows the relationship between the rear driven cassette (44), the rear suspension pivot axis (12), and the rear suspension pivot aperture/bore [Non-Drive] (17).

FIG. 22 shows an isolated isometric view of Rear Stator [Drive] [Embodiment-1][64] with Rear Stator Blades [Drive] [Embodiment-1] (65).

FIG. 23 shows an isometric view of Rear Wheel Carrier [Drive] [Embodiment-1] (51) with Rear Wheel Carrier Blades [Drive] [Embodiment-1] (52) in the extended state.

FIG. 24 shows an isolated isometric view of Rear Wheel Carrier [Drive] [Embodiment-1] (51) in the extended state. Here the Rear Elastomers Top-Out Extended [Drive] [Embodiment-1] (70) and the Rear Elastomers Primary Extended [Drive] [Embodiment-1] (72) are shown Dotted, while the Rear Elastomers Top-Out Compressed [Drive] [Embodiment-1] (71) and Rear Elastomers Primary Compressed [Drive] [Embodiment-1] (73) are shown dotted. This provides a visualization of the allotted migration of Rear Wheel Carrier Blades [Drive] [Embodiment-1] (52) as the rear wheel axis moves from the Rear Wheel Axis [Extended] (21) position to the Rear Wheel Axis [Compressed][24] position to the Rear Wheel Axis [Over-Extended] (23) position

FIG. 25 shows an isolated isometric view of Rear Wheel Carrier [Drive] [Embodiment-1] (51) in the extended state. Here the Rear Elastomers Top-Out Extended [Drive] [Embodiment-1] (70) and the Rear Elastomers Primary Extended [Drive] [Embodiment-1] (72) are shown Solid. This provides a visualization of the assembly in the Rear Wheel Axis [Extended] (21) position.

FIG. 26 shows an isolated isometric view of Rear Wheel Carrier [Drive] [Embodiment-1] (51) in the compressed state. Here the Rear Elastomers Top-Out Extended [Drive] [Embodiment-1] (70) and the Rear Elastomers Primary Compressed [Drive] [Embodiment-1] (73) are shown Solid. This provides a visualization of the assembly in the Rear Wheel Axis [Compressed] (24) position.

FIG. 27 shows an isolated isometric view of Rear Wheel Carrier [Drive] [Embodiment-1] (51) in the over-extended state. Here the Rear Elastomers Top-Out Compressed [Drive] [Embodiment-1] (71) and the Rear Elastomers Primary Extended [Drive] [Embodiment-1] (72) are shown Solid. This provides a visualization of the assembly in the Rear Wheel Axis [Over-Extended] (23) position.

FIG. 28 shows the cross section line D-D via a cropped top view of embodiment 1 of the disclosed rear rotary suspension system with various parts removed for clarity.

FIG. 29 shows a cross section D-D view of FIG. 28 in the extended state.

FIG. 30 shows a cross section D-D view of FIG. 28 in the compressed state.

FIG. 31 shows a cross section D-D view of FIG. 28 in the over-extended state.

FIG. 32 shows an isometric exploded view of the Rear Wheel Carrier and Brake Carrier [Non-Drive] [Embodiment-1] (56) and various parts to highlight the assembly of the Rear Hub Flange Interconnect (38).

FIG. 33 shows an alternative isometric exploded view of the Rear Wheel Carrier and Brake Carrier [Non-Drive] [Embodiment-1] (56) and various parts to highlight the assembly of the Rear Hub Flange Interconnect (38).

FIG. 34 is a cropped isometric view of the two-wheeled vehicle shown in FIG. 1 showing embodiment 1 of the disclosed front rotary suspension system with additional parts removed for clarity.

FIG. 35 is a cropped top view of the two-wheeled vehicle shown in FIG. 1 state showing embodiment 1 of the disclosed front rotary suspension system with additional parts removed for clarity.

FIG. 36 is an exploded, isometric view of the two-wheeled vehicle shown in FIG. 1 showing embodiment 1 of the disclosed front rotary suspension system assembly with additional parts added back in for clarity.

FIG. 37 shows the cross section line E-E via a cropped drive-side view of embodiment 1 of the disclosed rear rotary suspension system in the extended state with various parts removed for clarity.

FIG. 38 shows a cross section E-E view of FIG. 37.

FIG. 39 shows a cropped cross section B-B of FIG. 16 with the front wheel axle (112), the front hub flange interconnect (108), and the front brake caliper (113) removed for clarity. This view shows the relationship between the front wheel carrier and brake carrier caliper mounts [Non-Drive] [Embodiment-1] (128), the front suspension pivot axis (82), and the front suspension pivot aperture/bore [Non-Drive] (87).

FIG. 40 shows a cropped cross section B-B of FIG. 16 with the front wheel axle (121) and the front hub flange interconnect (108) removed for clarity. This view shows a relationship between the front brake caliper (113), the front suspension pivot axis (82), and the front suspension pivot aperture/bore [Non-Drive] (87).

FIG. 41 shows a cropped cross section B-B of FIG. 16 with the front triangle (1) and the front brake rotor (115) for clarity. This view shows the relationship between the front brake rotor (115), the front suspension pivot axis (87), and the front suspension pivot aperture/bore [Non-Drive] (87).

FIG. 42 shows an isometric exploded view of the Front Wheel Carrier [Drive] [Embodiment-1] (116) and various parts to highlight the assembly of the Front Hub Flange Interconnect (108).

FIG. 43 shows an alternative isometric exploded view of the Front Wheel Carrier [Drive] [Embodiment-1] (116) and various parts to highlight the assembly of the Front Hub Flange Interconnect (108).

FIG. 44 is a cropped isometric view of the two-wheeled vehicle shown in FIG. 1 showing embodiment 2 of the disclosed rear rotary suspension system with additional parts removed for clarity.

FIG. 45 is a cropped, exploded, isometric view of the two-wheeled vehicle shown in FIG. 1 showing embodiment 2 of the disclosed rear rotary cartridge suspension system assembly with additional parts added back in for clarity.

FIG. 46 is drive-side view of the Rotary Cartridge [Drive] (139)

FIG. 47 an isometric view of the Rotary Cartridge [Drive] (139)

FIG. 48 a top view of the Rotary Cartridge [Drive] (139)

FIG. 49 an isometric, exploded view of the Rotary Cartridge [Drive] (139)

FIG. 50 an alternative isometric, exploded view of the Rotary Cartridge [Drive] (139)

FIG. 51 a cropped isometric, exploded view of the Rotary Cartridge [Non-Drive] (140) and the Rear Wheel Carrier and Brake Carrier Caliper Mounts [Non-Drive] [Embodiment-2] (176)

FIG. 52 shows the cross section line F-F via a cropped drive-side view of embodiment 2 of the disclosed rear rotary suspension system with various parts removed for clarity.

FIG. 53 shows cross section F-F of FIG. 52.

FIG. 54 is an isometric view of the Rotary Cartridge [Drive] (139) with the Rotary Cartridge Stator Inner (146) cut away as shown with hashed marks, in the extended state. Here the Rear Elastomers Top-Out Extended [Drive] [Embodiment-2] (159) and the Rear Elastomers Primary Extended [Drive] [Embodiment-2] (161) are shown Dotted, while the Rear Elastomers Top-Out Compressed [Drive] [Embodiment-2] (160) and Rear Elastomers Primary Compressed [Drive] [Embodiment-2] (160) are shown dotted. This provides a visualization of the allotted migration of Rotary Cartridge Rotor Blade [Solid] (155) as the rear wheel axis moves from the Rear Wheel Axis [Extended] (21) position to the Rear Wheel Axis [Compressed] (24) position to the Rear Wheel Axis [Over-Extended] (23) position

FIG. 55 shows an isometric view of the Rotary Cartridge [Drive] (139) with the Rotary Cartridge Stator Inner (146) cut away as shown with hashed marks, in the extended state. Here the Rear Elastomers Top-Out Extended [Drive] [Embodiment-2] (159) and the Rear Elastomers Primary Extended [Drive] [Embodiment-2] (161) are shown Solid. This provides a visualization of the assembly in the Rear Wheel Axis [Extended] (21) position.

FIG. 56 shows an isometric view of the Rotary Cartridge [Drive] with the Rotary Cartridge Stator Inner (146) cut away as shown with hashed marks, in the compressed state. Here the Rear Elastomers Top-Out Extended [Drive] [Embodiment-2][159] and the Rear Elastomers Primary Compressed [Drive] [Embodiment-1] (162) are shown Solid. This provides a visualization of the assembly in the Rear Wheel Axis [Compressed] (24) position.

FIG. 57 shows an isometric view of the Rotary Cartridge [Drive] (139) with the Rotary Cartridge Stator Inner (146) cut away as shown with hashed marks, in the over-extended state. Here the Rear Elastomers Top-Out Compressed [Drive] [Embodiment-2] (160) and the Rear Elastomers Primary Extended [Drive] [Embodiment-2] (161) are shown Solid. This provides a visualization of the assembly in the Rear Wheel Axis [Over-Extended] (23) position.

FIG. 58 shows the cross section line G-G via a cropped top view of embodiment 2 of the disclosed rear rotary suspension system with various parts removed for clarity.

FIG. 59 shows a cross section G-G view of FIG. 58 in the extended state.

FIG. 60 shows a cross section G-G view of FIG. 58 in the compressed state.

FIG. 61 shows a cross section G-G view of FIG. 58 in the over-extended state.

FIG. 62 shows an isometric view of the fluid damper embodiment 3 of the Rotary Cartridge [Drive] with the Rotary Cartridge Stator Inner (146) cut away as shown with hashed marks, in a position between the extended and compressed state. Here the Rotary Cartridge Rotor [153] has Rotary Cartridge Rotor Blades [With Valves] (156), with Rotary Cartridge Stator Inner Blade [Solid][148]. In addition, the Rotary Cartridge Damping Valves [163] are shown along with the Rotary Cartridge Damping Fluid (164) locations.

FIG. 63 shows an isometric, exploded view of the fluid damper embodiment 3 of the Rotary Cartridge [Drive] (139) in a position between the extended and compressed state. Here the Rotary Cartridge Rotor (153) has Rotary Cartridge Rotor Blades [With Valves] (156). In addition, the Rotary Cartridge Damping Valves (163) are shown.

FIG. 64 shows an isometric view of the fluid damper embodiment 4 of the Rotary Cartridge [Drive] with the Rotary Cartridge Stator Inner (146) cut away as shown with hashed marks, in a position between the extended and compressed state. Here the Rotary Cartridge Rotor (153) has Rotary Cartridge Rotor Blades [Solid] (155), with Rotary Cartridge Stator Inner Blade [With Valves] (149). In addition, the Rotary Cartridge Damping Valves [163] are shown along with the Rotary Cartridge Damping Fluid (164) locations.

FIG. 65 shows an isometric, exploded view of the fluid damper embodiment 4 of the Rotary Cartridge [Drive] (139) in a position between the extended and compressed state. Here the Rotary Cartridge Rotor (153) has Rotary Cartridge Rotor Blades [Solid] (155) with Rotary Cartridge Stator Inner Blade [With Valves] (149). In addition, the Rotary Cartridge Damping Valves (163) are shown.

FIG. 66 shows an isometric view of the air spring embodiment 5 of the Rotary Cartridge [Drive] (139) with the Rotary Cartridge Stator Inner (146) cut away as shown with hashed marks, in a position between the extended and compressed state. Here the Rotary Cartridge Rotor (153) has Rotary Cartridge Rotor Blades [Solid] (155). In addition the Rotary Cartridge Spring Gas (164) locations are shown.

FIG. 67 shows an isometric, exploded view of the air spring embodiment 5 of the Rotary Cartridge [Drive] (139) in a position between the extended and compressed state. Here the Rotary Cartridge Rotor (153) has Rotary Cartridge Rotor Blades [Solid] (155).

FIG. 68 shows an isometric view of the air spring fluid damper combination embodiment 6 of the Rotary Cartridge [Drive] (139) with the Rotary Cartridge Stator Inner (146) cut away as shown with hashed marks, in a position between the extended and compressed state. Here the Rotary Cartridge Rotor (153) has a Rotary Cartridge Rotor Blade [With Valves] (156) on one side, and Rotary Cartridge Stator Inner Blade [Solid] (148) on the other. Rotary Cartridge Damping Fluid (164) locations and Rotary Cartridge Spring Gas (164) locations are shown.

FIG. 69 shows an isometric, exploded view of the air spring fluid damper combination embodiment 6 of the Rotary Cartridge [Drive] (139) in a position between the extended and compressed state. Here the Rotary Cartridge Rotor (153) has a Rotary Cartridge Rotor Blade [With Valves] (156) on one side a Rotary Cartridge Rotor Blades [Solid] (155) on the other.

FIG. 70 shows an isometric view of the coil or torsional spring embodiment 7 of the Rotary Cartridge [Drive] (139) with the Rotary Cartridge Stator Inner (146) cut away as shown with hashed marks, in a position between the extended and compressed state. Here the Rotary Cartridge Rotor (153) has Rotary Cartridge Rotor Blades [Solid] (155). In addition, the Rotary Cartridge Primary Coil or Torsional Spring (166) and the Rotary Cartridge Top Out Coil or Torsional Spring (167) are shown.

FIG. 71 shows an isometric, exploded view of the metal spring embodiment 7 of the Rotary Cartridge [Drive] (139) with the Rotary Cartridge Stator Inner (146) in a position between the extended and compressed state. Here the Rotary Cartridge Rotor (153) has Rotary Cartridge Rotor Blades [Solid] (155) and the Rotary Cartridge Primary Coil or Torsional Spring (166) and the Rotary Cartridge Top Out Coil or Torsional Spring (167) are shown.

FIG. 72 shows an isometric view of the metal spring fluid damper combination embodiment 8 of the Rotary Cartridge [Drive] (139) with the Rotary Cartridge Stator Inner (146) cut away as shown with hashed marks, in a position between the extended and compressed state. Here the Rotary Cartridge Rotor (153) has a Rotary Cartridge Rotor Blade [With Valves] (156) on one side, and Rotary Cartridge Stator Inner Blade [Solid] (148) on the other. Rotary Cartridge Damping Fluid (164) locations are shown.

FIG. 73 shows an isometric, exploded view of the metal spring fluid damper combination embodiment 8 of the Rotary Cartridge [Drive] (139) in a position between the extended and compressed state. Here the Rotary Cartridge Rotor (153) has a Rotary Cartridge Rotor Blade [With Valves] (156) on one side a Rotary Cartridge Rotor Blades [Solid] (155) and the Rotary Cartridge Primary Coil Springs (166) and the Rotary Cartridge Top Out Coil Springs (167) are shown.

FIG. 74 shows an isometric view of the bearing portion of embodiment 9 of the Rotary Cartridge [Drive] (139) with the Rotary Cartridge Stator Inner (146) cut away as shown with hashed marks, in a position between the extended and compressed state. Here the Rotary Cartridge Rotor (153) has no Rotor Blades and the cartridge acts as a bearing only.

FIG. 75 shows an isometric, exploded view of the bearing portion embodiment 9 of the Rotary Cartridge [Drive] (139) in a position between the extended and compressed state. Here the Rotary Cartridge Rotor (153) has no Rotor Blades and the cartridge acts as a bearing only.

FIG. 76 shows a drive-side view of the non-constant radius of curvature spring element embodiment 10 of the Rotary Cartridge [Drive] (139) with the Rotary Cartridge Stator Inner (146) cut away as shown with hashed marks, in the extended state. Here the Rotary Cartridge Stator Inner (146) has Rotary Cartridge Stator Inner Splined Slots (150) that are filled with Rotary Cartridge Elastomer Capsules [Extended] (168).

FIG. 77 shows a drive-side view of the non-constant radius of curvature spring element embodiment 10 of the Rotary Cartridge [Drive] (139) with the Rotary Cartridge Stator Inner (146) cut away as shown with hashed marks, in the compressed state. Here the Rotary Cartridge Rotor (153) has a Rotary Cartridge Rotor Blade [With Slots] (157) and the Rotary Cartridge Stator Inner (146) has Rotary Cartridge Stator Inner Splined Slots (150) that are filled with Rotary Cartridge Elastomer Capsules [Extended] (168) and Rotary Cartridge Elastomer Capsules [Compressed] (169).

FIG. 78 shows an isometric, exploded view the non-constant radius of curvature spring element embodiment 10 of the Rotary Cartridge [Drive] (139) in the extended state. Here the Rotary Cartridge Rotor (153) has a Rotary Cartridge Rotor Blade [With Slots] (157) and the Rotary Cartridge Stator Inner (146) has Rotary Cartridge Stator Inner Splined Slots (150) that are filled with Rotary Cartridge Elastomer Capsules [Extended] (168).

FIG. 79 shows an isometric view of the elastomer embodiment 11 of the Rotary Cartridge [Drive] (139) with the Rotary Cartridge Stator Inner (146) cut away as shown with hashed marks has multitude of rotary cartridge stator Inner Blades (148), in extended state. Here the Rotary Cartridge Rotor (153) has a multitude of Rotary Cartridge Rotor Blades [Solid] (155). Also included are a multitude of rotary cartridge elastomer cylinders [Extended] (191).

FIG. 80 shows an isometric, exploded view of the elastomer embodiment 11 of the Rotary Cartridge [Drive] (139) in an extended state.

FIG. 81 shows an isometric view of the elastomer embodiment 12 of the Rotary Cartridge [Drive] (139) with the Rotary Cartridge Stator Inner (146) cut away as shown with hashed marks has multitude of rotary cartridge stator Inner Blades (148), in an extended state. Here the Rotary Cartridge Rotor (153) has a multitude of Rotary Cartridge Rotor Blades [Solid] (155). Also included are a multitude of rotary cartridge elastomer discs [Extended] (192).

FIG. 82 shows an isometric, exploded view of the elastomer embodiment 12 of the Rotary Cartridge [Drive] (139) in an extended state.

FIG. 83 shows a cross section D-D view of FIG. 28 in the extended state with certain components removed except for the rear triangle (2) and the Rear Suspension Pivot Structure [Drive] (13) to illustrate the wheel path clearly. Here the following figure items can be seen: Vertical Wheel Travel [E-C] (179), Angular Wheel Travel [E-C] (180), Resistance Curve Length [E-C] (181), Vertical Wheel Travel [E-OE] (182), Angular Wheel Travel [E-OE] (183), Resistance Curve Length [E-OE] (184), Resistance Curve Length Distance (185).

FIG. 84 shows the embodiment of FIG. 9 with certain components removed except for the fork upper (78) and the included Front Suspension Pivot Structure [Drive] (83) to illustrate the wheel path clearly. Here the following figure items are shown: Vertical Wheel Travel [E-C] (179), Angular Wheel Travel [E-C] (180), Resistance Curve Length [E-C] (181), Vertical Wheel Travel [E-OE] (182), Angular Wheel Travel [E-OE] (183), Resistance Curve Length [E-OE] (184), Resistance Curve Length Distance (185).

FIG. 85 is a drive-side view of a complete two-wheeled vehicle shown with embodiment 3 of the disclosed rear rotary suspension system in the extended state, according to aspects of the present disclosure.

FIG. 86 is a drive-side view of a complete two-wheeled vehicle shown with embodiment 3 of the disclosed rear rotary suspension system in the compressed state, according to aspects of the present disclosure.

FIG. 87 is an isometric view of embodiment 3 of the disclosed rear rotary suspension system with the rear wheel removed for clarity, according to aspects of the present disclosure.

FIG. 88 is an isometric view of embodiment 3 of the disclosed rear suspension assembly in a compressed state with the rear wheel removed for clarity, according to aspects of the present disclosure.

FIG. 89 is an isometric view of the rear triangle portion of embodiment 3 with certain components removed to expose structural features, according to aspects of the present disclosure.

FIG. 90 is an isometric view of a complete two-wheeled vehicle shown with embodiment 3 of the disclosed rear rotary suspension system in the compressed state with the rear wheel removed for clarity, according to aspects of the present disclosure.

FIG. 91 is a detail view of embodiment 3 of the disclosed rear suspension system in the compressed state focused about the rear wheel axis, according to aspects of the present disclosure.

FIG. 92 is an alternate isometric view of a complete two-wheeled vehicle shown with embodiment 3 with the rear wheel removed in the extended state, according to aspects of the present disclosure.

FIG. 93 is a detail isometric view of embodiment 3 of the disclosed rear suspension system focused about the rear wheel axis in the extended state, according to aspects of the present disclosure.

FIG. 94 is a detail view of the rear triangle isolating the rear suspension pivot structures in embodiment 3, according to aspects of the present disclosure.

FIG. 95 is an alternate isometric view of a complete two-wheeled vehicle shown with embodiment 3 with the rear wheel removed in the compressed state, according to aspects of the present disclosure.

FIG. 96 is a detail view of embodiment 3 of the disclosed rear suspension system in the compressed state isolating the rear triangle components, according to aspects of the present disclosure.

FIG. 97 is a drive-side view of a complete two-wheeled vehicle shown with embodiment 3 of the disclosed rear rotary suspension system in the extended state with the rear wheel removed for clarity, according to aspects of the present disclosure.

FIG. 98 is a detail view of embodiment 3 of the disclosed rear rotary suspension system in the extended state focused about the rear wheel axis, according to aspects of the present disclosure.

FIG. 99 is a section view showing the H-H section line of FIG. 98, according to aspects of the present disclosure.

FIG. 100 is a section view H-H showing both the damper and spring assemblies installed into the suspended body of embodiment 3, according to aspects of the present disclosure.

FIG. 101 is a drive-side view of a complete two-wheeled vehicle shown with embodiment 3 of the disclosed rear rotary suspension system in the compressed state, according to aspects of the present disclosure.

FIG. 102 is a detail view of a complete two-wheeled vehicle shown with embodiment 3 of the disclosed rear rotary suspension system in the compressed state focused about the rear wheel axis, according to aspects of the present disclosure.

FIG. 103 is a non-drive-side view of a complete two-wheeled vehicle shown with embodiment 3 of the disclosed rear rotary suspension system in the extended state with the rear wheel removed for clarity, according to aspects of the present disclosure.

FIG. 104 is a detail view of the non-drive side of embodiment 3 of the disclosed rear suspension system in the extended state focused about the rear wheel axis, according to aspects of the present disclosure.

FIG. 105 is a non-drive-side view of a complete two-wheeled vehicle shown with embodiment 3 of the disclosed rear rotary suspension system in the compressed state, according to aspects of the present disclosure.

FIG. 106 is a detail view of embodiment 3 of the disclosed rear suspension system in the compressed state shown from the non-drive side, according to aspects of the present disclosure.

FIG. 107 is an isometric exploded view of embodiment 3 showing the modular damper assembly, spring assembly, and brake carrier linkage assembly, according to aspects of the present disclosure.

FIG. 108 is an isometric view of the brake carrier linkage assembly for embodiment 3, according to aspects of the present disclosure.

FIG. 109 is an alternate isometric view of the brake carrier linkage assembly for embodiment 3, according to aspects of the present disclosure.

FIG. 110 is an alternate isometric exploded view of the brake carrier linkage assembly for embodiment 3, according to aspects of the present disclosure.

FIG. 111 is an isometric view of the modular damper assembly for embodiment 3, according to aspects of the present disclosure.

FIG. 112 is an isometric exploded view of the modular damper assembly for embodiment 3, according to aspects of the present disclosure.

FIG. 113 is an alternate isometric view of the modular damper assembly for embodiment 3, according to aspects of the present disclosure.

FIG. 114 is an isometric exploded view of the modular damper assembly for embodiment 3 showing damper valve components, according to aspects of the present disclosure.

FIG. 115 is an isometric view of the modular spring assembly for embodiment 3, according to aspects of the present disclosure.

FIG. 116 is an isometric exploded view of the modular spring assembly for embodiment 3, according to aspects of the present disclosure.

FIG. 117 is an isometric view of the modular spring assembly for embodiment 3 showing spring cap and stator components, according to aspects of the present disclosure.

FIG. 118 is an isometric exploded view of the modular spring assembly for embodiment 3 showing internal spring components, according to aspects of the present disclosure.

FIG. 119 is a drive-side view of the modular damper assembly for embodiment 3 in the extended state with the damper cap removed, according to aspects of the present disclosure.

FIG. 120 is a drive-side view of the modular damper assembly for embodiment 3 in the compressed state with the damper cap removed, according to aspects of the present disclosure.

FIG. 121 is a drive-side view of the modular spring assembly for embodiment 3 in the extended state with the spring cap removed, according to aspects of the present disclosure.

FIG. 122 is a drive-side view of the modular spring assembly for embodiment 3 in the compressed state with the spring cap removed, according to aspects of the present disclosure.

FIG. 123 is a detailed isometric exploded view of embodiment 3 showing both the damper and spring sides of the rear suspension system, according to aspects of the present disclosure.

FIG. 124 is a drive-side view of a complete two-wheeled vehicle shown with embodiment 3 of the disclosed rear rotary suspension system in the extended state illustrating anti-rise behavior, according to aspects of the present disclosure.

FIG. 125 is a drive-side view of a complete two-wheeled vehicle shown with embodiment 3 of the disclosed rear rotary suspension system in the compressed state illustrating anti-rise behavior, according to aspects of the present disclosure.

FIG. 126 is an anti-rise percentage versus wheel travel plot for embodiment 3 of the disclosed rear rotary suspension system, according to aspects of the present disclosure.

FIG. 127 is a non-drive-side view of a complete two-wheeled vehicle shown with embodiment 4 of the disclosed front rotary suspension system in the extended state illustrating anti-dive behavior, according to aspects of the present disclosure.

FIG. 128 is a non-drive-side view of a complete two-wheeled vehicle shown with embodiment 4 of the disclosed front rotary suspension system in the compressed state illustrating anti-dive behavior, according to aspects of the present disclosure.

FIG. 129 is an anti-dive percentage versus wheel travel plot for embodiment 4 of the disclosed front rotary suspension system, according to aspects of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Each of the various embodiments can be variously applied to the embodiments and examples of the various systems discussed in more detail below. Various theories, methods, algorithms or analysis systems are provided herein. These systems are provided for better understanding of the structures and configurations described. Unless specifically claimed, the systems are not limiting regardless of current accuracy or subsequent clarifications or understandings of the structures and configurations that may be determined by persons of ordinary skill in the art.

Accordingly, provided herein are various methods or algorithms suitable for analyzing suspension linkage systems. For example, various methods are provided for calculating unknown IVCs of linkage bodies for a suspension system. Such analytical methods are provided for fuller understanding of the various mechanisms discussed herein. As it is understood that throughout this disclosure the relationship of various linkages are described with respect to characteristics of those linkages. The study of kinematics describes the motion of bodies or objects or points where each body or object is considered to be theoretically rigid. When more than one kinematic body is jointly connected, the system is referred to as a kinematic chain or linkage or mechanism. Kinematic bodies may also be interchangeably referred to as kinematic links or kinematic bars or kinematic members. Linkages may be classified by how the objects are constrained in space. Examples include planar (constrained to a plan), spherical (maintain a constant distance to a common center point) or spatial (can occupy any position in space). Note that with planar linkages h=0 in the mobility analysis of mechanisms described in detail below.

There are various classifications of kinematic joints (also referred to as pairs or nodes) that define the particular type of relative motion allowed between kinematic bodies.

These classifications can be further grouped into lower pairs, and higher pairs. For the scope of this disclosure, the focus will be first order joints. Frist order joints can be further categorized by the degree of freedom (DOF) that is allowed between the jointed bodies. For the scope of this disclosure, we will focus on first order joints with 1 DOF, which are also known as first order joints or full-joints. However, it may be understood that higher order joints are possible. Note that in first order joints f=1 for each first order joint of the mechanism being considered in the mobility analysis described in detail below.

In addition, a single kinematic body may be classified by the number of joints or nodes it has. Examples include Binary (two joints), ternary (three joints), quaternary (4 joints), and pentanary (5 joints).

Note that while this disclosure focuses on planar, constrained mechanisms with first order revolute joints, this is not intended to limit the scope of the disclosure, and any type of mechanism or joint classification type is possible.

In engineering, kinematic analysis is used to determine the movement of a mechanism. Mechanisms or linkages are designed to perform a useful output given a defined input and may be classified based on their system properties. In the case of this disclosure a suspension system, be it a rear suspension or a front suspension is considered a mechanism or a linkage. In accordance with various embodiments, a two-wheeled vehicle suspension system that utilize a rotary (about an axis of a kinematic joint) resistive or resistance mechanism. The resistance mechanism may be referred to, but not limited to, a shock, a spring, an elastomer, or a damper.

Other common names include valve damper, disc damper, rotary damper, rotary spring, and fluid damper. The present disclosure is described and illustrated in the context of human powered two-wheeled vehicle; however, it can also be applied to a two-wheeled vehicle that is at least partially driven by a motor, or by combined motor and human power. Although in other embodiments, combinations of each of these are also understood. Note that “drive” or “drive-side” will refer to the side of the vehicle in which the drivetrain (driving/driven cogs, chain/belt, derailleurs/etc.) are installed, while “non-drive” or “non-drive side” will refer to the opposite side. In the disclosure the “drive-side” is located on the right side of the vehicle when viewed from the back, and the “non-drive side” is located on the left side of the vehicle when viewed from the back. Note that in practice this can be reversed or mixed.

For this disclosure, it is useful to distinguish a kinematic suspension body or bar or member or link from a structural body or bar or member.

A kinematic body as described above. Note that a kinematic body refers to n in the mobility analysis of mechanisms described in detail below.

A structural body will be defined as body within the physical mechanism.

It is useful to note that when a planar kinematic linkage is applied to a physical three-dimensional mechanism such as the suspension system in a two-wheeled vehicle, there may be more than one structural body that undergoes identical motion (or lack of). In other words, the motion of more than one structural body can have the identical kinematic body.

One analysis system useful for assessing these relationships is the Mobility Analysis of Mechanisms. The Mobility Analysis of Mechanisms (Kutzbach (or Grubler) mobility criterion) may be used to describe the mobility, or output degree of freedom of a linkage. This system may be used to describe the mobility m of a planar linkage including n links or bodies or bars that are coupled with p first order joints/pivots. In the various embodiments, discussed herein, the links can be connected via these flexible joints/pivots allowing some degree of freedom between one another. Additionally, the relationship of the links via the joints define various characteristics such as instantaneous velocity centers (IVCs). In various examples as applied to the various embodiments discussed herein, the flexible joints/pivots can include revolute, slider, cam joints, or any other suitable flexible joints or pivots that enable one degree of freedom movement between the two links they connect. Notably, flexible joints may include intermediary devices connecting the linkages. Depending on the types of joints, quality of joints, or the tolerances in the joints, characteristics (e.g. the IVCs or other characteristics discussed herein) may have small variances between joints due to real world engineering constraints and calculations. Terminology such as generally, substantially, or other similar terms may be used to account for the expected, calculated, or otherwise real world accuracy of the characteristics discussed herein while allowing for real world variance in the characteristics. Note that if bodies are coupled as one and not considered completely rigid, a specific joint (e.g. a revolute joint) may be assumed theoretically for analysis near the point of flexure in the flexible joint. Also, note that although the linkage is considered planar kinematically, the assembly of the mechanism may be 3-dimensional.

The following simplified equation for a planar linkage with revolute joints (f=1) is used for analysis of the various linkage systems herein:

$$mobility = m = 3 ( n - 1 ) - 2 f - h$$

### Where

m=mobility of a linkage (DOF)
n=number of kinematic linkage bodies (or links or members)
f=number of lower pairs
h=number of higher pairs

### First Each First Order Joint

$$f = 1$$

### For Planar Mechanisms

$$h = 1$$

Therefore when
p=number of joints

$$mobility = m = 3 ( n - 1 ) - 2 p$$

Or rearranged

$$mobility = m = 3 ( n - 1 - p ) + p$$

A linkage or mechanism with a mobility m=1 is classified as a constrained mechanism.

As an example, this equation may be applied to a 2-bar planar kinematic linkage with first order joints. The following solves the mobility equation in this case:

$$n = 2$$

$$p = 1$$

$$m = 3 ( n - 1 - p ) + p$$

$$m = 3 ( 2 - 1 - 1 ) + 1$$

$$m = 3 ( 0 ) + 1$$

$$m = 0 + 1$$

$$m = 1$$

As another example, this equation may be applied to a 4-bar planar kinematic linkage with first order joints. The following solves the mobility equation in this case:

$$p = n = 4$$

$$m = 3 ( n - 1 - p ) + p$$

$$m = 3 ( 4 - 1 - 4 ) + 4$$

$$m = 3 ( - 1 ) + 4$$

$$m = - 3 + 4$$

$$m = 1$$

As another example, this equation may be applied to a 6-bar planar kinematic linkage with first order joints. The following solves the mobility equation in this case:

$$n = 6$$

$$p = 7$$

$$m = 3 ( n - 1 - p ) + p$$

$$m = 3 ( 6 - 1 - 7 ) + 7$$

$$m = 3 ( - 2 ) + 7$$

$$m = - 6 + 7$$

$$m = 1$$

In the examples above, 2-bar, 4-bar and 6-bar planar kinematic linkages with first order joints, m=1, or there is one degree of freedom of motion. In other words, the mechanism can be driven by a single input motion.

An IVC is a point common to two kinematic linkage bodies where there is zero relative velocity. Depending upon the reference frame chosen for suspension analysis, these IVCs may change location instantaneously as the suspension is cycled from its extended to compressed state. In the case where the kinematic suspended body is assumed to remain fixed, any joint or pivot that is attached to the kinematic suspended body also remains fixed, resulting in an IVC that too remains fixed.

It is important to distinguish a “known” or “primary” IVC which is defined by a physical joint or pivot, to an “unknown” or “virtual” IVC that may not be located at a joint or pivot. Virtual IVCs must be derived from using primary IVC locations, with virtual IVCs that have already been solved for, or a combination of both.

For reference herein, specific instantaneous velocity centers of a linkage are denoted as IVC[Body-A][Body-B]. Body-A and Body-B being the relevant bodies in the relationship. For example, IVC[1][2] is the instantaneous velocity center relative to a body-1 and a body-2. Additionally, IVC[1][2] is equivalent to IVC[2][1].

The suspension system may include several kinematic bodies. In various examples, the suspension system may include a kinematic suspended body. In a two-wheeled vehicle suspension system, the kinematic bodies can be classified as suspended or unsuspended. Suspended kinematic bodies refer to the portion of the vehicles supported by the suspension (like the chassis or body and the passenger(s)). The suspended kinematic body will refer to the two-wheeled vehicles main chassis in which the passenger(s) resides. Unsuspended kinematic bodies refer to the portion of the vehicle that moves independently from the suspended body such as a suspension swingarm or the wheel of a two-wheeled vehicle. In various examples, an unsuspended kinematic body may include a “wheel carrier”, which is operatively coupled to the driven wheel or front wheel, a “brake carrier”, which is operatively coupled to the driven wheel or front brake, or a kinematic “dynamic body” (DB), which is any combination of a wheel carrier and a brake carrier body (e.g., DB=wheel carrier body, or DB=brake carrier body, or DB=wheel and brake carrier body).

Specific IVC migrations called dynamic IVCs (DIVCs) may be utilized to determine the vehicle's dynamic response with respect to the rear wheel and or with respect to the front wheel. The DIVCs depend upon the specific linkage layout but also depend upon suspended body-1 since this is the body in which a passenger or rider will be included. Suspended body-1 is often called the front triangle of a two-wheeled vehicle, however, note that the suspended body can also include the rear triangle or more depending on which members are rigidly connected.

As used herein DIVC[AD] can define both the acceleration and deceleration response of the vehicle.

As used herein DIVC[A] can define the acceleration response of the vehicle.

As used herein DIVC[D] can define a deceleration response of the vehicle.

As used herein DIVC[C] is defined as a DIVC that includes the acceleration component. DIVC[C] can be equal to DIVC[A] or DIVC[AD].

As used herein DIVC[E] is defined as a DIVC that includes the deceleration component. DIVC[E] can be equal to DIVC[D] or DIVC[AD].

As used herein DIVC is a general term and therefore a DIVC may be a DIVC[AD] or a DIVC[A] or a DIVC[D] or a DIVC[C] or a DIVC[E]. As used herein DIVC[L] is the length of the DIVC migration path, spline or curve.

In accordance with various embodiments, the kinematic body-X can be both a wheel carrier and a brake carrier body. In such an embodiment, there is a single DIVC[AD] migration, DIVC[AD][1][X].

In accordance with various embodiments, wheel carrier kinematic body-Y can be separate from the brake carrier kinematic body-Z. In such an embodiment, there are two DIVCs, DIVC[A][1][Y] and DIVC[D][1][Z].

Finally, in accordance with various embodiments, the wheel carrier kinematic body-Y is pivotally concentric to a brake carrier kinematic body-Z. In this case, again there are two DIVCs, DIVC[A][1][Y] and DIVC[D][1][Z]].

Note that with a two-wheeled vehicle each wheel may be analyzed independently for DIVCs. For instance, DIVC[A] or DIVC[D] associated with the rear wheel are different than those associated with the front wheel. Typically, the front wheel only has a DIVC[D] associated as typically only the rear wheel is driven providing acceleration. However, note that it is possible to also have a DIVC[A] associated with the front wheel.

For purposes of understanding, but not to be limiting, it can be noted that the point in which the force of gravity acts on the sum of the suspended vehicle mass (also known as the sprung mass) and any additional mass such as a passenger or cargo that is supported by the suspension is known as the center of gravity (COG). In the static case, with both wheels on the ground, the force due to the suspended mass through the COG is supported by the vehicles two wheels. Depending on the COG location and the wheelbase of the vehicle, the distribution of force between the two wheels may vary. When the vehicle accelerates, load transfer occurs and the force distribution between the two wheels changes. The rear wheel load is increased while the front wheel load is decreased. Thus, the rear suspension tends to compress or squat. Driving forces of the vehicle such as a chain or belt may be utilized to counteract the tendency to squat during acceleration. This is known in vehicle dynamics as anti-squat.

Anti-squat is typically described as a percentage value. 100% anti-squat is when the anti-squat force is equal and opposite to the load transfer force due to acceleration. As a result, the system is in equilibrium and no suspension squat occurs. Over 100% anti-squat is when the anti-squat force is both opposite and greater than the load transfer force and therefore the suspension extends during acceleration. Anti-squat of 0% is when there is zero anti-squat force to counteract the load transfer and therefore suspension squats during acceleration. Anti-squat between 0-100% is when the anti-squat force is both opposite and less than the load transfer force and therefore the suspension squats during acceleration but to a lesser degree than with 0% anti-squat. A negative anti-squat percentage is when the anti-squat force acts in the same direction on the rear wheel as the load transfer force and therefore the squat due to load transfer is magnified. Anti-squat is directly related to the DIVC[C] migration of the suspension linkage. Anti-squat around or slightly above 100% is ideal where pedaling occurs typically around the first half of travel to improve pedaling efficiency. After this point, an anti-squat below 100% is ideal so that the driving force is minimized, and the suspension can be utilized later in the travel where pedaling typically does not occur. This also minimizes feedback from the driving force to the rider. Too high of an anti-squat is less than ideal because it results in high feedback from the driving force to the rider and is detrimental to pedaling efficiency because the load transfer and anti-squat force are far from equilibrium.

When the vehicle decelerates, the force distribution changes and the front wheel load is increased while the rear wheel load is decreased. As a result, the rear suspension tends to extend or rise, and the front wheel tends to compress or dive. The relationship to this extension behavior based on deceleration and the rear linkage layout is known in vehicle dynamics as anti-rise. The relationship to this diving behavior based on deceleration and the front linkage layout is known in vehicle dynamics as anti-dive. The magnitude of anti-rise is directly related to the DIVC[E] migration or the driven or front wheel.

100% anti-rise is when the anti-rise force is equal and opposite to the load transfer force due to deceleration. As a result, the system is in equilibrium and no suspension rise occurs. Over 100% anti-rise is when the anti-rise force is both opposite and greater than the load transfer force and therefore the suspension squats during deceleration. Anti-rise of 0% is when there is zero anti-rise force to counteract the load transfer and therefore suspension rises during deceleration. Anti-rise between 0-100% is when the anti-rise force is both opposite and less than the load transfer force and therefore the suspension rises during deceleration but to a lesser degree than with 0% anti-rise. A negative anti-rise percentage is when the anti-rise force acts in the same direction on the rear wheel as the load transfer force and therefore the rise due to load transfer is magnified. Anti-rise less than 100% may help improve traction while anti-rise greater than 0% may help stabilize geometry during deceleration. Therefore, an anti-rise in the 50-100% can be a suitable range for an improved ride. The same applies to anti-dive as noted with anti-rise.

Based upon the number of bodies present in the structure, the total number of instantaneous velocity centers (IVCs) can be determined. The following equation can be used:

$$Number of Instance Centers = N = \frac{n ( n - 1 )}{2}$$

n=number of bodies moving relative to one another
N=total number of instantaneous velocity centers of the linkage

As an example, this equation may be applied to a 2-bar linkage. In this example, n=2. The following solves the equation for a 2-bar linkage:

$${N}_{2} = \frac{2 ( 2 - 1 )}{2} = \frac{2}{2} = 1$$

As an example, this equation may be applied to a 4-bar linkage. In this example, n=4. The following solves the equation for a 4-bar linkage:

$${N}_{4} = \frac{4 ( 4 - 1 )}{2} = \frac{12}{2} = 6$$

This example shows that there are 6 total instantaneous velocity centers for a 4-bar linkage.

As another example, this equation may be applied to a 6-bar linkage. In this example, n=6. The following solves the equation for a 6-bar linkage:

$${N}_{6} = \frac{6 ( 6 - 1 )}{2} = \frac{30}{2} = 15$$

This example shows that there are 15 total instantaneous velocity centers for a 6-bar linkage.

In accordance with various embodiments, the suspension system can include a suspension setup having two or more kinematic links. It may be noted that while some of the concepts discussed herein might be accomplished with two kinematic links, however, as is suitable, more or fewer links can also be used to accomplish the various concepts as discussed herein.

Turning now to the figures for embodiment 1, in accordance with various embodiments, a two-wheeled vehicle suspension system that utilize a rotary (about an axis) resistive mechanism. Specifically, about an axis of a kinematic joint that will also be referred to as a suspension pivot axis.

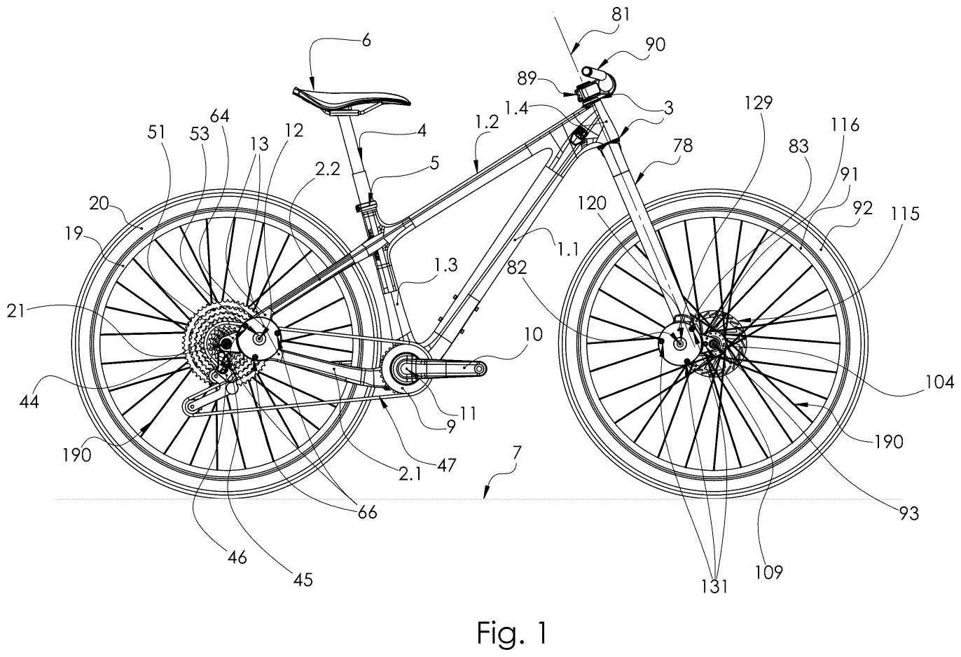

Referring to FIG. 1, a drive-side view of a complete two-wheeled vehicle is shown with embodiment 1 of a rear and front rotary suspension system in an extended state. The two-wheeled vehicle may be a bicycle, an electric two-wheeled vehicle, an e-bike, an eMTB, a pedelec, or a motorcycle. The wheel sizes may include 12, 16, 20, 24, 26, 27.5, 29, 32, or 36 inch wheels, as well as 650B or 700 CC sizes.

The two-wheeled vehicle includes a front triangle 1 comprising a down tube 1.1, a top tube 1.2, a seat tube 1.3, and a head tube 1.4. The front triangle 1 is rigidly combined with a rear triangle 2 that includes a chainstay 2.1 and a seatstay 2.2. A headset 3 is installed into the head tube 1.4. A seat post 4 is installed into the seat tube 1.3 and secured by a seat post clamp 5, with a saddle 6 affixed to the seat post 4. The two-wheeled vehicle rests on a ground [Extended] 7.

With continued reference to FIG. 1, a driving cog 9 is fixed to a crank 10, which is pivotally connected about a crank axis 11. A rear wheel carrier [Drive] [Embodiment-1] 51 is pivotally connected to a rear suspension pivot structure [Drive] 13 about a rear suspension pivot axis 12. A rear stator [Drive] [Embodiment-1] 64 is fastened to the rear suspension pivot structure [Drive] 13 via rear stator fasteners [Drive] [Embodiment-1] 66. The rear wheel carrier [Drive] [Embodiment-1] 51 is pivotally fastened to the rear stator [Drive] [Embodiment-1] 64 via a rear wheel carrier fastener [Drive] [Embodiment-1] 53.

A rear tire 20 is mounted to a rear rim 19, defining a rear wheel axis [Extended] 21. The rear rim 19 is connected via wheel spokes 190 to a rear hub. A rear driven cassette 44 is operably connected to the rear hub. A chain/belt 47 connects the driving cog 9 to the rear driven cassette 44 to transfer power from the crank 10 to the rear wheel. A rear derailleur hanger 45 is mounted to the rear wheel carrier [Drive] [Embodiment-1] 51, and a rear derailleur 46 is mounted to the rear derailleur hanger 45 to shift the chain/belt 47 among various cogs within the rear driven cassette 44.

As further shown in FIG. 1, a fork upper 78 is pivotally mounted to the headset 3 about a fork steering axis 81. A stem 89 is clamped to the fork upper 78, and a handlebar 90 is clamped to the stem 89. A front wheel carrier [Drive] [Embodiment-1] 116 is pivotally connected to a front suspension pivot structure [Drive] 83 about a front suspension pivot axis 82. A front stator [Drive] [Embodiment-1] 129 is fastened to the front suspension pivot structure [Drive] 83 via front stator fasteners [Drive] [Embodiment-1] 131. The front wheel carrier [Drive] [Embodiment-1] 116 is pivotally fastened to the front stator [Drive] [Embodiment-1] 129 via a front wheel carrier fastener [Drive] [Embodiment-1] 120.

A front tire 92 is mounted to a front rim 91, defining a front wheel axis [Extended] 93. The front rim 91 is connected via the wheel spokes 190 to a front hub 104. A front brake rotor 115 is fastened to the front hub 104. A front hub flange interconnect fastener 109 is installed into the front wheel carrier [Drive] [Embodiment-1] 116. The rear tire 20 and the front tire 92 are tangent to the ground [Extended] 7.

The rear suspension pivot axis 12 defines the location of a rotary resistance mechanism for the rear suspension system, while the front suspension pivot axis 82 defines the location of a rotary resistance mechanism for the front suspension system. The rotary resistance mechanisms resist relative motion between suspension kinematic bodies about the respective rotation axes by applying a torque. This torque may be position and/or velocity dependent. The rotary resistance mechanism may include resistance components that are spaced radially with respect to the rotation axes. The radially spacing may or may not be constant. With a rotary resistance mechanism, the angular displacement defines the resistance versus a linear displacement with a linear resistance mechanism.

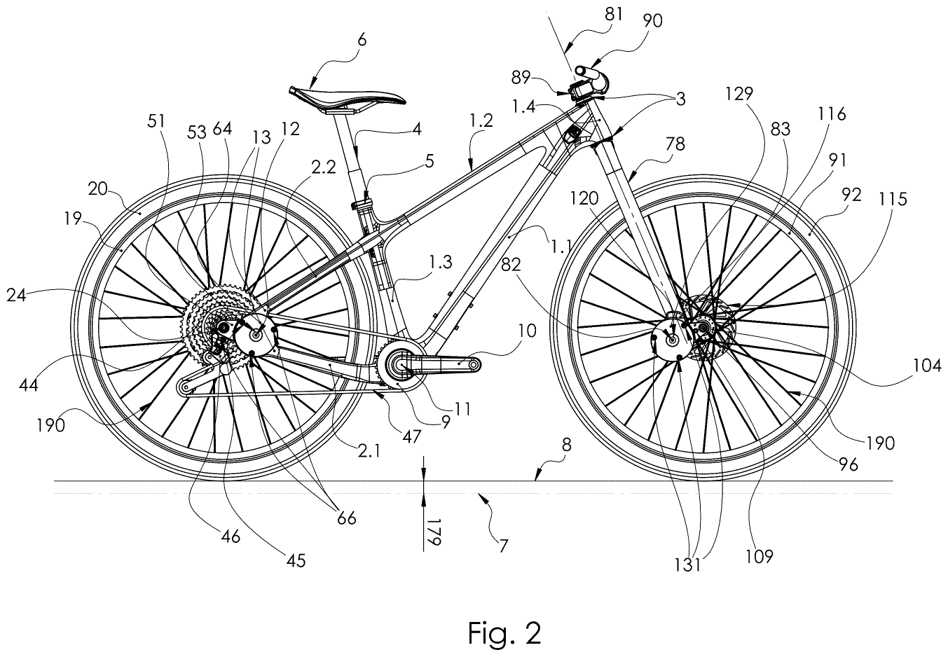

Referring to FIG. 2, a drive-side view of the complete two-wheeled vehicle is shown with embodiment 1 of the disclosed rear and front rotary suspension system in a compressed state. The two-wheeled vehicle frame structure remains the same as described with reference to FIG. 1, including the front triangle 1 comprising the down tube 1.1, the top tube 1.2, the seat tube 1.3, and the head tube 1.4. The rear triangle 2 includes the chainstay 2.1 and the seatstay 2.2. The headset 3 is installed in the head tube 1.4. The seat post 4 is secured by the seat post clamp 5, with the saddle 6 mounted on top.

The rear suspension system includes the rear suspension pivot structure [Drive] 13 defining the rear suspension pivot axis 12. The rear wheel carrier [Drive] [Embodiment-1] 51 is pivotally connected to the rear suspension pivot structure [Drive] 13 via the rear wheel carrier fastener [Drive] [Embodiment-1] 53. The rear stator [Drive] [Embodiment-1] 64 is fastened to the rear suspension pivot structure [Drive] 13 via the rear stator fasteners [Drive] [Embodiment-1] 66. The rear tire 20 is mounted to the rear rim 19, with the wheel spokes 190 connecting the rear rim 19 to the rear hub assembly. The rear driven cassette 44 is operably connected to the rear hub. The rear derailleur hanger 45 supports the rear derailleur 46, and the chain/belt 47 connects the driving cog 9 to the rear driven cassette 44. The crank 10 rotates about the crank axis 11. A rear wheel axis [Compressed] 24 indicates the position of the rear wheel in the compressed state.

With continued reference to FIG. 2, the front suspension system includes the fork upper 78 defining the fork steering axis 81. The front suspension pivot structure [Drive] 83 defines the front suspension pivot axis 82. The front wheel carrier [Drive] [Embodiment-1] 116 is pivotally connected to the front suspension pivot structure [Drive] 83 via the front wheel carrier fastener [Drive] [Embodiment-1] 120. The front stator [Drive] [Embodiment-1] 129 is fastened to the front suspension pivot structure [Drive] 83 via the front stator fasteners [Drive] [Embodiment-1] 131. The front tire 92 is mounted to the front rim 91, with the wheel spokes 190 connecting the front rim 91 to the front hub 104. The front brake rotor 115 is fastened to the front hub 104. The front hub flange interconnect fastener 109 is installed into the front wheel carrier [Drive] [Embodiment-1] 116. A front wheel axis [Compressed] 96 indicates the position of the front wheel in the compressed state.

The stem 89 is clamped to the fork upper 78, and the handlebar 90 is clamped to the stem 89. A vertical wheel travel [E-C] 179 represents the distance between a ground [Extended] 7 and a ground [Compressed] 8, indicating the suspension travel from the extended state to the compressed state while the suspended body remains stationary. The suspended body, which includes the front triangle 1 and the rear triangle 2, maintains a fixed position relative to the ground reference while the rear wheel axis moves from the rear wheel axis [Extended] 21 to the rear wheel axis [Compressed] 24 and the front wheel axis moves from the front wheel axis [Extended] 93 to the front wheel axis [Compressed] 96.

The suspension travel magnitude may range from approximately 5-75 mm in some embodiments. In other embodiments, travel above 150 mm is also possible. The vertical wheel travel [E-C] 179 defines the vertical distance that the wheel axes travel as the suspension moves from the extended state to the compressed state. The ground [Extended] 7 represents the ground plane when the suspension is in the extended state, while the ground [Compressed] 8 represents the ground plane when the suspension is in the compressed state with the suspended body remaining stationary. The rear tire 20 and the front tire 92 are tangent to the ground [Compressed] 8 when the suspension is in the compressed state.

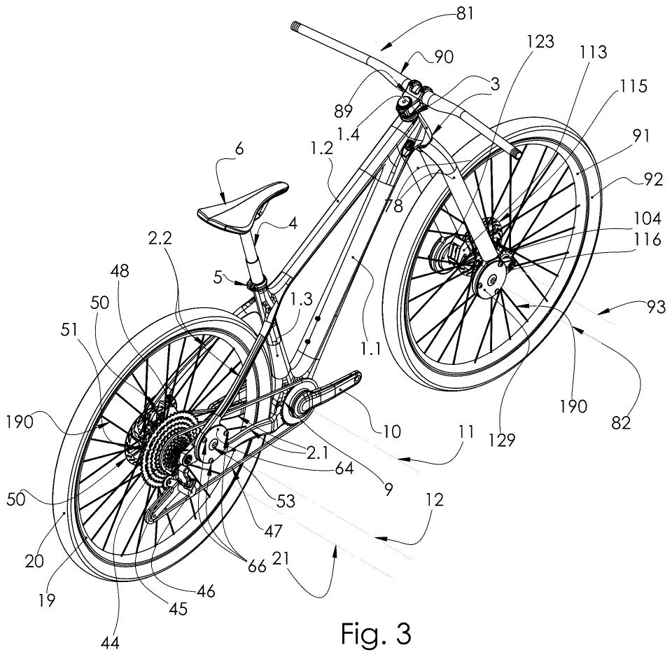

Referring to FIG. 3, an isometric view of the complete two-wheeled vehicle is shown with embodiment 1 of the disclosed rear and front rotary suspension system in the extended state. The isometric perspective reveals the three-dimensional arrangement of suspension components on both the drive side and the non-drive side of the two-wheeled vehicle.

The two-wheeled vehicle includes the front triangle 1 comprising the down tube 1.1, the top tube 1.2, the seat tube 1.3, and the head tube 1.4. The front triangle 1 is rigidly combined with the rear triangle 2 that includes the chainstay 2.1 and the seatstay 2.2. The headset 3 is installed in the head tube 1.4. The seat post 4 is secured by the seat post clamp 5, and the saddle 6 is mounted to the seat post 4. The driving cog 9 is connected to the crank 10, which rotates about the crank axis 11. The rear suspension pivot axis 12 defines the rotational axis for the rear suspension system.

With continued reference to FIG. 3, the rear rim 19 supports the rear tire 20, with the rear wheel axis [Extended] 21 defining the wheel position in the extended state. The rear driven cassette 44 is mounted to a rear hub, with the rear derailleur hanger 45 supporting the rear derailleur 46. The chain/belt 47 connects the driving cog 9 to the rear driven cassette 44. A rear brake caliper 48 is mounted to a rear wheel carrier and brake carrier on the non-drive side, and a rear brake rotor 50 is attached to the rear hub. The rear wheel carrier [Drive] [Embodiment-1] 51 is secured by the rear wheel carrier fastener [Drive] [Embodiment-1] 53. The rear stator [Drive] [Embodiment-1] 64 is fastened to the rear suspension pivot structure via the rear stator fasteners [Drive] [Embodiment-1] 66.

The front portion of the two-wheeled vehicle includes the fork upper 78 that rotates about the fork steering axis 81. The front suspension pivot axis 82 defines the rotational axis for the front suspension. The stem 89 connects to the handlebar 90. The front rim 91 supports the front tire 92, with the front wheel axis [Extended] 93 defining the front wheel position. The front hub 104 is connected to the front wheel. A front brake caliper 113 and the front brake rotor 115 provide braking capability. The front wheel carrier [Drive] [Embodiment-1] 116 and a front wheel carrier and brake carrier [Non-Drive] [Embodiment-1] 123 support a front wheel assembly 194. The front stator [Drive] [Embodiment-1] 129 is mounted to the front suspension pivot structure. The wheel spokes 190 connect the rims to their respective hubs on both wheels.

The driving cog 9 may be one of several cogs of various size chainrings that can be shifted via a front derailleur. The driven cog within the rear driven cassette 44 may be one of several cogs of various sizes combined into a cassette assembly that can be shifted via the rear derailleur 46. Additional cogs, driven or idle, may be added between the driven cog and the primary driving cog 9 to manipulate the dynamics of the driving force to the suspension. The driving cog 9 may be located separately from the crank 10 and the crank axis 11, such as when a gearbox is used wherein an output driving cog is offset from the crank 10.

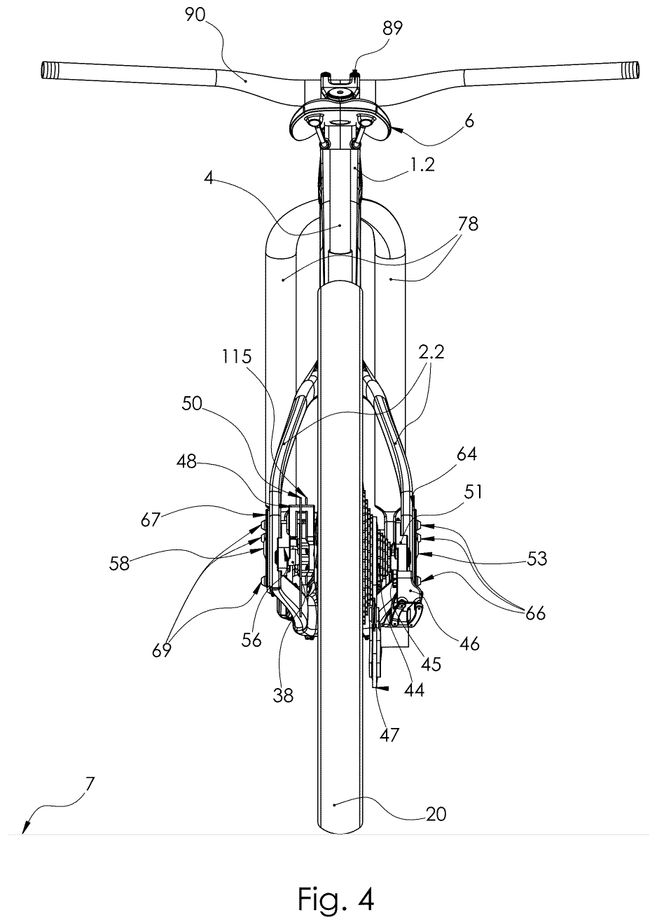

Referring to FIG. 4, a rear view of the complete two-wheeled vehicle is shown with embodiment 1 of the disclosed rear and front rotary suspension system in the extended state. The view shows the two-wheeled vehicle from behind, providing visibility of components on both the drive and non-drive sides of the vehicle.

The upper portion of the two-wheeled vehicle includes the handlebar 90 connected to the stem 89, which is mounted to the fork upper 78. The top tube 1.2 extends rearward, and the seat post 4 supports the saddle 6. The seatstay 2.2 extends downward from the seat tube area toward the rear suspension pivot structure.

A rear wheel assembly 193 is centrally positioned in this view. The rear tire 20 contacts the ground [Extended] 7. A rear hub flange interconnect 38 is visible at the center of the rear wheel, providing a connection between the wheel carrier bodies on opposite sides of the wheel. The rear driven cassette 44 is operably connected to a rear hub 34, with the rear derailleur hanger 45 and the rear derailleur 46 positioned on the drive side. The chain/belt 47 connects the drivetrain components.

With continued reference to FIG. 4, on the drive side, the rear wheel carrier [Drive] [Embodiment-1] 51 is pivotally connected to the rear suspension pivot structure. The rear wheel carrier fastener [Drive] [Embodiment-1] 53 secures the wheel carrier to the rear stator [Drive] [Embodiment-1] 64, which is fastened to the rear suspension pivot structure via the rear stator fasteners [Drive] [Embodiment-1] 66.

On the non-drive side, a rear wheel carrier and brake carrier [Non-Drive] [Embodiment-1] 56 is pivotally connected to the rear suspension pivot structure. A rear wheel carrier and brake carrier fastener [Non-Drive] [Embodiment-1] 58 secures the rear wheel carrier and brake carrier [Non-Drive] [Embodiment-1] 56 to a rear stator [Non-Drive] [Embodiment-1] 67, which is fastened via rear stator fasteners [Non-Drive] [Embodiment-1] 69. The rear brake caliper 48 is fastened to the rear wheel carrier and brake carrier [Non-Drive] [Embodiment-1] 56, and the rear brake rotor 50 is mounted to the rear hub 34.

The front brake rotor 115 is visible at the front wheel position in this rear view. The rear hub flange interconnect 38 aids in preventing relative motion between the rear wheel carrier [Drive] [Embodiment-1] 51 and the rear wheel carrier and brake carrier [Non-Drive] [Embodiment-1] 56, providing structural rigidity between the separated wheel carrier bodies.

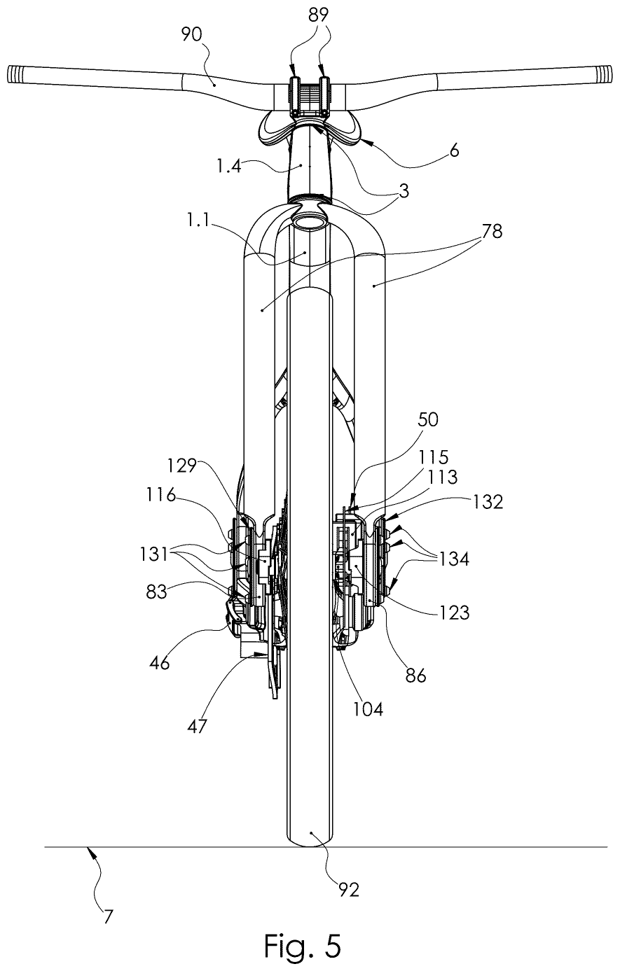

Referring to FIG. 5, a front view of the complete two-wheeled vehicle is shown with embodiment 1 of the disclosed rear and front rotary suspension system in the extended state. The two-wheeled vehicle is shown from the front perspective, providing visibility of the front suspension components and their arrangement.

The upper portion of the two-wheeled vehicle includes the handlebar 90 connected to the stem 89, which is mounted to the fork steerer tube through the headset 3 installed in the head tube 1.4. The saddle 6 is visible at the top of the frame. The down tube 1.1 extends downward from the head tube 1.4.

The fork upper 78 extends downward from the headset 3 and includes the front suspension pivot structure on both sides. The front suspension pivot structure [Drive] 83 is positioned on one side while a front suspension pivot structure [Non-Drive] 86 is positioned on the opposite side. The front stator [Drive] [Embodiment-1] 129 is fastened to the front suspension pivot structure [Drive] 83 via the front stator fasteners [Drive] [Embodiment-1] 131. Similarly, a front stator [Non-Drive] [Embodiment-1] 132 is fastened to the front suspension pivot structure [Non-Drive] 86 via front stator fasteners [Non-Drive] [Embodiment-1] 134.

With continued reference to FIG. 5, the front wheel carrier [Drive] [Embodiment-1] 116 is pivotally connected to the front suspension pivot structure [Drive] 83. The front wheel carrier and brake carrier [Non-Drive] [Embodiment-1] 123 is pivotally connected to the front suspension pivot structure [Non-Drive] 86. The front hub 104 is positioned centrally between these wheel carriers. The front brake caliper 113 is mounted to the front wheel carrier and brake carrier [Non-Drive] [Embodiment-1] 123, and the front brake rotor 115 is fastened to the front hub 104. The front tire 92 is mounted to the front rim and contacts the ground [Extended] 7.

The rear portion of the two-wheeled vehicle shows the rear brake rotor 50, the rear derailleur 46, and the chain/belt 47 extending from the drivetrain components. The front wheel assembly 194 includes the front hub 104, the front rim 91, the front tire 92, and the wheel spokes 190 connecting the front rim 91 to the front hub 104.

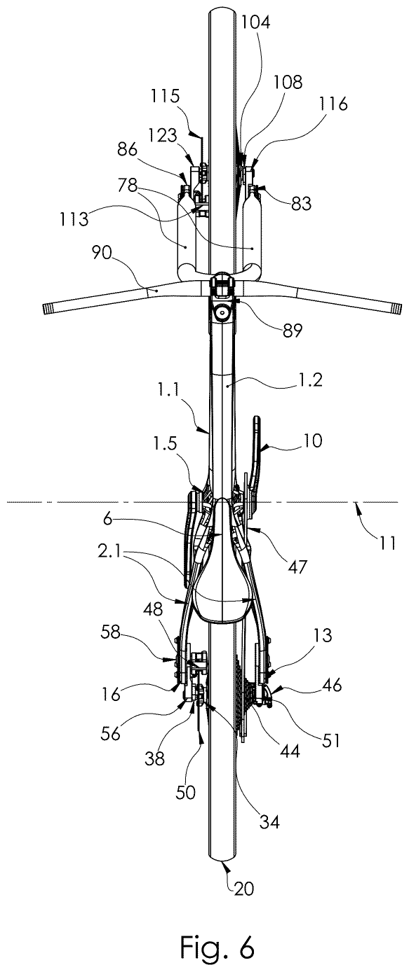

Referring to FIG. 6, a top view of the complete two-wheeled vehicle is shown with embodiment 1 of the disclosed rear and front rotary suspension system in the extended state. The two-wheeled vehicle includes the front triangle 1 comprising the down tube 1.1, the top tube 1.2, and a bottom bracket or drive unit interface or gearbox interface 1.5. The chainstay 2.1 extends rearward from the bottom bracket area. The saddle 6 is positioned atop the two-wheeled vehicle frame. The crank 10 is pivotally connected about the crank axis 11.

The rear suspension pivot structure [Drive] 13 and a rear suspension pivot structure [Non-Drive] 16 are visible at the junction of the chainstay 2.1 and the seatstay 2.2. The rear tire 20 is mounted to the rear hub 34, with the rear hub flange interconnect 38 providing structural connection. The rear driven cassette 44 is operably connected to the rear hub 34, and the rear derailleur 46 is mounted to shift the chain/belt 47 across the cassette. The rear brake caliper 48 and the rear brake rotor 50 provide braking functionality.

As further shown in FIG. 6, the rear wheel carrier [Drive] [Embodiment-1] 51 and the rear wheel carrier and brake carrier [Non-Drive] [Embodiment-1] 56 are pivotally connected to their respective rear suspension pivot structures. The rear wheel carrier and brake carrier fastener [Non-Drive] [Embodiment-1] 58 secures the assembly on the non-drive side.

At the front of the two-wheeled vehicle, the fork upper 78 supports the front suspension components. The front suspension pivot structure [Drive] 83 and the front suspension pivot structure [Non-Drive] 86 define the front suspension pivot axis 82. The stem 89 connects to the handlebar 90 for steering control. The front hub 104 with a front hub flange interconnect 108 supports the front wheel assembly 194. The front brake caliper 113 and the front brake rotor 115 provide front braking. The front wheel carrier [Drive] [Embodiment-1] 116 and the front wheel carrier and brake carrier [Non-Drive] [Embodiment-1] 123 are pivotally connected to their respective front suspension pivot structures.

The rear wheel assembly 193 includes the rear hub 34, the rear rim 19, the rear tire 20, and the wheel spokes 190 connecting the rear rim 19 to the rear hub 34. The front hub flange interconnect 108 aids in preventing relative motion between the front wheel carrier [Drive] [Embodiment-1] 116 and the front wheel carrier and brake carrier [Non-Drive] [Embodiment-1] 123, providing structural rigidity between the separated wheel carrier bodies on the front wheel.

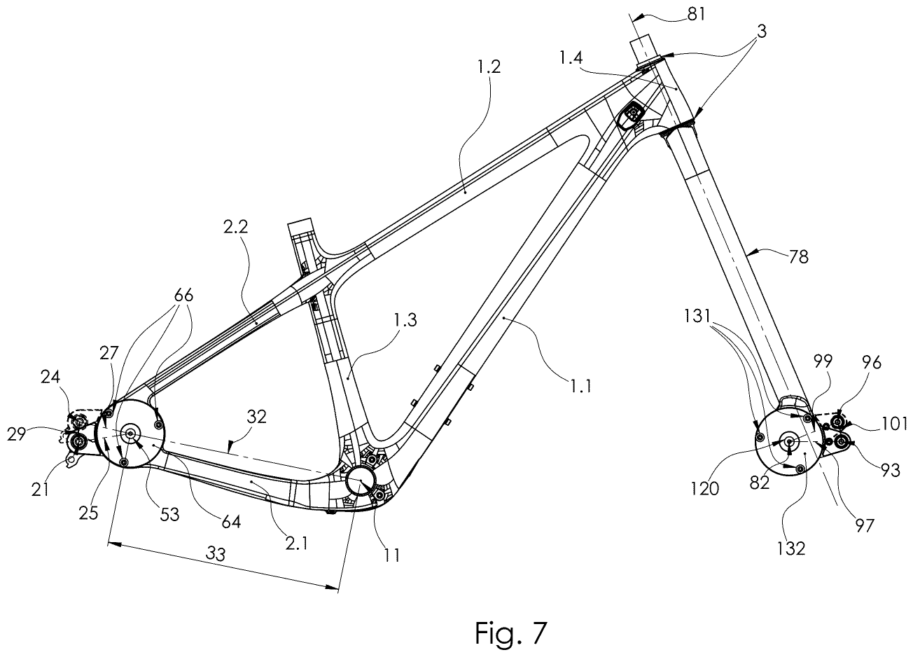

Referring to FIG. 7, a drive-side view of the two-wheeled vehicle frame and fork assembly is shown with embodiment 1 of the rear and front rotary suspension system with parts removed for clarity. The system is shown in both the extended state, represented by solid lines, and the compressed state, represented by dotted lines.

The frame assembly includes the front triangle 1 comprising the down tube 1.1, the top tube 1.2, the seat tube 1.3, and the head tube 1.4. The headset 3 is installed in the head tube 1.4. The rear triangle 2 includes the chainstay 2.1 and the seatstay 2.2 that are rigidly connected to the front triangle 1.

The rear suspension components include the rear stator [Drive] [Embodiment-1] 64 fastened to the rear suspension pivot structure via the rear stator fasteners [Drive] [Embodiment-1] 66. The rear wheel carrier fastener [Drive] [Embodiment-1] 53 secures the wheel carrier assembly. The rear wheel axis [Extended] 21 and the rear wheel axis [Compressed] 24 are shown as points along a rear wheel path 29, illustrating the travel of the rear wheel during suspension compression. A rear wheel axis to rear suspension pivot axis [Extended] 25 and a rear wheel axis to rear suspension pivot axis [Compressed] 27 define the geometric relationship between the wheel position and the suspension pivot at different states. The crank axis 11 is shown, along with a crank axis to rear suspension pivot axis 32 line and a crank axis to rear suspension pivot axis length 33 dimension.

With continued reference to FIG. 7, the front suspension assembly includes the fork upper 78 that defines the fork steering axis 81. The front suspension pivot axis 82 is positioned rearward of the fork steering axis 81. The front stator [Non-Drive] [Embodiment-1] 132 is secured by the front stator fasteners [Drive] [Embodiment-1] 131, and the front wheel carrier fastener [Drive] [Embodiment-1] 120 secures the front wheel carrier. The front wheel axis [Extended] 93 and the front wheel axis [Compressed] 96 are shown as points along a front wheel path 101. A front wheel axis to rear suspension pivot axis [Extended] 97 and a front wheel axis to rear suspension pivot axis [Compressed] 99 illustrate the geometric relationship between the front wheel position and the front suspension pivot axis 82 at different suspension states.

The rear wheel path 29 defines the arc along which the rear wheel axis travels as the suspension moves between the extended state and the compressed state. The front wheel path 101 defines the arc along which the front wheel axis travels during front suspension movement. The crank axis to rear suspension pivot axis length 33 may be greater than or less than a rear wheel axis to rear suspension pivot axis length [Extended] 26, depending upon the suspension geometry and design goals.

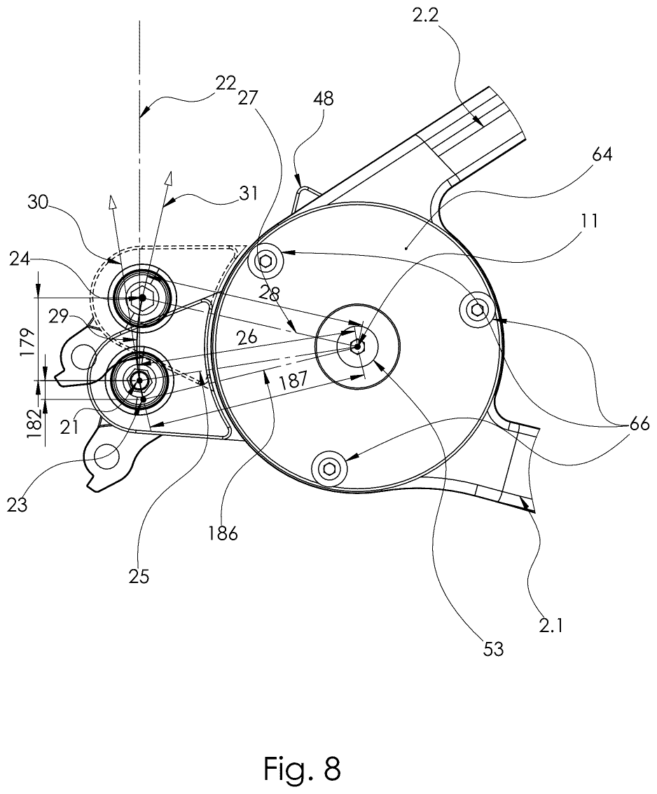

Referring to FIG. 8, a cropped and zoomed drive-side view of the rear portion of the disclosed rotary suspension system according to Embodiment-1 is shown in both the extended state represented by solid lines and the compressed state represented by dotted lines. The view depicts the relationship between the chainstay 2.1 and the seatstay 2.2 of the rear triangle 2, along with the rear suspension components.

The rear wheel axis [Extended] 21 and the rear wheel axis [Compressed] 24 are shown as points on the rear wheel path 29, with a rear wheel axis [Over-Extended] 23 also visible as an additional point on the rear wheel path 29. A rear wheel reference vertical [Extended] 22 provides a vertical reference line intersecting the rear wheel axis [Extended] 21. The rear wheel axis to rear suspension pivot axis [Extended] 25 line extends from the rear wheel axis [Extended] 21 to the suspension pivot, with the rear wheel axis to rear suspension pivot axis length [Extended] 26 indicating this distance. Similarly, the rear wheel axis to rear suspension pivot axis [Compressed] 27 line and a rear wheel axis to rear suspension pivot axis length [Compressed] 28 represent the corresponding relationship in the compressed state. A rear wheel axis to rear suspension pivot axis [Over-Extended] 186 line and a rear wheel axis to rear suspension pivot axis length [Over-Extended] 187 define the geometry in the over-extended state.

With continued reference to FIG. 8, a rear wheel path tangent [Extended] 30 is shown coincident to the rear wheel axis [Extended] 21 and perpendicular to the rear wheel axis to rear suspension pivot axis [Extended] 25, while a rear wheel path tangent [Compressed] 31 is coincident to the rear wheel axis [Compressed] 24 and perpendicular to the rear wheel axis to rear suspension pivot axis [Compressed] 27. The vertical wheel travel [E-C] 179 indicates the vertical distance between the rear wheel axis [Extended] 21 and the rear wheel axis [Compressed] 24, while a vertical wheel travel [E-OE] 182 indicates the vertical distance from the rear wheel axis [Extended] 21 to the rear wheel axis [Over-Extended] 23. The rear stator [Drive] [Embodiment-1] 64 is secured by the rear stator fasteners [Drive] [Embodiment-1] 66, and the rear wheel carrier fastener [Drive] [Embodiment-1] 53 is visible. The rear brake caliper 48 is also shown in this view.

The rear wheel path tangent [Extended] 30 defines the direction of the wheel path at the extended position, which may be used to characterize the bump absorption and anti-squat behavior of the suspension. The rear wheel path tangent [Compressed] 31 defines the direction of the wheel path at the compressed position. The more rearward the rear wheel path tangent, the greater the bump absorption may be and the higher the anti-squat. The more forward the rear wheel path, the lower the anti-squat and the lower the chain growth. Different wheel paths may be warranted depending upon design goals and the rear and front suspension configurations.

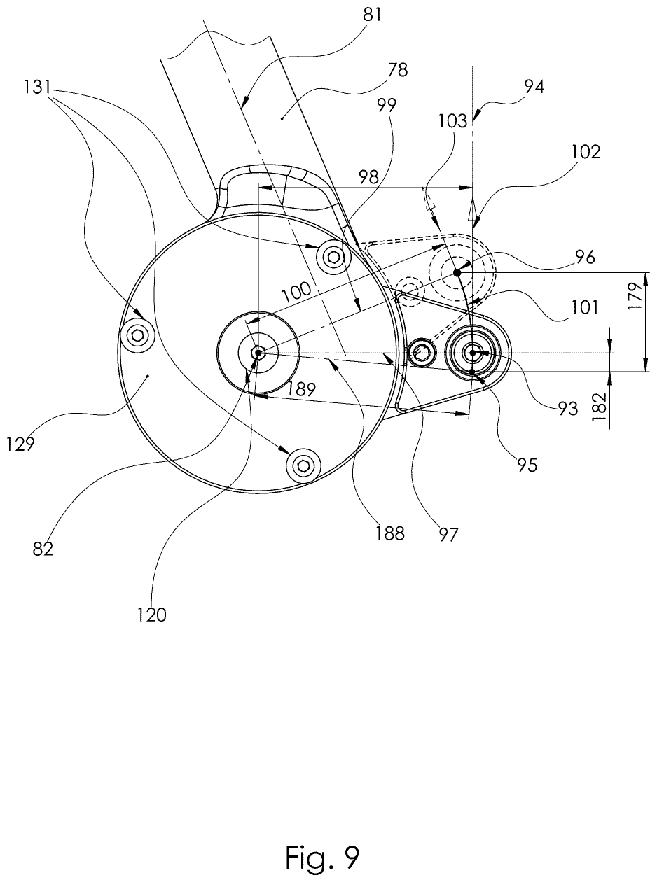

Referring to FIG. 9, a cropped and zoomed drive-side view of the front portion of the disclosed rotary suspension system according to Embodiment-1 is shown in both the extended state represented by solid lines and the compressed state represented by dotted lines. The figure illustrates the front suspension system with various geometric relationships and measurements.

The fork upper 78 is shown with the fork steering axis 81 extending through the fork upper 78. The front suspension pivot axis 82 is positioned rearward of the fork steering axis 81. The front wheel axis [Extended] 93 and the front wheel axis [Compressed] 96 are shown as points along the front wheel path 101. Additionally, a front wheel axis [Over-Extended] 95 is shown as another point on the front wheel path 101.

A front wheel reference vertical [Extended] 94 is a vertical line that intersects the front wheel axis [Extended] 93, providing a reference for measuring angular relationships. The front wheel axis to rear suspension pivot axis [Extended] 97 and the front wheel axis to rear suspension pivot axis [Compressed] 99 are lines connecting the respective wheel axis positions to the front suspension pivot axis 82. A front wheel axis to rear suspension pivot axis length [Extended] 98 represents the length dimension of the front wheel axis to rear suspension pivot axis [Extended] 97, while a front wheel axis to rear suspension pivot axis length [Compressed] 100 represents the length dimension of the front wheel axis to rear suspension pivot axis [Compressed] 99. A front wheel axis to rear suspension pivot axis [Over-Extended] 188 connects the over-extended wheel position to the pivot axis, with a front wheel axis to rear suspension pivot axis length [Over-Extended] 189 representing the length dimension of the front wheel axis to rear suspension pivot axis [Over-Extended] 188.

With continued reference to FIG. 9, a front wheel path tangent [Extended] 102 is coincident to the front wheel axis [Extended] 93 and perpendicular to the front wheel axis to rear suspension pivot axis [Extended] 97, representing the direction of the wheel path at that position. Similarly, a front wheel path tangent [Compressed] 103 is coincident to the front wheel axis [Compressed] 96 and perpendicular to the front wheel axis to rear suspension pivot axis [Compressed] 99. The vertical wheel travel [E-C] 179 indicates the vertical distance between the front wheel axis [Extended] 93 and the front wheel axis [Compressed] 96. The vertical wheel travel [E-OE] 182 indicates the vertical distance from the front wheel axis [Extended] 93 to the front wheel axis [Over-Extended] 95.

The front wheel carrier fastener [Drive] [Embodiment-1] 120 is shown securing the wheel carrier assembly. The front stator [Drive] [Embodiment-1] 129 is fastened to the front suspension pivot structure via the front stator fasteners [Drive] [Embodiment-1] 131. The front suspension pivot axis 82 may be positioned behind the fork steering axis 81 or in front of the fork steering axis 81 depending upon the suspension design and packaging requirements.

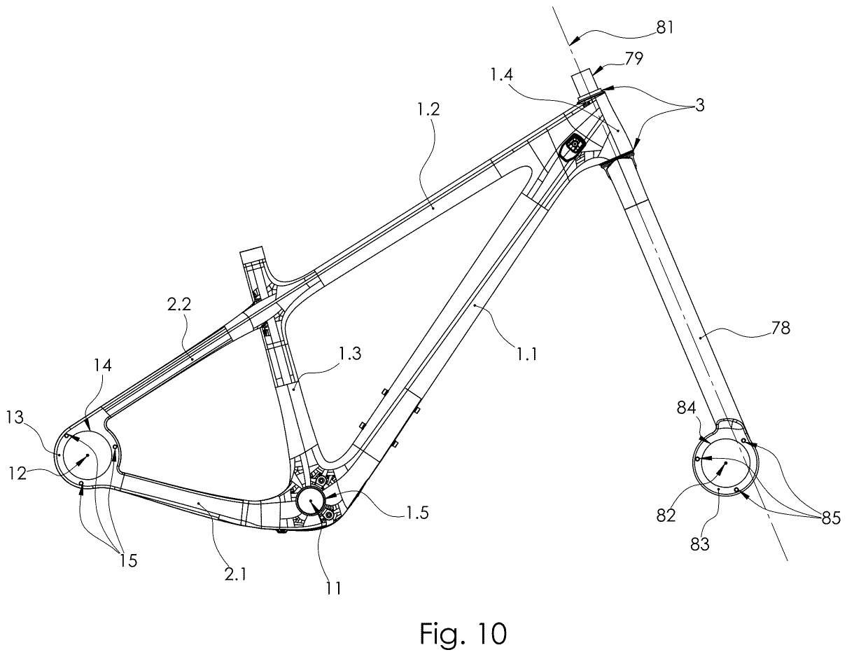

Referring to FIG. 10, a drive-side view of the two-wheeled vehicle frame and fork assembly is shown with embodiment 1 of the disclosed rear and front rotary suspension system with additional parts removed for clarity. The frame includes the front triangle 1 comprising the down tube 1.1, the top tube 1.2, the seat tube 1.3, the head tube 1.4, and the bottom bracket or drive unit interface or gearbox interface 1.5. The rear triangle 2 includes the chainstay 2.1 and the seatstay 2.2, which are rigidly connected to the front triangle 1. The headset 3 is installed into the head tube 1.4.

The rear suspension pivot structure [Drive] 13 is located at the intersection of the chainstay 2.1 and the seatstay 2.2, and includes a rear suspension pivot aperture/bore [Drive] 14 that is concentric to the rear suspension pivot axis 12. A rear pivot structure fastener interface [Drive] [Embodiment-1] 15 is positioned on the rear suspension pivot structure [Drive] 13 to receive fasteners for securing stator components. The crank axis 11 is defined at the bottom bracket or drive unit interface or gearbox interface 1.5.

With continued reference to FIG. 10, the fork upper 78 is rigidly connected to a fork steerer tube 79, which is pivotally mounted to the headset 3 and defines the fork steering axis 81. The front suspension pivot structure [Drive] 83 is positioned on the fork upper 78 and includes a front suspension pivot aperture/bore [Drive] 84 that is concentric to the front suspension pivot axis 82. A front pivot structure fastener interface [Drive] [Embodiment-1] 85 is located on the front suspension pivot structure [Drive] 83 to receive fasteners for securing stator components. This view illustrates the structural relationship between the frame components and the locations of the rear and front suspension pivot axes relative to the overall two-wheeled vehicle geometry.

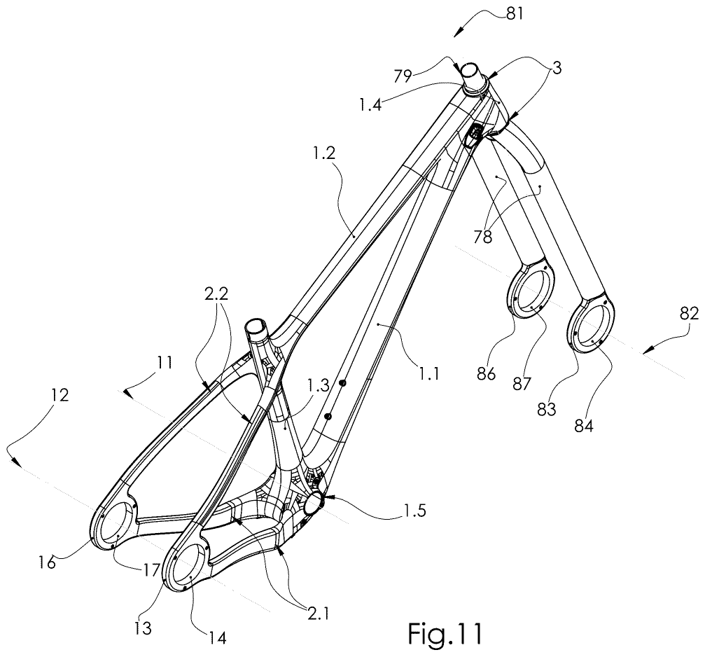

Referring to FIG. 11, an isometric view of the frame and fork of embodiment 1 of the disclosed rear and front rotary suspension system is shown with parts removed for clarity. The view shows the front triangle 1 including the down tube 1.1, the top tube 1.2, the seat tube 1.3, the head tube 1.4, and the bottom bracket or drive unit interface or gearbox interface 1.5. The front triangle 1 is rigidly combined with the rear triangle 2 that includes the chainstay 2.1 and the seatstay 2.2. The headset 3 is installed into the head tube 1.4.

The chainstay 2.1 and the seatstay 2.2 are rigidly connected at the rear suspension pivot structure [Drive] 13 on the drive side and at a rear suspension pivot structure [Non-Drive] 16 on the non-drive side. The rear suspension pivot aperture/bore [Drive] 14 is a feature of the rear suspension pivot structure [Drive] 13 and is concentric to the rear suspension pivot axis 12. A rear suspension pivot aperture/bore [Non-Drive] 17 is a feature of the rear suspension pivot structure [Non-Drive] 16 and is also concentric to the rear suspension pivot axis 12. The crank axis 11 defines the rotational axis for the crank assembly.

As further shown in FIG. 11, the fork upper 78 is rigidly connected to the fork steerer tube 79, which is pivotally mounted to the headset 3 and is concentric to the fork steering axis 81. The front suspension pivot structure [Drive] 83 includes the front suspension pivot aperture/bore [Drive] 84, which is concentric to the front suspension pivot axis 82. The front suspension pivot structure [Non-Drive] 86 includes a front suspension pivot aperture/bore [Non-Drive] 87, which is also concentric to the front suspension pivot axis 82. This isometric view provides a three-dimensional representation of the structural relationship between the suspended body components and the pivot structures that define the rotary suspension system for both the rear and front wheels. Note that with the frame of reference chosen for suspension/kinematic analysis the suspended body remains stationary, while the rear and/or front wheels are displaced. Therefore, in addition to front triangle 1 and rear triangle 2, fork upper 78 is also considered to be part of the suspended body. This is despite the fact that fork upper 78 can rotate with respect to fork steering axis 81. It is important to note that front suspension pivot axis 82 is perpendicular to fork steering axis 81. Suspension analysis is relative to the plane defined by front suspension pivot axis 82 or rear suspension pivot axis 12.

The rear suspension pivot structures may have through bores creating an open aperture with inner diameters to accept outer diameters of wheel carrier bushings. In other embodiments, the rear suspension pivot structures may have blind bores. The through bore configuration may allow for separate stator components to be fastened to the pivot structures via the rear pivot structure fastener interface [Drive] [Embodiment-1] 15 on the drive side. The blind bore configuration may eliminate the need for separate stator fasteners since the stator may be integrated into the rear suspension pivot structures. The front suspension pivot structures may similarly have through bores or blind bores depending upon the suspension design and manufacturing considerations.

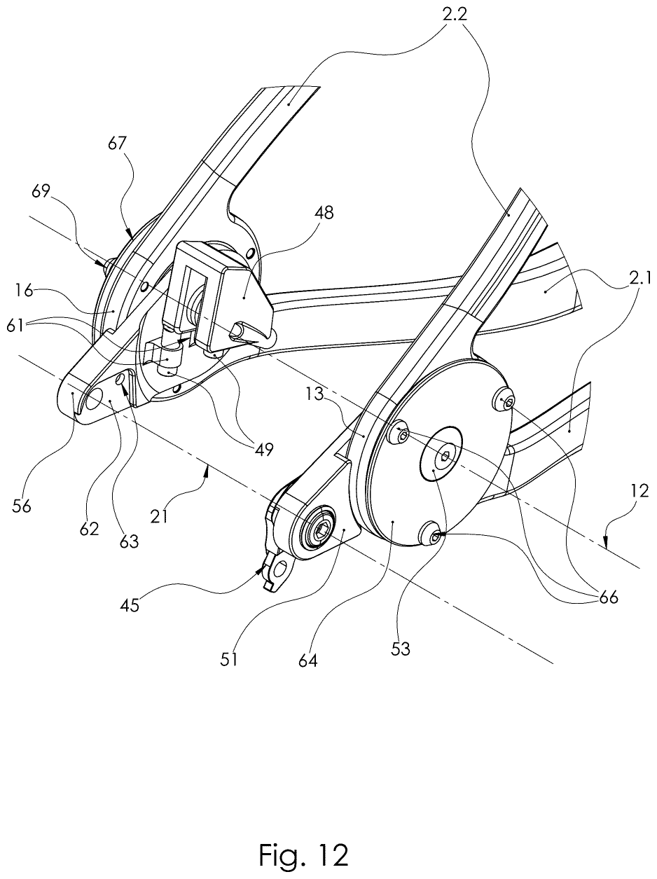

Referring to FIG. 12, a cropped isometric view of the rear rotary suspension system according to Embodiment-1 is shown with additional parts removed for clarity. The view shows the intersection of the chainstay 2.1 and the seatstay 2.2, which form part of the rear triangle 2 structure. The rear suspension pivot structure [Drive] 13 and the rear suspension pivot structure [Non-Drive] 16 are positioned at this intersection, defining the rear suspension pivot axis 12.

The rear wheel carrier [Drive] [Embodiment-1] 51 is pivotally connected to the rear suspension pivot structure [Drive] 13 about the rear suspension pivot axis 12, and is secured via the rear wheel carrier fastener [Drive] [Embodiment-1] 53. The rear stator [Drive] [Embodiment-1] 64 is fastened to the rear suspension pivot structure [Drive] 13 via the rear stator fasteners [Drive] [Embodiment-1] 66. On the non-drive side, the rear wheel carrier and brake carrier [Non-Drive] [Embodiment-1] 56 is shown with the rear stator [Non-Drive] [Embodiment-1] 67 fastened to the rear suspension pivot structure [Non-Drive] 16 via the rear stator fasteners [Non-Drive] [Embodiment-1] 69.

With continued reference to FIG. 12, the rear brake caliper 48 is fastened to the rear wheel carrier and brake carrier [Non-Drive] [Embodiment-1] 56 at rear wheel carrier and brake carrier caliper mounts [Non-Drive] [Embodiment-1] 61 using rear brake caliper fasteners 49. A rear wheel carrier and brake carrier hub interconnect interface [Non-Drive] [Embodiment-1] 62 and a rear wheel carrier and brake carrier hub interconnect fastener bore [Non-Drive] [Embodiment-1] 63 are located on the rear wheel carrier and brake carrier [Non-Drive] [Embodiment-1] 56. The rear derailleur hanger 45 is mounted to the rear wheel carrier [Drive] [Embodiment-1] 51. The rear wheel axis [Extended] 21 indicates the position of the rear wheel axis in the extended state of the suspension system.

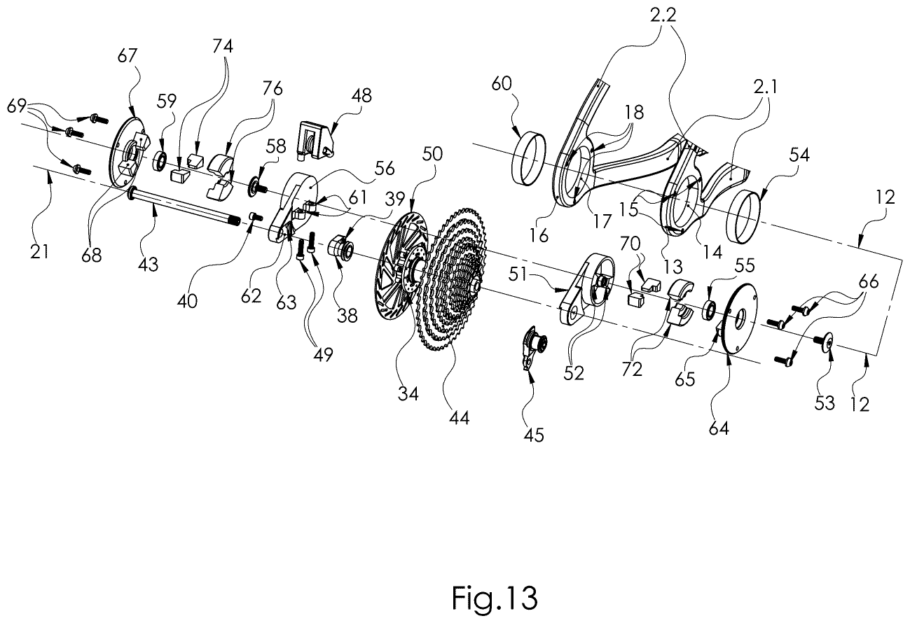

Referring to FIG. 13, a cropped, exploded, isometric view of the rear rotary suspension system assembly according to Embodiment-1 is shown. The exploded view illustrates the relationship between the various components of the rear suspension system and their assembly sequence.

The rear suspension pivot structure [Drive] 13 includes the rear suspension pivot aperture/bore [Drive] 14 which is concentric to the rear suspension pivot axis 12. The rear pivot structure fastener interface [Drive] [Embodiment-1] 15 receives the rear stator fasteners [Drive] [Embodiment-1] 66 which secure the rear stator [Drive] [Embodiment-1] 64 to the rear suspension pivot structure [Drive] 13. The rear stator [Drive] [Embodiment-1] 64 includes rear stator blades [Drive] [Embodiment-1] 65.

With continued reference to FIG. 13, a rear wheel carrier bushing [Drive] [Embodiment-1] 54 is installed into the rear suspension pivot aperture/bore [Drive] 14 to receive the rear wheel carrier [Drive] [Embodiment-1] 51 and reduce rotational friction between these components. The rear wheel carrier [Drive] [Embodiment-1] 51 includes rear wheel carrier blades [Drive] [Embodiment-1] 52. A rear wheel carrier bearing [Drive] [Embodiment-1] 55 is installed into the rear stator [Drive] [Embodiment-1] 64 to reduce rotational friction with the rear wheel carrier [Drive] [Embodiment-1] 51. The rear wheel carrier fastener [Drive] [Embodiment-1] 53 pivotally fastens the rear wheel carrier [Drive] [Embodiment-1] 51 to the rear stator [Drive] [Embodiment-1] 64.

Rear elastomers top-out extended [Drive] [Embodiment-1] 70 and rear elastomers primary extended [Drive] [Embodiment-1] 72 are installed between the rear wheel carrier blades [Drive] [Embodiment-1] 52 and the rear stator blades [Drive] [Embodiment-1] 65. The rear elastomers top-out extended [Drive] [Embodiment-1] 70 may resist motion of the kinematic wheel carrier as the kinematic wheel carrier moves from an extended state to an over-extended state. The rear elastomers primary extended [Drive] [Embodiment-1] 72 may resist motion of the kinematic wheel carrier as the kinematic wheel carrier moves from the extended state to a compressed state.

As further shown in FIG. 13, on the non-drive side, the rear suspension pivot structure [Non-Drive] 16 includes the rear suspension pivot aperture/bore [Non-Drive] 17 and a rear pivot structure fastener interface [Non-Drive] [Embodiment 1] 18. The rear stator fasteners [Non-Drive] [Embodiment-1] 69 secure the rear stator [Non-Drive] [Embodiment-1] 67 which includes rear stator blades [Non-Drive] [Embodiment-1] 68. A rear wheel carrier and brake carrier bushing [Non-Drive] [Embodiment-1] 60 is installed into the rear suspension pivot aperture/bore [Non-Drive] 17 to receive the rear wheel carrier and brake carrier [Non-Drive] [Embodiment-1] 56. A rear wheel carrier and brake carrier bearing [Non-Drive] [Embodiment-1] 59 is installed into the rear stator [Non-Drive] [Embodiment-1] 67. The rear wheel carrier and brake carrier fastener [Non-Drive] [Embodiment-1] 58 secures the assembly.

Rear elastomers top-out extended [Non-Drive] [Embodiment-1] 74 and rear elastomers primary extended [Non-Drive] [Embodiment-1] 76 are installed between the rear wheel carrier and brake carrier [Non-Drive] [Embodiment-1] 56 and the rear stator blades [Non-Drive] [Embodiment-1] 68. Rear elastomers top-out compressed [Non-Drive] [Embodiment-1] 75 and rear elastomers primary compressed [Non-Drive] [Embodiment-1] 77 represent the positions of the elastomeric components when the suspension is in the compressed and over-extended states respectively.

With continued reference to FIG. 13, the rear wheel carrier and brake carrier [Non-Drive] [Embodiment-1] 56 includes the rear wheel carrier and brake carrier caliper mounts [Non-Drive] [Embodiment-1] 61, the rear wheel carrier and brake carrier hub interconnect interface [Non-Drive] [Embodiment-1] 62, and the rear wheel carrier and brake carrier hub interconnect fastener bore [Non-Drive] [Embodiment-1] 63.

The rear hub 34 is shown with the rear hub flange interconnect 38, which includes a rear hub flange interconnect fastener interface 39 and receives a rear hub flange interconnect fastener 40. The rear driven cassette 44 is operably connected to the rear hub 34. The rear brake rotor 50 is fastened to the rear hub 34, and the rear brake caliper 48 is secured via the rear brake caliper fasteners 49. A rear wheel axle 43 is installed through the rear wheel carrier [Drive] [Embodiment-1] 51, the rear hub 34, the rear hub flange interconnect 38, and the rear wheel carrier and brake carrier [Non-Drive] [Embodiment-1] 56, with the rear derailleur hanger 45 positioned at the assembly. The rear wheel axis [Extended] 21 and the rear wheel reference vertical [Extended] 22 define the wheel position in the extended state.

The rear hub flange interconnect 38 includes a positive feature that is asymmetric about the rear wheel axis [Extended] 21. The positive offset of the rear hub flange interconnect 38 may have many various shapes or forms. When the positive feature of the rear hub flange interconnect 38 is installed into the rear wheel carrier and brake carrier hub interconnect interface [Non-Drive] [Embodiment-1] 62, no substantial rotation can occur between the rear wheel carrier and brake carrier [Non-Drive] [Embodiment-1] 56 and the rear hub flange interconnect 38. The rear hub flange interconnect fastener 40 may be installed through the rear wheel carrier and brake carrier hub interconnect fastener bore [Non-Drive] [Embodiment-1] 63 and into the rear hub flange interconnect fastener interface 39 to mechanically connect the rear hub flange interconnect 38 to the rear wheel carrier and brake carrier [Non-Drive] [Embodiment-1] 56. In some embodiments, the rear hub flange interconnect fastener 40, the rear wheel carrier and brake carrier hub interconnect fastener bore [Non-Drive] [Embodiment-1] 63, and the rear hub flange interconnect fastener interface 39 may be omitted while still preventing relative motion between the rear hub flange interconnect 38 and the rear wheel carrier and brake carrier [Non-Drive] [Embodiment-1] 56.

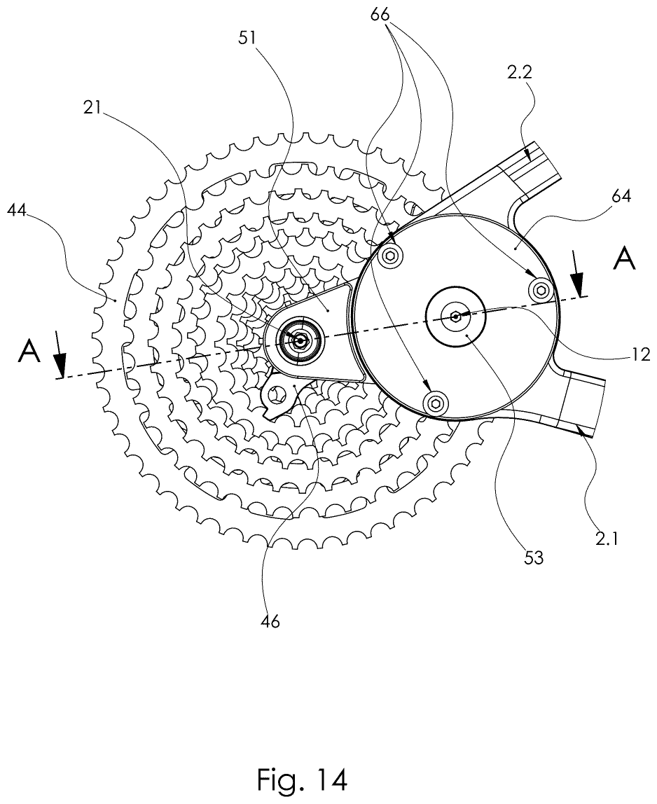

Referring to FIG. 14, a cropped drive-side view of embodiment 1 of the disclosed rear rotary suspension system is shown with various parts removed for clarity. The view illustrates a section line A-A used for subsequent cross-sectional views. The rear suspension system includes the chainstay 2.1 and the seatstay 2.2 that form part of the rear triangle 2 structure. The rear suspension pivot axis 12 defines the axis about which the suspension components rotate. The rear wheel axis [Extended] 21 indicates the position of the rear wheel in the extended state. The rear driven cassette 44 is shown operably connected to the rear hub 34, with the rear derailleur 46 positioned to shift the chain between the various cogs of the rear driven cassette 44. The rear wheel carrier [Drive] [Embodiment-1] 51 is pivotally connected about the rear suspension pivot axis 12 and is secured by the rear wheel carrier fastener [Drive] [Embodiment-1] 53. The rear stator [Drive] [Embodiment-1] 64 is fastened to the rear suspension pivot structure via the rear stator fasteners [Drive] [Embodiment-1] 66. This view provides a reference for understanding the spatial relationships between the suspension components and establishes the section line A-A for detailed cross-sectional analysis of the rotary resistance mechanism assembly.

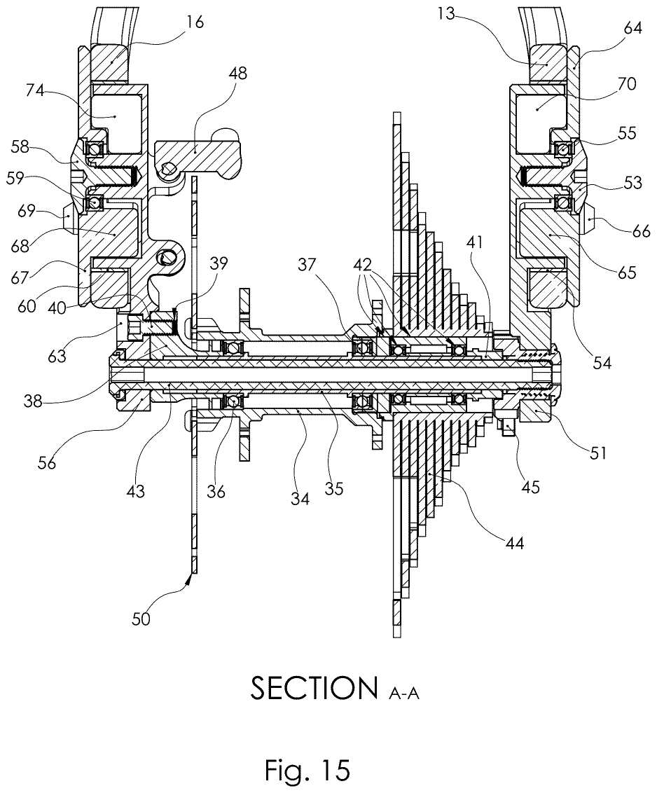

Referring to FIG. 15, a section view A-A of the rear rotary suspension system according to Embodiment-1 is shown, revealing the internal arrangement and relationship of components within the suspension assembly. The section view reveals the structural configuration of the rear suspension pivot structures and the associated wheel carrier components on both the drive and non-drive sides of the two-wheeled vehicle.

On the drive side, the rear suspension pivot structure [Drive] 13 houses the rear wheel carrier [Drive] [Embodiment-1] 51, which is pivotally connected via the rear wheel carrier bushing [Drive] [Embodiment-1] 54. The rear wheel carrier bearing [Drive] [Embodiment-1] 55 is installed to reduce rotational friction between the rear wheel carrier [Drive] [Embodiment-1] 51 and the rear stator [Drive] [Embodiment-1] 64. The rear stator blades [Drive] [Embodiment-1] 65 extend from the rear stator [Drive] [Embodiment-1] 64, and the rear stator fasteners [Drive] [Embodiment-1] 66 secure the rear stator [Drive] [Embodiment-1] 64 to the rear suspension pivot structure [Drive] 13. The rear elastomers top-out extended [Drive] [Embodiment-1] 70 is positioned between the rear stator blades [Drive] [Embodiment-1] 65 and the rear wheel carrier blades [Drive] [Embodiment-1] 52 to provide resistance during suspension movement. The rear wheel carrier fastener [Drive] [Embodiment-1] 53 secures the wheel carrier assembly.

With continued reference to FIG. 15, on the non-drive side, the rear suspension pivot structure [Non-Drive] 16 accommodates the rear wheel carrier and brake carrier [Non-Drive] [Embodiment-1] 56. The rear wheel carrier and brake carrier bushing [Non-Drive] [Embodiment-1] 60 and the rear wheel carrier and brake carrier bearing [Non-Drive][Embodiment-1] 59 facilitate rotational movement. The rear stator [Non-Drive] [Embodiment-1] 67 with the rear stator blades [Non-Drive] [Embodiment-1] 68 is secured by the rear stator fasteners [Non-Drive] [Embodiment-1] 69. The rear elastomers top-out extended [Non-Drive] [Embodiment-1] 74 provides resistance on the non-drive side. The rear wheel carrier and brake carrier fastener [Non-Drive] [Embodiment-1] 58 and the rear wheel carrier and brake carrier hub interconnect fastener bore [Non-Drive] [Embodiment-1] 63 are also visible.

As further shown in FIG. 15, the central portion of the section view shows the rear hub 34 with a rear hub main axle 35 extending through the rear hub 34. A rear hub flange interconnect main bearing 36 and a rear hub main bearing 37 support the hub assembly. The rear hub flange interconnect 38 connects to the rear hub 34 via the rear hub flange interconnect fastener interface 39 and the rear hub flange interconnect fastener 40. A rear hub flange 41 is positioned on the drive side, while a rear free hub mechanism 42 enables the connection to the rear driven cassette 44. The rear wheel axle 43 passes through the entire assembly, and the rear derailleur hanger 45 is mounted to accommodate the rear derailleur 46. The rear brake caliper 48 is mounted on the non-drive side, and the rear brake rotor 50 is attached to the hub assembly.

The rear hub main axle 35 provides the central structural support for the rear hub 34 and extends through the rear hub flange interconnect main bearing 36 and the rear hub main bearing 37. The rear hub flange interconnect main bearing 36 supports the interface between the rear hub flange interconnect 38 and the rear hub 34, while the rear hub main bearing 37 supports the rotation of the rear hub 34 relative to the rear wheel axle 43. The rear hub flange 41 provides a mounting interface for the wheel spokes 190 on the drive side of the rear hub 34. The rear free hub mechanism 42 allows the rear driven cassette 44 to rotate freely in one direction while engaging the rear hub 34 when rotational force is applied in the driving direction.

In some embodiments, the rear hub flange interconnect 38 may be omitted and replaced with a standard rear hub flange. In such configurations, the rear hub flange interconnect main bearing 36 may also be omitted, and the rear hub 34 may include a rear hub flange on both the drive side and the non-drive side. The standard rear hub flange configuration may provide a simplified hub assembly while the rear hub flange interconnect 38 configuration may provide improved structural rigidity between the separated wheel carrier bodies on the drive and non-drive sides.

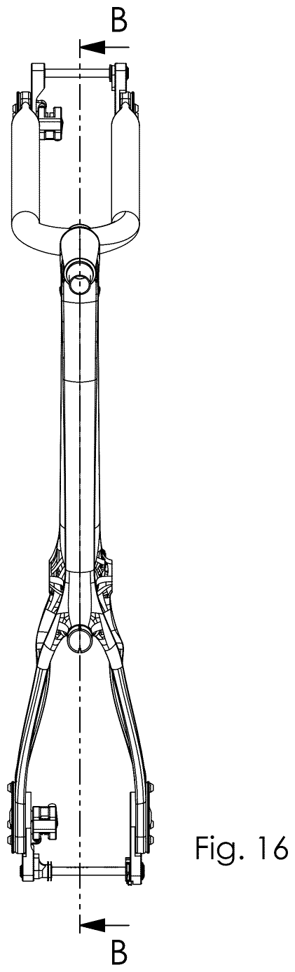

Referring to FIG. 16, a top view of embodiment 1 of the disclosed rear rotary suspension system in the extended state is shown with various parts removed for clarity. The view illustrates a section line B-B which is used for subsequent cross-sectional views of the rear suspension assembly. The figure depicts the rear suspension components from above, showing the symmetrical arrangement of the drive side and non-drive side suspension structures. A vertical dashed line extends through the center of the assembly, indicating the section plane B-B with directional arrows pointing inward at both the top and bottom of the figure. This section line passes through the rear suspension pivot axis and the rear wheel axis, providing a reference for examining the internal arrangement of components including the relationship between the rear wheel carrier, brake carrier, suspension pivot structures, and the rotary resistance mechanism. The top view perspective reveals the lateral spacing between the drive side and non-drive side components of the rear suspension system, as well as the positioning of the hub flange interconnect and associated fastening elements relative to the suspension pivot apertures.

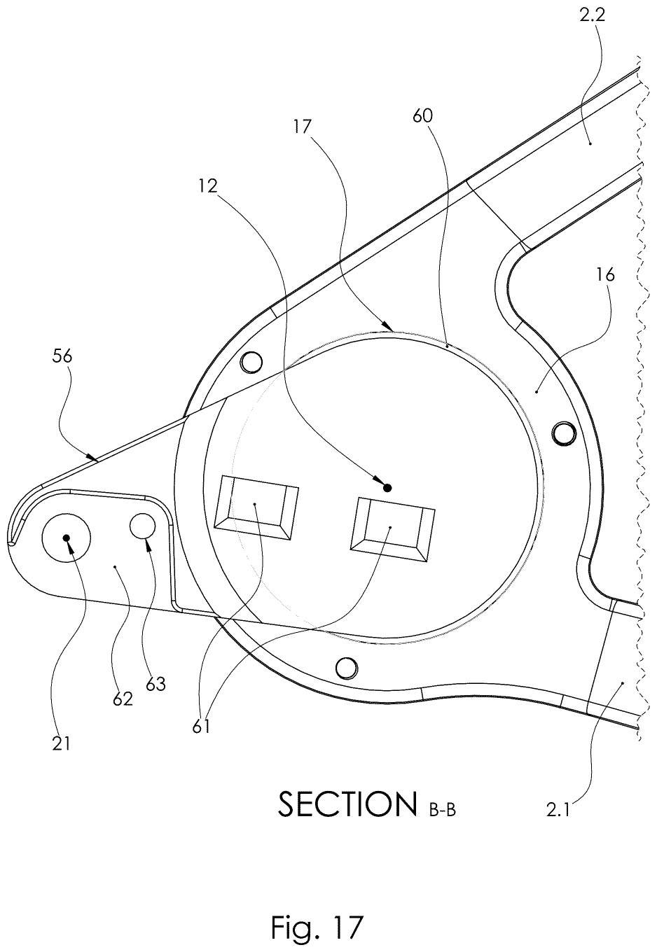

Referring to FIG. 17, a cropped section view B-B of the disclosed rear rotary suspension system is shown with certain components removed for clarity, illustrating the relationship between the rear wheel carrier and brake carrier components, the rear suspension pivot axis 12, and the rear suspension pivot aperture/bore [Non-Drive] 17. The section view reveals the rear triangle 2 structure including the chainstay 2.1 and the seatstay 2.2, which are rigidly connected at the rear suspension pivot structure [Non-Drive] 16. The rear suspension pivot aperture/bore [Non-Drive] 17 is a feature of the rear suspension pivot structure [Non-Drive] 16 and is concentric to the rear suspension pivot axis 12.

With continued reference to FIG. 17, the rear wheel carrier and brake carrier [Non-Drive] [Embodiment-1] 56 is pivotally connected to the rear suspension pivot structure [Non-Drive] 16 about the rear suspension pivot axis 12. The rear wheel carrier and brake carrier bushing [Non-Drive] [Embodiment-1] 60 is installed into the rear suspension pivot aperture/bore [Non-Drive] 17 to receive the rear wheel carrier and brake carrier [Non-Drive] [Embodiment-1] 56 and to reduce rotational friction between these components. The rear wheel carrier and brake carrier caliper mounts [Non-Drive] [Embodiment-1] 61 are visible on the rear wheel carrier and brake carrier [Non-Drive] [Embodiment-1] 56, with at least a portion of a projection of the rear wheel carrier and brake carrier caliper mounts [Non-Drive] [Embodiment-1] 61 located within a projection of the rear suspension pivot aperture/bore [Non-Drive] 17 when viewed normal to the rear suspension pivot axis 12. The rear wheel carrier and brake carrier hub interconnect interface [Non-Drive] [Embodiment-1] 62 and the rear wheel carrier and brake carrier hub interconnect fastener bore [Non-Drive] [Embodiment-1] 63 are located on the rear wheel carrier and brake carrier [Non-Drive] [Embodiment-1] 56. The rear wheel axis [Extended] 21 defines the pivotal connection point for the rear wheel hub to the carrier structure.

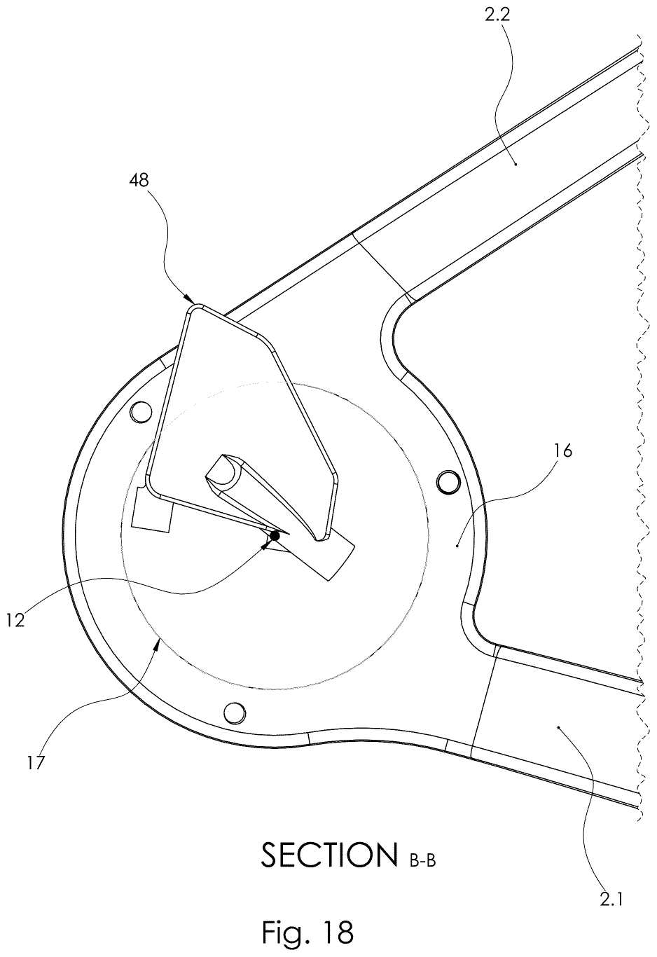

Referring to FIG. 18, a cropped section B-B view of the rear rotary suspension system in embodiment 1 is shown with certain components removed for clarity. This view illustrates the relationship between the rear brake caliper 48, the rear suspension pivot axis 12, and the rear suspension pivot aperture/bore [Non-Drive] 17. The rear suspension pivot structure [Non-Drive] 16 is visible along with the chainstay 2.1 and the seatstay 2.2 portions of the rear triangle 2.

As further shown in FIG. 18, the section view demonstrates that at least a portion of a projection of the rear brake caliper 48 is located within a projection of the rotary mechanism interface when viewed normal to the rear suspension pivot axis 12 at any point of the suspension travel. This is shown by noting that at least a portion of a projection of the rear brake caliper 48 is located within a projection of the rear suspension pivot aperture/bore [Non-Drive] 17 when viewed normal to the rear suspension pivot axis 12 at any point of the suspension travel. Since the resistance mechanism is located within the rear suspension pivot aperture/bore [Non-Drive] 17 in this configuration, at least a portion of the projection of the rear brake caliper 48 is located within a projection of the resistance mechanism. The rear suspension pivot axis 12 intersects at least a portion of the rear brake caliper 48 in this configuration. The view provides insight into the spatial arrangement of the braking components relative to the rotary suspension pivot structure on the non-drive side of the two-wheeled vehicle.

Referring to FIG. 19, a cropped section view B-B is shown with the rear triangle 2 and the rear brake rotor 50 illustrated for clarity. This view depicts the relationship between the rear brake rotor 50, the rear suspension pivot axis 12, and the rear suspension pivot aperture/bore [Non-Drive] 17. The rear brake rotor 50 is shown as a circular disc with multiple elongated slots arranged in a radial pattern around a circumference of the rear brake rotor 50, which is a configuration used for heat dissipation during braking operations.

With continued reference to FIG. 19, the rear suspension pivot structure [Non-Drive] 16 is visible as part of the rear triangle 2 assembly, which includes the chainstay 2.1 and the seatstay 2.2. The rear suspension pivot aperture/bore [Non-Drive] 17 is a feature of the rear suspension pivot structure [Non-Drive] 16 and is concentric to the rear suspension pivot axis 12. At least a portion of a projection of the rear brake rotor 50, which is a component of a braking mechanism, is located within a projection of the rotary mechanism interface when viewed normal to the rear suspension pivot axis 12 at any point of the suspension travel. This is shown by noting that at least a portion the rear suspension pivot aperture/bore [Non-Drive] 17 when viewed normal to the rear suspension pivot axis 12 as shown in this view, at any point of the suspension travel. Since the resistance mechanism is located within the rear suspension pivot aperture/bore [Non-Drive] 17 in this configuration, at least a portion of the projection of the rear brake rotor 50 is located within a projection of the resistance mechanism. The rear suspension pivot axis 12 intersects at least a portion of the rear brake rotor 50 in this configuration.

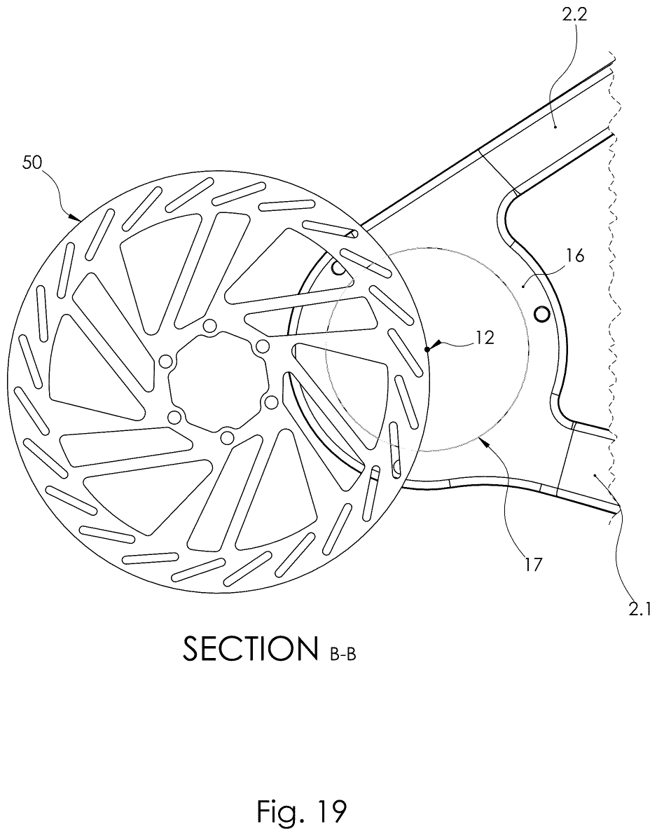

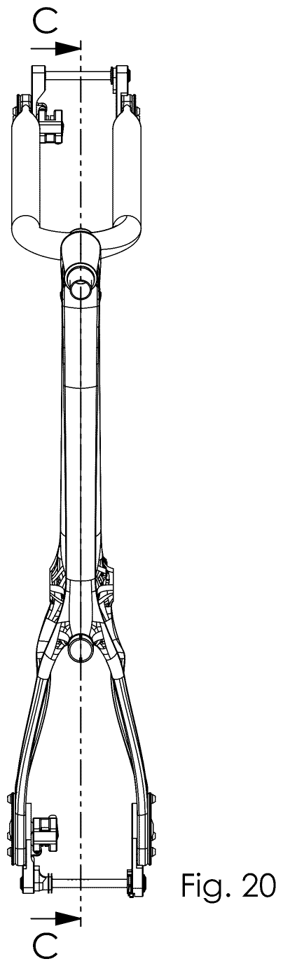

Referring to FIG. 20, a top view of embodiment 1 of the disclosed rear rotary suspension system in the extended state is shown with various parts removed for clarity. The view illustrates a section line C-C which is used for subsequent cross-sectional views. The rear tire 20 is visible in this top-down perspective, positioned at the rear portion of the two-wheeled vehicle. A dashed line running vertically through the center of the image indicates the section line C-C, with directional arrows labeled C pointing inward to denote the viewing direction for the corresponding cross-sectional view. This top view provides a reference for understanding the spatial relationships between the rear suspension components and the rear tire 20 when examining the cross-sectional details in related figures.

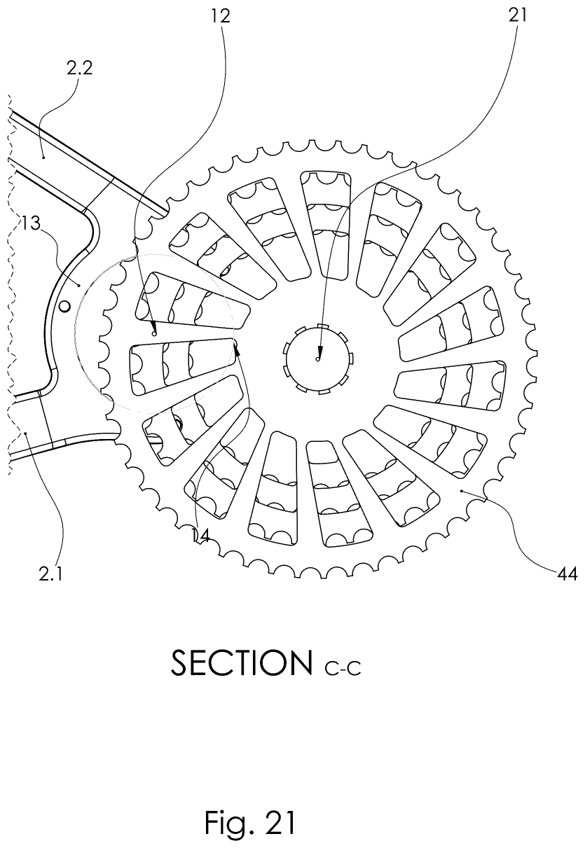

Referring to FIG. 21, a cropped section view C-C is shown with the rear wheel axle 43, the rear hub flange interconnect 38, and the rear brake caliper 48 removed and the rear driven cassette 44 added for clarity. This view illustrates the relationship between the rear driven cassette 44, the rear suspension pivot axis 12, and the rear suspension pivot aperture/bore [Drive] 14. The section view reveals the internal arrangement of components within the rear suspension system of the two-wheeled vehicle.

With continued reference to FIG. 21, the chainstay 2.1 and the seatstay 2.2 are visible as structural members of the rear triangle 2, converging at the rear suspension pivot structure [Drive] 13. The rear suspension pivot aperture/bore [Drive] 14 is a circular feature of the rear suspension pivot structure [Drive] 13 and is concentric to the rear suspension pivot axis 12. The rear driven cassette 44 is shown with multiple gear cogs arranged concentrically about the rear wheel axis [Extended] 21. The view demonstrates that at least a portion of a projection of the rear driven cassette 44 is located within a projection of the rotary mechanism interface when viewed normal to the rear suspension pivot axis 12 at any point of the suspension travel. This is shown by noting that at least a portion of a projection of the rear suspension pivot aperture/bore [Drive] 14 when viewed normal to the rear suspension pivot axis 12 at any point of the suspension travel. Since the resistance mechanism is located within the rear suspension pivot aperture/bore [Drive] 14 in this configuration, at least a portion of the projection of the rear driven cassette 44 is located within a projection of the resistance mechanism. The rear suspension pivot axis 12 intersects at least a portion of the rear driven cassette 44 in this arrangement.

The disc brake system shown in the various section views may be replaced with a rim brake system in some embodiments. In configurations utilizing a rim brake system, the rear brake caliper 48 and the rear brake rotor 50 may be omitted, and brake pads may be positioned to engage directly with a braking surface on the rear rim 19. The rim brake system configuration may provide reduced weight and simplified maintenance compared to the disc brake system configuration, while the disc brake system configuration may provide improved braking performance in wet or muddy conditions.

Referring to FIG. 22, an isolated isometric view of the rear stator [Drive] [Embodiment-1] 64 with the rear stator blades [Drive] [Embodiment-1] 65 is shown. The rear stator [Drive] [Embodiment-1] 64 is a generally circular component that includes a central aperture defined by the rear suspension pivot axis 12. The rear stator blades [Drive] [Embodiment-1] 65 extend inwardly from an inner circumference of the rear stator [Drive] [Embodiment-1] 64 toward the central aperture. The rear stator [Drive] [Embodiment-1] 64 includes a raised peripheral rim along an outer edge of the rear stator [Drive] [Embodiment-1] 64 and features multiple mounting holes positioned around a circumference of the rear stator [Drive] [Embodiment-1] 64 for fastening purposes. The rear stator blades [Drive] [Embodiment-1] 65 are configured to interface with corresponding wheel carrier blades and elastomers to provide resistance during suspension movement about the rear suspension pivot axis 12. This configuration enables the rotary resistance mechanism to resist relative motion between suspension kinematic bodies as the suspension cycles between extended and compressed states.

With continued reference to FIG. 22, the rear stator blades [Drive] [Embodiment-1] 65 may be arranged in a radial pattern extending from the inner circumference of the rear stator [Drive] [Embodiment-1] 64. The geometry of the rear stator blades [Drive] [Embodiment-1] 65 defines spaces between adjacent blades where elastomeric components may be positioned. The rear stator [Drive] [Embodiment-1] 64 remains stationary relative to the suspended body when installed into the rear suspension pivot structure, while the wheel carrier rotates about the rear suspension pivot axis 12 during suspension movement. The resistance mechanism may include one or more stator blades, with additional blades increasing the number of resistance instances within the rotary mechanism. As the number of blades increases, so does the number of resistance instances, which may enable the design of each instance to be optimized for a particular average leverage ratio.

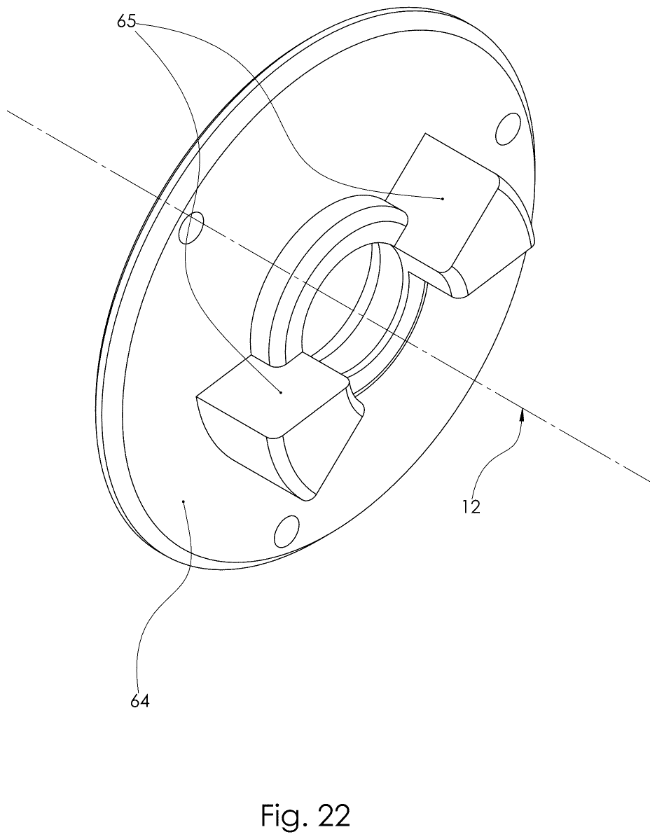

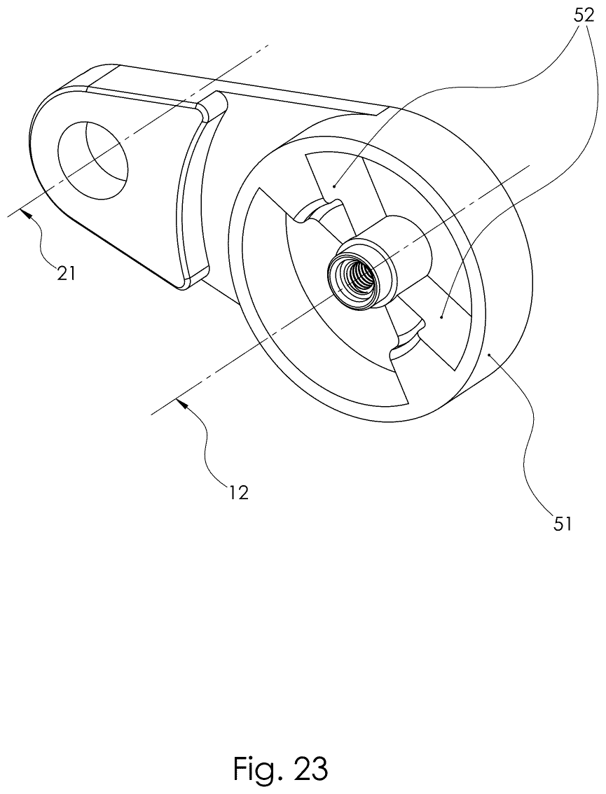

Referring to FIG. 23, an isometric view of the rear wheel carrier [Drive] [Embodiment-1] 51 with the rear wheel carrier blades [Drive] [Embodiment-1] 52 in the extended state is shown. The rear wheel carrier [Drive] [Embodiment-1] 51 is a structural component that is pivotally connected to the rear suspension pivot structure about the rear suspension pivot axis 12. The rear wheel carrier [Drive] [Embodiment-1] 51 includes an elongated body portion that extends from a circular hub region toward a wheel mounting area. The circular hub region is configured to interface with the suspension pivot structure and includes features for receiving bearings and bushings.

As further shown in FIG. 23, the rear wheel carrier blades [Drive] [Embodiment-1] 52 are integral features of the rear wheel carrier [Drive] [Embodiment-1] 51 and extend radially from the central hub region. The rear wheel carrier blades [Drive] [Embodiment-1] 52 are configured to interact with the rear stator blades [Drive] [Embodiment-1] 65 and elastomers within the rotary resistance mechanism to provide spring resistance as the suspension moves between extended, compressed, and over-extended states. The rear wheel axis [Extended] 21 is located at a distal end of the rear wheel carrier [Drive] [Embodiment-1] 51, where the rear wheel hub is pivotally connected. A threaded bore is visible at a center of the hub region, which receives a fastener to secure the rear wheel carrier [Drive] [Embodiment-1] 51 to the stator assembly. The motion of the rear wheel carrier blades [Drive] [Embodiment-1] 52 moves in an arc with a constant radius of curvature about the rear suspension pivot axis 12 due to the symmetric design of this embodiment.

The rear wheel carrier blades [Drive] [Embodiment-1] 52 may be arranged to interleave with the rear stator blades [Drive] [Embodiment-1] 65 when the rear wheel carrier [Drive] [Embodiment-1] 51 is assembled into the rear stator [Drive] [Embodiment-1] 64. Elastomeric components may be positioned in spaces between the rear wheel carrier blades [Drive] [Embodiment-1] 52 and the rear stator blades [Drive] [Embodiment-1] 65 to provide resistance during relative rotation between the rear wheel carrier [Drive] [Embodiment-1] 51 and the rear stator [Drive] [Embodiment-1] 64. The resistance mechanism may include one or more rotor blades on the rear wheel carrier [Drive] [Embodiment-1] 51, with additional blades increasing the number of resistance instances. Additional resistance instances may allow the design of each instance to be optimized for a particular average leverage ratio, which may be applicable for suspension directions from the extended state to the compressed state, from the compressed state to the extended state, and from the extended state to the over-extended state.

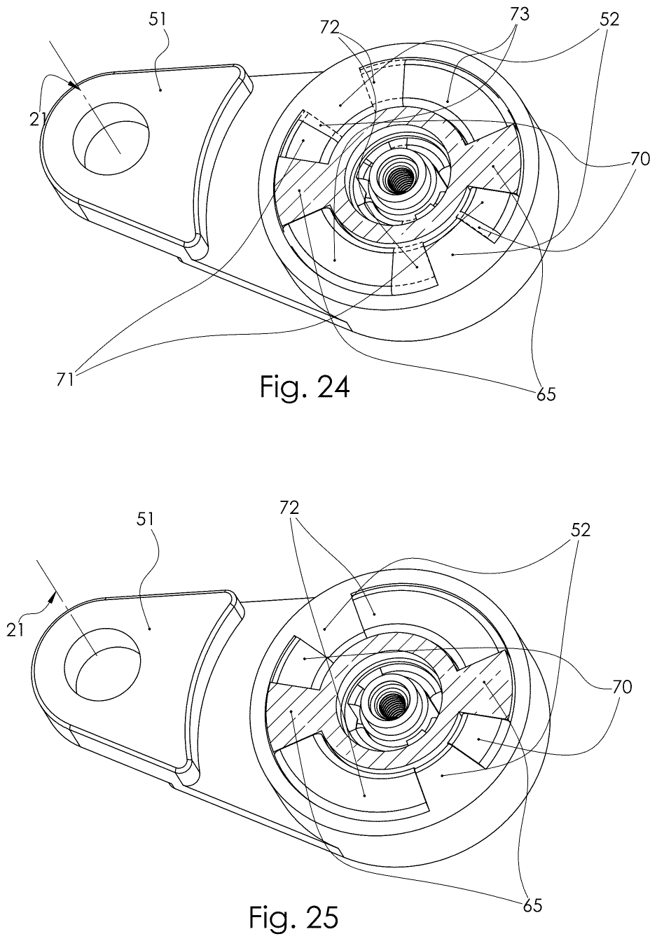

Referring to FIGS. 24-25, an isolated isometric view of the rear wheel carrier [Drive] [Embodiment-1] 51 in the extended state is shown. The rear wheel carrier [Drive] [Embodiment-1] 51 includes the rear wheel carrier blades [Drive] [Embodiment-1] 52 that extend radially from the carrier body. The view illustrates the relationship between the rear wheel carrier [Drive] [Embodiment-1] 51 and the elastomer components that provide resistance during suspension movement.

The rear elastomers top-out extended [Drive] [Embodiment-1] 70 and the rear elastomers primary extended [Drive] [Embodiment-1] 72 are shown in solid lines, representing positions of the elastomers in the extended state. A rear elastomers top-out compressed [Drive] [Embodiment-1] 71 and a rear elastomers primary compressed [Drive] [Embodiment-1] 73 are shown in dotted lines, indicating positions of the elastomers when the suspension is in the compressed state. The rear stator blades [Drive] [Embodiment-1] 65 are positioned between the elastomer components and interact with the rear wheel carrier blades [Drive] [Embodiment-1] 52 during suspension travel.

With continued reference to FIGS. 24-25, the rear wheel axis [Extended] 21 defines the rotational axis of the rear wheel when the suspension is in the extended position. This visualization provides a representation of the allotted migration of the rear wheel carrier blades [Drive] [Embodiment-1] 52 as the rear wheel axis moves from the extended position to the compressed position and to the over-extended position, with the elastomer components compressing and extending accordingly to provide resistive spring force during suspension movement.

The rear elastomers primary extended [Drive] [Embodiment-1] 72 may resist motion of the kinematic wheel carrier as the kinematic wheel carrier moves from the extended state to the compressed state. The rear elastomers top-out extended [Drive] [Embodiment-1] 70 may resist motion of the kinematic wheel carrier as the kinematic wheel carrier moves from the extended state to the over-extended state. The elastomer materials may include rubbers, plastics, polymers, and metals. The elastomers may be hollow to offer a lower spring rate or softer ride feel compared to solid elastomers.

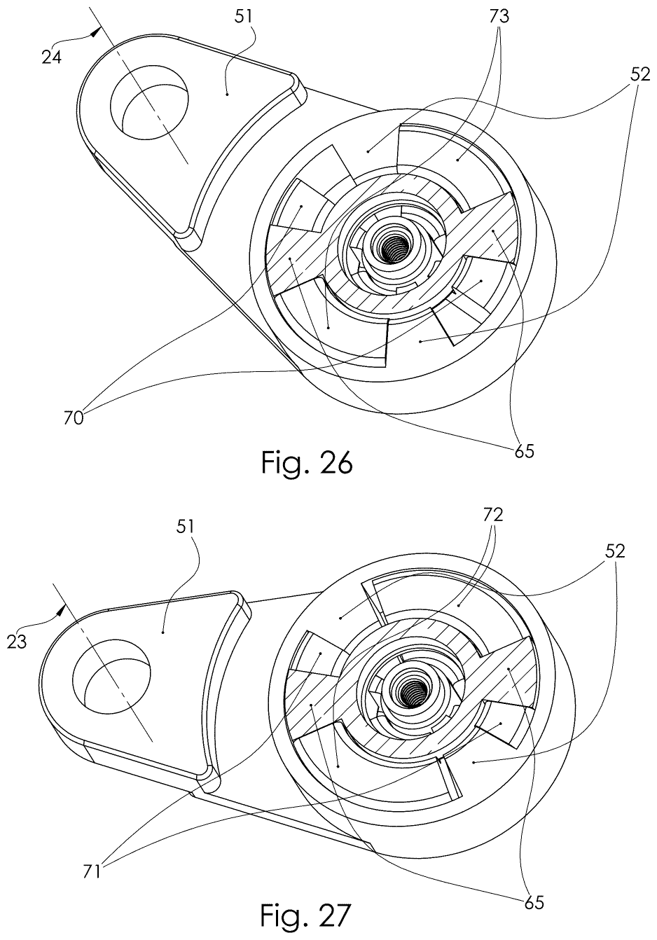

Referring to FIG. 26, an isolated isometric view of the rear wheel carrier [Drive] [Embodiment-1] 51 in the compressed state is shown. The rear wheel carrier [Drive] [Embodiment-1] 51 includes the rear wheel carrier blades [Drive] [Embodiment-1] 52 that extend radially from the carrier body. The view illustrates the assembly configuration when the rear wheel is positioned at a rear wheel axis [Compressed] 24 position.

In this compressed state, the rear elastomers top-out extended [Drive] [Embodiment-1] 70 and the rear elastomers primary compressed [Drive] [Embodiment-1] 73 are shown in their solid positions. The rear stator blades [Drive] [Embodiment-1] 65 are positioned relative to the rear wheel carrier blades [Drive] [Embodiment-1] 52, with the elastomeric components disposed between the rear stator blades [Drive] [Embodiment-1] 65 and the rear wheel carrier blades [Drive] [Embodiment-1] 52. The rear elastomers top-out compressed [Drive] [Embodiment-1] 71 and the rear elastomers primary extended [Drive] [Embodiment-1] 72 represent alternative positions of the elastomeric elements corresponding to different suspension states. A rear wheel axis [Over-Extended] 23 indicates the position of the wheel axis in the over-extended state for reference.

As further shown in FIG. 26, this visualization demonstrates the relative positioning of the rear wheel carrier blades [Drive] [Embodiment-1] 52 and the rear stator blades [Drive] [Embodiment-1] 65 when the suspension has moved from the extended state to the compressed state, showing how the rear elastomers primary compressed [Drive] [Embodiment-1] 73 are compressed while the rear elastomers top-out extended [Drive] [Embodiment-1] 70 remain in an extended configuration. A cross section of the elastomer may increase in a compressive direction to achieve a progressively stiffer spring rate as the suspension moves toward the compressed state.

Referring to FIG. 27, an isolated isometric view of the rear wheel carrier [Drive] [Embodiment-1] 51 in the over-extended state is shown. The rear wheel carrier [Drive] [Embodiment-1] 51 includes the rear wheel carrier blades [Drive] [Embodiment-1] 52 that extend radially from the carrier body. The view illustrates the assembly configuration when the rear wheel is positioned at the rear wheel axis [Over-Extended] 23 position.

In this over-extended state, the rear elastomers top-out compressed [Drive] [Embodiment-1] 71 and the rear elastomers primary extended [Drive] [Embodiment-1] 72 are shown in their solid positions. The rear stator blades [Drive] [Embodiment-1] 65 are positioned relative to the rear wheel carrier blades [Drive] [Embodiment-1] 52, with the elastomeric components disposed between the rear stator blades [Drive] [Embodiment-1] 65 and the rear wheel carrier blades [Drive] [Embodiment-1] 52. The rear elastomers top-out extended [Drive] [Embodiment-1] 70 and the rear elastomers primary compressed [Drive] [Embodiment-1] 73 represent alternative positions of the elastomeric elements corresponding to different suspension states. The rear wheel axis [Compressed] 24 indicates the position of the wheel axis in the compressed state for reference.

With continued reference to FIG. 27, this visualization demonstrates the relative positioning of the rear wheel carrier blades [Drive] [Embodiment-1] 52 and the rear stator blades [Drive] [Embodiment-1] 65 when the suspension has moved from the extended state to the over-extended state, showing how the rear elastomers top-out compressed [Drive] [Embodiment-1] 71 are compressed while the rear elastomers primary extended [Drive] [Embodiment-1] 72 remain in an extended configuration.

The rear elastomers top-out extended [Drive] [Embodiment-1] 70 may be firmer than the rear elastomers primary extended [Drive] [Embodiment-1] 72. In some configurations, a first top-out elastomer may be firmer than a second top-out elastomer, and both top-out elastomers may be firmer than both primary elastomers. The elastomers may be interchangeable or replaced to tune for various riders or riding conditions. A mechanism that pre-loads an elastomer in the extended state may be used to increase the spring rate or progression curve of the resistance mechanism.

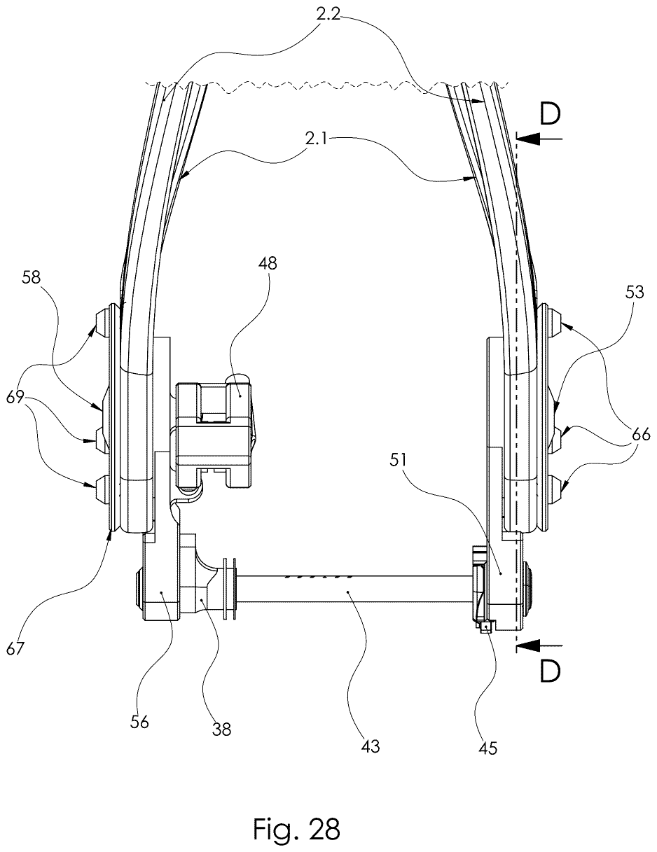

Referring to FIG. 28, a cropped top view of embodiment 1 of the disclosed rear rotary suspension system is shown with various parts removed for clarity, illustrating a section line D-D. The view depicts the rear suspension assembly from above, showing the relationship between the drive side and non-drive side components of the suspension system.

The chainstay and seatstay form part of the rear triangle structure. The rear wheel carrier on the drive side is shown secured by a rear wheel carrier fastener. Rear stator fasteners are visible on the drive side, connecting the stator to the rear suspension pivot structure.

On the non-drive side, the rear wheel carrier and brake carrier is positioned and secured by a rear wheel carrier and brake carrier fastener. A rear stator on the non-drive side is fastened to the rear suspension pivot structure via rear stator fasteners.

With continued reference to FIG. 28, a rear wheel axle extends through the assembly, connecting the drive side and non-drive side wheel carriers. A rear hub flange interconnect is positioned along the wheel axle, providing a mechanical connection to improve rigidity between the separated wheel carrier bodies. A rear derailleur hanger is visible at the rear of the drive side assembly.

A rear brake caliper is mounted on the non-drive side of the assembly, positioned to engage with a brake rotor for braking functionality. The section line D-D indicates a cutting plane for subsequent cross-sectional views that reveal the internal arrangement of the rotary resistance mechanism components.

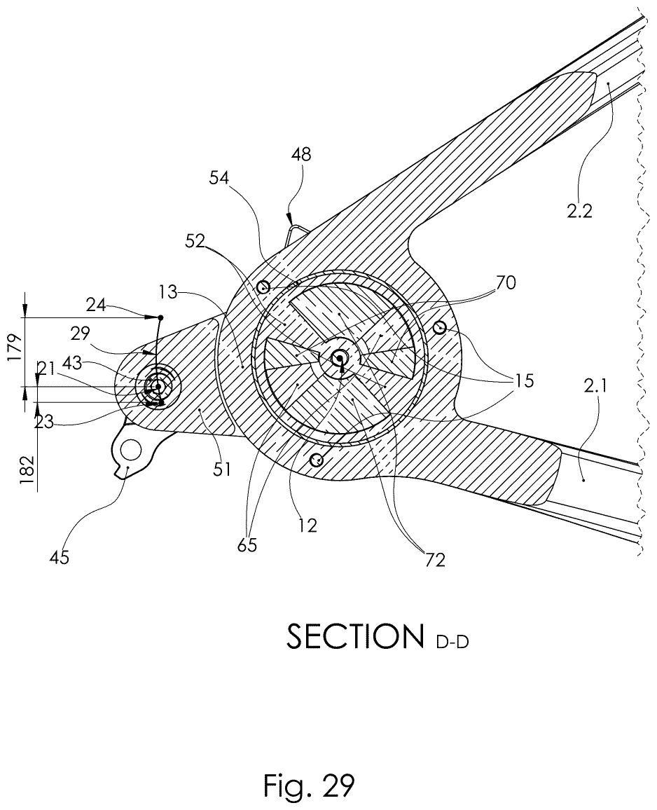

Referring to FIG. 29, a section D-D view of the rear rotary suspension system in the extended state is shown. The section view illustrates the internal arrangement of components within the rear suspension pivot structure and wheel carrier assembly. The chainstay and seatstay form part of the rear triangle structure, with the rear suspension pivot structure positioned at an intersection of the chainstay and seatstay. A rear suspension pivot axis defines the rotational center of the suspension system, with a rear pivot structure fastener interface providing attachment points for securing components.

A rear wheel carrier is shown pivotally connected about the rear suspension pivot axis, with rear wheel carrier blades extending from the carrier body. A rear wheel carrier bushing is installed within the pivot structure to reduce rotational friction between the wheel carrier and the suspended body. Rear stator blades are positioned to interact with the wheel carrier blades.

With continued reference to FIG. 29, the resistance mechanism includes rear elastomers in a top-out extended configuration and rear elastomers in a primary extended configuration, which are installed between the rear wheel carrier blades and the rear stator blades. These elastomers provide spring resistance as the suspension moves through a travel range.

A rear wheel axis in the extended position indicates a current wheel position, while a rear wheel axis in the over-extended position and a rear wheel axis in the compressed position show limits of suspension travel along a rear wheel path. A vertical wheel travel from the extended state to the compressed state represents a distance between the extended and compressed states, and a vertical wheel travel from the extended state to the over-extended state represents a distance from the extended state to the over-extended state.

A rear wheel axle passes through the wheel carrier to support the rear wheel, with a rear derailleur hanger mounted to the wheel carrier for drivetrain attachment. A rear brake caliper is also visible in this section view.

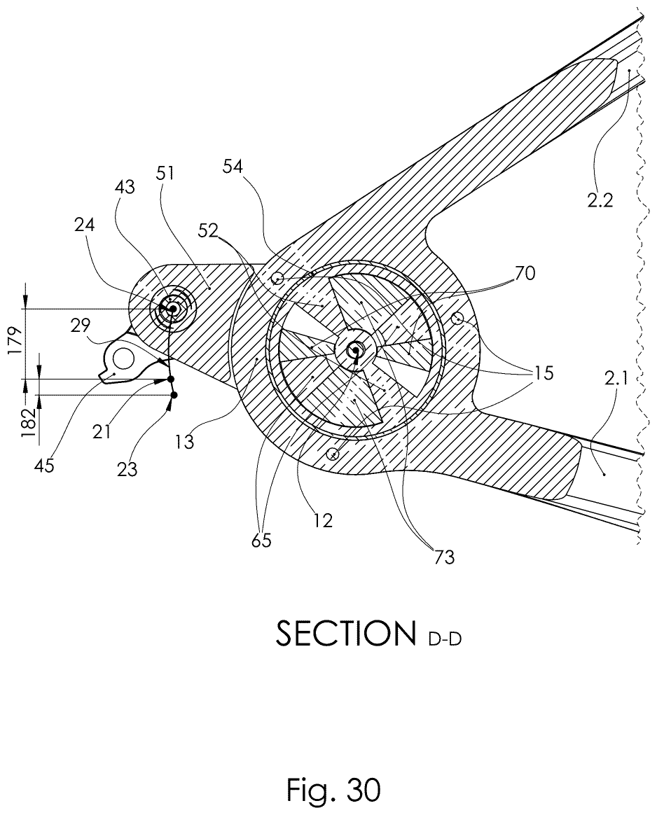

Referring to FIG. 30, a section D-D view of the rear rotary suspension system in the compressed state is shown. The section view illustrates the internal arrangement of components within the rear suspension assembly when the suspension has moved from the extended position to the compressed position.

The view depicts the chainstay and seatstay of the rear triangle, which are rigidly connected at the rear suspension pivot structure. The rear suspension pivot axis is shown as the central rotational axis about which the suspension components rotate. A rear pivot structure fastener interface is visible as part of the pivot structure.

A rear wheel carrier is pivotally connected to the suspension pivot structure and includes rear wheel carrier blades, which extend into the rotary resistance mechanism. A rear wheel carrier bushing is installed within the pivot aperture to reduce rotational friction between the wheel carrier and the pivot structure.

With continued reference to FIG. 30, rear stator blades are shown in a fixed position relative to the suspended body. Between the stator blades and the wheel carrier blades, rear elastomers in a top-out extended configuration and rear elastomers in a primary compressed configuration are positioned. In this compressed state, the primary elastomers are shown in a compressed configuration, providing resistive spring force against the suspension movement.

A rear wheel axle passes through the wheel carrier, and a rear derailleur hanger is mounted to the wheel carrier assembly. The rear wheel path illustrates an arc along which the rear wheel axis travels during suspension movement. Three positions along this path are indicated: a rear wheel axis in the extended position, a rear wheel axis in the compressed position, and a rear wheel axis in the over-extended position.

The vertical wheel travel from the extended state to the compressed state represents a vertical distance between the extended and compressed wheel axis positions, while the vertical wheel travel from the extended state to the over-extended state represents a vertical distance from the extended position to the over-extended position. These measurements define a range of suspension travel in both a primary compression direction and a secondary top-out direction.

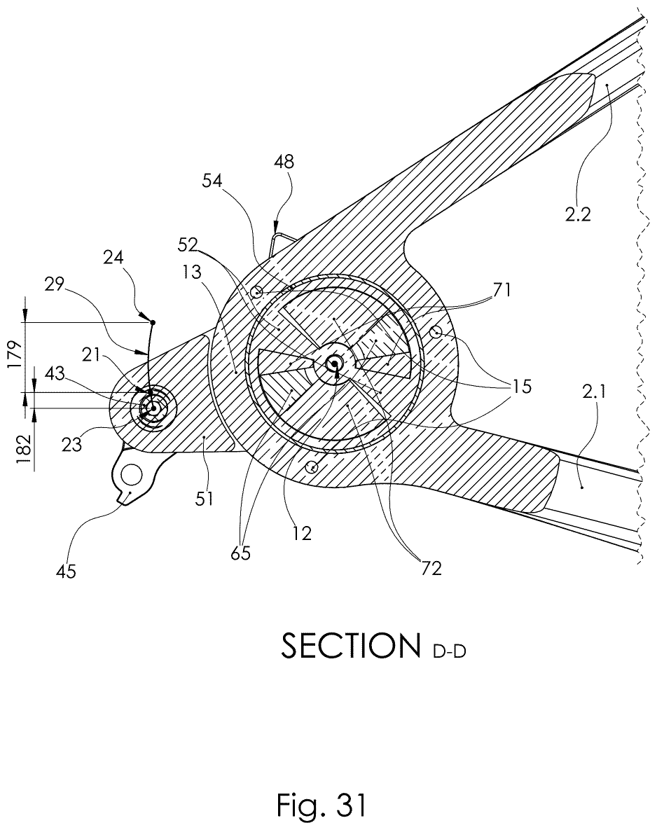

Referring to FIG. 31, a section D-D view of the rear rotary suspension system in the over-extended state is shown. The section view illustrates the internal arrangement of components within the rear suspension assembly when the suspension has moved from the extended position to the over-extended position.

The view depicts the chainstay and seatstay of the rear triangle, which are rigidly connected at the rear suspension pivot structure. The rear suspension pivot axis is shown as the central rotational axis about which the suspension components rotate. A rear pivot structure fastener interface is visible as part of the pivot structure.

With continued reference to FIG. 31, a rear wheel carrier is pivotally connected to the suspension pivot structure and includes rear wheel carrier blades, which extend into the rotary resistance mechanism. A rear wheel carrier bushing is installed within the pivot aperture to reduce rotational friction between the wheel carrier and the pivot structure.

Rear stator blades are shown in a fixed position relative to the suspended body. Between the stator blades and the wheel carrier blades, rear elastomers in a top-out compressed configuration and rear elastomers in a primary extended configuration are positioned. In this over-extended state, the top-out elastomers are shown in a compressed configuration, providing resistive spring force against the suspension movement in the over-extension direction.

A rear wheel axle passes through the wheel carrier, and a rear derailleur hanger is mounted to the wheel carrier assembly. The rear wheel path illustrates an arc along which the rear wheel axis travels during suspension movement. Three positions along this path are indicated: a rear wheel axis in the extended position, a rear wheel axis in the compressed position, and a rear wheel axis in the over-extended position.

The vertical wheel travel from the extended state to the compressed state represents a vertical distance between the extended and compressed wheel axis positions, while the vertical wheel travel from the extended state to the over-extended state represents a vertical distance from the extended position to the over-extended position. The over-extended state may occur when the rear wheel drops into a depression or when the suspended body is lifted relative to the rear wheel, causing the suspension to extend beyond the normal extended position. The top-out elastomers provide resistance to limit the over-extension travel and return the suspension toward the extended position.

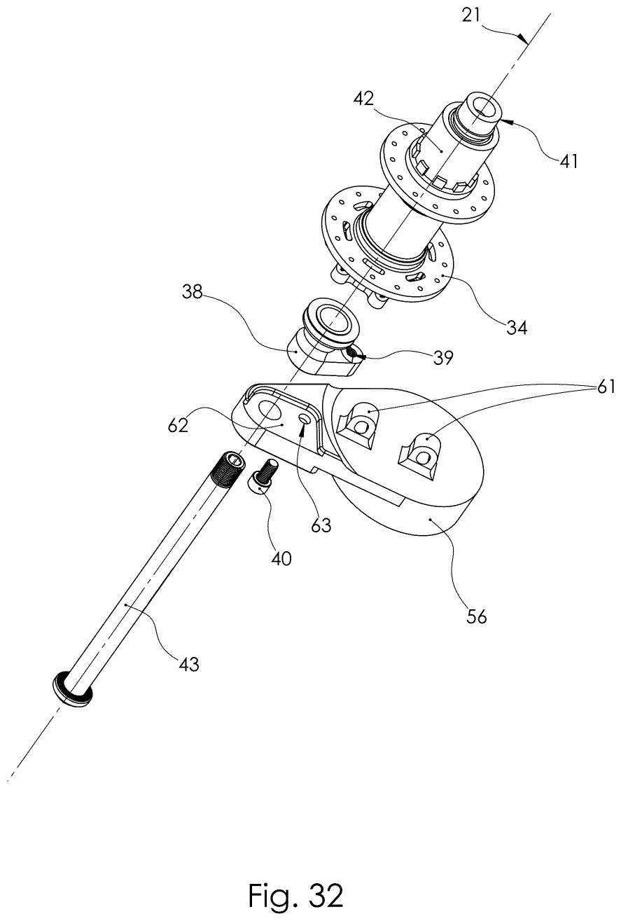

Referring to FIG. 32, an isometric exploded view of the rear wheel carrier and brake carrier [Non-Drive] [Embodiment-1] 56 and various parts is shown to highlight the assembly of the rear hub flange interconnect 38. The exploded view illustrates the spatial relationships between the components and the assembly sequence for connecting the rear hub flange interconnect 38 to the rear wheel carrier and brake carrier [Non-Drive] [Embodiment-1] 56.

The rear wheel carrier and brake carrier [Non-Drive] [Embodiment-1] 56 includes the rear wheel carrier and brake carrier hub interconnect interface [Non-Drive] [Embodiment-1] 62, which is configured to receive the rear hub flange interconnect 38. The rear wheel carrier and brake carrier hub interconnect interface [Non-Drive] [Embodiment-1] 62 includes a geometric profile that corresponds to a positive feature on the rear hub flange interconnect 38. The rear hub flange interconnect 38 includes a positive feature that is asymmetric about the rear wheel axis [Extended] 21. The asymmetric positive feature may have various shapes or forms, including but not limited to a keyed profile, a splined interface, or an offset geometric feature.

With continued reference to FIG. 32, when the positive feature of the rear hub flange interconnect 38 is installed into the rear wheel carrier and brake carrier hub interconnect interface [Non-Drive] [Embodiment-1] 62, no substantial rotation can occur between the rear wheel carrier and brake carrier [Non-Drive] [Embodiment-1] 56 and the rear hub flange interconnect 38. This arrangement aids in preventing relative motion between the rear wheel carrier [Drive] [Embodiment-1] 51 and the rear wheel carrier and brake carrier [Non-Drive] [Embodiment-1] 56, providing structural rigidity between the separated wheel carrier bodies on opposite sides of the rear wheel.

The rear wheel carrier and brake carrier [Non-Drive] [Embodiment-1] 56 includes the rear wheel carrier and brake carrier caliper mounts [Non-Drive] [Embodiment-1] 61, which provide mounting interfaces for securing the rear brake caliper 48. The rear hub flange 41 is visible on the rear hub flange interconnect 38, providing a mounting interface for the wheel spokes 190. The rear free hub mechanism 42 is operably connected to the rear hub flange interconnect 38 to enable connection to the rear driven cassette 44.

As further shown in FIG. 32, the rear hub flange interconnect fastener interface 39 is located on the rear hub flange interconnect 38 and is configured to receive the rear hub flange interconnect fastener 40. The rear wheel carrier and brake carrier hub interconnect fastener bore [Non-Drive] [Embodiment-1] 63 is positioned on the rear wheel carrier and brake carrier [Non-Drive] [Embodiment-1] 56 and is aligned with the rear hub flange interconnect fastener interface 39 when the rear hub flange interconnect 38 is assembled into the rear wheel carrier and brake carrier hub interconnect interface [Non-Drive] [Embodiment-1] 62. The rear hub flange interconnect fastener 40 may be installed through the rear wheel carrier and brake carrier hub interconnect fastener bore [Non-Drive] [Embodiment-1] 63 and into the rear hub flange interconnect fastener interface 39 to mechanically connect the rear hub flange interconnect 38 to the rear wheel carrier and brake carrier [Non-Drive] [Embodiment-1] 56.

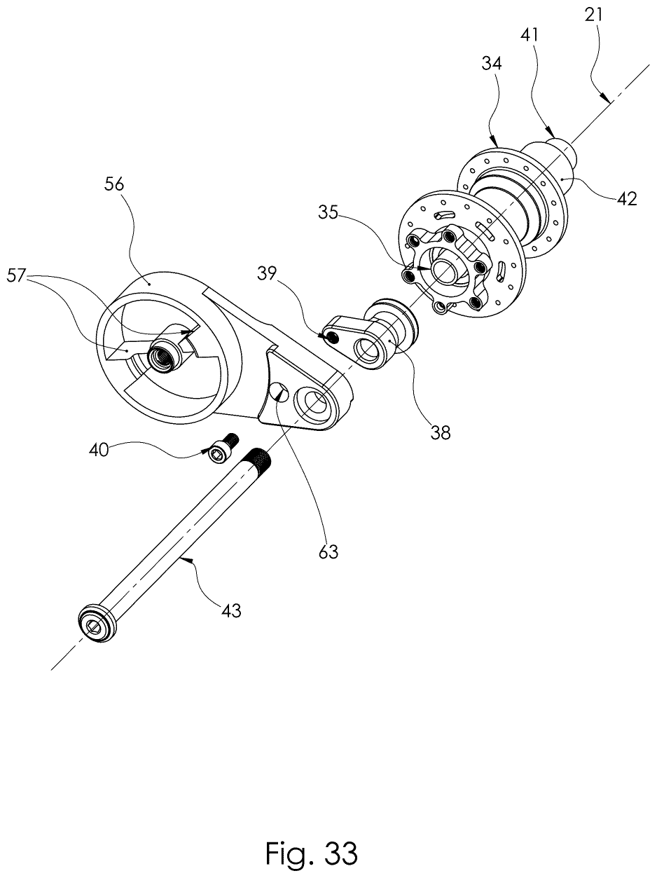

Referring to FIG. 33, an alternative isometric exploded view of the rear wheel carrier and brake carrier [Non-Drive] [Embodiment-1] 56 and various parts is shown to highlight the assembly of the rear hub flange interconnect 38 from a different perspective. This view provides additional visibility of the component relationships and the fastening arrangement.

The rear wheel carrier and brake carrier [Non-Drive] [Embodiment-1] 56 includes rear wheel carrier and brake carrier blades [Non-Drive] [Embodiment-1] 57, which extend radially from a hub region of the rear wheel carrier and brake carrier [Non-Drive] [Embodiment-1] 56. The rear wheel carrier and brake carrier blades [Non-Drive] [Embodiment-1] 57 are configured to interact with the rear stator blades [Non-Drive] [Embodiment-1] 68 and elastomeric components within the rotary resistance mechanism on the non-drive side of the suspension assembly.

With continued reference to FIG. 33, the rear hub 34 is shown with the rear hub main axle 35 extending through the rear hub 34. The rear hub flange interconnect 38 is positioned adjacent to the rear hub 34 and includes the rear hub flange 41 and the rear free hub mechanism 42. The rear hub flange interconnect fastener interface 39 is visible on the rear hub flange interconnect 38, and the rear hub flange interconnect fastener 40 is shown in an exploded position ready for installation through the rear wheel carrier and brake carrier hub interconnect fastener bore [Non-Drive] [Embodiment-1] 63.

The rear wheel carrier and brake carrier hub interconnect interface [Non-Drive] [Embodiment-1] 62 is configured with a geometry that matches the asymmetric positive feature of the rear hub flange interconnect 38. The matching geometry between the rear wheel carrier and brake carrier hub interconnect interface [Non-Drive] [Embodiment-1] 62 and the positive feature of the rear hub flange interconnect 38 prevents rotational movement between these components when assembled together. The rear hub flange interconnect fastener 40 provides additional mechanical connection to secure the rear hub flange interconnect 38 to the rear wheel carrier and brake carrier [Non-Drive] [Embodiment-1] 56.

In some embodiments, the rear hub flange interconnect fastener 40, the rear wheel carrier and brake carrier hub interconnect fastener bore [Non-Drive] [Embodiment-1] 63, and the rear hub flange interconnect fastener interface 39 may be omitted while still preventing relative motion between the rear hub flange interconnect 38 and the rear wheel carrier and brake carrier [Non-Drive] [Embodiment-1] 56 through the engagement of the asymmetric positive feature with the rear wheel carrier and brake carrier hub interconnect interface [Non-Drive] [Embodiment-1] 62. The hub flange interconnect arrangement aids in maintaining kinematic motion between the drive side and non-drive side wheel carrier bodies as identical as possible, even when these bodies are not directly connected. This configuration may provide reduced binding, a stiffer suspension structure that allows for improved ride control and performance, and greater durability.

In further embodiments a hub flange interconnect fastener interface may be omitted, increasing. The likelihood of the wheel carriers moving in unison may be performed through other means. For example, a pinch bolt feature within may be used to rigidly secure the wheel axle 43 or front wheel axle 112 to a wheel carrier or wheel carriers.

In further embodiments a hub flange interconnect fastener interface may be omitted, with no additional means of increasing the likelihood of the rear wheel carriers moving in unison. The large diameter of the wheel carrier bushings combined with the rear axle alone may provide adequate in-sync motion.

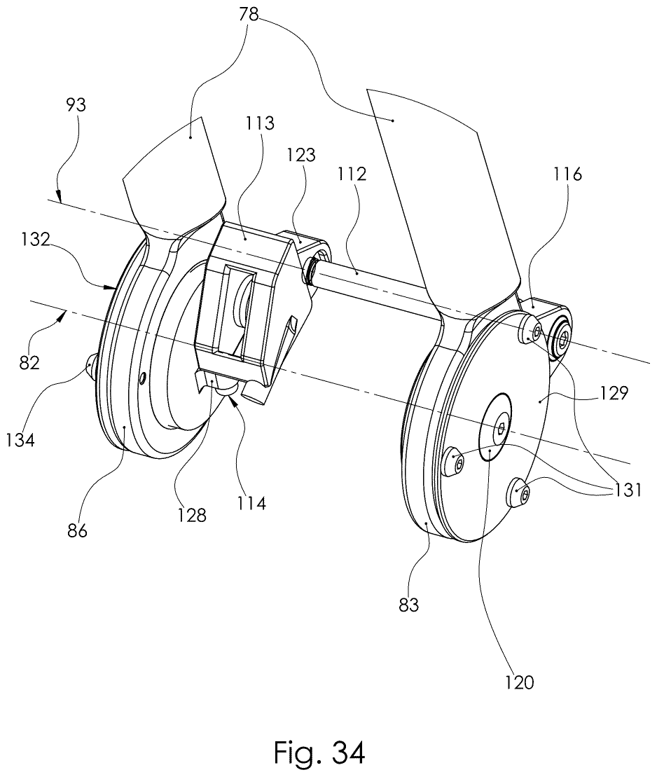

Referring to FIG. 34, a cropped isometric view of the front rotary suspension system according to Embodiment-1 is shown with additional parts removed for clarity. The view illustrates the arrangement of the front suspension components and their relationship to the fork upper 78.

The fork upper 78 extends downward from the headset and includes the front suspension pivot structure [Drive] 83 on the drive side and the front suspension pivot structure [Non-Drive] 86 on the non-drive side. The front suspension pivot axis 82 is defined by the front suspension pivot structures and provides the rotational axis about which the front wheel carriers pivot relative to the fork upper 78.

With continued reference to FIG. 34, the front wheel carrier [Drive] [Embodiment-1] 116 is pivotally connected to the front suspension pivot structure [Drive] 83 about the front suspension pivot axis 82. The front wheel carrier [Drive] [Embodiment-1] 116 is secured via the front wheel carrier fastener [Drive] [Embodiment-1] 120. The front stator [Drive] [Embodiment-1] 129 is fastened to the front suspension pivot structure [Drive] 83 via the front stator fasteners [Drive] [Embodiment-1] 131. On the non-drive side, the front wheel carrier and brake carrier [Non-Drive] [Embodiment-1] 123 is pivotally connected to the front suspension pivot structure [Non-Drive] 86. The front stator [Non-Drive] [Embodiment-1] 132 is fastened to the front suspension pivot structure [Non-Drive] 86 via the front stator fasteners [Non-Drive] [Embodiment-1] 134.

The front wheel carrier and brake carrier [Non-Drive] [Embodiment-1] 123 includes front wheel carrier and brake carrier caliper mounts [Non-Drive] [Embodiment-1] 128, which provide mounting interfaces for securing the front brake caliper 113. Front brake caliper fasteners 114 secure the front brake caliper 113 to the front wheel carrier and brake carrier caliper mounts [Non-Drive] [Embodiment-1] 128. A front wheel axle 112 extends through the front wheel carrier [Drive] [Embodiment-1] 116, the front hub 104, and the front wheel carrier and brake carrier [Non-Drive] [Embodiment-1] 123 to support the front wheel assembly 194.

As further shown in FIG. 34, the front wheel axis [Extended] 93 defines the rotational axis of the front wheel when the front suspension is in the extended state. The front suspension pivot axis 82 is positioned rearward of the fork steering axis 81 in this embodiment. The front suspension pivot axis 82 may be located rearward or forward of the fork steering axis 81 depending upon the suspension design and packaging requirements.

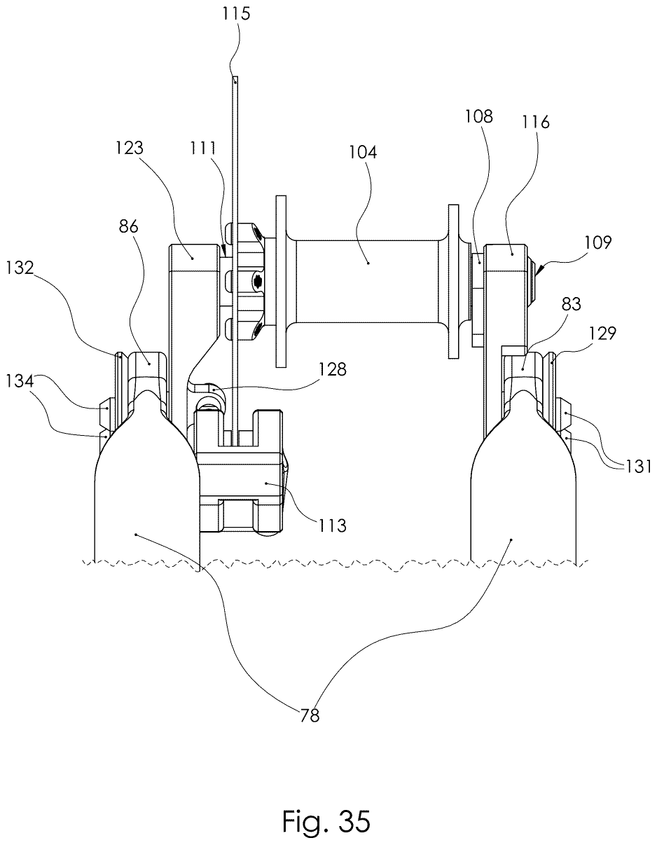

Referring to FIG. 35, a cropped top view of the front rotary suspension system according to Embodiment-1 is shown with additional parts removed for clarity. The top view perspective reveals the lateral spacing between the drive side and non-drive side components of the front suspension system.

The fork upper 78 is positioned centrally in the view, with the front suspension pivot structure [Drive] 83 extending toward the drive side and the front suspension pivot structure [Non-Drive] 86 extending toward the non-drive side. The front stator [Drive] [Embodiment-1] 129 is fastened to the front suspension pivot structure [Drive] 83 via the front stator fasteners [Drive] [Embodiment-1] 131. The front stator [Non-Drive] [Embodiment-1] 132 is fastened to the front suspension pivot structure [Non-Drive] 86 via the front stator fasteners [Non-Drive] [Embodiment-1] 134.

With continued reference to FIG. 35, the front wheel carrier [Drive] [Embodiment-1] 116 is visible on the drive side, and the front wheel carrier and brake carrier [Non-Drive] [Embodiment-1] 123 is visible on the non-drive side. The front wheel carrier and brake carrier caliper mounts [Non-Drive] [Embodiment-1] 128 are positioned on the front wheel carrier and brake carrier [Non-Drive] [Embodiment-1] 123 to receive the front brake caliper 113. The front hub 104 is positioned centrally between the front wheel carrier [Drive] [Embodiment-1] 116 and the front wheel carrier and brake carrier [Non-Drive] [Embodiment-1] 123. The front hub flange interconnect 108 is visible adjacent to the front hub 104, providing structural connection between the separated wheel carrier bodies on the front wheel.

The front brake rotor 115 is fastened to the front hub 104 and is positioned to engage with the front brake caliper 113 for braking functionality. The front wheel axle 112 extends through the front suspension assembly, connecting the drive side and non-drive side wheel carriers and supporting the front hub 104.

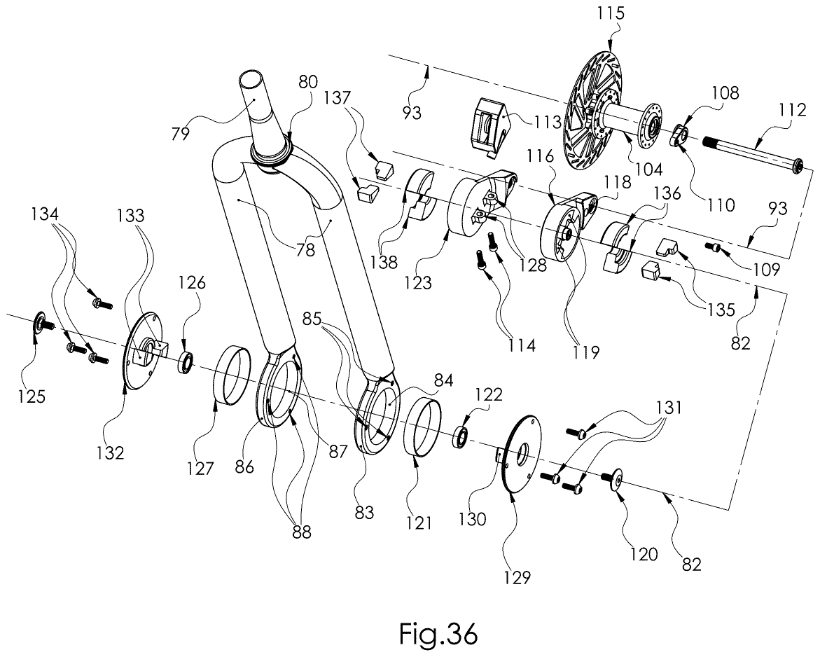

Referring to FIG. 36, a cropped, exploded, isometric view of the front rotary suspension system assembly according to Embodiment-1 is shown with additional parts added for clarity. The exploded view illustrates the relationship between the various components of the front suspension system and their assembly sequence.

The fork upper 78 is rigidly connected to the fork steerer tube 79, which is pivotally mounted to the headset through a fork crown race 80. The fork upper 78 includes the front suspension pivot structure [Drive] 83 on the drive side and the front suspension pivot structure [Non-Drive] 86 on the non-drive side. The front suspension pivot aperture/bore [Drive] 84 is a feature of the front suspension pivot structure [Drive] 83 and is concentric to the front suspension pivot axis 82. The front suspension pivot aperture/bore [Non-Drive] 87 is a feature of the front suspension pivot structure [Non-Drive] 86 and is also concentric to the front suspension pivot axis 82.

With continued reference to FIG. 36, the front pivot structure fastener interface [Drive] [Embodiment-1] 85 receives the front stator fasteners [Drive] [Embodiment-1] 131 which secure the front stator [Drive] [Embodiment-1] 129 to the front suspension pivot structure [Drive] 83. The front stator [Drive] [Embodiment-1] 129 includes front stator blades [Drive] [Embodiment-1] 130. A front pivot structure fastener interface [Non-Drive] [Embodiment 1] 88 receives the front stator fasteners [Non-Drive] [Embodiment-1] 134 which secure the front stator [Non-Drive] [Embodiment-1] 132 to the front suspension pivot structure [Non-Drive] 86. The front stator [Non-Drive] [Embodiment-1] 132 includes front stator blades [Non-Drive] [Embodiment-1] 133.

A front wheel carrier bushing [Drive] [Embodiment-1] 121 is installed into the front suspension pivot aperture/bore [Drive] 84 to receive the front wheel carrier [Drive] [Embodiment-1] 116 and reduce rotational friction between these components. The front wheel carrier [Drive] [Embodiment-1] 116 includes front wheel carrier blades [Drive] [Embodiment-1] 119. A front wheel carrier bearing [Drive] [Embodiment-1] 122 is installed into the front stator [Drive] [Embodiment-1] 129 to reduce rotational friction with the front wheel carrier [Drive] [Embodiment-1] 116. The front wheel carrier fastener [Drive] [Embodiment-1] 120 pivotally fastens the front wheel carrier [Drive] [Embodiment-1] 116 to the front stator [Drive] [Embodiment-1] 129.

As further shown in FIG. 36, front elastomers top-out extended [Drive] [Embodiment-1] 135 and front elastomers primary extended [Drive] [Embodiment-1] 136 are installed between the front wheel carrier blades [Drive] [Embodiment-1] 119 and the front stator blades [Drive] [Embodiment-1] 130. The front elastomers top-out extended [Drive] [Embodiment-1] 135 may resist motion of the kinematic wheel carrier as the kinematic wheel carrier moves from an extended state to an over-extended state. The front elastomers primary extended [Drive] [Embodiment-1] 136 may resist motion of the kinematic wheel carrier as the kinematic wheel carrier moves from the extended state to a compressed state.

On the non-drive side, a front wheel carrier and brake carrier bushing [Non-Drive] [Embodiment-1] 127 is installed into the front suspension pivot aperture/bore [Non-Drive] 87 to receive the front wheel carrier and brake carrier [Non-Drive] [Embodiment-1] 123. The front wheel carrier and brake carrier [Non-Drive] [Embodiment-1] 123 includes front wheel carrier and brake carrier blades [Non-Drive] [Embodiment-1] 124. A front wheel carrier and brake carrier bearing [Non-Drive] [Embodiment-1] 126 is installed into the front stator [Non-Drive] [Embodiment-1] 132. A front wheel carrier and brake carrier fastener [Non-Drive] [Embodiment-1] 125 secures the assembly.

With continued reference to FIG. 36, front elastomers top-out extended [Non-Drive] [Embodiment-1] 137 and front elastomers primary extended [Non-Drive] [Embodiment-1] 138 are installed between the front wheel carrier and brake carrier blades [Non-Drive] [Embodiment-1] 124 and the front stator blades [Non-Drive] [Embodiment-1] 133.

The front wheel carrier and brake carrier [Non-Drive] [Embodiment-1] 123 includes the front wheel carrier and brake carrier caliper mounts [Non-Drive] [Embodiment-1] 128. The front hub 104 is shown with the front hub flange interconnect 108, which includes a front hub flange interconnect fastener interface 110 and receives the front hub flange interconnect fastener 109. The front brake rotor 115 is fastened to the front hub 104, and the front brake caliper 113 is secured via the front brake caliper fasteners 114. The front wheel axle 112 is installed through the front wheel carrier [Drive] [Embodiment-1] 116, the front hub 104, the front hub flange interconnect 108, and the front wheel carrier and brake carrier [Non-Drive] [Embodiment-1] 123. The front wheel axis [Extended] 93 defines the wheel position in the extended state.

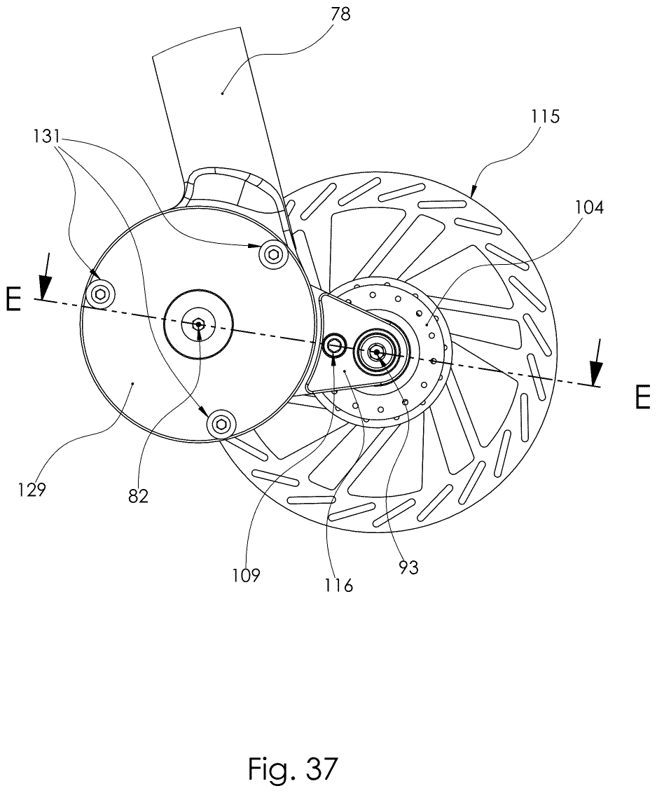

Referring to FIG. 37, a cropped drive-side view of embodiment 1 of the disclosed front rotary suspension system is shown with various parts removed for clarity. The view illustrates a section line E-E used for subsequent cross-sectional views. The front suspension system includes the fork upper 78 with the front suspension pivot structure [Drive] 83. The front suspension pivot axis 82 defines the axis about which the suspension components rotate. The front wheel axis [Extended] 93 indicates the position of the front wheel in the extended state. The front hub 104 is shown with the front brake rotor 115 fastened to the front hub 104. The front wheel carrier [Drive] [Embodiment-1] 116 is pivotally connected about the front suspension pivot axis 82. The front stator [Drive] [Embodiment-1] 129 is fastened to the front suspension pivot structure [Drive] 83 via the front stator fasteners [Drive] [Embodiment-1] 131. The front hub flange interconnect fastener 109 is installed into the front wheel carrier [Drive] [Embodiment-1] 116. This view provides a reference for understanding the spatial relationships between the front suspension components and establishes the section line E-E for detailed cross-sectional analysis of the rotary resistance mechanism assembly.

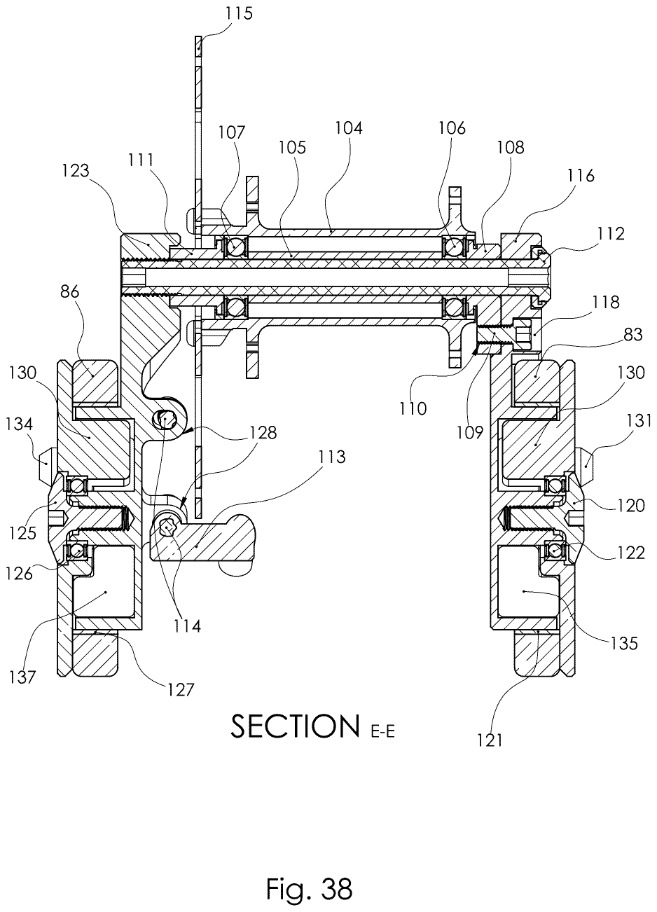

Referring to FIG. 38, a section E-E view of the front rotary suspension system according to Embodiment-1 is shown, revealing the internal arrangement and relationship of components within the front suspension assembly. The section view reveals the structural configuration of the front suspension pivot structures and the associated wheel carrier components on both the drive and non-drive sides of the two-wheeled vehicle.

On the drive side, the front suspension pivot structure [Drive] 83 houses the front wheel carrier [Drive] [Embodiment-1] 116, which is pivotally connected via the front wheel carrier bushing [Drive] [Embodiment-1] 121. The front wheel carrier bearing [Drive] [Embodiment-1] 122 is installed to reduce rotational friction between the front wheel carrier [Drive] [Embodiment-1] 116 and the front stator [Drive] [Embodiment-1] 129. The front stator blades [Drive] [Embodiment-1] 130 extend from the front stator [Drive] [Embodiment-1] 129, and the front stator fasteners [Drive] [Embodiment-1] 131 secure the front stator [Drive] [Embodiment-1] 129 to the front suspension pivot structure [Drive] 83. The front elastomers top-out extended [Drive] [Embodiment-1] 135 and the front elastomers primary extended [Drive] [Embodiment-1] 136 are positioned between the front stator blades [Drive] [Embodiment-1] 130 and the front wheel carrier blades [Drive] [Embodiment-1] 119 to provide resistance during suspension movement. The front wheel carrier fastener [Drive] [Embodiment-1] 120 secures the wheel carrier assembly.

With continued reference to FIG. 38, on the non-drive side, the front suspension pivot structure [Non-Drive] 86 accommodates the front wheel carrier and brake carrier [Non-Drive] [Embodiment-1] 123. The front wheel carrier and brake carrier bushing [Non-Drive] [Embodiment-1] 127 and the front wheel carrier and brake carrier bearing [Non-Drive] [Embodiment-1] 126 facilitate rotational movement. The front stator [Non-Drive] [Embodiment-1] 132 with the front stator blades [Non-Drive] [Embodiment-1] 133 is secured by the front stator fasteners [Non-Drive] [Embodiment-1] 134. The front elastomers top-out extended [Non-Drive] [Embodiment-1] 137 and the front elastomers primary extended [Non-Drive][Embodiment-1] 138 provide resistance on the non-drive side. The front wheel carrier and brake carrier fastener [Non-Drive] [Embodiment-1] 125 secures the assembly.

As further shown in FIG. 38, the central portion of the section view shows the front hub 104 with a front hub main axle 105 extending through the front hub 104. A front hub flange interconnect bearing 106 and a front hub main bearing 107 support the hub assembly. The front hub flange interconnect 108 connects to the front hub 104 via the front hub flange interconnect fastener interface 110 and the front hub flange interconnect fastener 109. A front hub flange 111 is positioned on the non-drive side. The front wheel axle 112 passes through the entire assembly. The front brake caliper 113 is mounted on the non-drive side via the front brake caliper fasteners 114, and the front brake rotor 115 is attached to the hub assembly. A front wheel carrier hub interconnect fastener bore [Drive] [Embodiment-1] 118 is located on the front wheel carrier [Drive] [Embodiment-1] 116.

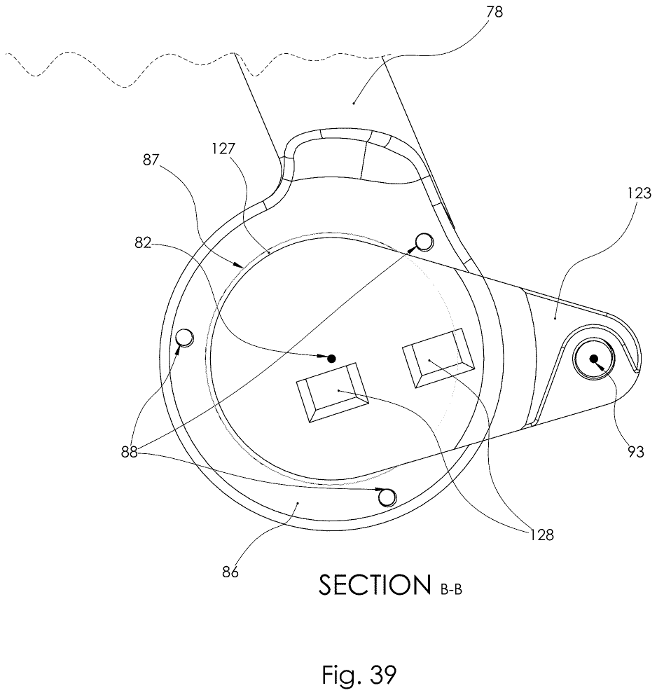

Referring to FIG. 39, a cropped section B-B view of the front rotary suspension system is shown with certain components removed for clarity, illustrating the relationship between the front wheel carrier and brake carrier components, the front suspension pivot axis 82, and the front suspension pivot aperture/bore [Non-Drive] 87. The section view reveals the front suspension pivot structure [Non-Drive] 86. The front suspension pivot aperture/bore [Non-Drive] 87 is a feature of the front suspension pivot structure [Non-Drive] 86 and is concentric to the front suspension pivot axis 82.

With continued reference to FIG. 39, the front wheel carrier and brake carrier [Non-Drive] [Embodiment-1] 123 is pivotally connected to the front suspension pivot structure [Non-Drive] 86 about the front suspension pivot axis 82. The front wheel carrier and brake carrier bushing [Non-Drive] [Embodiment-1] 127 is installed into the front suspension pivot aperture/bore [Non-Drive] 87 to receive the front wheel carrier and brake carrier [Non-Drive] [Embodiment-1] 123 and to reduce rotational friction between these components. The front wheel carrier and brake carrier caliper mounts [Non-Drive] [Embodiment-1] 128 are visible on the front wheel carrier and brake carrier [Non-Drive] [Embodiment-1] 123, with at least a portion of a projection of the front wheel carrier and brake carrier caliper mounts [Non-Drive] [Embodiment-1] 128 located within a projection of the rotary mechanism interface when viewed normal to the front suspension pivot axis 82 at any point of the suspension travel. This is shown by noting that at least a portion of a projection of the front suspension pivot aperture/bore [Non-Drive] 87 when viewed normal to the front suspension pivot axis 82. The front pivot structure fastener interface [Non-Drive] [Embodiment 1] 88 is visible on the front suspension pivot structure [Non-Drive] 86. The front wheel axis [Extended] 93 defines the pivotal connection point for the front wheel hub to the carrier structure.

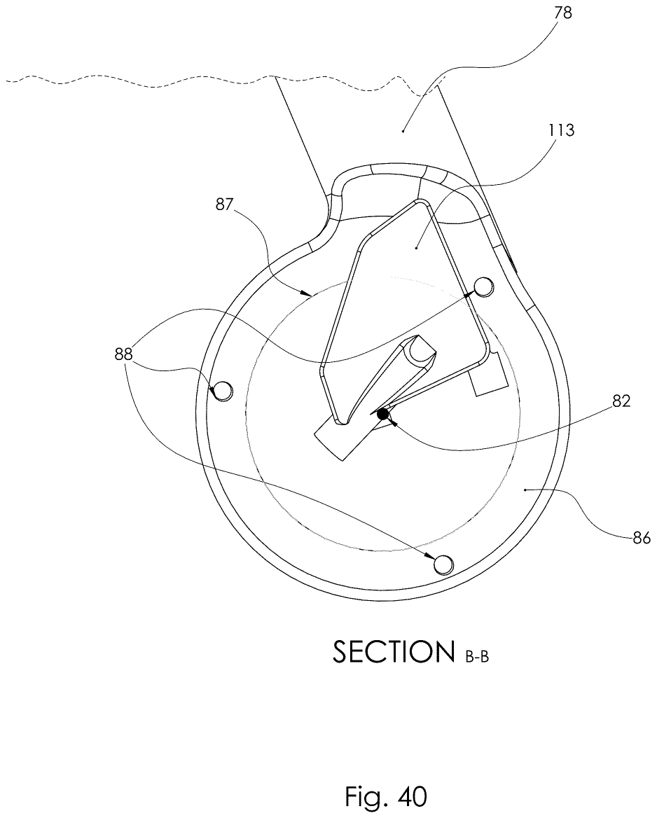

Referring to FIG. 40, a cropped section B-B view of the front rotary suspension system is shown with certain components removed for clarity. This view illustrates the relationship between the front brake caliper 113, the front suspension pivot axis 82, and the front suspension pivot aperture/bore [Non-Drive] 87. The front suspension pivot structure [Non-Drive] 86 is visible.

As further shown in FIG. 40, the section view demonstrates that at least a portion of a projection of the front brake caliper 113 is located within a projection of the rotary mechanism interface when viewed normal to the front suspension pivot axis 82 at any point of the suspension travel. This is shown by noting that at least a portion of a projection of the front suspension pivot aperture/bore [Non-Drive] 87 when viewed normal to the front suspension pivot axis 82 at any point of the suspension travel. Since the resistance mechanism is located within the front suspension pivot aperture/bore [Non-Drive] 87 in this configuration, at least a portion of the projection of the front brake caliper 113 is located within a projection of the resistance mechanism. The front suspension pivot axis 82 intersects at least a portion of the front brake caliper 113 in this configuration. The front wheel carrier and brake carrier bushing [Non-Drive] [Embodiment-1] 127 is installed within the front suspension pivot aperture/bore [Non-Drive] 87. The front pivot structure fastener interface [Non-Drive] [Embodiment 1] 88 is positioned on the front suspension pivot structure [Non-Drive] 86.

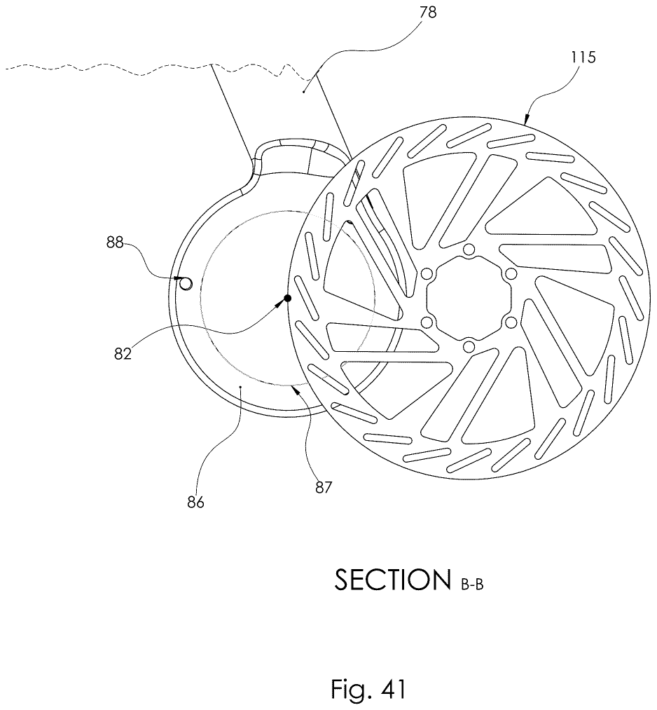

Referring to FIG. 41, a cropped section B-B view is shown with the front triangle 1 and the front brake rotor 115 illustrated for clarity. This view depicts the relationship between the front brake rotor 115, the front suspension pivot axis 82, and the front suspension pivot aperture/bore [Non-Drive] 87. The front brake rotor 115 is shown as a circular disc with multiple elongated slots arranged in a radial pattern around a circumference of the front brake rotor 115, which is a configuration used for heat dissipation during braking operations.

With continued reference to FIG. 41, the front suspension pivot structure [Non-Drive] 86 is visible. The front suspension pivot aperture/bore [Non-Drive] 87 is a feature of the front suspension pivot structure [Non-Drive] 86 and is concentric to the front suspension pivot axis 82. At least a portion of a projection of the front brake rotor 115 is located within a projection of the rotary mechanism interface when viewed normal to the front suspension pivot axis 82 at any point of the suspension travel. This is shown by noting that at least a portion of a projection of the front suspension pivot aperture/bore [Non-Drive] 87 when viewed normal to the front suspension pivot axis 82 as shown in this view, at any point of the suspension travel. Since the resistance mechanism is located within the front suspension pivot aperture/bore [Non-Drive] 87 in this configuration, at least a portion of the projection of the front brake rotor 115 is located within a projection of the resistance mechanism. The front suspension pivot axis 82 intersects at least a portion of the front brake rotor 115 in this configuration. The front pivot structure fastener interface [Non-Drive] [Embodiment 1] 88 is positioned on the front suspension pivot structure [Non-Drive] 86.

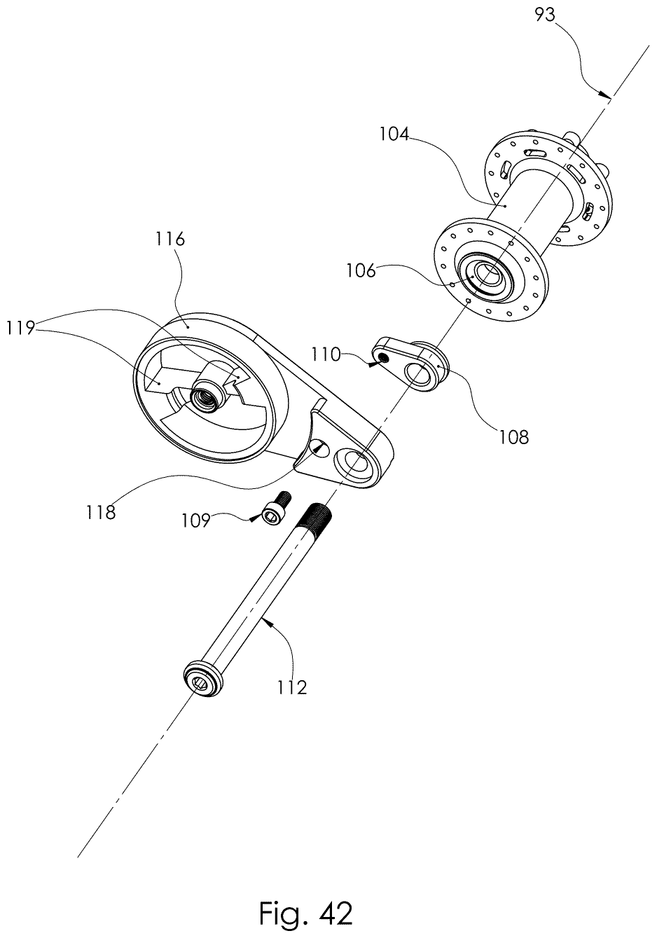

Referring to FIG. 42, an isometric exploded view of the front wheel carrier [Drive] [Embodiment-1] 116 and various parts is shown to highlight the assembly of the front hub flange interconnect 108. The exploded view illustrates the spatial relationships between the components and the assembly sequence for connecting the front hub flange interconnect 108 to the front wheel carrier [Drive] [Embodiment-1] 116.

The front wheel carrier [Drive] [Embodiment-1] 116 includes a front wheel carrier hub interconnect interface [Drive] [Embodiment-1] 117, which is configured to receive the front hub flange interconnect 108. The front wheel carrier hub interconnect interface [Drive] [Embodiment-1] 117 includes a geometric profile that corresponds to a positive feature on the front hub flange interconnect 108. The front hub flange interconnect 108 includes a positive feature that is asymmetric about the front wheel axis [Extended] 93. The asymmetric positive feature may have various shapes or forms, including but not limited to a keyed profile, a splined interface, or an offset geometric feature.

With continued reference to FIG. 42, when the positive feature of the front hub flange interconnect 108 is installed into the front wheel carrier hub interconnect interface [Drive] [Embodiment-1] 117, no substantial rotation can occur between the front wheel carrier [Drive] [Embodiment-1] 116 and the front hub flange interconnect 108. This arrangement aids in preventing relative motion between the front wheel carrier [Drive] [Embodiment-1] 116 and the front wheel carrier and brake carrier [Non-Drive] [Embodiment-1] 123, providing structural rigidity between the separated wheel carrier bodies on opposite sides of the front wheel.

The front wheel carrier blades [Drive] [Embodiment-1] 119 extend radially from a hub region of the front wheel carrier [Drive] [Embodiment-1] 116. The front wheel carrier hub interconnect fastener bore [Drive] [Embodiment-1] 118 is positioned on the front wheel carrier [Drive] [Embodiment-1] 116 and is aligned with the front hub flange interconnect fastener interface 110 when the front hub flange interconnect 108 is assembled into the front wheel carrier hub interconnect interface [Drive] [Embodiment-1] 117. The front hub flange interconnect fastener 109 may be installed through the front wheel carrier hub interconnect fastener bore [Drive] [Embodiment-1] 118 and into the front hub flange interconnect fastener interface 110 to mechanically connect the front hub flange interconnect 108 to the front wheel carrier [Drive] [Embodiment-1] 116.

As further shown in FIG. 42, the front hub 104 is shown with the front hub flange interconnect bearing 106 positioned between the front hub 104 and the front hub flange interconnect 108. The front wheel axle 112 extends through the front hub 104 and the front hub flange interconnect 108.

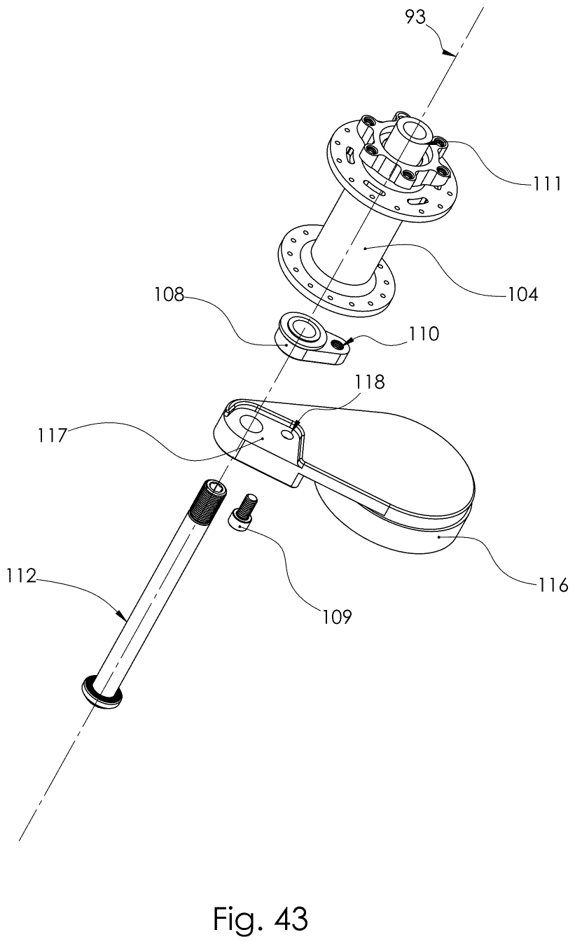

Referring to FIG. 43, an alternative isometric exploded view of the front wheel carrier [Drive] [Embodiment-1] 116 and various parts is shown to highlight the assembly of the front hub flange interconnect 108 from a different perspective. This view provides additional visibility of the component relationships and the fastening arrangement.

The front wheel carrier [Drive] [Embodiment-1] 116 includes the front wheel carrier hub interconnect interface [Drive] [Embodiment-1] 117, which is configured with a geometry that matches the asymmetric positive feature of the front hub flange interconnect 108. The matching geometry between the front wheel carrier hub interconnect interface [Drive] [Embodiment-1] 117 and the positive feature of the front hub flange interconnect 108 prevents rotational movement between these components when assembled together.

With continued reference to FIG. 43, the front hub 104 is shown with the front hub flange interconnect 108 positioned adjacent to the front hub 104. The front hub flange 111 is visible on the front hub flange interconnect 108, providing a mounting interface for the wheel spokes 190. The front hub flange interconnect fastener interface 110 is visible on the front hub flange interconnect 108, and the front hub flange interconnect fastener 109 is shown in an exploded position ready for installation through the front wheel carrier hub interconnect fastener bore [Drive] [Embodiment-1] 118.

The front wheel axle 112 extends through the front wheel carrier [Drive] [Embodiment-1] 116, the front hub 104, and the front hub flange interconnect 108. The front wheel axis [Extended] 93 defines the rotational axis of the front wheel when the front suspension is in the extended state.

In some embodiments, the front hub flange interconnect fastener 109, the front wheel carrier hub interconnect fastener bore [Drive] [Embodiment-1] 118, and the front hub flange interconnect fastener interface 110 may be omitted while still preventing relative motion between the front hub flange interconnect 108 and the front wheel carrier [Drive] [Embodiment-1] 116 through the engagement of the asymmetric positive feature with the front wheel carrier hub interconnect interface [Drive] [Embodiment-1] 117. The hub flange interconnect arrangement aids in maintaining kinematic motion between the drive side and non-drive side wheel carrier bodies as identical as possible, even when these bodies are not directly connected. This configuration may provide reduced binding, a stiffer suspension structure that allows for improved ride control and performance, and greater durability.

In some embodiments, the front hub flange interconnect 108 may be omitted and replaced with a standard front hub flange. In such configurations, the front hub flange interconnect bearing 106 may also be omitted, and the front hub 104 may include a front hub flange on both the drive side and the non-drive side. The standard front hub flange configuration may provide a simplified hub assembly while the front hub flange interconnect 108 configuration may provide improved structural rigidity between the separated wheel carrier bodies on the drive and non-drive sides.

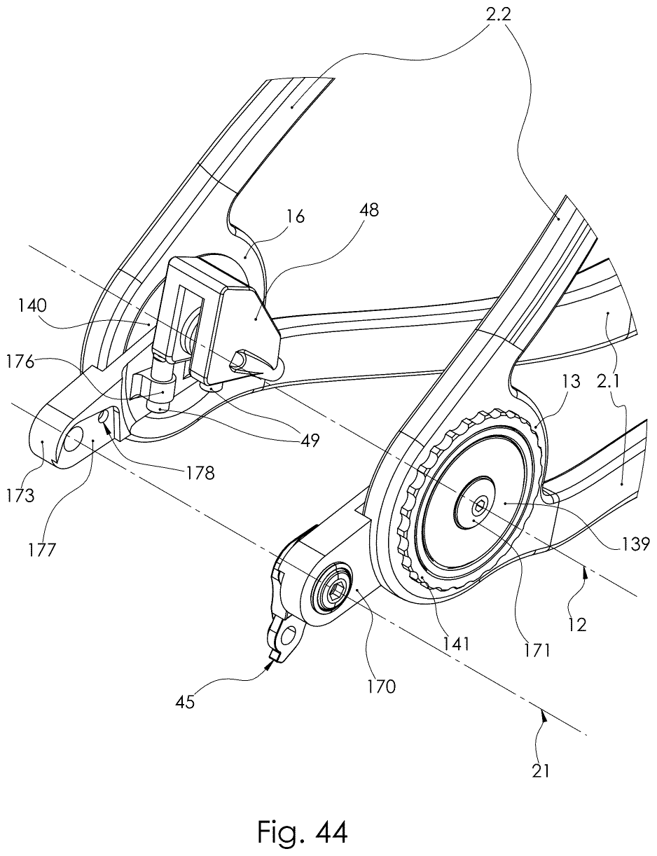

Referring to FIG. 44, a cropped isometric view of the rear rotary suspension system according to Embodiment-2 is shown with additional parts removed for clarity. Embodiment-2 utilizes a rotary cartridge configuration that provides a modular resistance mechanism for the rear suspension system.

The chainstay 2.1 and the seatstay 2.2 form part of the rear triangle 2 structure, converging at the rear suspension pivot structure [Drive] 13 on the drive side and the rear suspension pivot structure [Non-Drive] 16 on the non-drive side. The rear suspension pivot axis 12 defines the rotational axis about which the suspension components pivot relative to the suspended body.

A Rotary Cartridge [Drive] 139 is installed into the rear suspension pivot structure [Drive] 13 on the drive side. A Rotary Cartridge [Non-Drive] 140 is installed into the rear suspension pivot structure [Non-Drive] 16 on the non-drive side. The Rotary Cartridge [Drive] 139 and the Rotary Cartridge [Non-Drive] 140 provide modular resistance mechanisms that can be installed into the suspension pivot apertures as self-contained assemblies.

With continued reference to FIG. 44, a Rear Wheel Carrier [Drive] [Embodiment-2] 170 is pivotally connected to the rear suspension pivot structure [Drive] 13 about the rear suspension pivot axis 12. The Rear Wheel Carrier [Drive] [Embodiment-2] 170 includes a Rear Wheel Carrier Keying Feature [Drive] [Embodiment-2] 171, which is configured to engage with a corresponding keying feature on the Rotary Cartridge [Drive] 139 to transmit rotational motion from the Rear Wheel Carrier [Drive] [Embodiment-2] 170 to a rotor component within the Rotary Cartridge [Drive] 139.

On the non-drive side, a Rear Wheel Carrier and Brake Carrier [Non-Drive] [Embodiment-2] 173 is pivotally connected to the rear suspension pivot structure [Non-Drive] 16 about the rear suspension pivot axis 12. The Rear Wheel Carrier and Brake Carrier [Non-Drive] [Embodiment-2] 173 includes Rear Wheel Carrier and Brake Carrier Caliper Mounts [Non-Drive] [Embodiment-2] 176, which provide mounting interfaces for securing the rear brake caliper 48. A Rear Wheel Carrier and Brake Carrier Hub Interconnect Interface [Non-Drive] [Embodiment-2] 177 is located on the Rear Wheel Carrier and Brake Carrier [Non-Drive] [Embodiment-2] 173 and is configured to receive the rear hub flange interconnect 38. A Rear Wheel Carrier and Brake Carrier Hub Interconnect Fastener Bore [Non-Drive] [Embodiment-2] 178 is positioned on the Rear Wheel Carrier and Brake Carrier [Non-Drive] [Embodiment-2] 173 to receive a fastener for securing the rear hub flange interconnect 38 to the Rear Wheel Carrier and Brake Carrier [Non-Drive] [Embodiment-2] 173.

The rear derailleur hanger 45 is mounted to the Rear Wheel Carrier [Drive] [Embodiment-2] 170. The rear wheel axis [Extended] 21 defines the rotational axis of the rear wheel when the suspension is in the extended state.

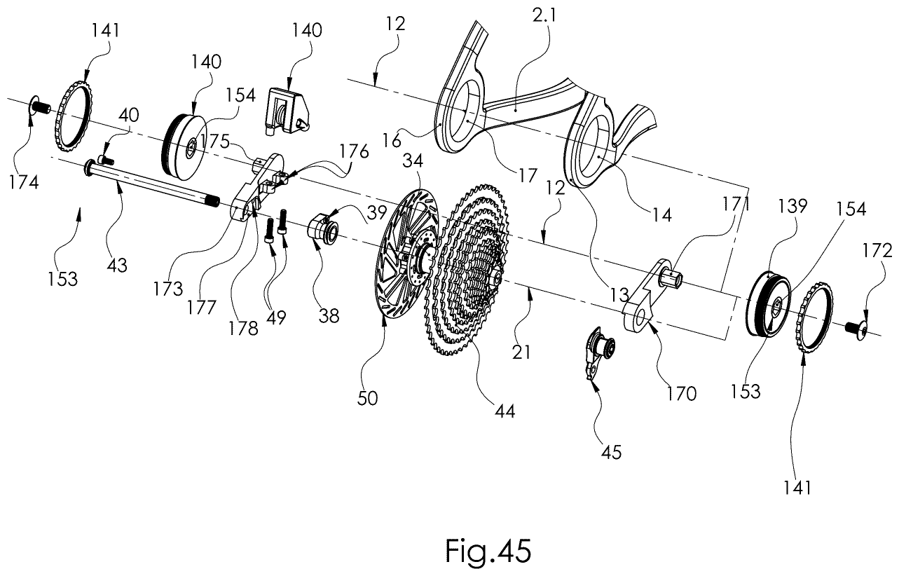

Referring to FIG. 45, a cropped, exploded, isometric view of the rear rotary cartridge suspension system assembly according to Embodiment-2 is shown with additional parts added for clarity. The exploded view illustrates the relationship between the various components of the rear suspension system and their assembly sequence.

The rear suspension pivot structure [Drive] 13 includes the rear suspension pivot aperture/bore [Drive] 14, which is concentric to the rear suspension pivot axis 12. The Rotary Cartridge [Drive] 139 is configured to be installed into the rear suspension pivot aperture/bore [Drive] 14 as a modular sub-assembly. A Rotary Cartridge Primary Fastener 141 secures the Rotary Cartridge [Drive] 139 to the rear suspension pivot structure [Drive] 13.

With continued reference to FIG. 45, the Rotary Cartridge [Drive] 139 includes a Rotary Cartridge Rotor 153, which is configured to rotate relative to a stator component within the Rotary Cartridge [Drive] 139. The Rotary Cartridge Rotor 153 includes a Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170. When the Rotary Cartridge Rotor Keying Feature 154 engages with the Rear Wheel Carrier Keying Feature [Drive] [Embodiment-2] 171, rotational motion of the Rear Wheel Carrier [Drive] [Embodiment-2] 170 about the rear suspension pivot axis 12 is transmitted to the Rotary Cartridge Rotor 153, causing the Rotary Cartridge Rotor 153 to rotate relative to the stator component within the Rotary Cartridge [Drive] 139.

The Rear Wheel Carrier [Drive] [Embodiment-2] 170 is secured by a Rear Wheel Carrier Fastener [Drive] [Embodiment-2] 172, which pivotally fastens the Rear Wheel Carrier [Drive] [Embodiment-2] 170 to the Rotary Cartridge [Drive] 139.

As further shown in FIG. 45, on the non-drive side, the rear suspension pivot structure [Non-Drive] 16 includes the rear suspension pivot aperture/bore [Non-Drive] 17. The Rotary Cartridge [Non-Drive] 140 is configured to be installed into the rear suspension pivot aperture/bore [Non-Drive] 17 as a modular sub-assembly. The Rotary Cartridge Primary Fastener 141 secures the Rotary Cartridge [Non-Drive] 140 to the rear suspension pivot structure [Non-Drive] 16.

The Rear Wheel Carrier and Brake Carrier [Non-Drive] [Embodiment-2] 173 includes a Rear Wheel Carrier Keying Feature [Non-Drive] [Embodiment-2] 174, which is configured to engage with a corresponding Rotary Cartridge Rotor Keying Feature 154 on a Rotary Cartridge Rotor 153 within the Rotary Cartridge [Non-Drive] 140. A Rear Wheel Carrier and Brake Carrier Fastener [Non-Drive] [Embodiment-2] 175 secures the Rear Wheel Carrier and Brake Carrier [Non-Drive] [Embodiment-2] 173 to the Rotary Cartridge [Non-Drive] 140.

The Rear Wheel Carrier and Brake Carrier [Non-Drive] [Embodiment-2] 173 includes the Rear Wheel Carrier and Brake Carrier Caliper Mounts [Non-Drive] [Embodiment-2] 176, the Rear Wheel Carrier and Brake Carrier Hub Interconnect Interface [Non-Drive] [Embodiment-2] 177, and the Rear Wheel Carrier and Brake Carrier Hub Interconnect Fastener Bore [Non-Drive] [Embodiment-2] 178.

With continued reference to FIG. 45, the rear hub 34 is shown with the rear hub flange interconnect 38, which includes the rear hub flange interconnect fastener interface 39 and receives the rear hub flange interconnect fastener 40. The rear wheel axle 43 is installed through the Rear Wheel Carrier [Drive] [Embodiment-2] 170, the rear hub 34, the rear hub flange interconnect 38, and the Rear Wheel Carrier and Brake Carrier [Non-Drive] [Embodiment-2] 173. The rear derailleur hanger 45 is positioned at the assembly. The rear wheel axis [Extended] 21 defines the wheel position in the extended state.

A keying feature may be added to the rear suspension pivot aperture/bore [Drive] 14 or the rear suspension pivot aperture/bore [Non-Drive] 17 to align with a mating keying feature in the Rotary Cartridge [Drive] 139 or the Rotary Cartridge [Non-Drive] 140 to prevent relative rotation between the rotary cartridge stator and the suspended body. The keying feature may include a flat, a spline, a slot, or other geometric profile that prevents rotational movement between the rotary cartridge and the suspension pivot structure when the rotary cartridge is installed into the suspension pivot aperture.

The rotary cartridge configuration of Embodiment-2 provides a modular resistance mechanism that can be assembled and tested as a self-contained unit before installation into the suspension pivot structure. The modular configuration may allow for different rotary cartridges with varying spring rates, damping characteristics, or travel ranges to be interchanged within the same suspension pivot structure to accommodate different rider preferences or riding conditions.

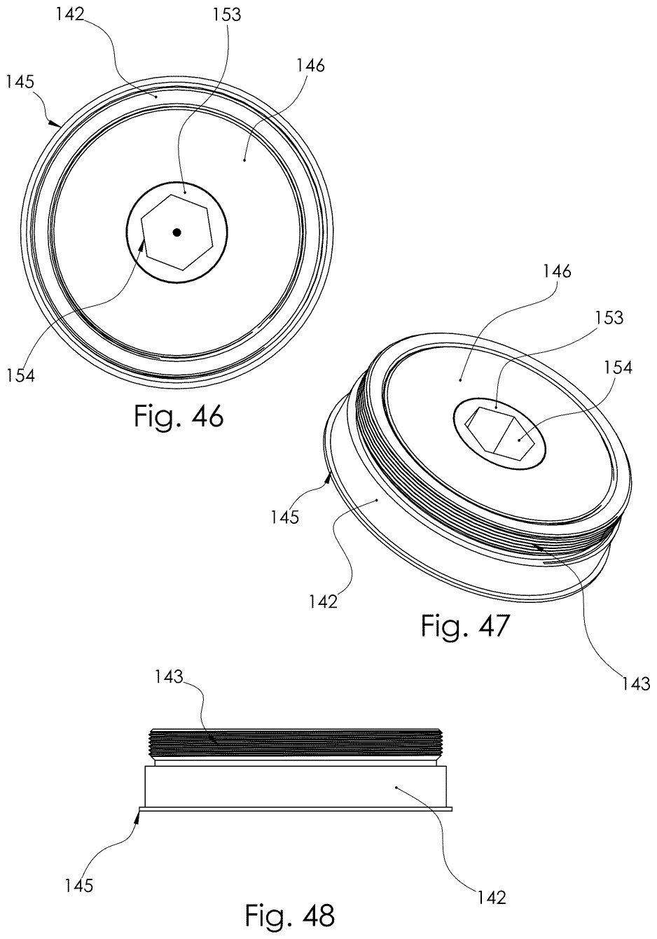

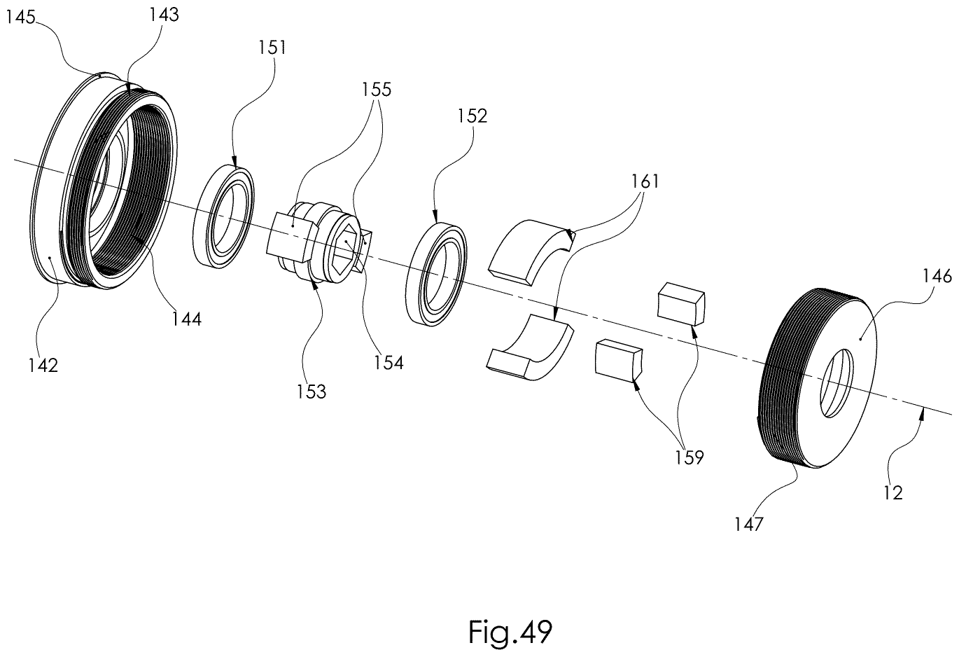

Referring to FIG. 46, a drive-side view of the Rotary Cartridge [Drive] 139 is shown. The Rotary Cartridge [Drive] 139 is a modular sub-assembly that provides a self-contained rotary resistance mechanism for the rear suspension system. The drive-side view reveals the overall form factor of the Rotary Cartridge [Drive] 139, which is configured to be installed into the rear suspension pivot aperture as a complete unit.

The Rotary Cartridge [Drive] 139 includes a Rotary Cartridge Stator Outer 142, which forms an outer housing of the Rotary Cartridge [Drive] 139. The Rotary Cartridge Stator Outer 142 is a generally cylindrical component that defines an outer boundary of the rotary cartridge assembly. A Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Fastening Feature [Primary] 143 may include threaded features, bolt holes, or other fastening interfaces that receive the Rotary Cartridge Primary Fastener 141.

With continued reference to FIG. 46, a Rotary Cartridge Stator Outer Flange [Primary] 145 extends radially outward from the Rotary Cartridge Stator Outer 142. The Rotary Cartridge Stator Outer Flange [Primary] 145 provides a bearing surface and structural interface between the Rotary Cartridge [Drive] 139 and the rear suspension pivot structure when the Rotary Cartridge [Drive] 139 is installed. The Rotary Cartridge Stator Outer Flange [Primary] 145 may contact a corresponding surface on the rear suspension pivot structure to position the Rotary Cartridge [Drive] 139 axially within the rear suspension pivot aperture.

The Rotary Cartridge Rotor 153 is visible in this drive-side view, positioned within the Rotary Cartridge Stator Outer 142. The Rotary Cartridge Rotor Keying Feature 154 is located on the Rotary Cartridge Rotor 153 and is configured to engage with the Rear Wheel Carrier Keying Feature [Drive] [Embodiment-2] 171 on the Rear Wheel Carrier [Drive] [Embodiment-2] 170. A Rotary Cartridge Stator Inner 146 is positioned within the Rotary Cartridge Stator Outer 142 and provides internal structure for the rotary resistance mechanism.

Referring to FIG. 47, an isometric view of the Rotary Cartridge [Drive] 139 is shown. The isometric perspective reveals the three-dimensional arrangement of the rotary cartridge components and their spatial relationships within the modular assembly.

The Rotary Cartridge Stator Outer 142 is visible as the outer housing of the Rotary Cartridge [Drive] 139. The Rotary Cartridge Stator Outer Fastening Feature [Primary] 143 is positioned on the Rotary Cartridge Stator Outer 142, providing the mounting interface for securing the Rotary Cartridge [Drive] 139 to the rear suspension pivot structure via the Rotary Cartridge Primary Fastener 141. The Rotary Cartridge Stator Outer Flange [Primary] 145 extends radially from the Rotary Cartridge Stator Outer 142, providing a structural interface and positioning feature for the rotary cartridge assembly.

With continued reference to FIG. 47, the Rotary Cartridge Stator Inner 146 is positioned within the Rotary Cartridge Stator Outer 142. The Rotary Cartridge Stator Inner 146 provides internal structure that interfaces with rotor components and resistance elements within the rotary cartridge assembly. The Rotary Cartridge Rotor 153 is visible within the assembly, with the Rotary Cartridge Rotor Keying Feature 154 extending from the Rotary Cartridge Rotor 153. The Rotary Cartridge Rotor Keying Feature 154 is configured to transmit rotational motion from the Rear Wheel Carrier [Drive] [Embodiment-2] 170 to the Rotary Cartridge Rotor 153 when the Rear Wheel Carrier Keying Feature [Drive] [Embodiment-2] 171 engages with the Rotary Cartridge Rotor Keying Feature 154.

Referring to FIG. 48, a top view of the Rotary Cartridge [Drive] 139 is shown. The top view perspective reveals the circular profile of the Rotary Cartridge [Drive] 139 and the arrangement of components when viewed along the rear suspension pivot axis.

The Rotary Cartridge Stator Outer 142 forms the outer perimeter of the Rotary Cartridge [Drive] 139 in this top view. The Rotary Cartridge Stator Outer Fastening Feature [Primary] 143 is visible on the Rotary Cartridge Stator Outer 142, positioned to receive fasteners for securing the rotary cartridge to the rear suspension pivot structure. The Rotary Cartridge Stator Outer Flange [Primary] 145 is visible extending radially from the Rotary Cartridge Stator Outer 142.

As further shown in FIG. 48, the Rotary Cartridge Stator Inner 146 is positioned concentrically within the Rotary Cartridge Stator Outer 142. The Rotary Cartridge Rotor 153 is visible at the center of the assembly, with the Rotary Cartridge Rotor Keying Feature 154 extending from the Rotary Cartridge Rotor 153. The top view illustrates the concentric arrangement of the stator outer, stator inner, and rotor components within the Rotary Cartridge [Drive] 139.

The Rotary Cartridge [Drive] 139 and the Rotary Cartridge [Non-Drive] 140 may have identical or different configurations depending upon the suspension design requirements. In some embodiments, the Rotary Cartridge [Drive] 139 and the Rotary Cartridge [Non-Drive] 140 may include different resistance mechanisms, such as different spring rates or damping characteristics, to provide asymmetric resistance on the drive side and non-drive side of the suspension system. In other embodiments, the Rotary Cartridge [Drive] 139 and the Rotary Cartridge [Non-Drive] 140 may have identical configurations to provide symmetric resistance on both sides of the suspension system.

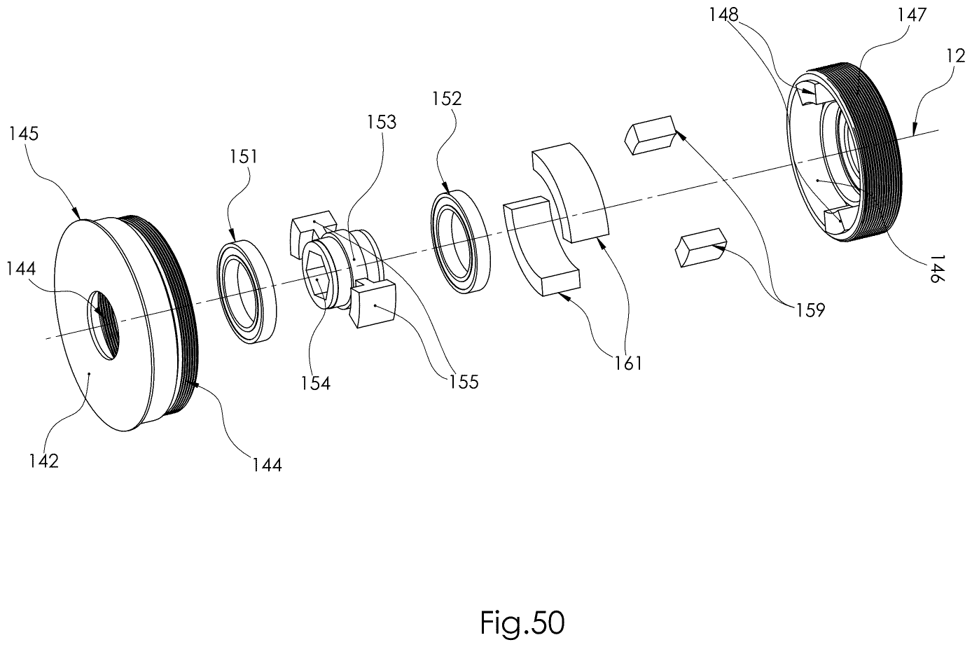

Referring to FIG. 50, an alternative isometric, exploded view of the Rotary Cartridge [Drive] 139 is shown. The exploded view illustrates the internal components of the rotary cartridge assembly and their spatial relationships within the modular resistance mechanism.

The Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure via the Rotary Cartridge Primary Fastener 141. A Rotary Cartridge Stator Outer Fastening Feature [Inner] 144 is located on an inner surface of the Rotary Cartridge Stator Outer 142 and is configured to engage with a corresponding fastening feature on the Rotary Cartridge Stator Inner 146. The Rotary Cartridge Stator Outer Flange [Primary] 145 extends radially from the Rotary Cartridge Stator Outer 142, providing a structural interface and positioning feature for the rotary cartridge assembly.

With continued reference to FIG. 50, the Rotary Cartridge Stator Inner 146 is positioned within the Rotary Cartridge Stator Outer 142. A Rotary Cartridge Stator Inner Fastening Feature [Outer] 147 is located on an outer surface of the Rotary Cartridge Stator Inner 146 and is configured to engage with the Rotary Cartridge Stator Outer Fastening Feature [Inner] 144 on the Rotary Cartridge Stator Outer 142. The engagement between the Rotary Cartridge Stator Inner Fastening Feature [Outer] 147 and the Rotary Cartridge Stator Outer Fastening Feature [Inner] 144 secures the Rotary Cartridge Stator Inner 146 within the Rotary Cartridge Stator Outer 142 and prevents relative rotation between these components. The fastening features of the Rotary Cartridge Stator Inner 146 and the Rotary Cartridge Stator Outer 142 may be executed using bolts or other fasteners instead of threaded interfaces.

A Rotary Cartridge Stator Inner Blade [Solid] 148 extends from the Rotary Cartridge Stator Inner 146 toward a central region of the rotary cartridge assembly. The Rotary Cartridge Stator Inner Blade [Solid] 148 is configured to interact with rotor blades and elastomeric components within the rotary cartridge to provide resistance during suspension movement about the rear suspension pivot axis.

As further shown in FIG. 50, a Rotary Cartridge Bearing [Linkage Side] 151 is positioned on a linkage side of the rotary cartridge assembly. The Rotary Cartridge Bearing [Linkage Side] 151 is configured to reduce rotational friction between the Rotary Cartridge Rotor 153 and the stator components as the Rotary Cartridge Rotor 153 rotates relative to the Rotary Cartridge Stator Inner 146 during suspension movement. A Rotary Cartridge Bearing [Fastener Side] 152 is positioned on a fastener side of the rotary cartridge assembly, opposite the Rotary Cartridge Bearing [Linkage Side] 151. The Rotary Cartridge Bearing [Fastener Side] 152 provides additional bearing support for the Rotary Cartridge Rotor 153 and facilitates smooth rotational movement within the rotary cartridge assembly.

The Rotary Cartridge Rotor 153 is positioned between the Rotary Cartridge Bearing [Linkage Side] 151 and the Rotary Cartridge Bearing [Fastener Side] 152. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170. A Rotary Cartridge Rotor Blade [Solid] 155 extends from the Rotary Cartridge Rotor 153 and is configured to interact with the Rotary Cartridge Stator Inner Blade [Solid] 148 and elastomeric components to provide resistance during suspension movement.

With continued reference to FIG. 50, a Rear Cartridge Elastomers Top-Out Extended 159 is positioned between the Rotary Cartridge Rotor Blade [Solid] 155 and the Rotary Cartridge Stator Inner Blade [Solid] 148. The Rear Cartridge Elastomers Top-Out Extended 159 may resist motion of the Rotary Cartridge Rotor 153 as the kinematic wheel carrier moves from an extended state to an over-extended state. A Rear Cartridge Elastomers Primary Extended 161 is positioned between the Rotary Cartridge Rotor Blade [Solid] 155 and the Rotary Cartridge Stator Inner Blade [Solid] 148. The Rear Cartridge Elastomers Primary Extended 161 may resist motion of the Rotary Cartridge Rotor 153 as the kinematic wheel carrier moves from the extended state to a compressed state.

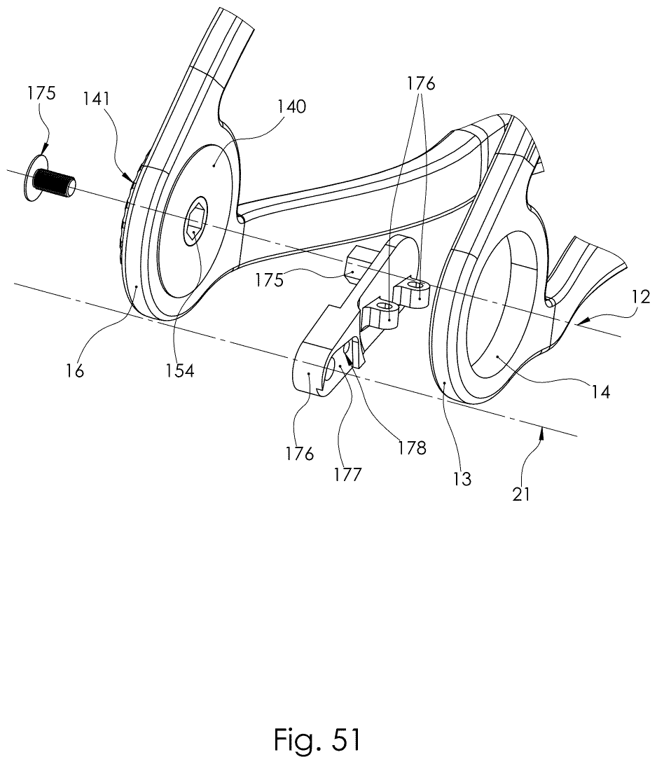

Referring to FIG. 51, a cropped isometric, exploded view of the Rotary Cartridge [Non-Drive] 140 and the Rear Wheel Carrier and Brake Carrier Caliper Mounts [Non-Drive] [Embodiment-2] 176 is shown. The exploded view illustrates the relationship between the Rotary Cartridge [Non-Drive] 140 and the Rear Wheel Carrier and Brake Carrier [Non-Drive] [Embodiment-2] 173 on the non-drive side of the rear suspension system.

The Rotary Cartridge [Non-Drive] 140 includes the Rotary Cartridge Stator Outer 142, the Rotary Cartridge Stator Inner 146, and the Rotary Cartridge Rotor 153 in a configuration similar to the Rotary Cartridge [Drive] 139. The Rotary Cartridge Rotor 153 includes the Rotary Cartridge Rotor Keying Feature 154, which is configured to engage with the Rear Wheel Carrier Keying Feature [Non-Drive] [Embodiment-2] 174 on the Rear Wheel Carrier and Brake Carrier [Non-Drive] [Embodiment-2] 173.

With continued reference to FIG. 51, the Rear Wheel Carrier and Brake Carrier [Non-Drive] [Embodiment-2] 173 includes the Rear Wheel Carrier and Brake Carrier Caliper Mounts [Non-Drive] [Embodiment-2] 176, which provide mounting interfaces for securing a brake caliper. The Rear Wheel Carrier and Brake Carrier Hub Interconnect Interface [Non-Drive] [Embodiment-2] 177 is located on the Rear Wheel Carrier and Brake Carrier [Non-Drive] [Embodiment-2] 173 and is configured to receive a hub flange interconnect. The Rear Wheel Carrier and Brake Carrier Hub Interconnect Fastener Bore [Non-Drive] [Embodiment-2] 178 is positioned on the Rear Wheel Carrier and Brake Carrier [Non-Drive] [Embodiment-2] 173 to receive a fastener for securing the hub flange interconnect to the Rear Wheel Carrier and Brake Carrier [Non-Drive] [Embodiment-2] 173.

The Rotary Cartridge Primary Fastener 141 secures the Rotary Cartridge [Non-Drive] 140 to the rear suspension pivot structure on the non-drive side. The Rear Wheel Carrier and Brake Carrier Fastener [Non-Drive] [Embodiment-2] 175 secures the Rear Wheel Carrier and Brake Carrier [Non-Drive] [Embodiment-2] 173 to the Rotary Cartridge [Non-Drive] 140.

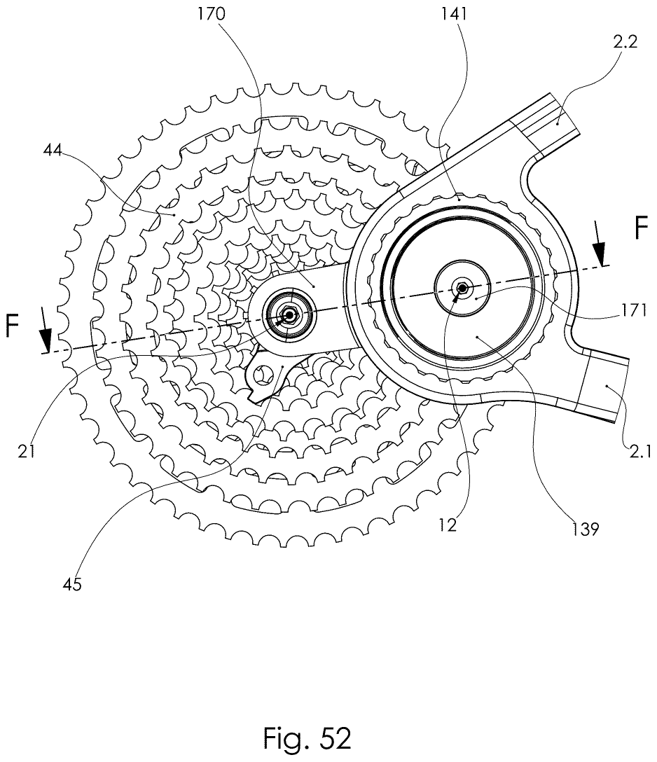

Referring to FIG. 52, a cropped drive-side view of embodiment 2 of the disclosed rear rotary suspension system is shown with various parts removed for clarity. The view illustrates a section line F-F used for subsequent cross-sectional views. The Rotary Cartridge [Drive] 139 is installed into the rear suspension pivot structure on the drive side. The Rear Wheel Carrier [Drive] [Embodiment-2] 170 is pivotally connected about the rear suspension pivot axis and is secured by the Rear Wheel Carrier Fastener [Drive] [Embodiment-2] 172. The Rear Wheel Carrier Keying Feature [Drive] [Embodiment-2] 171 is visible on the Rear Wheel Carrier [Drive] [Embodiment-2] 170, configured to engage with the Rotary Cartridge Rotor Keying Feature 154 on the Rotary Cartridge Rotor 153 within the Rotary Cartridge [Drive] 139. The Rotary Cartridge Primary Fastener 141 secures the Rotary Cartridge [Drive] 139 to the rear suspension pivot structure. This view provides a reference for understanding the spatial relationships between the rotary cartridge components and establishes the section line F-F for detailed cross-sectional analysis of the rotary cartridge assembly.

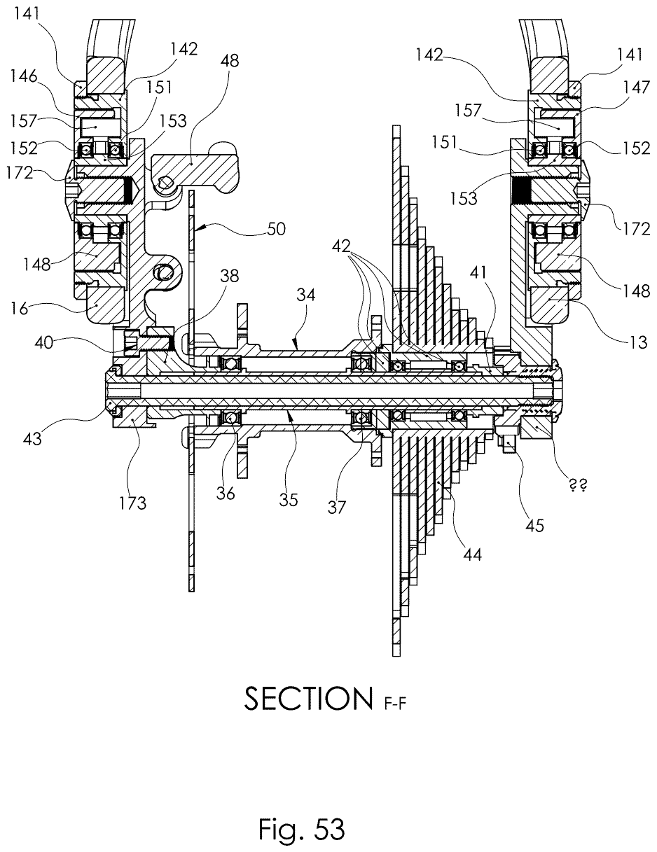

Referring to FIG. 53, a section F-F view of the rear rotary suspension system according to Embodiment-2 is shown, revealing the internal arrangement and relationship of components within the rotary cartridge assembly. The section view reveals the structural configuration of the Rotary Cartridge [Drive] 139 and the Rotary Cartridge [Non-Drive] 140 installed within the rear suspension pivot structures on the drive side and non-drive side respectively.

With continued reference to FIG. 53, on the drive side, the Rotary Cartridge Stator Outer 142 forms the outer housing of the Rotary Cartridge [Drive] 139 and is positioned within the rear suspension pivot aperture. The Rotary Cartridge Stator Outer Flange [Primary] 145 extends radially from the Rotary Cartridge Stator Outer 142 and contacts a corresponding surface on the rear suspension pivot structure to position the Rotary Cartridge [Drive] 139 axially within the rear suspension pivot aperture. The Rotary Cartridge Primary Fastener 141 secures the Rotary Cartridge [Drive] 139 to the rear suspension pivot structure through the Rotary Cartridge Stator Outer Fastening Feature [Primary] 143.

The Rotary Cartridge Stator Inner 146 is positioned within the Rotary Cartridge Stator Outer 142. The Rotary Cartridge Stator Inner Fastening Feature [Outer] 147 engages with the Rotary Cartridge Stator Outer Fastening Feature [Inner] 144 to secure the Rotary Cartridge Stator Inner 146 within the Rotary Cartridge Stator Outer 142 and prevent relative rotation between these components. The Rotary Cartridge Stator Inner Blade [Solid] 148 extends from the Rotary Cartridge Stator Inner 146 toward a central region of the rotary cartridge assembly.

As further shown in FIG. 53, the Rotary Cartridge Rotor 153 is positioned between the Rotary Cartridge Bearing [Linkage Side] 151 and the Rotary Cartridge Bearing [Fastener Side] 152. The Rotary Cartridge Bearing [Linkage Side] 151 and the Rotary Cartridge Bearing [Fastener Side] 152 reduce rotational friction between the Rotary Cartridge Rotor 153 and the stator components as the Rotary Cartridge Rotor 153 rotates relative to the Rotary Cartridge Stator Inner 146 during suspension movement. The Rotary Cartridge Rotor 153 includes the Rotary Cartridge Rotor Keying Feature 154, which engages with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

A Rotary Cartridge Rotor Blade [Slotted] 157 extends from the Rotary Cartridge Rotor 153 and is configured to interact with the Rotary Cartridge Stator Inner Blade [Solid] 148 and elastomeric components to provide resistance during suspension movement. The Rotary Cartridge Rotor Blade [Slotted] 157 may include slots or openings that allow for the installation of elastomeric capsules or other resistance elements within the blade structure. The Rotary Cartridge Rotor Blade [Slotted] 157 interfaces with the Rotary Cartridge Stator Inner Blade [Solid] 148 such that relative rotation between the Rotary Cartridge Rotor 153 and the Rotary Cartridge Stator Inner 146 causes compression of elastomeric components positioned between the Rotary Cartridge Rotor Blade [Slotted] 157 and the Rotary Cartridge Stator Inner Blade [Solid] 148.

With continued reference to FIG. 53, the Rear Wheel Carrier [Drive] [Embodiment-2] 170 is pivotally connected to the Rotary Cartridge [Drive] 139 via the Rear Wheel Carrier Fastener [Drive] [Embodiment-2] 172. The Rear Wheel Carrier Keying Feature [Drive] [Embodiment-2] 171 on the Rear Wheel Carrier [Drive] [Embodiment-2] 170 engages with the Rotary Cartridge Rotor Keying Feature 154 on the Rotary Cartridge Rotor 153, such that rotational motion of the Rear Wheel Carrier [Drive] [Embodiment-2] 170 about the rear suspension pivot axis is transmitted to the Rotary Cartridge Rotor 153.

On the non-drive side, the Rotary Cartridge [Non-Drive] 140 is installed into the rear suspension pivot structure in a configuration similar to the Rotary Cartridge [Drive] 139 on the drive side. The Rotary Cartridge Primary Fastener 141 secures the Rotary Cartridge [Non-Drive] 140 to the rear suspension pivot structure. The Rear Wheel Carrier and Brake Carrier [Non-Drive] [Embodiment-2] 173 is pivotally connected to the Rotary Cartridge [Non-Drive] 140 via the Rear Wheel Carrier and Brake Carrier Fastener [Non-Drive] [Embodiment-2] 175. The Rear Wheel Carrier Keying Feature [Non-Drive] [Embodiment-2] 174 on the Rear Wheel Carrier and Brake Carrier [Non-Drive] [Embodiment-2] 173 engages with the Rotary Cartridge Rotor Keying Feature 154 on the Rotary Cartridge Rotor 153 within the Rotary Cartridge [Non-Drive] 140.

The section view demonstrates the modular nature of the rotary cartridge configuration, wherein the Rotary Cartridge [Drive] 139 and the Rotary Cartridge [Non-Drive] 140 are installed into the rear suspension pivot structures as self-contained sub-assemblies. The rotary cartridge configuration allows the stator and rotor components to be assembled and tested as complete units before installation into the suspension pivot structures. The engagement between the Rotary Cartridge Rotor Keying Feature 154 and the respective wheel carrier keying features on the drive side and non-drive side transmits rotational motion from the wheel carriers to the rotary cartridge rotors, causing the rotary cartridge rotors to rotate relative to the stator components and compress the elastomeric resistance elements positioned between the rotor blades and the stator inner blades.

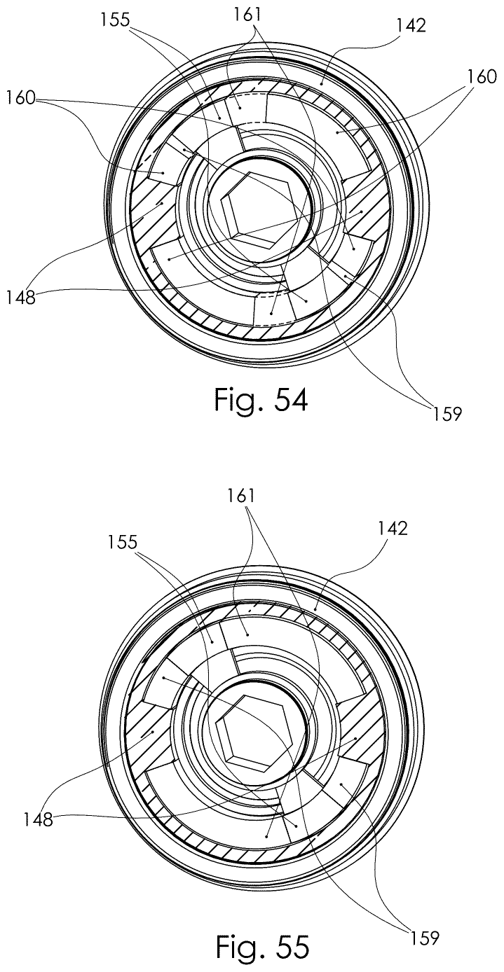

Referring to FIG. 54, an isometric view of the Rotary Cartridge [Drive] 139 is shown with the Rotary Cartridge Stator Inner 146 cut away as indicated by hashed marks, in the extended state. The cut-away view reveals the internal arrangement of the elastomeric resistance elements and the Rotary Cartridge Rotor Blade [Solid] 155 within the rotary cartridge assembly.

The Rear Cartridge Elastomers Top-Out Extended 159 and the Rear Cartridge Elastomers Primary Extended 161 are shown in dotted lines, while a Rear Cartridge Elastomers Top-Out Compressed 160 and a Rear Cartridge Elastomers Primary Compressed 162 are also shown in dotted lines. This visualization provides a representation of the allotted migration of the Rotary Cartridge Rotor Blade [Solid] 155 as the rear wheel axis moves from the rear wheel axis [Extended] position to the rear wheel axis [Compressed] position to the rear wheel axis [Over-Extended] position.

With continued reference to FIG. 54, the Rotary Cartridge Stator Inner Blade [Solid] 148 is visible extending from the Rotary Cartridge Stator Inner 146 toward a central region of the rotary cartridge assembly. The Rotary Cartridge Rotor Blade [Solid] 155 extends from the Rotary Cartridge Rotor 153 and is positioned between the Rotary Cartridge Stator Inner Blade [Solid] 148 and the elastomeric components. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170.

The Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142.

Referring to FIG. 55, an isometric view of the Rotary Cartridge [Drive] 139 is shown with the Rotary Cartridge Stator Inner 146 cut away as indicated by hashed marks, in the extended state. The Rear Cartridge Elastomers Top-Out Extended 159 and the Rear Cartridge Elastomers Primary Extended 161 are shown in solid lines. This visualization provides a representation of the assembly in the rear wheel axis [Extended] position.

In the extended state, the Rear Cartridge Elastomers Top-Out Extended 159 is positioned between the Rotary Cartridge Rotor Blade [Solid] 155 and the Rotary Cartridge Stator Inner Blade [Solid] 148 in an uncompressed or minimally compressed configuration. The Rear Cartridge Elastomers Primary Extended 161 is similarly positioned between the Rotary Cartridge Rotor Blade [Solid] 155 and the Rotary Cartridge Stator Inner Blade [Solid] 148 in an uncompressed or minimally compressed configuration. The extended state represents a neutral or rest position of the suspension system where the elastomeric components are not substantially compressed by suspension movement.

With continued reference to FIG. 55, the Rotary Cartridge Rotor 153 is positioned within the Rotary Cartridge Stator Inner 146 such that the Rotary Cartridge Rotor Blade [Solid] 155 is located at an angular position corresponding to the extended state of the suspension. The Rotary Cartridge Bearing [Linkage Side] 151 and the Rotary Cartridge Bearing [Fastener Side] 152 support the Rotary Cartridge Rotor 153 and facilitate rotational movement between the Rotary Cartridge Rotor 153 and the stator components during suspension travel.

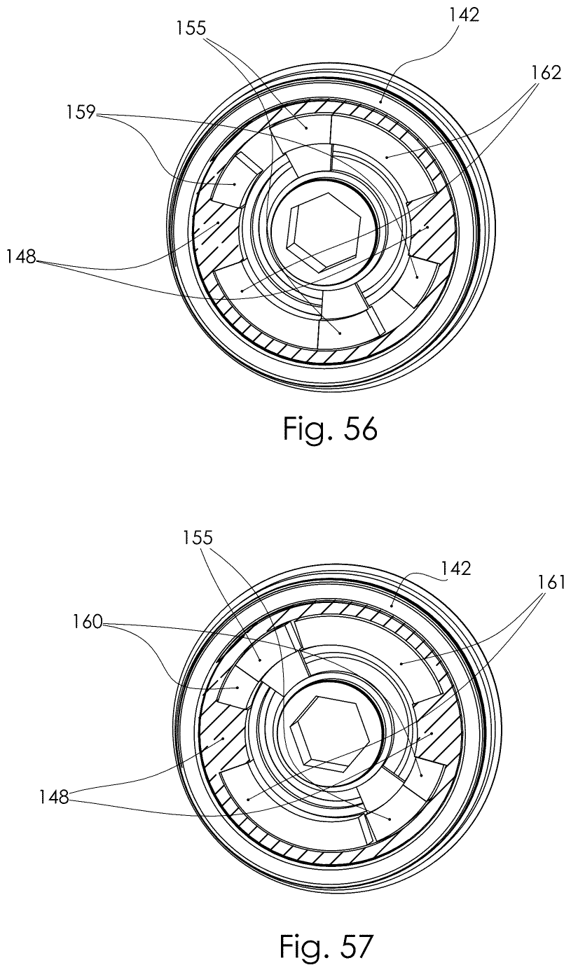

Referring to FIG. 56, an isometric view of the Rotary Cartridge [Drive] 139 is shown with the Rotary Cartridge Stator Inner 146 cut away as indicated by hashed marks, in the compressed state. The Rear Cartridge Elastomers Top-Out Extended 159 and the Rear Cartridge Elastomers Primary Compressed 162 are shown in solid lines. This visualization provides a representation of the assembly in the rear wheel axis [Compressed] position.

In the compressed state, the Rotary Cartridge Rotor 153 has rotated relative to the Rotary Cartridge Stator Inner 146 in response to movement of the Rear Wheel Carrier [Drive] [Embodiment-2] 170 about the rear suspension pivot axis. The rotation of the Rotary Cartridge Rotor 153 causes the Rotary Cartridge Rotor Blade [Solid] 155 to move toward the Rotary Cartridge Stator Inner Blade [Solid] 148, compressing the Rear Cartridge Elastomers Primary Compressed 162 positioned between the Rotary Cartridge Rotor Blade [Solid] 155 and the Rotary Cartridge Stator Inner Blade [Solid] 148.

With continued reference to FIG. 56, the Rear Cartridge Elastomers Top-Out Extended 159 remains in an uncompressed or minimally compressed configuration in the compressed state, as the Rotary Cartridge Rotor Blade [Solid] 155 has moved away from the Rear Cartridge Elastomers Top-Out Extended 159 during the rotation from the extended state to the compressed state. The Rear Cartridge Elastomers Primary Compressed 162 provides resistive spring force against the suspension movement as the kinematic wheel carrier moves from the extended state toward the compressed state.

The Rotary Cartridge Stator Outer 142, the Rotary Cartridge Stator Outer Fastening Feature [Primary] 143, and the Rotary Cartridge Stator Outer Flange [Primary] 145 remain in fixed positions relative to the suspended body throughout the suspension travel, while the Rotary Cartridge Rotor 153 and the Rotary Cartridge Rotor Blade [Solid] 155 rotate relative to the stator components.

Referring to FIG. 57, an isometric view of the Rotary Cartridge [Drive] 139 is shown with the Rotary Cartridge Stator Inner 146 cut away as indicated by hashed marks, in the over-extended state. The Rear Cartridge Elastomers Top-Out Compressed 160 and the Rear Cartridge Elastomers Primary Extended 161 are shown in solid lines. This visualization provides a representation of the assembly in the rear wheel axis [Over-Extended] position.

In the over-extended state, the Rotary Cartridge Rotor 153 has rotated relative to the Rotary Cartridge Stator Inner 146 in a direction opposite to the compression direction, in response to movement of the Rear Wheel Carrier [Drive] [Embodiment-2] 170 about the rear suspension pivot axis toward the over-extended position. The rotation of the Rotary Cartridge Rotor 153 causes the Rotary Cartridge Rotor Blade [Solid] 155 to move toward the Rear Cartridge Elastomers Top-Out Compressed 160, compressing the Rear Cartridge Elastomers Top-Out Compressed 160 positioned between the Rotary Cartridge Rotor Blade [Solid] 155 and the Rotary Cartridge Stator Inner Blade [Solid] 148.

With continued reference to FIG. 57, the Rear Cartridge Elastomers Primary Extended 161 remains in an uncompressed or minimally compressed configuration in the over-extended state, as the Rotary Cartridge Rotor Blade [Solid] 155 has moved away from the Rear Cartridge Elastomers Primary Extended 161 during the rotation from the extended state to the over-extended state. The Rear Cartridge Elastomers Top-Out Compressed 160 provides resistive spring force against the suspension movement as the kinematic wheel carrier moves from the extended state toward the over-extended state.

The over-extended state may occur when the rear wheel drops into a depression or when the suspended body is lifted relative to the rear wheel, causing the suspension to extend beyond the normal extended position. The Rear Cartridge Elastomers Top-Out Compressed 160 provides resistance to limit the over-extension travel and return the suspension toward the extended position.

The rotary cartridge configuration allows for independent tuning of the resistance characteristics in the compression direction and the over-extension direction through selection of different elastomeric materials, geometries, or durometers for the Rear Cartridge Elastomers Primary Extended 161 and the Rear Cartridge Elastomers Top-Out Extended 159. The Rear Cartridge Elastomers Top-Out Extended 159 may have a different spring rate than the Rear Cartridge Elastomers Primary Extended 161 to provide different resistance characteristics in the over-extension direction compared to the compression direction.

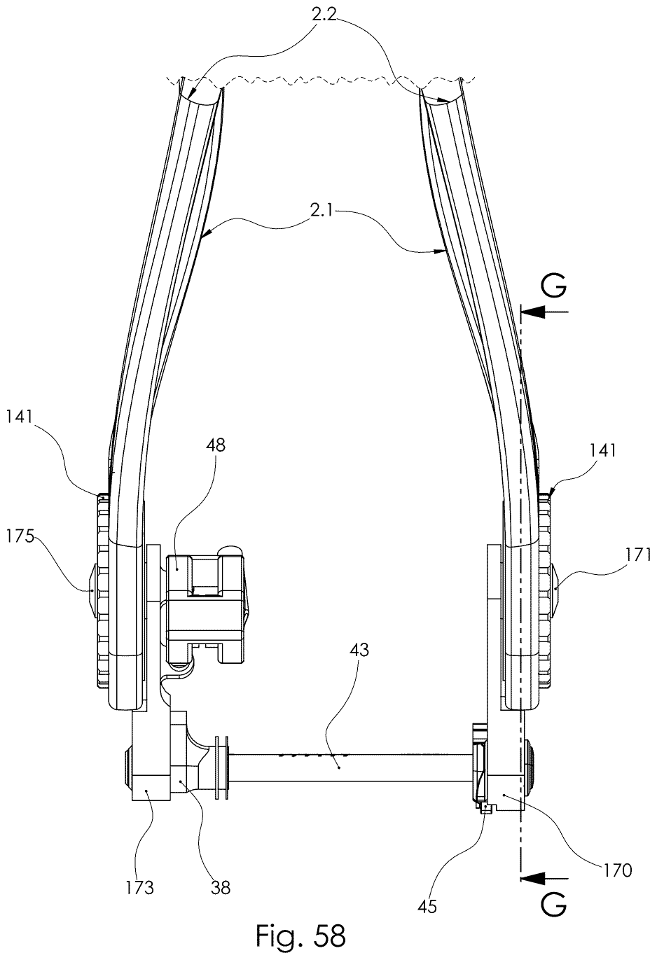

Referring to FIG. 58, a cropped top view of embodiment 2 of the disclosed rear rotary suspension system is shown with various parts removed for clarity. The view illustrates a section line G-G used for subsequent cross-sectional views. The section line G-G passes through the rotary cartridge assembly along a plane that reveals the internal arrangement of the rotor blade, stator inner blades, and elastomeric resistance elements within the rotary cartridge. The top view perspective shows the lateral arrangement of the suspension components and establishes the section plane for detailed cross-sectional analysis of the rotary cartridge in various suspension states.

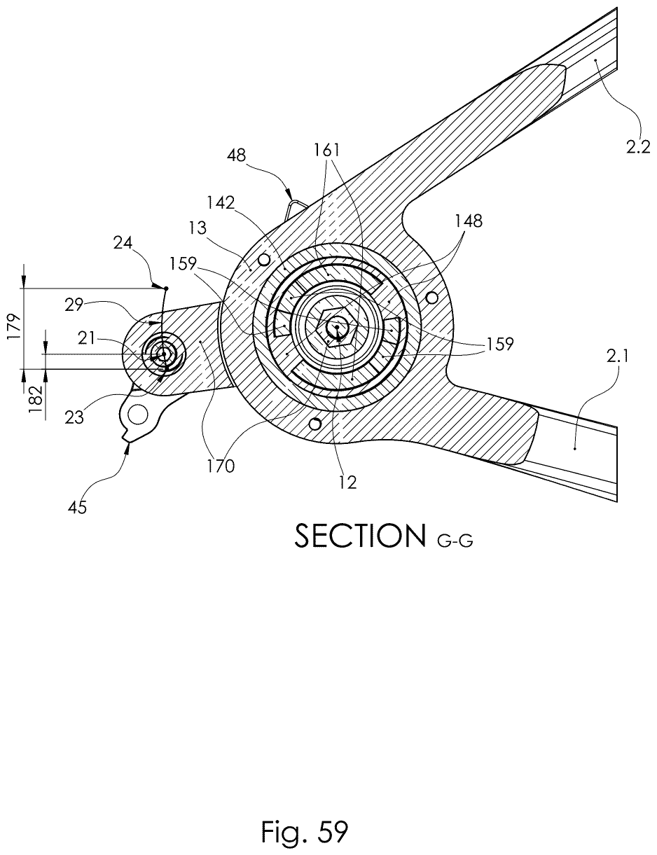

Referring to FIG. 59, a section G-G view of the rotary cartridge suspension system according to Embodiment-2 is shown in the extended state. The section view reveals the internal arrangement of the rotor blade, stator inner blades, and elastomeric resistance elements within the rotary cartridge assembly when the suspension is in the extended position.

In the extended state, the rotor blade is positioned at an angular location corresponding to the neutral or rest position of the suspension system. The stator inner blades extend from the stator inner component toward a central region of the rotary cartridge assembly and remain in fixed angular positions relative to the suspended body throughout the suspension travel. The rotor blade is positioned between the stator inner blades such that elastomeric resistance elements are located on both sides of the rotor blade.

With continued reference to FIG. 59, the elastomeric resistance elements positioned between the rotor blade and the stator inner blades are in an uncompressed or minimally compressed configuration in the extended state. A primary elastomer is positioned on one side of the rotor blade and is configured to resist motion as the kinematic wheel carrier moves from the extended state toward the compressed state. A top-out elastomer is positioned on an opposite side of the rotor blade and is configured to resist motion as the kinematic wheel carrier moves from the extended state toward the over-extended state. The rear wheel path is visible in the section view, illustrating the arc along which the rear wheel axis travels during suspension movement. The rear wheel axis in the extended position, the rear wheel axis in the compressed position, and the rear wheel axis in the over-extended position are indicated along the rear wheel path.

The vertical wheel travel from the extended state to the compressed state and the vertical wheel travel from the extended state to the over-extended state are indicated in the section view, providing dimensional references for the suspension travel range. The chainstay and seatstay portions of the rear triangle are visible in the section view, illustrating the structural relationship between the frame components and the rotary cartridge assembly.

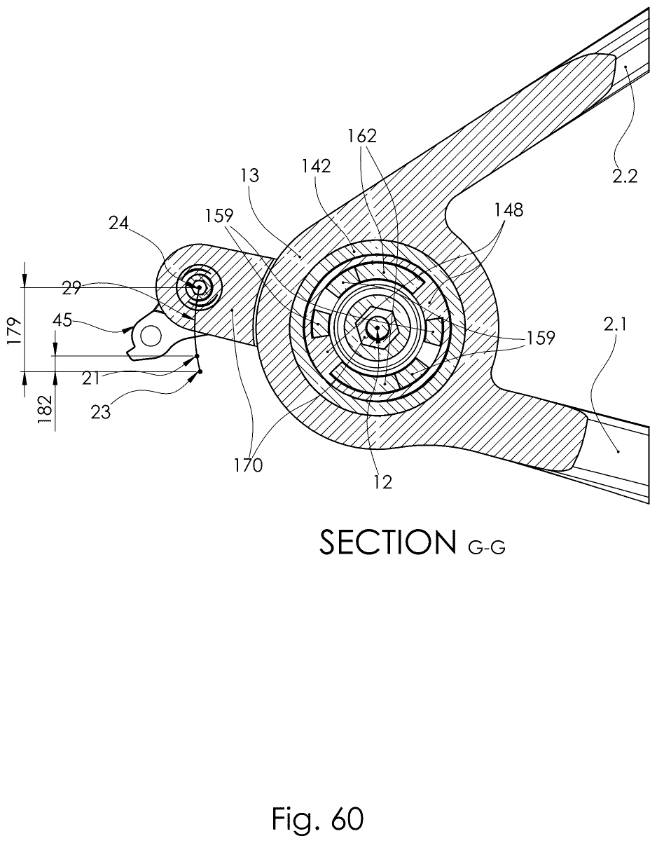

Referring to FIG. 60, a section G-G view of the rotary cartridge suspension system according to Embodiment-2 is shown in the compressed state. The section view reveals the internal arrangement of the rotor blade, stator inner blades, and elastomeric resistance elements within the rotary cartridge assembly when the suspension is in the compressed position.

In the compressed state, the rotor blade has rotated relative to the stator inner blades in response to movement of the wheel carrier about the rear suspension pivot axis. The rotation of the rotor blade causes the rotor blade to move toward one of the stator inner blades, compressing the primary elastomer positioned between the rotor blade and the stator inner blade. The primary elastomer in the compressed configuration provides resistive spring force against the suspension movement as the kinematic wheel carrier moves from the extended state toward the compressed state.

With continued reference to FIG. 60, the top-out elastomer positioned on the opposite side of the rotor blade remains in an uncompressed or minimally compressed configuration in the compressed state, as the rotor blade has moved away from the top-out elastomer during the rotation from the extended state to the compressed state. The stator inner blades remain in fixed angular positions relative to the suspended body, while the rotor blade rotates relative to the stator inner blades during suspension travel.

The rear wheel path is visible in the section view, with the rear wheel axis in the compressed position indicated along the rear wheel path. The rear wheel axis in the extended position and the rear wheel axis in the over-extended position are also indicated, providing reference for the relative positions of the wheel axis throughout the suspension travel range. The vertical wheel travel from the extended state to the compressed state is indicated in the section view.

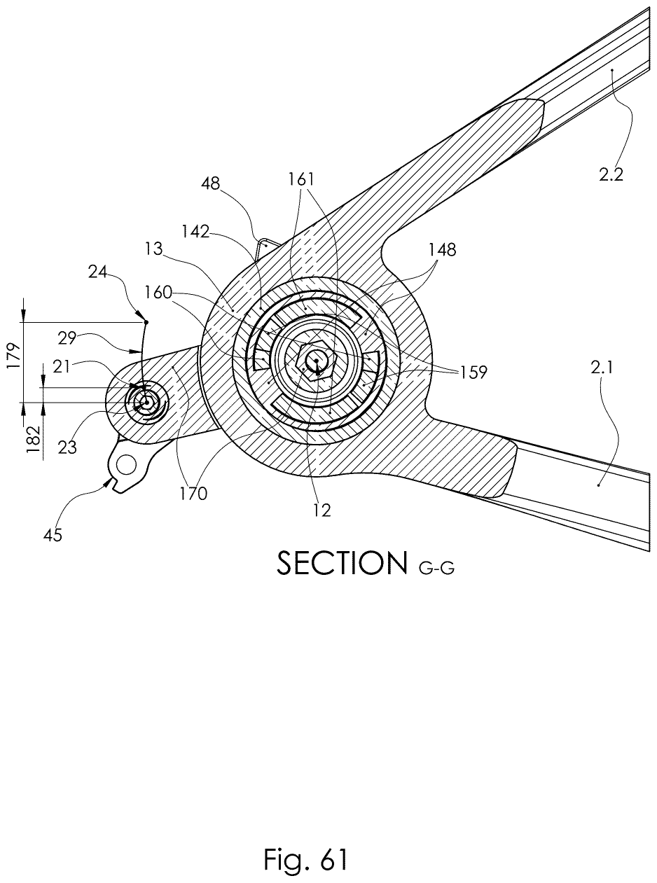

Referring to FIG. 61, a section G-G view of the rotary cartridge suspension system according to Embodiment-2 is shown in the over-extended state. The section view reveals the internal arrangement of the rotor blade, stator inner blades, and elastomeric resistance elements within the rotary cartridge assembly when the suspension is in the over-extended position.

In the over-extended state, the rotor blade has rotated relative to the stator inner blades in a direction opposite to the compression direction, in response to movement of the wheel carrier about the rear suspension pivot axis toward the over-extended position. The rotation of the rotor blade causes the rotor blade to move toward one of the stator inner blades on the opposite side from the compression direction, compressing the top-out elastomer positioned between the rotor blade and the stator inner blade. The top-out elastomer in the compressed configuration provides resistive spring force against the suspension movement as the kinematic wheel carrier moves from the extended state toward the over-extended state.

With continued reference to FIG. 61, the primary elastomer positioned on the opposite side of the rotor blade remains in an uncompressed or minimally compressed configuration in the over-extended state, as the rotor blade has moved away from the primary elastomer during the rotation from the extended state to the over-extended state. The stator inner blades remain in fixed angular positions relative to the suspended body throughout the suspension travel, including the over-extended state.

The rear wheel path is visible in the section view, with the rear wheel axis in the over-extended position indicated along the rear wheel path. The rear wheel axis in the extended position and the rear wheel axis in the compressed position are also indicated, providing reference for the relative positions of the wheel axis throughout the suspension travel range. The vertical wheel travel from the extended state to the over-extended state is indicated in the section view.

The over-extended state may occur when the rear wheel drops into a depression or when the suspended body is lifted relative to the rear wheel, causing the suspension to extend beyond the normal extended position. The top-out elastomer provides resistance to limit the over-extension travel and return the suspension toward the extended position. The rotary cartridge configuration allows for independent tuning of the resistance characteristics in the compression direction and the over-extension direction through selection of different elastomeric materials, geometries, or durometers for the primary elastomer and the top-out elastomer.

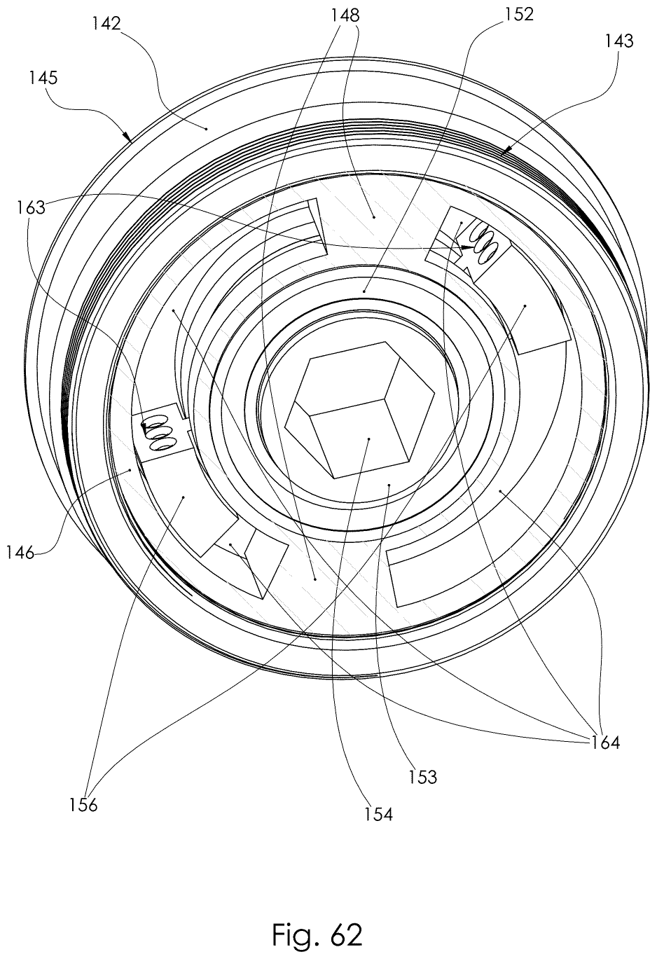

Referring to FIG. 62, an isometric view of a fluid damper embodiment of the Rotary Cartridge [Drive] 139 is shown with the Rotary Cartridge Stator Inner 146 cut away as indicated by hashed marks, in a position between the extended and compressed state. This embodiment illustrates a rotary cartridge configuration that provides velocity-dependent resistance through controlled fluid flow within the rotary resistance mechanism.

The Rotary Cartridge Rotor 153 includes Rotary Cartridge Rotor Blades [With Valves] 156, which extend from the Rotary Cartridge Rotor 153 toward the Rotary Cartridge Stator Inner 146. The Rotary Cartridge Rotor Blades [With Valves] 156 are configured to include Rotary Cartridge Damping Valves 163, which control the flow of Rotary Cartridge Damping Fluid 164 within the rotary cartridge assembly during suspension movement. The Rotary Cartridge Stator Inner 146 includes the Rotary Cartridge Stator Inner Blade [Solid] 148, which extends from the Rotary Cartridge Stator Inner 146 toward a central region of the rotary cartridge assembly.

With continued reference to FIG. 62, the Rotary Cartridge Damping Fluid 164 is contained within chambers defined by the Rotary Cartridge Rotor Blades [With Valves] 156, the Rotary Cartridge Stator Inner Blade [Solid] 148, and the inner surfaces of the Rotary Cartridge Stator Inner 146 and the Rotary Cartridge Stator Outer 142. As the Rotary Cartridge Rotor 153 rotates relative to the Rotary Cartridge Stator Inner 146 during suspension movement, the Rotary Cartridge Rotor Blades [With Valves] 156 move through the Rotary Cartridge Damping Fluid 164, forcing the Rotary Cartridge Damping Fluid 164 to flow through the Rotary Cartridge Damping Valves 163 positioned on the Rotary Cartridge Rotor Blades [With Valves] 156.

The Rotary Cartridge Damping Valves 163 provide velocity-dependent resistance by controlling the rate at which the Rotary Cartridge Damping Fluid 164 flows through the Rotary Cartridge Rotor Blades [With Valves] 156. When the Rotary Cartridge Rotor 153 rotates at a low velocity relative to the Rotary Cartridge Stator Inner 146, the Rotary Cartridge Damping Fluid 164 flows through the Rotary Cartridge Damping Valves 163 at a relatively low rate, providing a corresponding level of damping resistance. When the Rotary Cartridge Rotor 153 rotates at a higher velocity relative to the Rotary Cartridge Stator Inner 146, the Rotary Cartridge Damping Fluid 164 is forced through the Rotary Cartridge Damping Valves 163 at a higher rate, providing increased damping resistance.

As further shown in FIG. 62, the Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

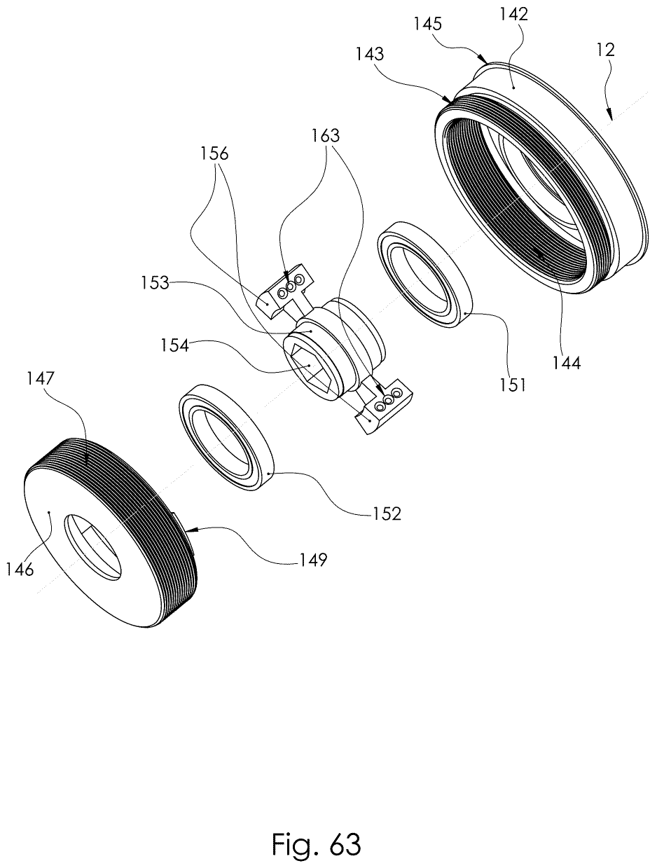

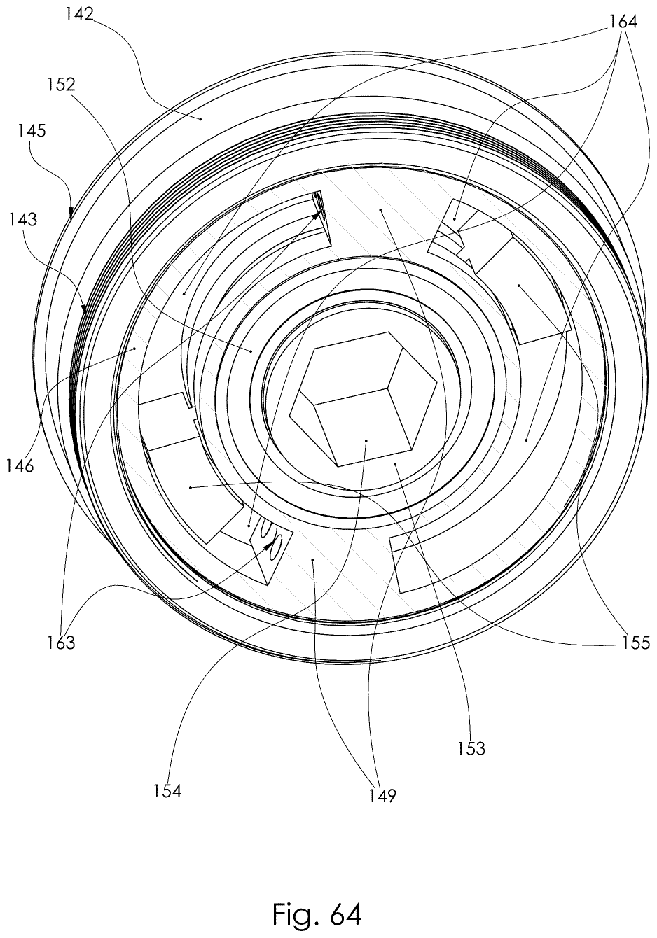

Referring to FIG. 63, an isometric, exploded view of the fluid damper embodiment of the Rotary Cartridge [Drive] 139 is shown in a position between the extended and compressed state. The exploded view illustrates the spatial relationships between the components of the fluid damper rotary cartridge assembly.

The Rotary Cartridge Rotor 153 is shown with the Rotary Cartridge Rotor Blades [With Valves] 156 extending from the Rotary Cartridge Rotor 153. The Rotary Cartridge Damping Valves 163 are visible on the Rotary Cartridge Rotor Blades [With Valves] 156, positioned to control the flow of the Rotary Cartridge Damping Fluid 164 as the Rotary Cartridge Rotor 153 rotates relative to the Rotary Cartridge Stator Inner 146 during suspension movement.

With continued reference to FIG. 63, the Rotary Cartridge Stator Inner 146 is shown with the Rotary Cartridge Stator Inner Blade [Solid] 148 extending from the Rotary Cartridge Stator Inner 146. The Rotary Cartridge Stator Inner Fastening Feature [Outer] 147 is located on an outer surface of the Rotary Cartridge Stator Inner 146 and is configured to engage with the Rotary Cartridge Stator Outer Fastening Feature [Inner] 144 on the Rotary Cartridge Stator Outer 142 to secure the Rotary Cartridge Stator Inner 146 within the Rotary Cartridge Stator Outer 142 and prevent relative rotation between these components.

The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement.

The Rotary Cartridge Damping Valves 163 may include separate low speed and high speed tuning valves for both compression and rebound directions. The compression valves may control the flow of the Rotary Cartridge Damping Fluid 164 as the kinematic wheel carrier moves from the extended state toward the compressed state, while the rebound valves may control the flow of the Rotary Cartridge Damping Fluid 164 as the kinematic wheel carrier moves from the compressed state toward the extended state. The low speed valves may provide damping resistance at low velocities of suspension movement, while the high speed valves may provide damping resistance at higher velocities of suspension movement.

In some embodiments, one valve may be used for compression and one valve may be used for rebound. In other embodiments, one valve may be used for both compression and rebound directions. The Rotary Cartridge Damping Valves 163 may be adjusted by turning adjuster features to open or restrict fluid flow depending upon adjuster turns and turn direction, allowing the damping characteristics to be tuned for various riding conditions and rider preferences.

Referring to FIG. 64, an isometric view of an alternative fluid damper embodiment of the Rotary Cartridge [Drive] 139 is shown with the Rotary Cartridge Stator Inner 146 cut away as indicated by hashed marks, in a position between the extended and compressed state. This embodiment illustrates a rotary cartridge configuration where the damping valves are located on the stator inner blades rather than on the rotor blades.

The Rotary Cartridge Rotor 153 includes Rotary Cartridge Rotor Blades [Solid] 155, which extend from the Rotary Cartridge Rotor 153 toward the Rotary Cartridge Stator Inner 146. The Rotary Cartridge Rotor Blades [Solid] 155 are configured without valves, providing a solid blade structure that moves through the Rotary Cartridge Damping Fluid 164 as the Rotary Cartridge Rotor 153 rotates relative to the Rotary Cartridge Stator Inner 146 during suspension movement.

With continued reference to FIG. 64, the Rotary Cartridge Stator Inner 146 includes Rotary Cartridge Stator Inner Blades [With Valves] 149, which extend from the Rotary Cartridge Stator Inner 146 toward a central region of the rotary cartridge assembly. The Rotary Cartridge Stator Inner Blades [With Valves] 149 are configured to include Rotary Cartridge Damping Valves 163, which control the flow of the Rotary Cartridge Damping Fluid 164 within the rotary cartridge assembly during suspension movement.

The Rotary Cartridge Damping Fluid 164 is contained within chambers defined by the Rotary Cartridge Rotor Blades [Solid] 155, the Rotary Cartridge Stator Inner Blades [With Valves] 149, and the inner surfaces of the Rotary Cartridge Stator Inner 146 and the Rotary Cartridge Stator Outer 142. As the Rotary Cartridge Rotor 153 rotates relative to the Rotary Cartridge Stator Inner 146 during suspension movement, the Rotary Cartridge Rotor Blades [Solid] 155 move through the Rotary Cartridge Damping Fluid 164, forcing the Rotary Cartridge Damping Fluid 164 to flow through the Rotary Cartridge Damping Valves 163 positioned on the Rotary Cartridge Stator Inner Blades [With Valves] 149.

As further shown in FIG. 64, the Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

The stator-mounted valve configuration provides an alternative arrangement for controlling fluid flow within the rotary damper mechanism. By positioning the Rotary Cartridge Damping Valves 163 on the Rotary Cartridge Stator Inner Blades [With Valves] 149 rather than on the rotor blades, the valves remain stationary relative to the suspended body during suspension movement. This configuration may provide different packaging options for valve adjustment mechanisms, as the stationary valve location may allow for external access to valve adjusters without requiring rotational seals or other accommodations for adjusting valves on a rotating component.

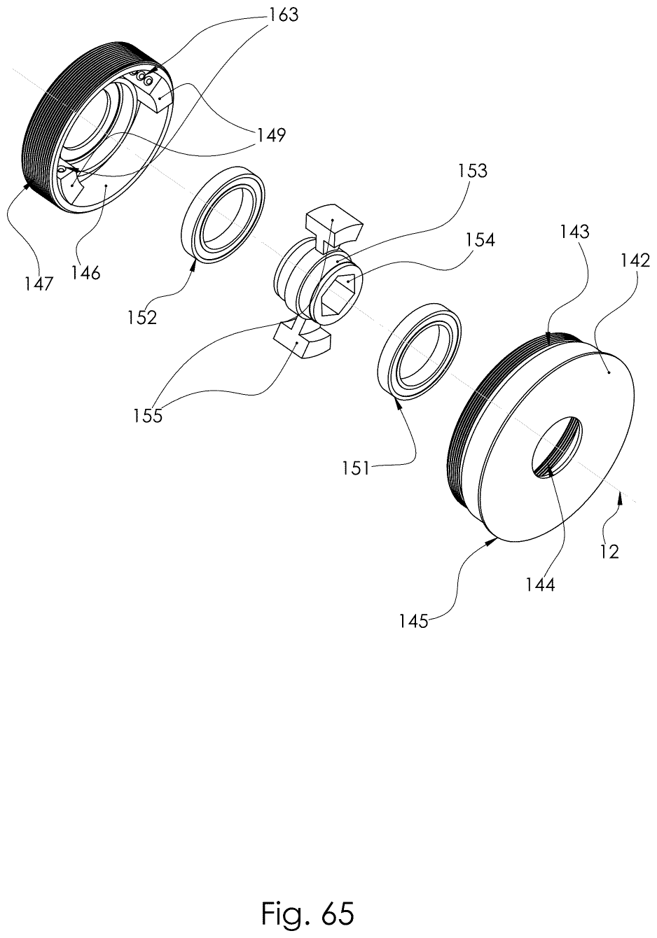

Referring to FIG. 65, an isometric, exploded view of the fluid damper embodiment of the Rotary Cartridge [Drive] 139 with stator-mounted valves is shown in a position between the extended and compressed state. The exploded view illustrates the spatial relationships between the components of the fluid damper rotary cartridge assembly with the alternative valve placement configuration.

The Rotary Cartridge Rotor 153 is shown with the Rotary Cartridge Rotor Blades [Solid] 155 extending from the Rotary Cartridge Rotor 153. The Rotary Cartridge Rotor Blades [Solid] 155 are configured as solid blade structures without valves, providing a simplified rotor component that moves through the Rotary Cartridge Damping Fluid 164 during suspension movement.

With continued reference to FIG. 65, the Rotary Cartridge Stator Inner 146 is shown with the Rotary Cartridge Stator Inner Blades [With Valves] 149 extending from the Rotary Cartridge Stator Inner 146. The Rotary Cartridge Damping Valves 163 are visible on the Rotary Cartridge Stator Inner Blades [With Valves] 149, positioned to control the flow of the Rotary Cartridge Damping Fluid 164 as the Rotary Cartridge Rotor 153 rotates relative to the Rotary Cartridge Stator Inner 146 during suspension movement.

The Rotary Cartridge Stator Inner Fastening Feature [Outer] 147 is located on an outer surface of the Rotary Cartridge Stator Inner 146 and is configured to engage with the Rotary Cartridge Stator Outer Fastening Feature [Inner] 144 on the Rotary Cartridge Stator Outer 142 to secure the Rotary Cartridge Stator Inner 146 within the Rotary Cartridge Stator Outer 142 and prevent relative rotation between these components.

The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement.

The Rotary Cartridge Damping Valves 163 on the Rotary Cartridge Stator Inner Blades [With Valves] 149 may include separate compression and rebound valves to control fluid flow in both directions of suspension movement. The compression valves may control the flow of the Rotary Cartridge Damping Fluid 164 as the kinematic wheel carrier moves from the extended state toward the compressed state, while the rebound valves may control the flow of the Rotary Cartridge Damping Fluid 164 as the kinematic wheel carrier moves from the compressed state toward the extended state. The stator-mounted valve configuration may allow for valve adjustment mechanisms to be accessed from a fixed location on the suspended body, as the Rotary Cartridge Stator Inner 146 remains stationary relative to the suspended body throughout the suspension travel.

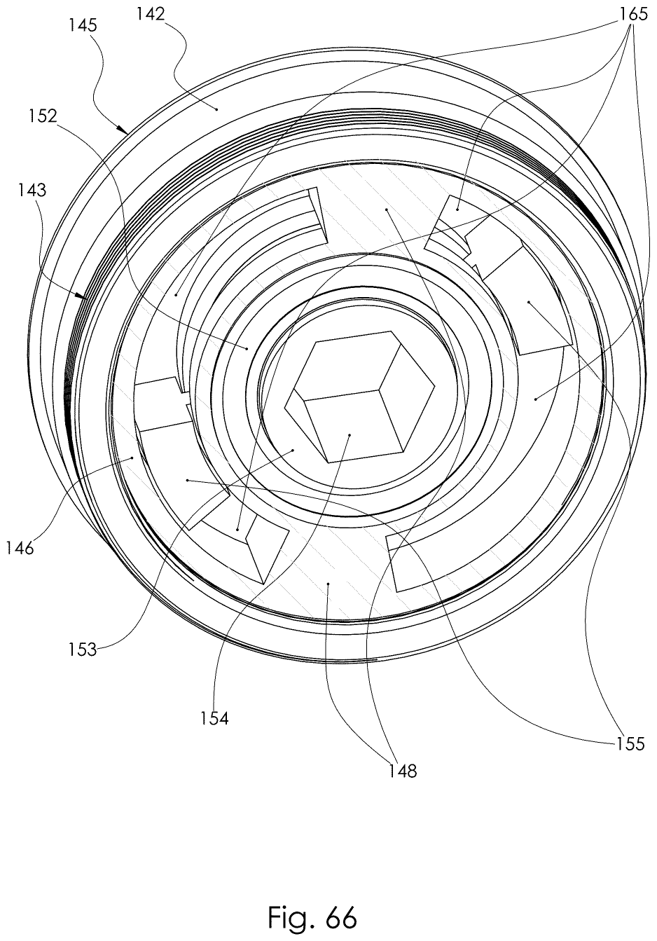

Referring to FIG. 66, an isometric view of an air spring embodiment of the Rotary Cartridge [Drive] 139 is shown with the Rotary Cartridge Stator Inner 146 cut away as indicated by hashed marks, in a position between the extended and compressed state. This embodiment illustrates a rotary cartridge configuration that provides pneumatic spring resistance through compressed gas contained within sealed chambers of the rotary cartridge assembly.

The Rotary Cartridge Rotor 153 includes the Rotary Cartridge Rotor Blade [Solid] 155, which extends from the Rotary Cartridge Rotor 153 toward the Rotary Cartridge Stator Inner 146. The Rotary Cartridge Rotor Blade [Solid] 155 is configured as a solid blade structure that moves through sealed chambers containing a Rotary Cartridge Spring Gas 165 as the Rotary Cartridge Rotor 153 rotates relative to the Rotary Cartridge Stator Inner 146 during suspension movement.

With continued reference to FIG. 66, the Rotary Cartridge Spring Gas 165 is contained within chambers defined by the Rotary Cartridge Rotor Blade [Solid] 155, the Rotary Cartridge Stator Inner Blade [Solid] 148, and the inner surfaces of the Rotary Cartridge Stator Inner 146 and the Rotary Cartridge Stator Outer 142. The chambers are sealed to contain the Rotary Cartridge Spring Gas 165 under pressure. As the Rotary Cartridge Rotor 153 rotates relative to the Rotary Cartridge Stator Inner 146 during suspension movement, the Rotary Cartridge Rotor Blade [Solid] 155 moves within the sealed chambers, compressing the Rotary Cartridge Spring Gas 165 on one side of the Rotary Cartridge Rotor Blade [Solid] 155 while expanding the volume on an opposite side of the Rotary Cartridge Rotor Blade [Solid] 155.

The compression of the Rotary Cartridge Spring Gas 165 provides pneumatic spring resistance that opposes the rotational movement of the Rotary Cartridge Rotor 153 relative to the Rotary Cartridge Stator Inner 146. The magnitude of the spring resistance is dependent upon the pressure of the Rotary Cartridge Spring Gas 165 within the sealed chambers and the volume change that occurs as the Rotary Cartridge Rotor Blade [Solid] 155 rotates through the chambers during suspension movement.

As further shown in FIG. 66, the Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

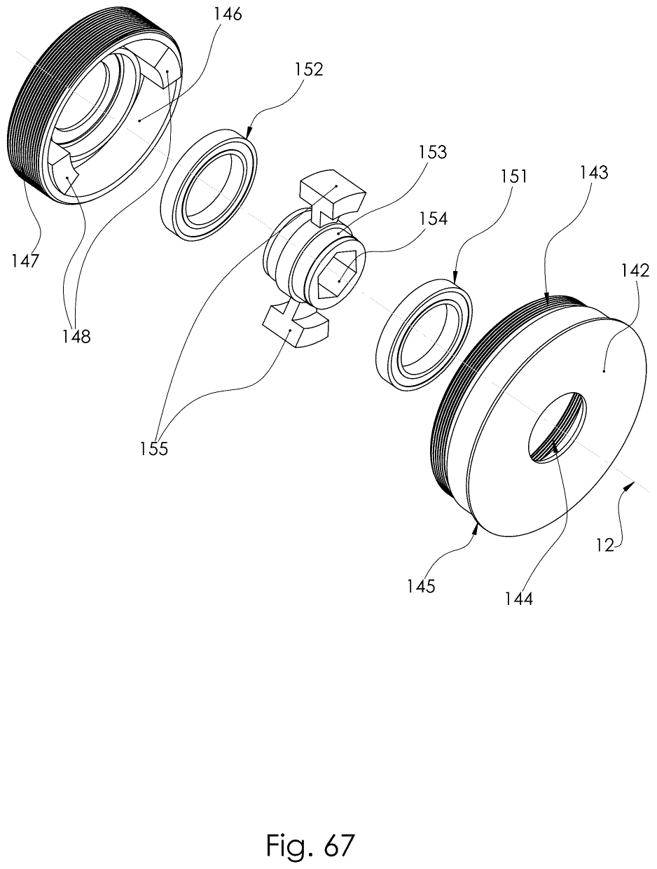

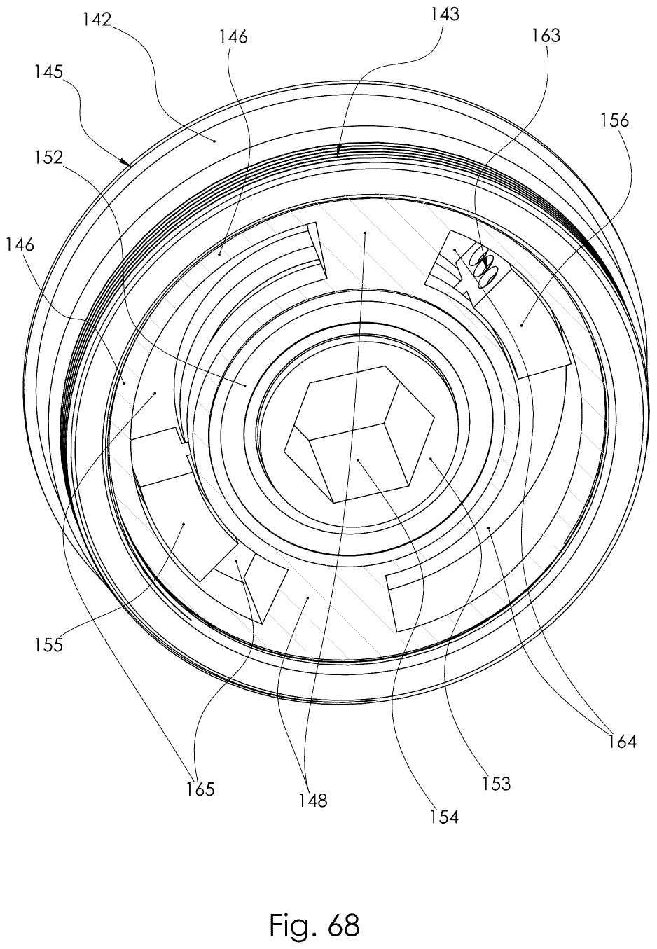

Referring to FIG. 67, an isometric, exploded view of the air spring embodiment of the Rotary Cartridge [Drive] 139 is shown in a position between the extended and compressed state. The exploded view illustrates the spatial relationships between the components of the air spring rotary cartridge assembly.

The Rotary Cartridge Rotor 153 is shown with the Rotary Cartridge Rotor Blade [Solid] 155 extending from the Rotary Cartridge Rotor 153. The Rotary Cartridge Rotor Blade [Solid] 155 is configured as a solid blade structure that interfaces with the sealed chambers containing the Rotary Cartridge Spring Gas 165 during suspension movement.

With continued reference to FIG. 67, the Rotary Cartridge Stator Inner 146 is shown with the Rotary Cartridge Stator Inner Blade [Solid] 148 extending from the Rotary Cartridge Stator Inner 146. The Rotary Cartridge Stator Inner Fastening Feature [Outer] 147 is located on an outer surface of the Rotary Cartridge Stator Inner 146 and is configured to engage with the Rotary Cartridge Stator Outer Fastening Feature [Inner] 144 on the Rotary Cartridge Stator Outer 142 to secure the Rotary Cartridge Stator Inner 146 within the Rotary Cartridge Stator Outer 142 and prevent relative rotation between these components.

The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement. The bearings also provide sealing interfaces that aid in containing the Rotary Cartridge Spring Gas 165 within the sealed chambers of the rotary cartridge assembly.

The air spring embodiment of the rotary cartridge provides adjustable spring resistance through changes in the pressure of the Rotary Cartridge Spring Gas 165 within the sealed chambers. The pressure of the Rotary Cartridge Spring Gas 165 may be adjusted by adding or removing gas through a fill valve or port provided on the rotary cartridge assembly. Increasing the pressure of the Rotary Cartridge Spring Gas 165 increases the spring resistance, while decreasing the pressure of the Rotary Cartridge Spring Gas 165 decreases the spring resistance. This adjustability allows the spring characteristics of the rotary cartridge to be tuned for various rider weights and riding conditions without replacing physical spring components.

The air spring configuration may provide a progressive spring rate characteristic, wherein the spring resistance increases as the Rotary Cartridge Spring Gas 165 is compressed to smaller volumes during suspension movement toward the compressed state. The progressive spring rate may provide a softer initial response at the beginning of the suspension travel and increased resistance as the suspension approaches the compressed state, which may aid in preventing bottoming out of the suspension during large impacts.

In some embodiments, the air spring rotary cartridge may include both a positive chamber and a negative chamber separated by the Rotary Cartridge Rotor Blade [Solid] 155 and the Rotary Cartridge Stator Inner Blade [Solid] 148. The positive chamber may contain the Rotary Cartridge Spring Gas 165 that resists movement in the direction from the extended state to the compressed state. The negative chamber may contain the Rotary Cartridge Spring Gas 165 that assists movement in the direction from the extended state to the compressed state, which may reduce friction and provide a more supple initial response to suspension inputs.

Referring to FIG. 68, an isometric view of a combined air spring and fluid damper embodiment of the Rotary Cartridge [Drive] 139 is shown with the Rotary Cartridge Stator Inner 146 cut away as indicated by hashed marks, in a position between the extended and compressed state. This embodiment illustrates a rotary cartridge configuration that provides both pneumatic spring resistance and velocity-dependent damping resistance within a single modular cartridge assembly.

The Rotary Cartridge Rotor 153 includes a Rotary Cartridge Rotor Blade [With Valves] 156 on one side and interfaces with a Rotary Cartridge Stator Inner Blade [Solid] 148 on an opposite side. The Rotary Cartridge Rotor Blade [With Valves] 156 is configured to include Rotary Cartridge Damping Valves 163, which control the flow of Rotary Cartridge Damping Fluid 164 within a damping portion of the rotary cartridge assembly during suspension movement. The Rotary Cartridge Stator Inner Blade [Solid] 148 extends from the Rotary Cartridge Stator Inner 146 toward a central region of the rotary cartridge assembly and interfaces with sealed chambers containing Rotary Cartridge Spring Gas 165.

With continued reference to FIG. 68, the Rotary Cartridge Damping Fluid 164 is contained within chambers on one side of the rotary cartridge assembly, while the Rotary Cartridge Spring Gas 165 is contained within chambers on an opposite side of the rotary cartridge assembly. As the Rotary Cartridge Rotor 153 rotates relative to the Rotary Cartridge Stator Inner 146 during suspension movement, the Rotary Cartridge Rotor Blade [With Valves] 156 moves through the Rotary Cartridge Damping Fluid 164, forcing the Rotary Cartridge Damping Fluid 164 to flow through the Rotary Cartridge Damping Valves 163 to provide velocity-dependent damping resistance. Simultaneously, the rotation of the Rotary Cartridge Rotor 153 compresses the Rotary Cartridge Spring Gas 165 within the sealed chambers to provide pneumatic spring resistance.

The combined air spring and fluid damper configuration provides both spring and damping functions within a single rotary cartridge assembly. The spring function resists suspension movement and returns the suspension toward the extended position after compression, while the damping function controls the rate of suspension movement by providing velocity-dependent resistance. The integration of both functions within a single rotary cartridge assembly may reduce the number of separate components and simplify the overall suspension system architecture.

As further shown in FIG. 68, the Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

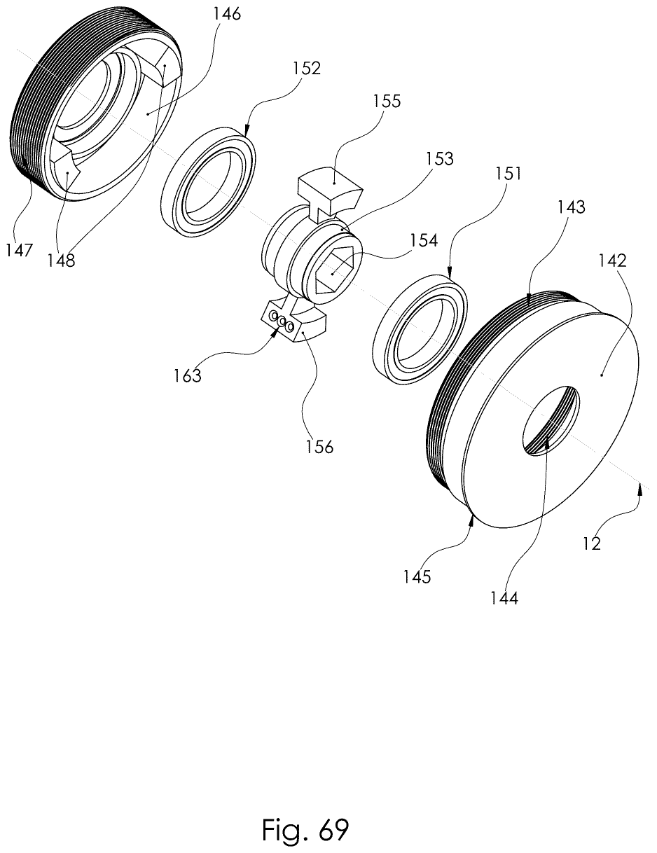

Referring to FIG. 69, an isometric, exploded view of the combined air spring and fluid damper embodiment of the Rotary Cartridge [Drive] 139 is shown in a position between the extended and compressed state. The exploded view illustrates the spatial relationships between the components of the combined air spring and fluid damper rotary cartridge assembly.

The Rotary Cartridge Rotor 153 is shown with the Rotary Cartridge Rotor Blade [With Valves] 156 extending from the Rotary Cartridge Rotor 153. The Rotary Cartridge Damping Valves 163 are visible on the Rotary Cartridge Rotor Blade [With Valves] 156, positioned to control the flow of the Rotary Cartridge Damping Fluid 164 as the Rotary Cartridge Rotor 153 rotates relative to the Rotary Cartridge Stator Inner 146 during suspension movement. The Rotary Cartridge Rotor 153 also includes a Rotary Cartridge Rotor Blade [Solid] 155 on an opposite side from the Rotary Cartridge Rotor Blade [With Valves] 156, which interfaces with the air spring portion of the rotary cartridge assembly.

With continued reference to FIG. 69, the Rotary Cartridge Stator Inner 146 is shown with the Rotary Cartridge Stator Inner Blade [Solid] 148 extending from the Rotary Cartridge Stator Inner 146. The Rotary Cartridge Stator Inner Fastening Feature [Outer] 147 is located on an outer surface of the Rotary Cartridge Stator Inner 146 and is configured to engage with the Rotary Cartridge Stator Outer Fastening Feature [Inner] 144 on the Rotary Cartridge Stator Outer 142 to secure the Rotary Cartridge Stator Inner 146 within the Rotary Cartridge Stator Outer 142 and prevent relative rotation between these components.

The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement. The bearings also provide sealing interfaces that aid in containing the Rotary Cartridge Damping Fluid 164 and the Rotary Cartridge Spring Gas 165 within their respective chambers of the rotary cartridge assembly.

In some embodiments, an air spring version of the resistance mechanism may be used on one side of the two-wheeled vehicle suspension while a fluid damper mechanism may be used on an opposite side. For example, the Rotary Cartridge [Drive] 139 on the drive side may include an air spring configuration, while the Rotary Cartridge [Non-Drive] 140 on the non-drive side may include a fluid damper configuration. Alternatively, the Rotary Cartridge [Drive] 139 on the drive side may include a fluid damper configuration, while the Rotary Cartridge [Non-Drive] 140 on the non-drive side may include an air spring configuration. This arrangement allows the spring and damping functions to be distributed across the drive side and non-drive side of the suspension system, with each rotary cartridge providing a dedicated function.

The combined air spring and fluid damper embodiment shown in FIGS. 68 and 69 provides an alternative configuration where both spring and damping functions are integrated within a single rotary cartridge assembly. The combined configuration may be used on both the drive side and the non-drive side of the suspension system, or the combined configuration may be used on one side while a dedicated spring or damper configuration is used on an opposite side. The modular nature of the rotary cartridge assemblies allows for various combinations of spring and damper configurations to be selected based upon suspension design requirements and rider preferences.

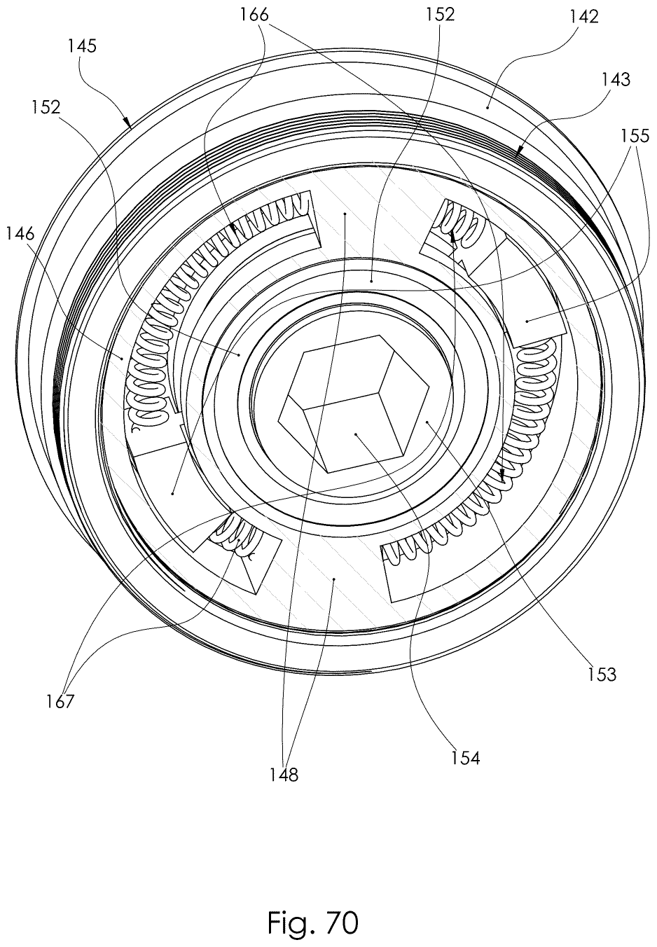

Referring to FIG. 70, an isometric view of a coil or torsional spring embodiment of the Rotary Cartridge [Drive] 139 is shown with the Rotary Cartridge Stator Inner 146 cut away as indicated by hashed marks, in a position between the extended and compressed state. This embodiment illustrates a rotary cartridge configuration that provides mechanical spring resistance through coil or torsional spring elements contained within the rotary cartridge assembly.

The Rotary Cartridge Rotor 153 includes the Rotary Cartridge Rotor Blade [Solid] 155, which extends from the Rotary Cartridge Rotor 153 toward the Rotary Cartridge Stator Inner 146. The Rotary Cartridge Rotor Blade [Solid] 155 is configured as a solid blade structure that interfaces with spring elements positioned within the rotary cartridge assembly.

With continued reference to FIG. 70, a Rotary Cartridge Primary Coil or Torsional Spring 166 is positioned within the rotary cartridge assembly and is configured to resist motion of the Rotary Cartridge Rotor 153 as the kinematic wheel carrier moves from the extended state toward the compressed state. The Rotary Cartridge Primary Coil or Torsional Spring 166 is arranged to engage with the Rotary Cartridge Rotor 153 and the Rotary Cartridge Stator Inner 146 such that relative rotation between the Rotary Cartridge Rotor 153 and the Rotary Cartridge Stator Inner 146 causes the Rotary Cartridge Primary Coil or Torsional Spring 166 to be loaded, providing resistive spring force against the suspension movement.

A Rotary Cartridge Top Out Coil or Torsional Spring 167 is positioned within the rotary cartridge assembly and is configured to resist motion of the Rotary Cartridge Rotor 153 as the kinematic wheel carrier moves from the extended state toward the over-extended state. The Rotary Cartridge Top Out Coil or Torsional Spring 167 is arranged to engage with the Rotary Cartridge Rotor 153 and the Rotary Cartridge Stator Inner 146 such that relative rotation between the Rotary Cartridge Rotor 153 and the Rotary Cartridge Stator Inner 146 in the over-extension direction causes the Rotary Cartridge Top Out Coil or Torsional Spring 167 to be loaded, providing resistive spring force against the over-extension movement.

As further shown in FIG. 70, the Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142. The Rotary Cartridge Stator Inner Blade [Solid] 148 extends from the Rotary Cartridge Stator Inner 146 toward a central region of the rotary cartridge assembly. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

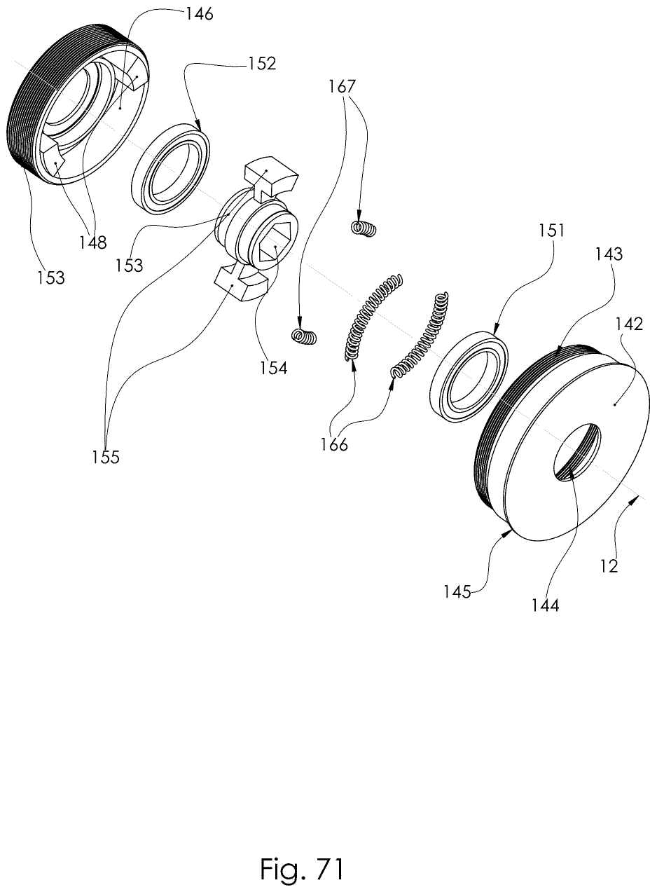

Referring to FIG. 71, an isometric, exploded view of the coil or torsional spring embodiment of the Rotary Cartridge [Drive] 139 is shown in a position between the extended and compressed state. The exploded view illustrates the spatial relationships between the components of the coil or torsional spring rotary cartridge assembly.

The Rotary Cartridge Rotor 153 is shown with the Rotary Cartridge Rotor Blade [Solid] 155 extending from the Rotary Cartridge Rotor 153. The Rotary Cartridge Rotor Blade [Solid] 155 is configured as a solid blade structure that interfaces with the Rotary Cartridge Primary Coil or Torsional Spring 166 and the Rotary Cartridge Top Out Coil or Torsional Spring 167 during suspension movement.

With continued reference to FIG. 71, the Rotary Cartridge Primary Coil or Torsional Spring 166 is shown in an exploded position relative to the Rotary Cartridge Rotor 153 and the Rotary Cartridge Stator Inner 146. The Rotary Cartridge Primary Coil or Torsional Spring 166 may be a helical coil spring or a torsional spring element that is configured to provide spring resistance about the rotational axis of the rotary cartridge assembly. The Rotary Cartridge Primary Coil or Torsional Spring 166 may have one end that engages with the Rotary Cartridge Rotor 153 or the Rotary Cartridge Rotor Blade [Solid] 155 and an opposite end that engages with the Rotary Cartridge Stator Inner 146 or the Rotary Cartridge Stator Inner Blade [Solid] 148, such that relative rotation between the rotor and stator components causes the Rotary Cartridge Primary Coil or Torsional Spring 166 to be wound or unwound, providing spring resistance.

The Rotary Cartridge Top Out Coil or Torsional Spring 167 is shown in an exploded position relative to the Rotary Cartridge Rotor 153 and the Rotary Cartridge Stator Inner 146. The Rotary Cartridge Top Out Coil or Torsional Spring 167 may be a helical coil spring or a torsional spring element that is configured to provide spring resistance in the over-extension direction. The Rotary Cartridge Top Out Coil or Torsional Spring 167 may have one end that engages with the Rotary Cartridge Rotor 153 or the Rotary Cartridge Rotor Blade [Solid] 155 and an opposite end that engages with the Rotary Cartridge Stator Inner 146 or the Rotary Cartridge Stator Inner Blade [Solid] 148, such that relative rotation between the rotor and stator components in the over-extension direction causes the Rotary Cartridge Top Out Coil or Torsional Spring 167 to be loaded, providing spring resistance against over-extension movement.

As further shown in FIG. 71, the Rotary Cartridge Stator Inner 146 is shown with the Rotary Cartridge Stator Inner Blade [Solid] 148 extending from the Rotary Cartridge Stator Inner 146. The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement.

The coil or torsional spring embodiment of the rotary cartridge provides mechanical spring resistance through metal spring elements rather than elastomeric components or pneumatic pressure. The Rotary Cartridge Primary Coil or Torsional Spring 166 may be selected or replaced to provide different spring rates for the compression direction, while the Rotary Cartridge Top Out Coil or Torsional Spring 167 may be selected or replaced to provide different spring rates for the over-extension direction. The spring rate of the Rotary Cartridge Primary Coil or Torsional Spring 166 may be different from the spring rate of the Rotary Cartridge Top Out Coil or Torsional Spring 167 to provide different resistance characteristics in the compression direction compared to the over-extension direction.

The elastomeric components within the rotary resistance mechanism may have various configurations. In some embodiments, the component having an elastomeric property may comprise a solid continuous, or filled main body. In other embodiments, the component may comprise an at least partially hollow main body, which may offer a lower spring rate or softer ride feel compared to a solid configuration. The component may have a constant cross section along its length, or alternatively, the component may have a variable cross section that changes along its length. An elastomer within the resistance mechanism may have a substantially constant spring rate throughout its compression range, or alternatively, the elastomer may have a non-constant spring rate that varies as the elastomer is compressed. The spring rate of an elastomer may be adjustable. In some configurations, the elastomer may be mechanically pre-loaded to adjust the spring rate. In other configurations, an elastomer may be replaced with a different elastomer to adjust the spring rate.

In some embodiments, a first component configured to resist motion from the extended state to the compressed state may have a spring rate that is lower than a spring rate of a second component configured to resist motion from the extended state to the over-extended state. This configuration may provide a softer response during compression travel while providing a firmer response during over-extension travel to limit the over-extension range.

In some embodiments, the Rotary Cartridge Primary Coil or Torsional Spring 166 may be mechanically pre-loaded to adjust the spring rate or to provide a threshold force before suspension movement begins. The pre-load may be adjusted by rotating one end of the Rotary Cartridge Primary Coil or Torsional Spring 166 relative to an opposite end before securing the spring within the rotary cartridge assembly. Similarly, the Rotary Cartridge Top Out Coil or Torsional Spring 167 may be mechanically pre-loaded to adjust the spring rate or threshold force in the over-extension direction.

The kinematic wheel carrier body may move within a defined range that corresponds to the suspension travel from the over-extended state through the extended state to the compressed state. In some embodiments, the defined range is adjustable. The range of motion may be adjusted by adding or removing a rigid spacer within the rotary resistance mechanism assembly. In other embodiments, a mechanism may adjust the geometry of a rotor blade to adjust the range of motion, or a mechanism may adjust the geometry of a stator blade to adjust the range of motion. In some configurations, the defined range is adjustable so that the geometry of the vehicle remains unchanged, wherein the suspension travel is modified without altering the wheel position in the extended state relative to the suspended body. In other configurations, the defined range is adjustable so that the geometry of the vehicle is altered, wherein the wheel position in the extended state relative to the suspended body changes when the defined range is adjusted.

The coil or torsional spring configuration may also be combined with a fluid damper mechanism within the same rotary cartridge assembly or within a separate rotary cartridge on an opposite side of the suspension system. For example, the Rotary Cartridge [Drive] 139 on the drive side may include the coil or torsional spring configuration, while the Rotary Cartridge [Non-Drive] 140 on the non-drive side may include a fluid damper configuration. This arrangement allows the spring and damping functions to be distributed across the drive side and non-drive side of the suspension system.

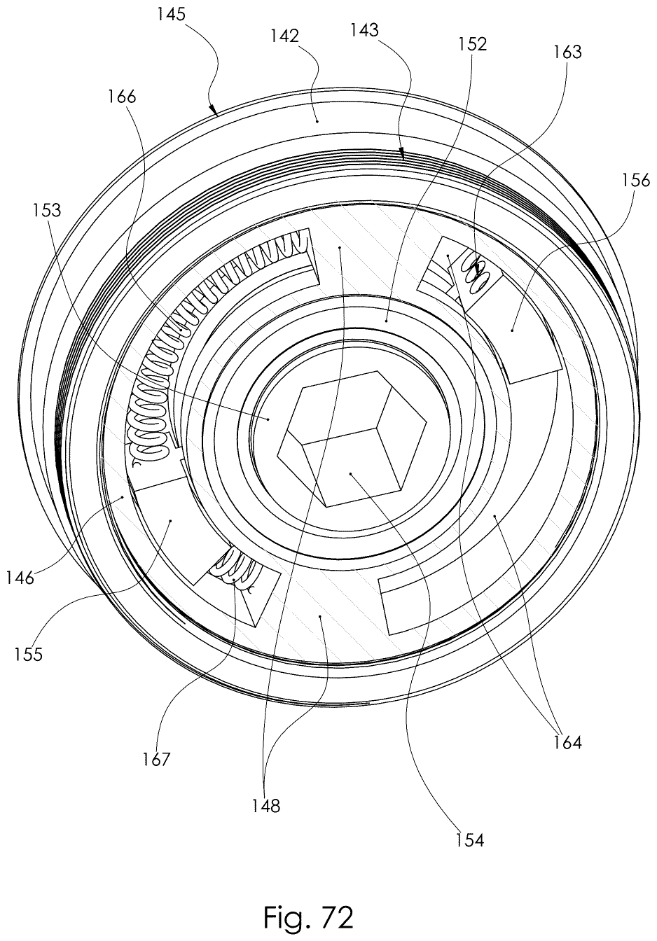

Referring to FIG. 72, an isometric view of a combined metal spring and fluid damper embodiment of the rotary cartridge is shown with the stator inner cut away as indicated by hashed marks, in a position between the extended and compressed state. This embodiment illustrates a rotary cartridge configuration that provides mechanical spring resistance through coil or torsional spring elements while simultaneously providing velocity-dependent damping resistance through controlled fluid flow within the rotary cartridge assembly.

The rotor includes rotor blades with valves, which extend from the rotor toward the stator inner. The rotor blades with valves are configured to include damping valves, which control the flow of damping fluid within the rotary cartridge assembly during suspension movement. The stator inner includes a stator inner blade that extends from the stator inner toward a central region of the rotary cartridge assembly.

With continued reference to FIG. 72, a primary coil or torsional spring is positioned within the rotary cartridge assembly and is configured to resist motion of the rotor as the kinematic wheel carrier moves from the extended state toward the compressed state. The primary coil or torsional spring is arranged to engage with the rotor and the stator inner such that relative rotation between the rotor and the stator inner causes the primary coil or torsional spring to be loaded, providing resistive spring force against the suspension movement.

A top out coil or torsional spring is positioned within the rotary cartridge assembly and is configured to resist motion of the rotor as the kinematic wheel carrier moves from the extended state toward the over-extended state. The top out coil or torsional spring is arranged to engage with the rotor and the stator inner such that relative rotation between the rotor and the stator inner in the over-extension direction causes the top out coil or torsional spring to be loaded, providing resistive spring force against the over-extension movement.

As further shown in FIG. 72, the damping fluid is contained within chambers defined by the rotor blades with valves, the stator inner blade, and the inner surfaces of the stator inner and the stator outer. As the rotor rotates relative to the stator inner during suspension movement, the rotor blades with valves move through the damping fluid, forcing the damping fluid to flow through the damping valves positioned on the rotor blades with valves. The damping valves provide velocity-dependent resistance by controlling the rate at which the damping fluid flows through the rotor blades with valves.

The stator outer forms the outer housing of the rotary cartridge. A stator outer fastening feature is positioned on the stator outer and provides a mounting interface for securing the rotary cartridge to the rear suspension pivot structure. A stator outer flange extends radially from the stator outer. The rotor includes a rotor keying feature, which is configured to engage with a corresponding wheel carrier keying feature to transmit rotational motion from the wheel carrier to the rotor.

The combined metal spring and fluid damper configuration provides both spring and damping functions within a single rotary cartridge assembly. The spring function is provided by the primary coil or torsional spring and the top out coil or torsional spring, which resist suspension movement and return the suspension toward the extended position after compression. The damping function is provided by the damping valves on the rotor blades with valves, which control the rate of suspension movement by providing velocity-dependent resistance as the damping fluid flows through the valves.

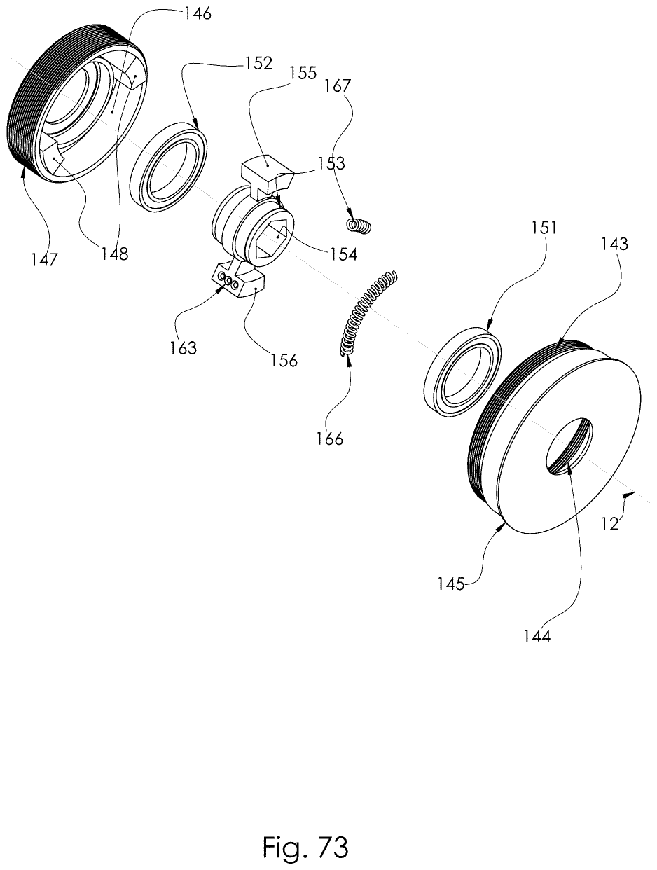

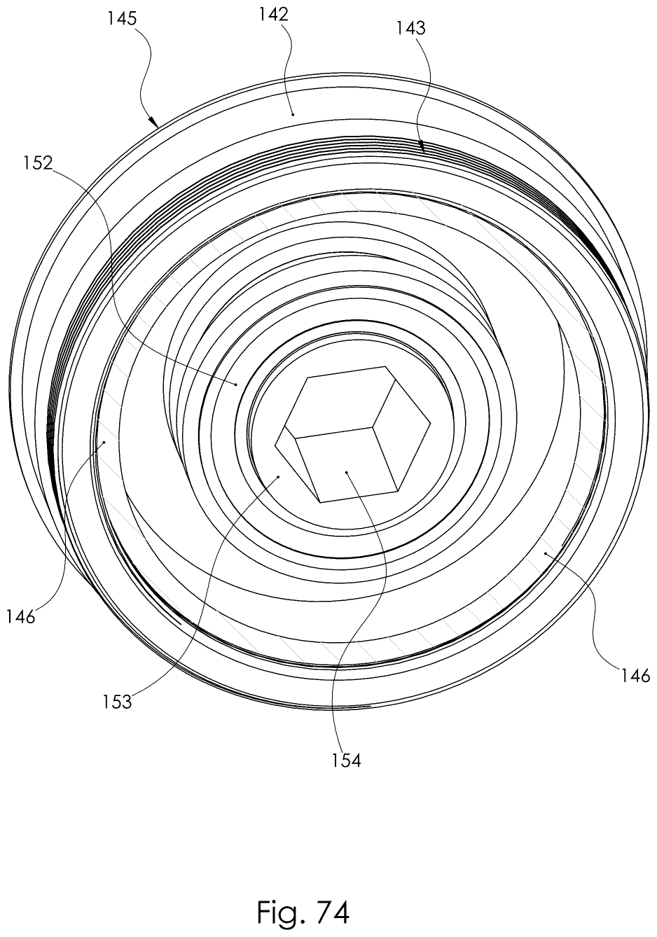

Referring to FIG. 73, an isometric, exploded view of the combined metal spring and fluid damper embodiment of the rotary cartridge is shown in a position between the extended and compressed state. The exploded view illustrates the spatial relationships between the components of the combined metal spring and fluid damper rotary cartridge assembly.

The rotor is shown with the rotor blades with valves extending from the rotor. The damping valves are visible on the rotor blades with valves, positioned to control the flow of the damping fluid as the rotor rotates relative to the stator inner during suspension movement. The rotor keying feature extends from the rotor and is configured to engage with the wheel carrier keying feature on the wheel carrier to transmit rotational motion from the wheel carrier to the rotor.

With continued reference to FIG. 73, the primary coil or torsional spring is shown in an exploded position relative to the rotor and the stator inner. The primary coil or torsional spring may be a helical coil spring or a torsional spring element that is configured to provide spring resistance about the rotational axis of the rotary cartridge assembly. The primary coil or torsional spring may have one end that engages with the rotor or the rotor blade and an opposite end that engages with the stator inner or the stator inner blade, such that relative rotation between the rotor and stator components causes the primary coil or torsional spring to be wound or unwound, providing spring resistance.

The top out coil or torsional spring is shown in an exploded position relative to the rotor and the stator inner. The top out coil or torsional spring may be a helical coil spring or a torsional spring element that is configured to provide spring resistance in the over-extension direction. The top out coil or torsional spring may have one end that engages with the rotor or the rotor blade and an opposite end that engages with the stator inner or the stator inner blade, such that relative rotation between the rotor and stator components in the over-extension direction causes the top out coil or torsional spring to be loaded, providing spring resistance against over-extension movement.

As further shown in FIG. 73, the stator inner is shown with the stator inner blade extending from the stator inner. A stator inner fastening feature is located on an outer surface of the stator inner and is configured to engage with a corresponding stator outer fastening feature on the stator outer to secure the stator inner within the stator outer and prevent relative rotation between these components.

Bearings are positioned on opposite sides of the rotor to reduce rotational friction between the rotor and the stator components as the rotor rotates relative to the stator inner during suspension movement. The bearings also provide sealing interfaces that aid in containing the damping fluid within the fluid chambers of the rotary cartridge assembly.

The combined metal spring and fluid damper embodiment provides mechanical spring resistance through the coil or torsional spring elements while providing velocity-dependent damping resistance through the valved rotor blades. The spring rate of the primary coil or torsional spring may be selected or adjusted to provide different spring characteristics for the compression direction, while the spring rate of the top out coil or torsional spring may be selected or adjusted to provide different spring characteristics for the over-extension direction. The damping characteristics may be adjusted through the damping valves on the rotor blades with valves, which may include separate compression and rebound valves to control fluid flow in both directions of suspension movement.

The combined metal spring and fluid damper configuration may provide advantages over separate spring and damper assemblies by integrating both functions within a single modular rotary cartridge. The metal spring elements may provide more consistent spring characteristics across a range of temperatures compared to elastomeric spring elements, as metal springs may be less sensitive to temperature variations than elastomeric materials. The fluid damper portion of the combined assembly provides velocity-dependent resistance that controls the rate of suspension movement, which may improve ride quality and handling characteristics compared to spring-only configurations.

In some embodiments, the primary coil or torsional spring may be mechanically pre-loaded to adjust the spring rate or to provide a threshold force before suspension movement begins. The pre-load may be adjusted by rotating one end of the primary coil or torsional spring relative to an opposite end before securing the spring within the rotary cartridge assembly. Similarly, the top out coil or torsional spring may be mechanically pre-loaded to adjust the spring rate or threshold force in the over-extension direction.

The damping valves on the rotor blades with valves may include separate low speed and high speed tuning valves for both compression and rebound directions. The compression valves may control the flow of the damping fluid as the kinematic wheel carrier moves from the extended state toward the compressed state, while the rebound valves may control the flow of the damping fluid as the kinematic wheel carrier moves from the compressed state toward the extended state. The low speed valves may provide damping resistance at low velocities of suspension movement, while the high speed valves may provide damping resistance at higher velocities of suspension movement. The damping valves may be adjusted by turning adjuster features to open or restrict fluid flow depending upon adjuster turns and turn direction, allowing the damping characteristics to be tuned for various riding conditions and rider preferences.

Referring to FIG. 74, an isometric view of a bearing-only embodiment of the rotary cartridge is shown with the stator inner cut away as indicated by hashed marks, in a position between the extended and compressed state. This embodiment illustrates a rotary cartridge configuration where the rotary cartridge rotor has no rotor blades, with the cartridge acting as a bearing without providing resistance to suspension movement.

The rotor is positioned within the stator inner and is supported by bearings on opposite sides of the rotor. The rotor includes a rotor keying feature, which is configured to engage with a corresponding wheel carrier keying feature to transmit rotational motion from the wheel carrier to the rotor. The rotor is configured without rotor blades extending from the rotor body, such that the rotor rotates freely within the stator inner without compressing elastomeric elements, displacing fluid through valves, or loading spring elements.

With continued reference to FIG. 74, the stator outer forms the outer housing of the rotary cartridge. A stator outer fastening feature is positioned on the stator outer and provides a mounting interface for securing the rotary cartridge to the rear suspension pivot structure. A stator outer flange extends radially from the stator outer. The stator inner is positioned within the stator outer and includes a stator inner blade extending from the stator inner toward a central region of the rotary cartridge assembly. The stator inner blade remains in a fixed angular position relative to the suspended body throughout the suspension travel.

The bearing-only configuration allows the rotary cartridge to function as a pivot bearing assembly without providing spring or damping resistance to suspension movement. The bearings positioned on opposite sides of the rotor reduce rotational friction between the rotor and the stator components as the rotor rotates relative to the stator inner during suspension movement. The bearing-only rotary cartridge may be installed on one side of the suspension system while a resistance-providing rotary cartridge is installed on an opposite side of the suspension system.

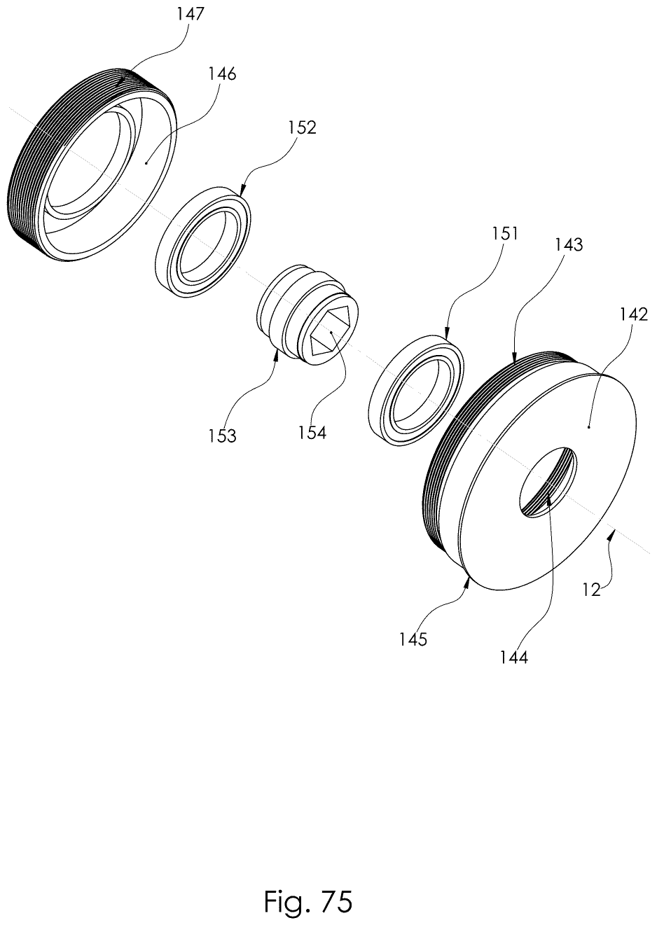

Referring to FIG. 75, an isometric, exploded view of the bearing-only embodiment of the rotary cartridge is shown in a position between the extended and compressed state. The exploded view illustrates the spatial relationships between the components of the bearing-only rotary cartridge assembly.

The rotor is shown without rotor blades extending from the rotor body. The rotor keying feature extends from the rotor and is configured to engage with the wheel carrier keying feature on the wheel carrier to transmit rotational motion from the wheel carrier to the rotor. The absence of rotor blades on the rotor allows the rotor to rotate within the stator inner without interacting with resistance elements positioned within the rotary cartridge assembly.

With continued reference to FIG. 75, the stator inner is shown with the stator inner blade extending from the stator inner. A stator inner fastening feature is located on an outer surface of the stator inner and is configured to engage with a corresponding stator outer fastening feature on the stator outer to secure the stator inner within the stator outer and prevent relative rotation between these components.

Bearings are positioned on opposite sides of the rotor to reduce rotational friction between the rotor and the stator components as the rotor rotates relative to the stator inner during suspension movement. The bearings provide support for the rotor and facilitate smooth rotational movement within the rotary cartridge assembly without providing resistance to the rotational movement.

The bearing-only embodiment of the rotary cartridge may be used in configurations where resistance is provided by a separate rotary cartridge on an opposite side of the suspension system. For example, a resistance-providing rotary cartridge including elastomeric elements, fluid damping valves, air spring chambers, or coil springs may be installed on the drive side of the suspension system, while the bearing-only rotary cartridge may be installed on the non-drive side of the suspension system. Alternatively, the bearing-only rotary cartridge may be installed on the drive side while the resistance-providing rotary cartridge is installed on the non-drive side.

The bearing-only configuration may also be used in applications where minimal or no resistance is desired from the rotary cartridge assembly. In such applications, the bearing-only rotary cartridge provides structural support and pivot bearing functionality for the wheel carrier without contributing spring or damping resistance to the suspension system. The modular nature of the rotary cartridge assemblies allows the bearing-only configuration to be exchanged with resistance-providing configurations as suspension requirements change.

In some embodiments, the two-wheeled vehicle suspension may include an additional pivotal connection between at least two kinematic suspension bodies that does not include a resistance mechanism. For example, the bearing-only rotary cartridge described with reference to FIGS. 74-75 may be installed at one location along the suspension pivot axis to provide a pivotal connection without resistance, while a resistance-providing rotary cartridge is installed at a different location along the same suspension pivot axis. This configuration allows the resistance mechanism to be concentrated at one location while the additional pivotal connection provides structural support without contributing resistance to the suspension movement.

The rotary resistance mechanism may be associated with a bore interface that defines a portion of the rotary mechanism. The bore interface may correspond to the rear suspension pivot aperture/bore [Drive] 14, the rear suspension pivot aperture/bore [Non-Drive] 17, the front suspension pivot aperture/bore [Drive] 84, or the front suspension pivot aperture/bore [Non-Drive] 87. The rotary mechanism may apply torque about the IVC axis defined by the kinematic joint between two linkage bodies. When viewed from a plane defined by the IVC axis, there may be an intersection between the projections of the bore interface, the rotary mechanism interface, or the rotary mechanism and a braking mechanism during at least a portion of a travel of the suspension. In some embodiments, the rotary mechanism may include a rotary fluid damper that applies torque about the IVC axis through controlled flow of damping fluid within the mechanism. The rotary fluid damper may be modular, wherein the modular rotary fluid damper provides a fixed suspension travel determined by the geometry of the module components.

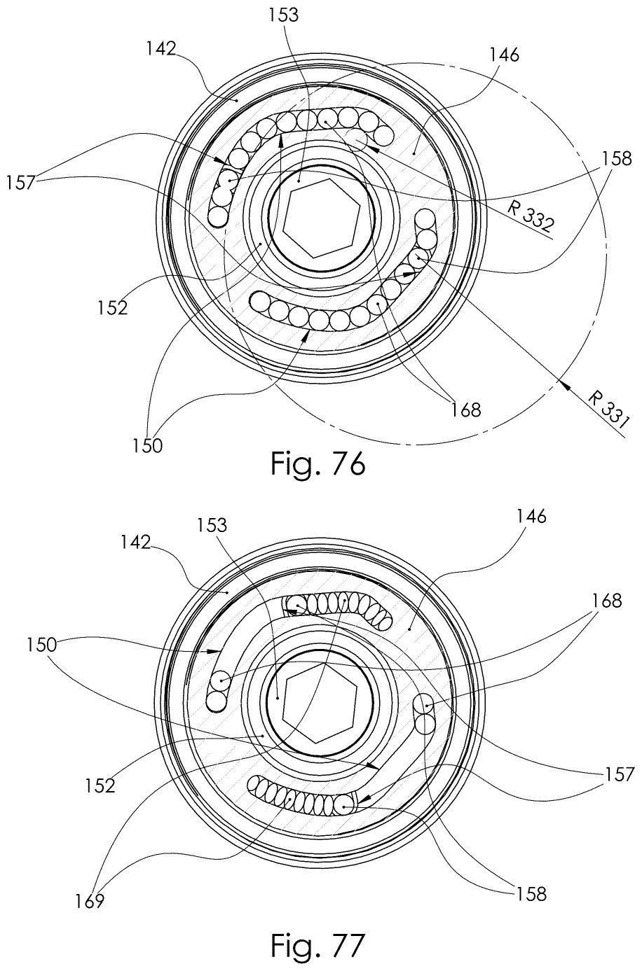

Referring to FIGS. 76-77, isometric views of a non-constant radius spring element embodiment of the Rotary Cartridge [Drive] 139 are shown with the Rotary Cartridge Stator Inner 146 cut away as indicated by hashed marks. This embodiment illustrates a rotary cartridge configuration where the path of resistance about the rotation axis has a non-constant radius of curvature, providing a variable spring rate progression as the suspension moves through the travel range.

The Rotary Cartridge Stator Inner 146 includes Rotary Cartridge Stator Inner Splined Slots 150, which are configured with a splined path having a non-constant radius of curvature. The Rotary Cartridge Stator Inner Splined Slots 150 extend from the Rotary Cartridge Stator Inner 146 and define curved channels that receive spring elements. A Radius of Curvature 1 R331 and a Radius of Curvature 2 are indicated in the figures, with the Radius of Curvature 1 R331 being unequal to the Radius of Curvature 2. The variation between the Radius of Curvature 1 R331 and the Radius of Curvature 2 provides a variable rate of elastomer compression as the Rotary Cartridge Rotor 153 rotates relative to the Rotary Cartridge Stator Inner 146 during suspension movement.

With continued reference to FIGS. 76-77, the Rotary Cartridge Rotor 153 includes a Rotary Cartridge Rotor Blade [Slotted] 157, which extends from the Rotary Cartridge Rotor 153 toward the Rotary Cartridge Stator Inner 146. The Rotary Cartridge Rotor Blade [Slotted] 157 includes slots or openings that receive Rotary Cartridge Rotor Slot Pins 158. The Rotary Cartridge Rotor Slot Pins 158 extend from the Rotary Cartridge Rotor Blade [Slotted] 157 and are configured to engage with spring elements positioned within the Rotary Cartridge Stator Inner Splined Slots 150.

Rotary Cartridge Elastomer Capsules [Extended] 168 are positioned within the Rotary Cartridge Stator Inner Splined Slots 150 in an extended or uncompressed configuration. The Rotary Cartridge Elastomer Capsules [Extended] 168 are spring capsule elements that are assembled into the Rotary Cartridge Stator Inner Splined Slots 150 with the non-constant radius of curvature. Rotary Cartridge Elastomer Capsules [Compressed] 169 represent the same elastomer capsule elements in a compressed configuration as the Rotary Cartridge Rotor 153 rotates relative to the Rotary Cartridge Stator Inner 146 during suspension movement toward the compressed state.

As the Rotary Cartridge Rotor 153 rotates relative to the Rotary Cartridge Stator Inner 146, the Rotary Cartridge Rotor Slot Pins 158 move along the Rotary Cartridge Stator Inner Splined Slots 150, compressing the Rotary Cartridge Elastomer Capsules [Extended] 168 into the Rotary Cartridge Elastomer Capsules [Compressed] 169 configuration. The non-constant radius of curvature of the Rotary Cartridge Stator Inner Splined Slots 150 causes the rate of compression of the elastomer capsules to vary as the Rotary Cartridge Rotor Slot Pins 158 travel along the splined path. Where the radius of curvature is larger, such as at the Radius of Curvature 1 R331, the rate of elastomer compression per degree of rotor rotation may be different than where the radius of curvature is smaller, such as at the Radius of Curvature 2.

The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

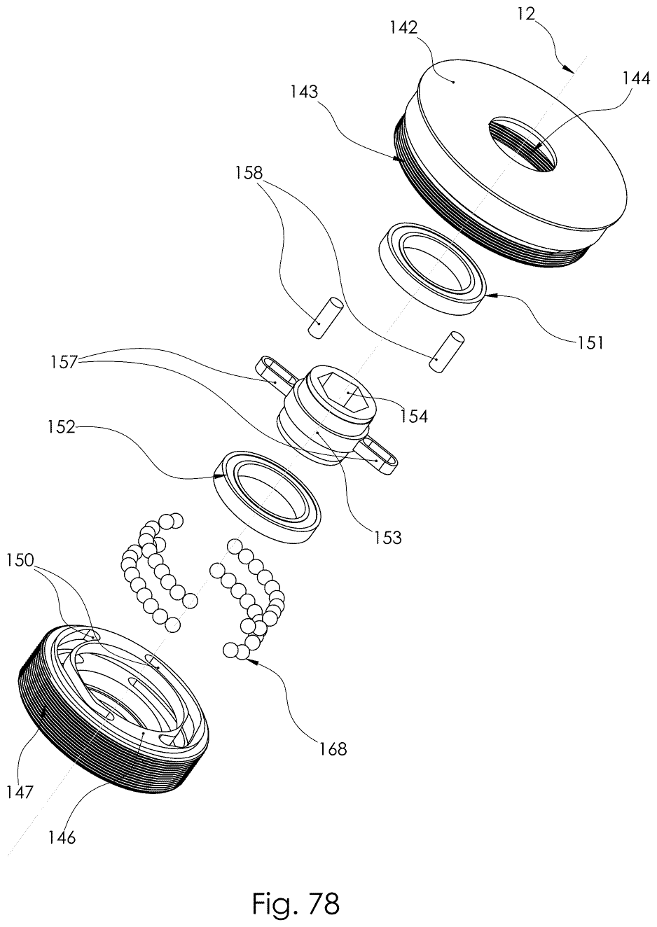

Referring to FIG. 78, a section view of the non-constant radius spring element embodiment of the Rotary Cartridge [Drive] 139 is shown. The section view reveals the internal arrangement of the Rotary Cartridge Stator Inner Splined Slots 150, the Rotary Cartridge Rotor Slot Pins 158, and the Rotary Cartridge Elastomer Capsules [Extended] 168 within the rotary cartridge assembly.

The Rotary Cartridge Stator Inner Splined Slots 150 are visible as curved channels within the Rotary Cartridge Stator Inner 146. The splined path of the Rotary Cartridge Stator Inner Splined Slots 150 follows a trajectory with the non-constant radius of curvature, transitioning between regions having the Radius of Curvature 1 R331 and regions having the Radius of Curvature 2. The variation in radius of curvature along the splined path provides a non-linear spring rate progression as the Rotary Cartridge Rotor Slot Pins 158 travel along the Rotary Cartridge Stator Inner Splined Slots 150 during suspension movement.

With continued reference to FIG. 78, the Rotary Cartridge Rotor Blade [Slotted] 157 is shown with the Rotary Cartridge Rotor Slot Pins 158 extending from the Rotary Cartridge Rotor Blade [Slotted] 157 into the Rotary Cartridge Stator Inner Splined Slots 150. The Rotary Cartridge Elastomer Capsules [Extended] 168 are positioned within the Rotary Cartridge Stator Inner Splined Slots 150 between the Rotary Cartridge Rotor Slot Pins 158 and end walls of the Rotary Cartridge Stator Inner Splined Slots 150. As the Rotary Cartridge Rotor 153 rotates, the Rotary Cartridge Rotor Slot Pins 158 compress the Rotary Cartridge Elastomer Capsules [Extended] 168 against the end walls of the Rotary Cartridge Stator Inner Splined Slots 150.

The non-constant radius of curvature configuration provides a variable spring rate that changes as the suspension moves through the travel range. In regions where the radius of curvature is larger, the Rotary Cartridge Rotor Slot Pins 158 travel a greater linear distance per degree of rotor rotation, which may result in a higher rate of elastomer compression per degree of rotation. In regions where the radius of curvature is smaller, the Rotary Cartridge Rotor Slot Pins 158 travel a lesser linear distance per degree of rotor rotation, which may result in a lower rate of elastomer compression per degree of rotation. The variation in compression rate provides a non-linear spring rate characteristic that may be tuned by selecting the geometry of the Rotary Cartridge Stator Inner Splined Slots 150 and the relative magnitudes of the Radius of Curvature 1 R331 and the Radius of Curvature 2.

The non-constant radius spring element embodiment may provide a progressive or digressive spring rate characteristic depending upon the arrangement of the varying radii of curvature along the splined path. A progressive spring rate may provide a softer initial response at the beginning of the suspension travel and increased resistance as the suspension approaches the compressed state. A digressive spring rate may provide a firmer initial response at the beginning of the suspension travel and decreased resistance as the suspension approaches the compressed state. The selection of the splined path geometry allows the spring rate progression to be tailored for various riding conditions and rider preferences.

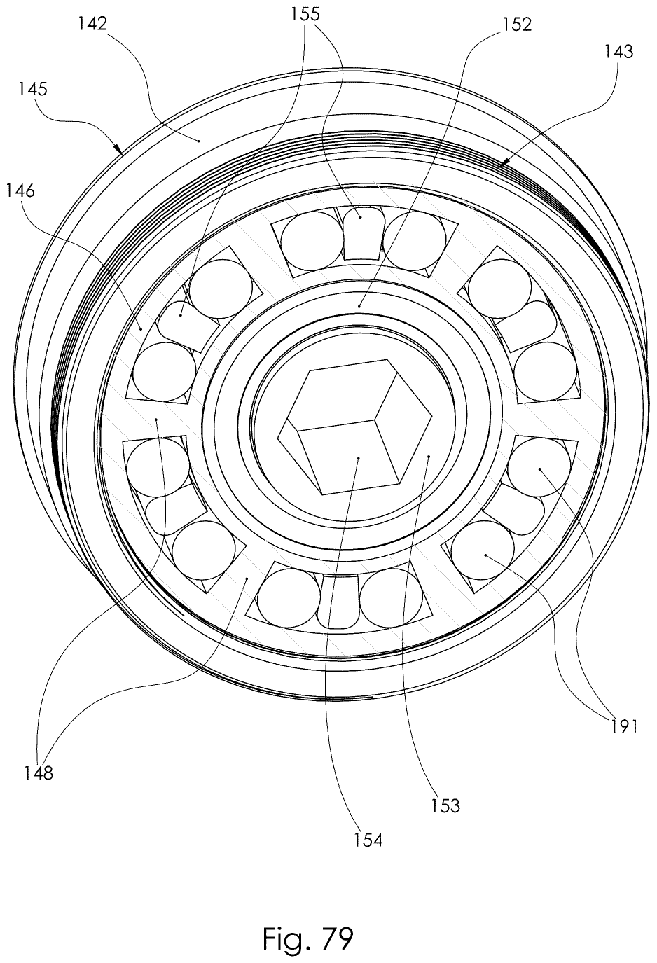

Referring to FIG. 79, an isometric view of an elastomer cylinder embodiment of the Rotary Cartridge [Drive] 139 is shown with the Rotary Cartridge Stator Inner 146 cut away as indicated by hashed marks, in a position between the extended and compressed state. This embodiment illustrates a rotary cartridge configuration where a multitude of Rotary Cartridge Elastomer Cylinders [Extended] 191 are positioned within the rotary cartridge assembly to provide spring resistance during suspension movement.

The Rotary Cartridge Rotor 153 includes the Rotary Cartridge Rotor Blade [Solid] 155, which extends from the Rotary Cartridge Rotor 153 toward the Rotary Cartridge Stator Inner 146. The Rotary Cartridge Stator Inner 146 includes the Rotary Cartridge Stator Inner Blade [Solid] 148, which extends from the Rotary Cartridge Stator Inner 146 toward a central region of the rotary cartridge assembly. The Rotary Cartridge Elastomer Cylinders [Extended] 191 are positioned between the Rotary Cartridge Rotor Blade [Solid] 155 and the Rotary Cartridge Stator Inner Blade [Solid] 148, such that relative rotation between the Rotary Cartridge Rotor 153 and the Rotary Cartridge Stator Inner 146 causes compression of the Rotary Cartridge Elastomer Cylinders [Extended] 191.

With continued reference to FIG. 79, the Rotary Cartridge Elastomer Cylinders [Extended] 191 are arranged in a configuration where multiple individual cylinder elements interface with both the Rotary Cartridge Stator Inner Blade [Solid] 148 and the Rotary Cartridge Rotor Blade [Solid] 155. The Rotary Cartridge Elastomer Cylinders [Extended] 191 may vary in size to provide different compression characteristics across the multitude of cylinder elements. The Rotary Cartridge Elastomer Cylinders [Extended] 191 may also vary in shape, with some cylinder elements having different diameters or lengths compared to other cylinder elements within the same rotary cartridge assembly. The Rotary Cartridge Elastomer Cylinders [Extended] 191 may further vary in material composition, with different cylinder elements being formed from elastomeric materials having different durometers or material properties.

As further shown in FIG. 79, the Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142. The Rotary Cartridge Rotor 153 includes the Rotary

Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

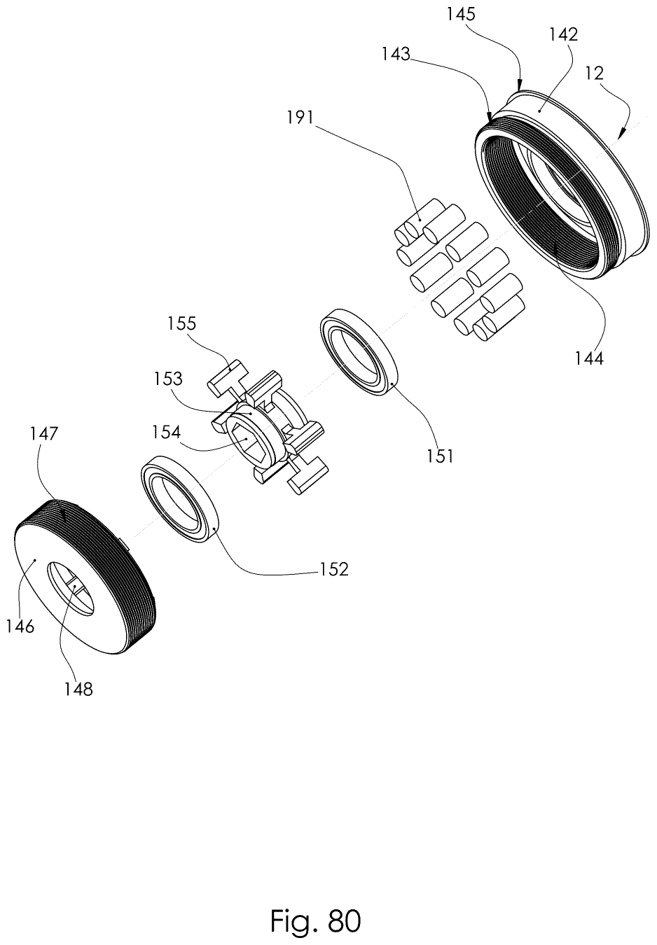

Referring to FIG. 80, an isometric, exploded view of the elastomer cylinder embodiment of the Rotary Cartridge [Drive] 139 is shown in a position between the extended and compressed state. The exploded view illustrates the spatial relationships between the components of the elastomer cylinder rotary cartridge assembly.

The Rotary Cartridge Rotor 153 is shown with the Rotary Cartridge Rotor Blade [Solid] 155 extending from the Rotary Cartridge Rotor 153. The Rotary Cartridge Rotor Blade [Solid] 155 is configured as a solid blade structure that interfaces with the Rotary Cartridge Elastomer Cylinders [Extended] 191 during suspension movement. The Rotary Cartridge Rotor Keying Feature 154 extends from the Rotary Cartridge Rotor 153 and is configured to engage with the Rear Wheel Carrier Keying Feature [Drive] [Embodiment-2] 171 on the Rear Wheel Carrier [Drive] [Embodiment-2] 170.

With continued reference to FIG. 80, the Rotary Cartridge Stator Inner 146 is shown with the Rotary Cartridge Stator Inner Blade [Solid] 148 extending from the Rotary Cartridge Stator Inner 146. The Rotary Cartridge Stator Inner Fastening Feature [Outer] 147 is located on an outer surface of the Rotary Cartridge Stator Inner 146 and is configured to engage with the Rotary Cartridge Stator Outer Fastening Feature [Inner] 144 on the Rotary Cartridge Stator Outer 142 to secure the Rotary Cartridge Stator Inner 146 within the Rotary Cartridge Stator Outer 142 and prevent relative rotation between these components.

The Rotary Cartridge Elastomer Cylinders [Extended] 191 are shown in an exploded position relative to the Rotary Cartridge Rotor Blade [Solid] 155 and the Rotary Cartridge Stator Inner Blade [Solid] 148. The multitude of the Rotary Cartridge Elastomer Cylinders [Extended] 191 allows for fine tuning of the elastomer spring rate by selecting cylinder elements that vary in size, shape, or material. Cylinder elements having larger diameters may provide greater spring resistance compared to cylinder elements having smaller diameters. Cylinder elements having greater lengths may provide different compression characteristics compared to cylinder elements having shorter lengths. Cylinder elements formed from elastomeric materials having higher durometers may provide stiffer spring resistance compared to cylinder elements formed from elastomeric materials having lower durometers.

The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement.

The elastomer cylinder embodiment of the rotary cartridge provides spring resistance through the compression of the multitude of the Rotary Cartridge Elastomer Cylinders [Extended] 191 as the Rotary Cartridge Rotor 153 rotates relative to the Rotary Cartridge Stator Inner 146. The variation in size, shape, or material of the individual cylinder elements within the multitude of the Rotary Cartridge Elastomer Cylinders [Extended] 191 allows the overall spring rate of the rotary cartridge assembly to be tuned for various rider weights and riding conditions. The cylinder elements may be selected or replaced to achieve different spring rate characteristics without replacing the entire rotary cartridge assembly.

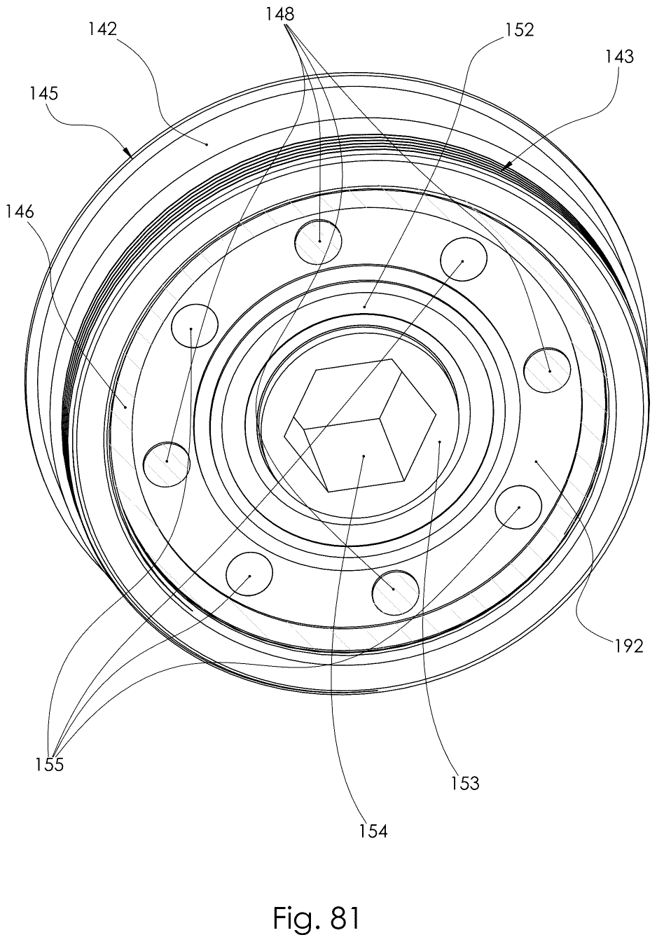

Referring to FIG. 81, an isometric view of an elastomer disc embodiment of the Rotary Cartridge [Drive] 139 is shown with the Rotary Cartridge Stator Inner 146 cut away as indicated by hashed marks, in a position between the extended and compressed state. This embodiment illustrates a rotary cartridge configuration where a multitude of Rotary Cartridge Elastomer Discs [Extended] 192 are positioned within the rotary cartridge assembly to provide spring resistance during suspension movement.

The Rotary Cartridge Rotor 153 includes the Rotary Cartridge Rotor Blade [Solid] 155, which extends from the Rotary Cartridge Rotor 153 toward the Rotary Cartridge Stator Inner 146. The Rotary Cartridge Stator Inner 146 includes the Rotary Cartridge Stator Inner Blade [Solid] 148, which extends from the Rotary Cartridge Stator Inner 146 toward a central region of the rotary cartridge assembly. The Rotary Cartridge Elastomer Discs [Extended] 192 are positioned between the Rotary Cartridge Rotor Blade [Solid] 155 and the Rotary Cartridge Stator Inner Blade [Solid] 148, such that relative rotation between the Rotary Cartridge Rotor 153 and the Rotary Cartridge Stator Inner 146 causes compression of the Rotary Cartridge Elastomer Discs [Extended] 192.

With continued reference to FIG. 81, the Rotary Cartridge Elastomer Discs [Extended] 192 are arranged in a configuration where multiple individual disc elements interface with both the Rotary Cartridge Stator Inner Blade [Solid] 148 and the Rotary Cartridge Rotor Blade [Solid] 155. The disc geometry of the Rotary Cartridge Elastomer Discs [Extended] 192 may aid in manufacturability compared to other elastomeric element geometries, as disc shapes may be formed through stamping, cutting, or molding processes that produce consistent dimensional tolerances across the multitude of disc elements.

As further shown in FIG. 81, the Rotary Cartridge Stator Outer 142 forms the outer housing of the Rotary Cartridge [Drive] 139. The Rotary Cartridge Stator Outer Fastening Feature [Primary] 143 is positioned on the Rotary Cartridge Stator Outer 142 and provides a mounting interface for securing the Rotary Cartridge [Drive] 139 to the rear suspension pivot structure. The Rotary Cartridge Stator Outer Flange [Primary] 145 extends radially from the Rotary Cartridge Stator Outer 142. The Rotary Cartridge Rotor 153 includes the Rotary Cartridge Rotor Keying Feature 154, which is configured to engage with the Rear Wheel Carrier Keying Feature [Drive] [Embodiment-2] 171 on the Rear Wheel Carrier [Drive] [Embodiment-2] 170 to transmit rotational motion from the Rear Wheel Carrier [Drive] [Embodiment-2] 170 to the Rotary Cartridge Rotor 153.

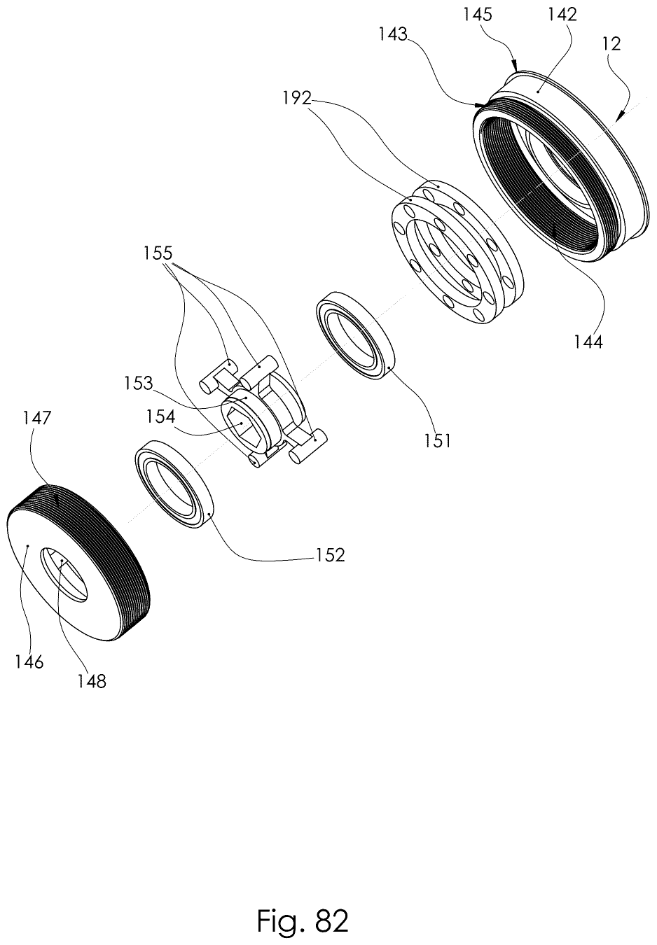

Referring to FIG. 82, an isometric, exploded view of the elastomer disc embodiment of the Rotary Cartridge [Drive] 139 is shown in a position between the extended and compressed state. The exploded view illustrates the spatial relationships between the components of the elastomer disc rotary cartridge assembly.

The Rotary Cartridge Rotor 153 is shown with the Rotary Cartridge Rotor Blade [Solid] 155 extending from the Rotary Cartridge Rotor 153. The Rotary Cartridge Rotor Blade [Solid] 155 is configured as a solid blade structure that interfaces with the Rotary Cartridge Elastomer Discs [Extended] 192 during suspension movement. The Rotary Cartridge Rotor Keying Feature 154 extends from the Rotary Cartridge Rotor 153 and is configured to engage with the Rear Wheel Carrier Keying Feature [Drive] [Embodiment-2] 171 on the Rear Wheel Carrier [Drive] [Embodiment-2] 170.

With continued reference to FIG. 82, the Rotary Cartridge Stator Inner 146 is shown with the Rotary Cartridge Stator Inner Blade [Solid] 148 extending from the Rotary Cartridge Stator Inner 146. The Rotary Cartridge Stator Inner Fastening Feature [Outer] 147 is located on an outer surface of the Rotary Cartridge Stator Inner 146 and is configured to engage with the Rotary Cartridge Stator Outer Fastening Feature [Inner] 144 on the Rotary Cartridge Stator Outer 142 to secure the Rotary Cartridge Stator Inner 146 within the Rotary Cartridge Stator Outer 142 and prevent relative rotation between these components.

The Rotary Cartridge Elastomer Discs [Extended] 192 are shown in an exploded position relative to the Rotary Cartridge Rotor Blade [Solid] 155 and the Rotary Cartridge Stator Inner Blade [Solid] 148. The multitude of the Rotary Cartridge Elastomer Discs [Extended] 192 may vary in size to provide different compression characteristics across the multitude of disc elements. Disc elements having larger diameters may provide greater spring resistance compared to disc elements having smaller diameters. Disc elements having greater thicknesses may provide different compression characteristics compared to disc elements having thinner thicknesses.

As further shown in FIG. 82, the Rotary Cartridge Elastomer Discs [Extended] 192 may vary in shape, with some disc elements having different outer profiles or inner aperture configurations compared to other disc elements within the same rotary cartridge assembly. The Rotary Cartridge Elastomer Discs [Extended] 192 may further vary in material composition, with different disc elements being formed from elastomeric materials having different durometers or material properties. The variation in size, shape, or material of the individual disc elements within the multitude of the Rotary Cartridge Elastomer Discs [Extended] 192 allows the overall spring rate of the rotary cartridge assembly to be fine tuned for various rider weights and riding conditions.

The Rotary Cartridge Bearing [Linkage Side] 151 and the Rotary Cartridge Bearing [Fastener Side] 152 are positioned on opposite sides of the Rotary Cartridge Rotor 153 to reduce rotational friction between the Rotary Cartridge Rotor 153 and the stator components as the Rotary Cartridge Rotor 153 rotates relative to the Rotary Cartridge Stator Inner 146 during suspension movement.

The elastomer disc embodiment of the rotary cartridge provides spring resistance through the compression of the multitude of the Rotary Cartridge Elastomer Discs [Extended] 192 as the Rotary Cartridge Rotor 153 rotates relative to the Rotary Cartridge Stator Inner 146. The disc elements may be selected or replaced to achieve different spring rate characteristics without replacing the entire rotary cartridge assembly. The disc geometry may provide manufacturing advantages through the use of standardized production processes that produce disc elements with consistent properties, while the ability to vary the size, shape, or material of individual disc elements within the multitude allows for spring rate tuning to accommodate different suspension requirements.

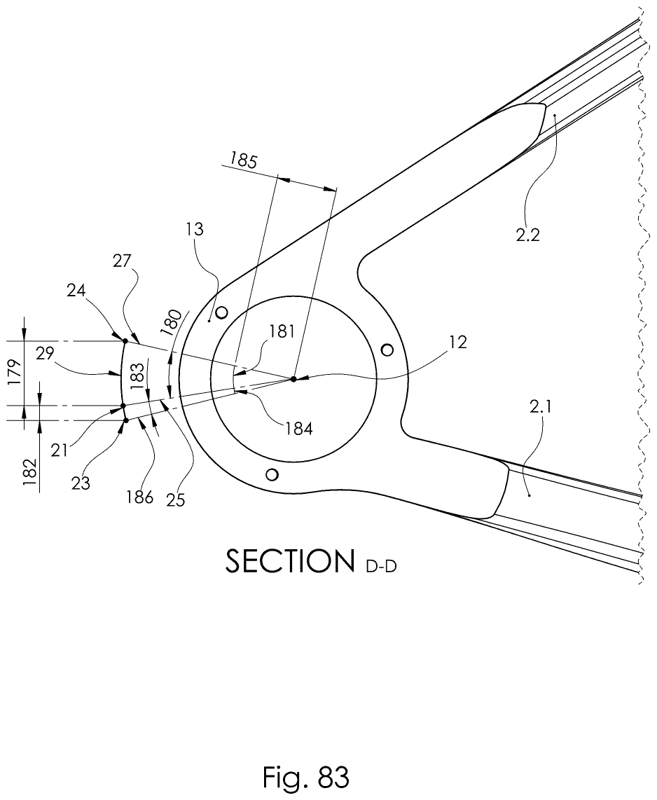

Referring to FIG. 83, a drive-side view of the rear suspension system is shown illustrating the wheel path and travel analysis for the rear rotary suspension system. The figure depicts the geometric relationships used to calculate the average leverage ratio of the rotary resistance mechanism relative to the vertical travel of the rear wheel with respect to the The rear suspension pivot axis 12 defines the rotational center about which the rear wheel carrier rotates relative to the suspended body. The rear wheel axis [Extended] 21, the rear wheel axis [Compressed] 24, and the rear wheel axis [Over-Extended] 23 are shown as points along the rear wheel path 29, illustrating the positions of the rear wheel axis throughout the suspension travel range. The rear wheel axis to rear suspension pivot axis [Extended] 25 extends from the rear wheel axis [Extended] 21 to the rear suspension pivot axis 12. The rear wheel axis to rear suspension pivot axis [Compressed] 27 extends from the rear wheel axis [Compressed] 24 to the rear suspension pivot axis 12. The rear wheel axis to rear suspension pivot axis [Over-Extended] 186 extends from the rear wheel axis [Over-Extended] 23 to the rear suspension pivot axis 12.

With continued reference to FIG. 83, the vertical wheel travel [E-C] 179 indicates the vertical distance between the rear wheel axis [Extended] 21 and the rear wheel axis [Compressed] 24. The vertical wheel travel [E-OE] 182 indicates the vertical distance from the rear wheel axis [Extended] 21 to the rear wheel axis [Over-Extended] 23. An angular wheel travel [E-C] 180 is defined as the angle between the rear wheel axis to rear suspension pivot axis [Extended] 25 and the rear wheel axis to rear suspension pivot axis [Compressed] 27. An angular wheel travel [E-OE] 183 is defined as the angle between the rear wheel axis to rear suspension pivot axis [Extended] 25 and the rear wheel axis to rear suspension pivot axis [Over-Extended] 186.

A resistance curve length [E-C] 181 represents the arc length traveled by the resistance mechanism as the suspension moves from the extended state to the compressed state. A resistance curve length [E-OE] 184 represents the arc length traveled by the resistance mechanism as the suspension moves from the extended state to the over-extended state. A resistance curve length distance 185 represents the radial distance from the rear suspension pivot axis 12 to the location where the resistance mechanism acts, which corresponds to the radius at which the elastomeric elements, damping fluid, or spring elements are positioned within the rotary cartridge assembly.

As further shown in FIG. 83, the resistance curve length [E-C] 181 may be calculated using the following relationship:

Similarly, the resistance curve length [E-OE] 184 may be calculated using the following relationship:

The average leverage ratio (ALR) is the ratio of the vertical wheel travel to the resistance curve length. The average leverage ratio from the extended state to the compressed state (ALR[E-C]) is defined as:

The average leverage ratio from the extended state to the over-extended state (ALR[E-OE]) is defined as:

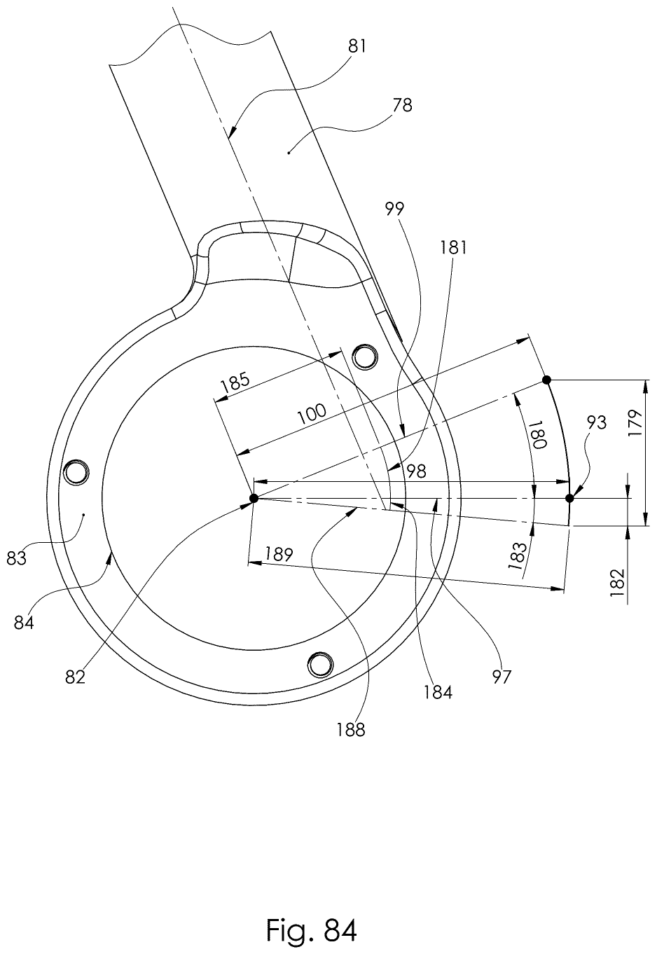

Referring to FIG. 84, a drive-side view of the front suspension system is shown illustrating the wheel path and travel analysis for the front rotary suspension system. The figure depicts the geometric relationships used to calculate the average leverage ratio of the front rotary resistance mechanism relative to the vertical travel of the front wheel with respect to the fork upper 78.

The front suspension pivot axis 82 defines the rotational center about which the front wheel carrier rotates relative to the fork upper 78. The front wheel axis [Extended] 93, the front wheel axis [Compressed] 96, and the front wheel axis [Over-Extended] 95 are shown as points along the front wheel path 101, illustrating the positions of the front wheel axis throughout the front suspension travel range. The front wheel axis to rear suspension pivot axis [Extended] 97 extends from the front wheel axis [Extended] 93 to the front suspension pivot axis 82. The front wheel axis to rear suspension pivot axis [Compressed] 99 extends from the front wheel axis [Compressed] 96 to the front suspension pivot axis 82. The front wheel axis to rear suspension pivot axis [Over-Extended] 188 extends from the front wheel axis [Over-Extended] 95 to the front suspension pivot axis 82.

With continued reference to FIG. 84, the vertical wheel travel [E-C] 179 indicates the vertical distance between the front wheel axis [Extended] 93 and the front wheel axis [Compressed] 96. The vertical wheel travel [E-OE] 182 indicates the vertical distance from the front wheel axis [Extended] 93 to the front wheel axis [Over-Extended] 95. The angular wheel travel [E-C] 180 is defined as the angle between the front wheel axis to rear suspension pivot axis [Extended] 97 and the front wheel axis to rear suspension pivot axis [Compressed] 99. The angular wheel travel [E-OE] 183 is defined as the angle between the front wheel axis to rear suspension pivot axis [Extended] 97 and the front wheel axis to rear suspension pivot axis [Over-Extended] 188.

The resistance curve length [E-C] 181 represents the arc length traveled by the front resistance mechanism as the front suspension moves from the extended state to the compressed state. The resistance curve length [E-OE] 184 represents the arc length traveled by the front resistance mechanism as the front suspension moves from the extended state to the over-extended state. The resistance curve length distance 185 represents the radial distance from the front suspension pivot axis 82 to the location where the front resistance mechanism acts within the front rotary cartridge assembly.

As further shown in FIG. 84, the front wheel axis to rear suspension pivot axis length [Extended] 98 represents the length dimension of the front wheel axis to rear suspension pivot axis [Extended] 97. The front wheel axis to rear suspension pivot axis length [Compressed] 100 represents the length dimension of the front wheel axis to rear suspension pivot axis [Compressed] 99. The front wheel axis to rear suspension pivot axis length [Over-Extended] 189 represents the length dimension of the front wheel axis to rear suspension pivot axis [Over-Extended] 188.

The average leverage ratio calculations for the front suspension follow the same relationships as described for the rear suspension. The average leverage ratio from the extended state to the compressed state (ALR[E-C]) for the front suspension is calculated by dividing the vertical wheel travel [E-C] 179 by the resistance curve length [E-C] 181. The average leverage ratio from the extended state to the over-extended state (ALR[E-OE]) for the front suspension is calculated by dividing the vertical wheel travel [E-OE] 182 by the resistance curve length [E-OE] 184.

As an example calculation for the rear suspension according to Embodiments 1-2, the vertical wheel travel [E-C] 179 may be 30 mm and the angular wheel travel [E-C] 180 may be 21.76 degrees. With a resistance curve length distance 185 of 28 mm, the resistance curve length [E-C] 181 may be calculated as:

The average leverage ratio from the extended state to the compressed state may then be calculated as:

For the over-extension direction in the same example, the vertical wheel travel [E-OE] 182 may be 6.84 mm and the angular wheel travel [E-OE] 183 may be 4.86 degrees. With the same resistance curve length distance 185 of 28 mm, the resistance curve length [E-OE] 184 may be calculated as:

The average leverage ratio from the extended state to the over-extended state may then be calculated as:

The ALR[E-C] value of 2.82 indicates that there is 2.82 times the amount of vertical wheel travel from the extended state to the compressed state compared to the amount of motion in the mechanical resistor as defined by the resistance curve length [E-C] 181. The higher the average leverage ratio, the greater the mechanical advantage on the mechanical resistor and the lower the force that activates the mechanical resistor. The lower the average leverage ratio, the lesser the mechanical advantage on the mechanical resistor and the higher the force that activates the mechanical resistor.

The layout and geometry of the rotary mechanism in the disclosed embodiments provide for desired average leverage ratios of the resistance mechanism relative to the vertical travel of the wheels with respect to the suspended body. When the average leverage ratio is too high, the resistance mechanism may be difficult to design to withstand the forces of riding without bottoming out. When the average leverage ratio is too low, the resistance mechanism may be difficult to design to move through the entire wheel travel range.

In several embodiments, the aperture diameter in which the resistance mechanism is captured is large enough to provide for resistance curve length distances 185 that provide for average leverage ratios that are greater than 1 and less than 7, with a focus on a range between 2-4. The average leverage ratio may also be less than 1 depending upon the damping and/or spring choice selected for the rotary cartridge assembly. The resistance curve length distance 185 corresponds to the radial position of the elastomeric elements, damping valves, air spring chambers, or coil spring elements within the Rotary Cartridge Stator Inner 146 and the Rotary Cartridge Stator Outer 142. Increasing the resistance curve length distance 185 by positioning the resistance elements at a greater radial distance from the rear suspension pivot axis 12 or the front suspension pivot axis 82 results in a longer resistance curve length for a given angular wheel travel, which decreases the average leverage ratio. Decreasing the resistance curve length distance 185 by positioning the resistance elements at a smaller radial distance from the suspension pivot axis results in a shorter resistance curve length for a given angular wheel travel, which increases the average leverage ratio.

In some embodiments, the average leverage ratio may be less than 1, depending upon the damping and/or spring choice selected for the rotary resistance mechanism. An average leverage ratio less than 1 indicates that the resistance curve length is greater than the vertical wheel travel, which may be achieved by positioning the resistance elements at a greater radial distance from the suspension pivot axis or by selecting a suspension geometry with a smaller angular wheel travel relative to the vertical wheel travel.

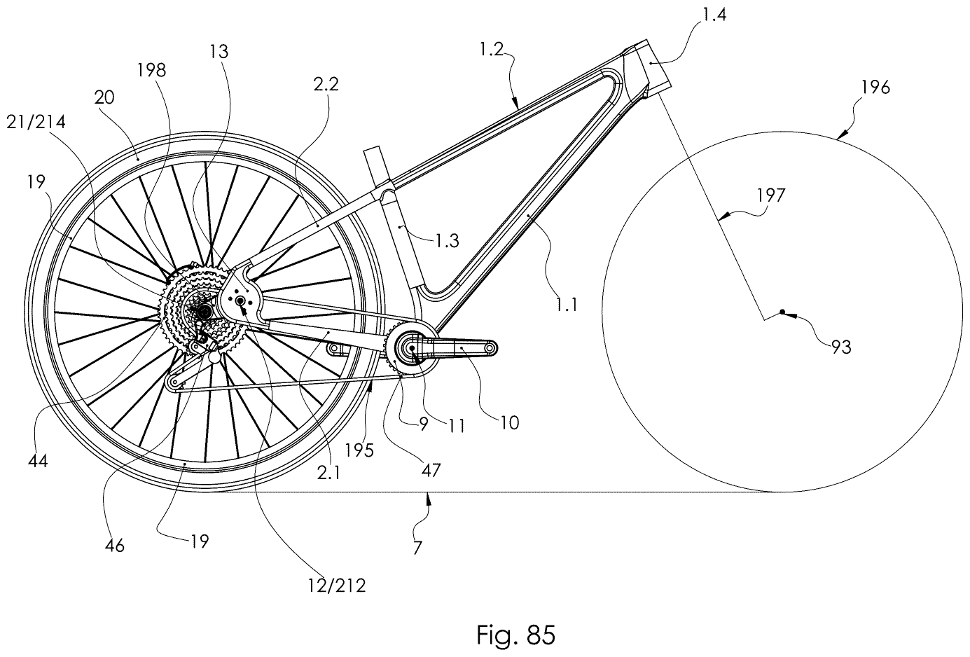

Referring to FIG. 85, a drive-side view of a complete two-wheeled vehicle is shown with embodiment 3 of the disclosed rear rotary suspension system in an extended state. Embodiment 3 illustrates a multi-bar (4-bar in this example) kinematic linkage configuration wherein a wheel carrier is separate from a brake carrier, allowing independent tuning of anti-squat and anti-rise behavior of the two-wheeled vehicle. Note that the figures show a rear suspension system, but the same can be applied to a suspension fork as well which will be discussed as embodiment 4 below. Also note that there are many additional embodiments possible that are not limited to embodiment 3, some of which will be discussed further below.

The two-wheeled vehicle includes the front triangle 1 comprising the down tube 1.1, the top tube 1.2, the seat tube 1.3, the head tube 1.4, and a bottom bracket or drive unit interface or gearbox interface 1.11. The front triangle 1 is rigidly combined with the rear triangle 2 that includes the chainstay 2.1 and the seatstay 2.2. The chainstay 2.1 and the seatstay 2.2 are rigidly connected at the rear suspension pivot structure [Drive] 13 on the drive side. The driving cog 9 is fixed to the crank 10, which is pivotally connected to the bottom bracket or drive unit interface or gearbox interface 1.11 about the crank axis 11.

With continued reference to FIG. 85, a fork schematic 197 and a front tire outer diameter 196 are represented by line diagrams for simplicity and clarity of the figures. The fork schematic 197 provides a simplified representation of the front fork assembly, while the front tire outer diameter 196 indicates the position and size of the front tire without depicting the detailed front suspension components. A rear tire outer diameter 195 is represented as a circular outline indicating the position and size of the rear tire. The rear tire 20 is mounted to the rear rim 19, defining the rear wheel axis [Extended] 21. The rear rim 19 is connected via the wheel spokes 190 to the rear hub 34. The rear driven cassette 44 is operably connected to the rear hub 34 via the rear free hub mechanism 42. The chain/belt 47 connects the driving cog 9 to the rear driven cassette 44 to transfer power from the crank 10 to the rear rim 19 and the rear tire 20. The rear derailleur hanger 45 is mounted to a rear wheel carrier on the drive side, and the rear derailleur 46 is mounted to the rear derailleur hanger 45 to shift the chain/belt 47 among various cogs within the rear driven cassette 44.

As further shown in FIG. 85, the rear tire 20 and the front tire 92 are tangent to the ground [Extended] 7. The rear suspension pivot axis 12 defines the location of a rotary resistance mechanism for the rear suspension system. Embodiment 3 is a planar, constrained, four-bar linkage with four first order revolute joints. The suspension linkage may be a 2-bar, 4-bar, or 6-bar (At least 7 kinematic joints) planar kinematic linkage with first order revolute joints depending upon the suspension design requirements. The kinematic linkage may include binary, ternary, quaternary, or pentanary bodies classified by the number of joints connecting each body within the linkage system.

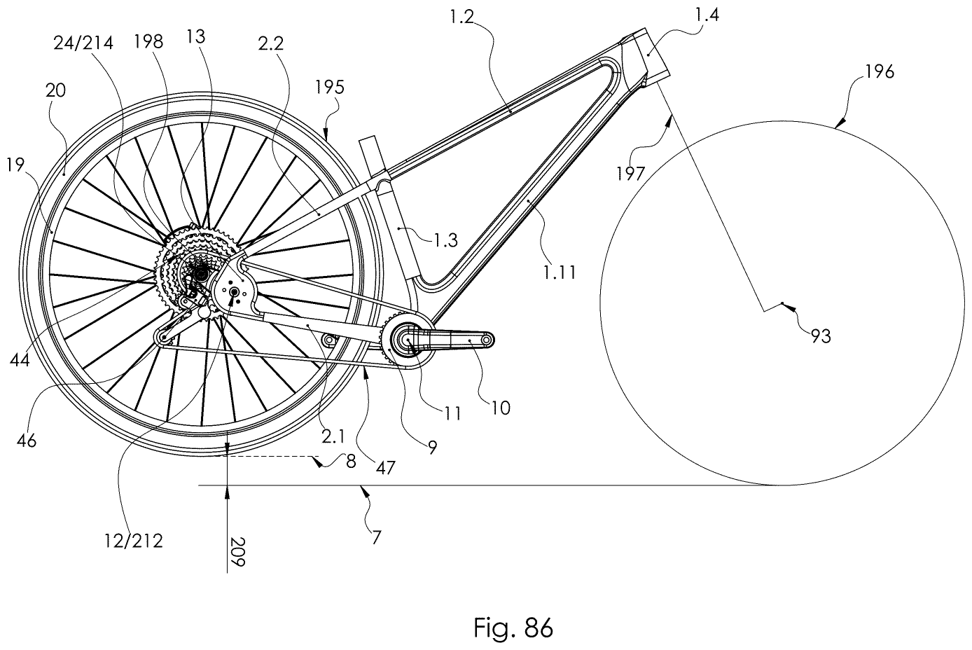

Referring to FIG. 86, a drive-side view of the complete two-wheeled vehicle is shown with embodiment 3 of the disclosed rear rotary suspension system in a compressed state, while the suspended body remains stationary. The fork schematic 197 and the front tire outer diameter 196 are represented by line diagrams for simplicity and clarity of the figures. The rear tire outer diameter 195 is represented as a circular outline indicating the position and size of the rear tire in the compressed state.

The rear wheel axis [Compressed] 24 indicates the position of the rear wheel in the compressed state. The front wheel axis [Extended] 93 is shown so that the rear tire 20 and the front tire 92 are tangent to a horizontal ground [Compressed] 8. A vertical rear wheel travel [Embodiment-3] 209 is the distance between the ground [Extended] 7 and the ground [Compressed] 8, indicating the vertical distance that the rear wheel axis travels as the suspension moves from the extended state to the compressed state while the suspended body remains stationary.

With continued reference to FIG. 86, the four-bar kinematic linkage of embodiment 3 includes a first kinematic body that is the kinematic suspended body, a second kinematic body that is the wheel carrier, a third kinematic body that is the brake carrier, and a fourth kinematic body that is a brake link connecting the brake carrier to the suspended body. The separation of the wheel carrier from the brake carrier allows the DIVC[D] of the brake carrier relative to the suspended body to be positioned independently from the DIVC[A] of the wheel carrier relative to the suspended body. This configuration provides independent tuning of the acceleration response through the wheel carrier geometry and the deceleration response through the brake carrier geometry.

Other possible embodiments not shown in figures include the following:

First the wheel carrier and the brake carrier may be the same body corresponding to a DIVC[A][D], such that it is not directly jointed to the kinematic suspended body. While this does not allow independent positioning of the brake carrier and wheel carrier IVCs, it does allow for a migrating DIVC[AD]. A migrating DIVC[AD] allows for greater tunability of the accelerations response which may increase suspension performance.

Second, the rotary resistance device may be placed at any kinematic joint as noted above. The angular displacement of the bodies associated with this kinematic joint may vary in magnitude and velocity depending upon location. Therefore, it may be advantageous to locate the rotary resistance device(s) in alternate or multiple IVCs to allow for various torque responses and therefore various suspension performance characteristics.

Third, in the case of a suspended fork, please see embodiment 4 below. These are only a few examples of the many possible permutations of layouts depending upon the desired performance characteristics preferred.

The vertical rear wheel travel [Embodiment-3] 209 may be greater than the vertical wheel travel [E-C] 179 described in embodiments 1-2, as the four-bar linkage configuration of embodiment 3 may accommodate larger suspension travel magnitudes while maintaining desired anti-rise characteristics. The rotary resistance mechanism of embodiment 3 resists relative motion between the wheel carrier and the suspended body about the rear suspension pivot axis 12, with the resistance mechanism located on the drive side and the non-drive side of the rear suspension pivot structure.

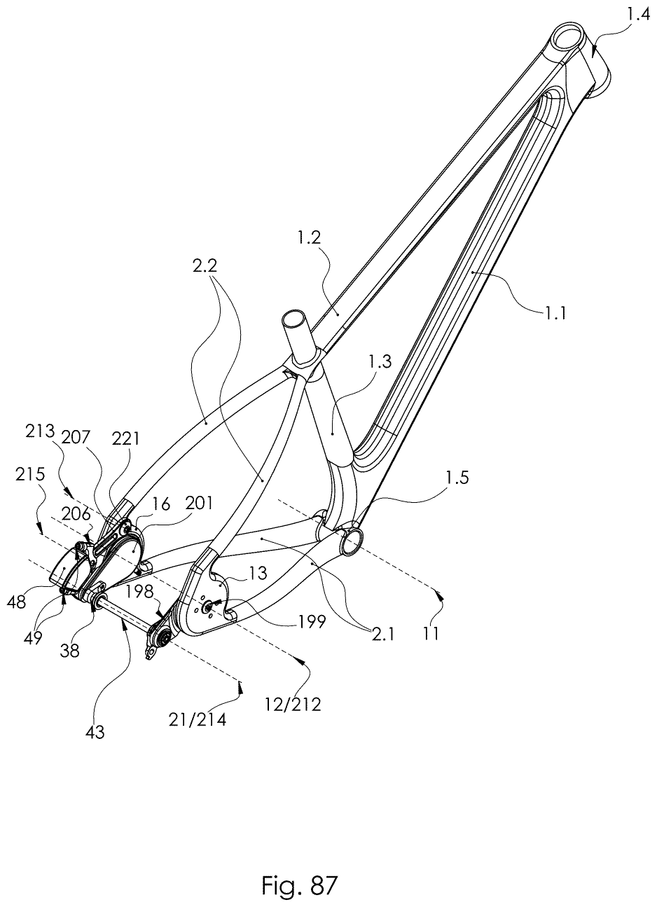

Referring to FIG. 87, an isometric view of the complete two-wheeled vehicle is shown with embodiment 3 of the disclosed rear rotary suspension system in the extended state, with the rear wheel removed for clarity. The isometric perspective reveals the three-dimensional arrangement of the four-bar kinematic linkage components on both the drive side and the non-drive side of the two-wheeled vehicle.

A Rear Wheel Brake Carrier [Non-Drive] [Embodiment-3] 206 is positioned on the non-drive side of the rear suspension system and is configured to support the rear brake caliper 48. A Rear Wheel Brake Link [Non-Drive] [Embodiment-3] 207 connects the Rear Wheel Brake Carrier [Non-Drive] [Embodiment-3] 206 to the suspended body through pivotal connections at opposite ends of the Rear Wheel Brake Link [Non-Drive] [Embodiment-3] 207. The Rear Wheel Brake Carrier [Non-Drive] [Embodiment-3] 206 and the Rear Wheel Brake Link [Non-Drive][Embodiment-3] 207 form part of the brake carrier linkage assembly that allows independent movement of the brake carrier relative to the wheel carrier.

With continued reference to FIG. 87, the four-bar kinematic linkage of embodiment 3 includes physical joints that define instantaneous velocity centers. An IVC[1][4] [Embodiment-3] 213 represents the pivotal connection between the suspended body and the Rear Wheel Brake Link [Non-Drive] [Embodiment-3] 207. An IVC[2][3] [Embodiment-3] 214 represents the pivotal connection between the wheel carrier and the Rear Wheel Brake Carrier [Non-Drive] [Embodiment-3] 206, which is coincident with a rear wheel axis 21/214 in the extended state. An IVC[3][4] [Embodiment-3] 215 represents the pivotal connection between the Rear Wheel Brake Carrier [Non-Drive] [Embodiment-3] 206 and the Rear Wheel Brake Link [Non-Drive] [Embodiment-3] 207.

As further shown in FIG. 87, an IVC[1][4] Fastener [Embodiment-3] 221 secures the pivotal connection at the IVC[1][4] [Embodiment-3] 213. The rear brake caliper 48 is mounted to the Rear Wheel Brake Carrier [Non-Drive] [Embodiment-3] 206 via the rear brake caliper fasteners 49. The rear hub flange interconnect 38 is visible at the center of the rear wheel position, and the rear wheel axle 43 extends through the wheel carrier bodies on both sides of the suspension system. A Rear Wheel Carrier Fastener [Non-Drive] [Embodiment-3] 199 secures the wheel carrier assembly on the non-drive side. A rear suspension pivot axis 12/212 defines the rotational center about which the wheel carrier rotates relative to the suspended body.

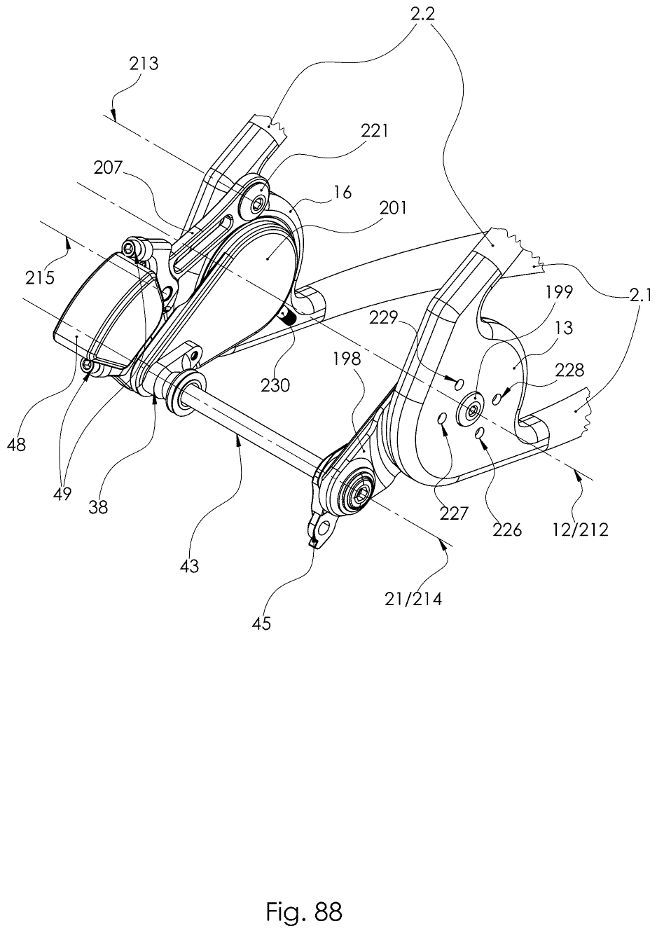

Referring to FIG. 88, a detail view of FIG. 87 is shown focused about the rear wheel axis 21/214 in the extended state. The detail view provides a closer examination of the brake carrier linkage assembly and the damper valve access features positioned on the rear suspension pivot structure.

A Damper Valve Access Feature [Compression][Low Speed] [Embodiment-3] 226 is positioned on the rear suspension pivot structure [Drive] 13 and provides access to a low speed compression damper valve within the rotary damper assembly. A Damper Valve Access Feature [Compression][High Speed] [Embodiment-3] 227 is positioned on the rear suspension pivot structure [Drive] 13 and provides access to a high speed compression damper valve within the rotary damper assembly. A Damper Valve Access Feature [Rebound][Low Speed] [Embodiment-3] 228 is positioned on the rear suspension pivot structure [Drive] 13 and provides access to a low speed rebound damper valve within the rotary damper assembly. A Damper Valve Access Feature [Rebound][High Speed] [Embodiment-3] 229 is positioned on the rear suspension pivot structure [Drive] 13 and provides access to a high speed rebound damper valve within the rotary damper assembly.

With continued reference to FIG. 88, an Air Spring Fill Valve [Embodiment-3] 230 is visible on the non-drive side of the rear suspension system and provides access for adjusting air spring pressure within the rotary spring assembly. The Air Spring Fill Valve [Embodiment-3] 230 allows air to be added or removed to achieve various spring forces depending upon rider weight and desired ride characteristics. The IVC[1][4] [Embodiment-3] 213 and the IVC[3][4] [Embodiment-3] 215 are visible in this detail view, illustrating the pivotal connections of the Rear Wheel Brake Link [Non-Drive] [Embodiment-3] 207 at opposite ends of the brake link body.

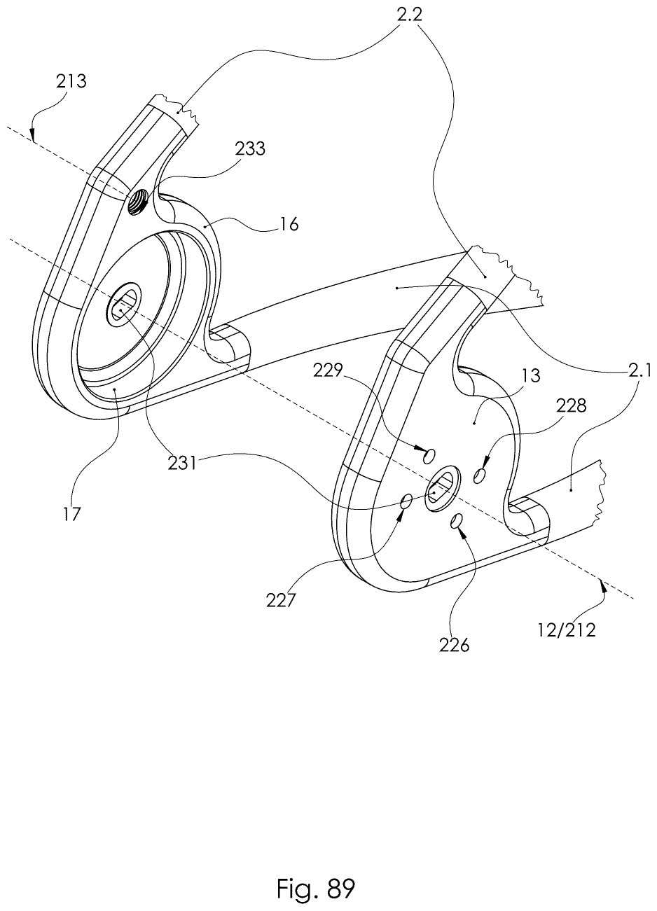

Referring to FIG. 89, a detail view of FIG. 88 is shown isolating the rear triangle 2 to reveal structural features of the rear suspension pivot structure. A Rear Suspension Pivot Structure Key Feature [Embodiment-3] 231 is visible on the rear suspension pivot structure and provides rotational alignment for stator components installed within the suspension pivot aperture. The Rear Suspension Pivot Structure Key Feature [Embodiment-3] 231 engages with corresponding key features on the damper stator and the spring stator to prevent relative rotation between the stator components and the suspended body throughout the suspension travel.

With continued reference to FIG. 89, an IVC[1][4] Fastener Interface [Embodiment-3] 233 is located on the rear suspension pivot structure and receives the IVC[1][4] Fastener [Embodiment-3] 221 to secure the pivotal connection at the IVC[1][4] [Embodiment-3] 213. The Damper Valve Access Feature [Compression][Low Speed] [Embodiment-3] 226, the Damper Valve Access Feature [Compression][High Speed] [Embodiment-3] 227, the Damper Valve Access Feature [Rebound][Low Speed] [Embodiment-3] 228, and the Damper Valve Access Feature [Rebound][High Speed] [Embodiment-3] 229 are positioned on the rear suspension pivot structure [Drive] 13 to allow adjustment of the damper valves from the exterior of the suspension assembly without disassembly of the rotary damper components.

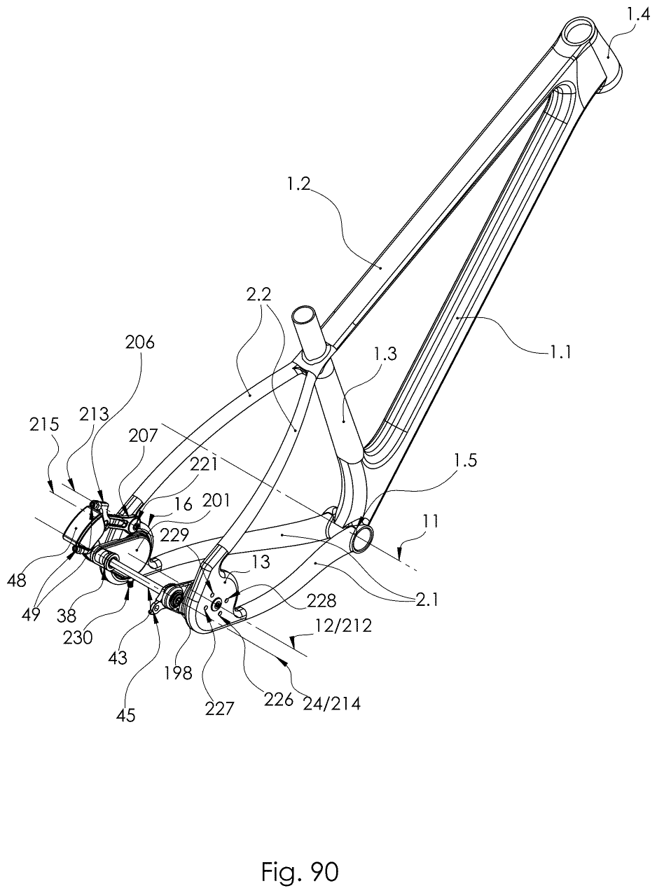

Referring to FIG. 90, an isometric view of the complete two-wheeled vehicle is shown with embodiment 3 of the disclosed rear rotary suspension system in the compressed state, with the rear wheel removed for clarity. The isometric perspective reveals the positions of the brake carrier linkage components when the suspension is in the compressed state.

The Rear Wheel Brake Carrier [Non-Drive] [Embodiment-3] 206 and the Rear Wheel Brake Link [Non-Drive] [Embodiment-3] 207 are shown in their compressed state positions. The IVC[1][4] [Embodiment-3] 213 remains in a fixed position relative to the suspended body as the suspension moves from the extended state to the compressed state, as the IVC[1][4] [Embodiment-3] 213 represents a physical joint attached to the suspended body. The IVC[3][4] [Embodiment-3] 215 moves relative to the suspended body as the Rear Wheel Brake Link [Non-Drive] [Embodiment-3] 207 rotates about the IVC[1][4] [Embodiment-3] 213 during suspension movement.

With continued reference to FIG. 90, a Rear Wheel Carrier [Drive] [Embodiment-3] 198 is visible on the drive side of the rear suspension system and is pivotally connected to the rear suspension pivot structure [Drive] 13 about the rear suspension pivot axis 12/212. A Rear Wheel Carrier [Non-Drive] [Embodiment-3] 201 is visible on the non-drive side of the rear suspension system and is pivotally connected to the rear suspension pivot structure [Non-Drive] 16 about the rear suspension pivot axis 12/212. The Rear Wheel Carrier [Drive] [Embodiment-3] 198 and the Rear Wheel Carrier [Non-Drive] [Embodiment-3] 201 undergo identical kinematic motion about the rear suspension pivot axis 12/212, as both wheel carrier bodies are kinematically equivalent to the second kinematic body of the four-bar linkage.

As further shown in FIG. 90, the rear wheel axis [Compressed] 24/214 indicates the position of the rear wheel axis in the compressed state. The rear hub flange interconnect 38 and the rear wheel axle 43 are visible at the rear wheel axis position. The IVC[1][4] Fastener [Embodiment-3] 221 secures the pivotal connection at the IVC[1][4] [Embodiment-3] 213. The rear brake caliper 48 is mounted to the Rear Wheel Brake Carrier [Non-Drive] [Embodiment-3] 206 via the rear brake caliper fasteners 49.

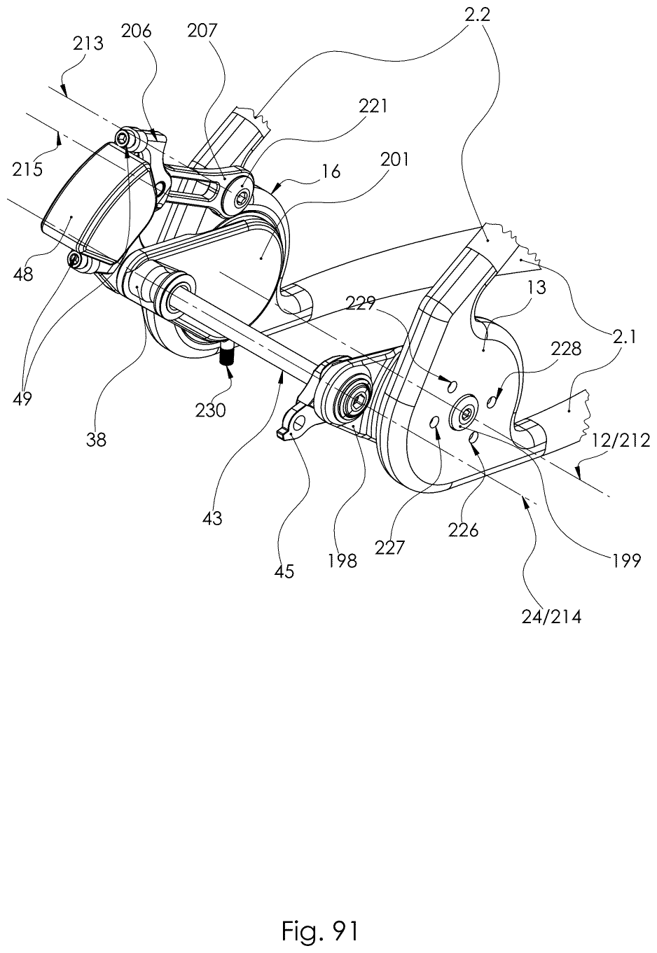

Referring to FIG. 91, a detail view of FIG. 90 is shown focused about the rear wheel axis [Compressed] 24/214 in the compressed state. The detail view provides a closer examination of the brake carrier linkage assembly and the damper valve access features when the suspension is in the compressed state.

The Damper Valve Access Feature [Compression][Low Speed] [Embodiment-3] 226, the Damper Valve Access Feature [Compression][High Speed] [Embodiment-3] 227, the Damper Valve Access Feature [Rebound][Low Speed] [Embodiment-3] 228, and the Damper Valve Access Feature [Rebound][High Speed] [Embodiment-3] 229 remain accessible on the rear suspension pivot structure [Drive] 13 in the compressed state. The damper valve access features allow adjustment of the damper valves at any point within the suspension travel range without requiring the suspension to be positioned in a specific state.

With continued reference to FIG. 91, the Air Spring Fill Valve [Embodiment-3] 230 remains accessible on the non-drive side of the rear suspension system in the compressed state. The Air Spring Fill Valve [Embodiment-3] 230 allows air spring pressure adjustments to be made at any point within the suspension travel range. The Rear Wheel Carrier

[Drive] [Embodiment-3] 198 and the Rear Wheel Carrier [Non-Drive] [Embodiment-3] 201 are shown in their compressed state positions, with the rear wheel axis [Compressed] 24/214 positioned below the rear wheel axis 21/214 in the extended state by the vertical rear wheel travel [Embodiment-3] 209.

The IVC[1][4] [Embodiment-3] 213 and the IVC[3][4] [Embodiment-3] 215 are visible in this detail view, illustrating the positions of the pivotal connections of the Rear Wheel Brake Link [Non-Drive] [Embodiment-3] 207 in the compressed state. The IVC[1][4] Fastener [Embodiment-3] 221 secures the pivotal connection at the IVC[1][4] [Embodiment-3] 213. The rear brake caliper 48 is mounted to the Rear Wheel Brake Carrier [Non-Drive] [Embodiment-3] 206, with the brake caliper position determined by the positions of the IVC[2][3] [Embodiment-3] 214 and the IVC[3][4] [Embodiment-3] 215 in the compressed state.

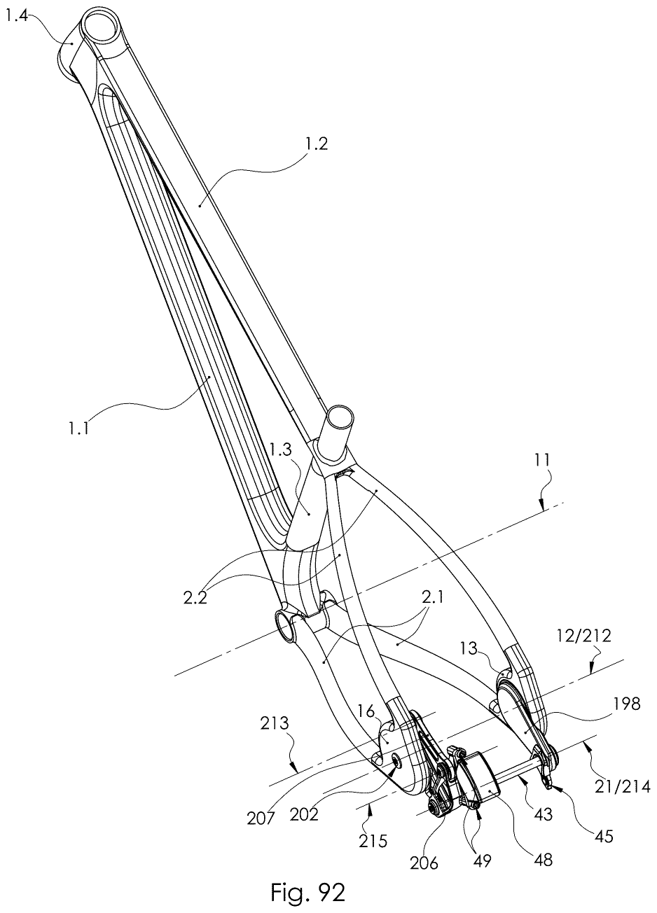

Referring to FIG. 92, an alternate isometric view of the complete two-wheeled vehicle is shown with embodiment 3 of the disclosed rear rotary suspension system in the extended state, with the rear wheel removed for clarity. The alternate isometric perspective provides visibility of the rear suspension components from a different viewing angle compared to FIG. 87, revealing additional details of the brake carrier linkage assembly and the rear suspension pivot structures on both the drive side and the non-drive side of the two-wheeled vehicle.

The rear triangle structure including the chainstay and the seatstay is visible in this alternate isometric view, with the rear suspension pivot structures positioned at the intersection of the chainstay and the seatstay. The rear wheel carrier on the drive side and the rear wheel carrier on the non-drive side are shown in their extended state positions, pivotally connected to their respective rear suspension pivot structures about the rear suspension pivot axis. The rear derailleur hanger is mounted to the rear wheel carrier on the drive side, and the rear wheel axle extends through the wheel carrier bodies on both sides of the suspension system.

With continued reference to FIG. 92, the brake carrier linkage assembly is visible on the non-drive side of the rear suspension system. The rear wheel brake carrier and the rear wheel brake link are shown in their extended state positions, with the pivotal connections at opposite ends of the rear wheel brake link visible from this alternate viewing angle. The rear brake caliper is mounted to the rear wheel brake carrier via the rear brake caliper fasteners. The pivotal connection between the suspended body and the rear wheel brake link remains in a fixed position relative to the suspended body, while the pivotal connection between the rear wheel brake carrier and the rear wheel brake link moves relative to the suspended body as the suspension travels through the travel range.

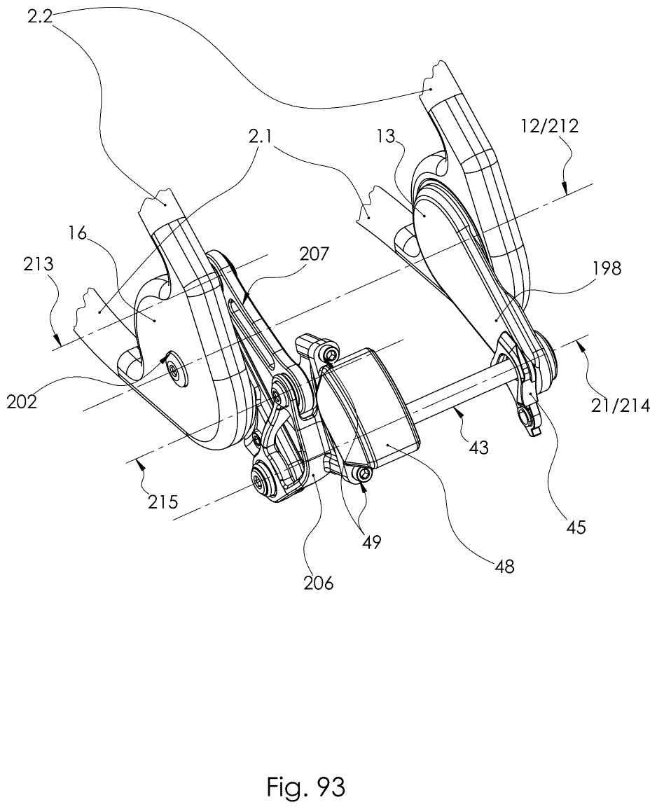

Referring to FIG. 93, a detail view of FIG. 92 is shown focused about the rear wheel axis in the extended state. The detail view provides a closer examination of the rear suspension components from the alternate isometric viewing angle, revealing the spatial relationships between the wheel carrier bodies, the brake carrier linkage assembly, and the rear suspension pivot structures.

The rear suspension pivot structure on the drive side and the rear suspension pivot structure on the non-drive side are visible in this detail view, positioned at the intersection of the chainstay and the seatstay. The rear wheel carrier on the drive side is pivotally connected to the rear suspension pivot structure on the drive side, and the rear wheel carrier on the non-drive side is pivotally connected to the rear suspension pivot structure on the non-drive side. The rear hub flange interconnect and the rear wheel axle are visible at the rear wheel axis position, providing structural connection between the wheel carrier bodies on opposite sides of the suspension system.

With continued reference to FIG. 93, the brake carrier linkage assembly components are visible from this alternate viewing angle. The rear wheel brake carrier is positioned on the non-drive side of the rear suspension system, with the rear brake caliper mounted to the rear wheel brake carrier. The rear wheel brake link connects the rear wheel brake carrier to the suspended body through pivotal connections at opposite ends of the rear wheel brake link. The pivotal connection between the suspended body and the rear wheel brake link is secured by a fastener that extends through the pivotal connection interface on the rear suspension pivot structure.

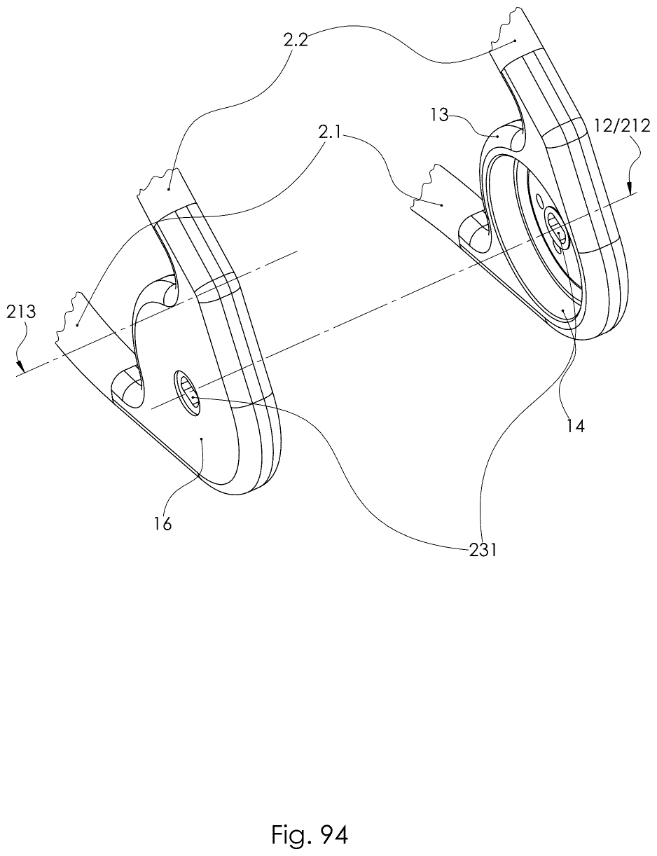

Referring to FIG. 94, a detail view of FIG. 93 is shown isolating the rear triangle to reveal structural features of the rear suspension pivot structures. The detail view provides visibility of the rear suspension pivot structure key feature, which provides rotational alignment for stator components installed within the suspension pivot apertures on both the drive side and the non-drive side of the rear suspension system.

The rear suspension pivot structure key feature is visible on the rear suspension pivot structure and is configured to engage with corresponding key features on the damper stator and the spring stator. The engagement between the rear suspension pivot structure key feature and the stator key features prevents relative rotation between the stator components and the suspended body throughout the suspension travel. The rear suspension pivot aperture on the non-drive side is visible in this detail view, with the aperture configured to receive the spring assembly module.

With continued reference to FIG. 94, the rear suspension pivot structure on the drive side includes a bore feature that receives the damper assembly module. The bore feature on the drive side may be a blind bore configuration where the bore does not extend completely through the rear suspension pivot structure, or the bore feature may be a through bore configuration where the bore extends completely through the rear suspension pivot structure. The blind bore configuration may eliminate the need for separate stator fasteners since the stator may be integrated into the rear suspension pivot structure. The through bore configuration may allow for separate stator components to be fastened to the rear suspension pivot structure via fastener interfaces positioned on the rear suspension pivot structure.

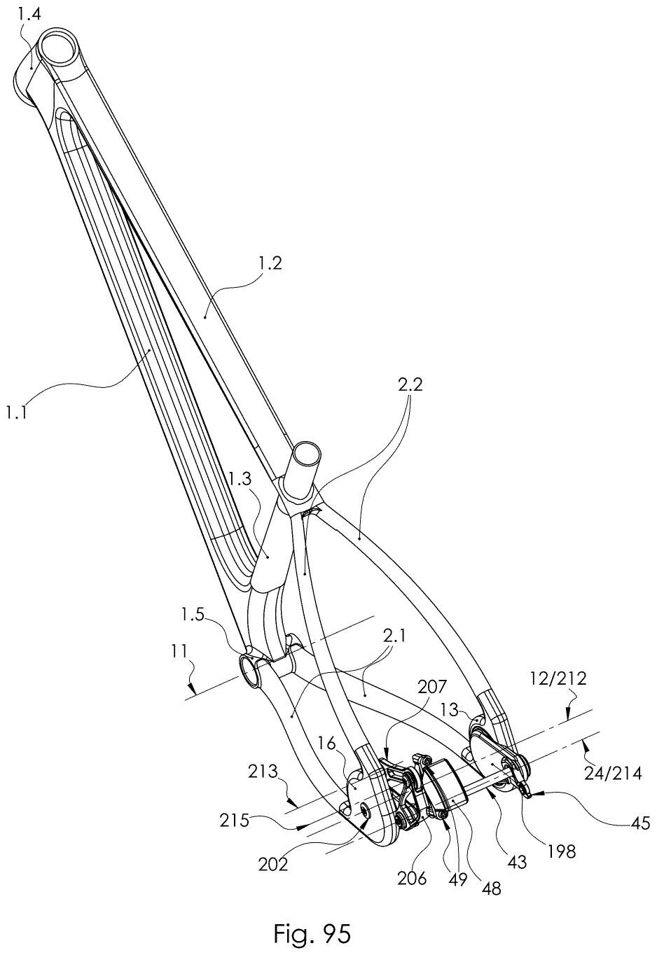

Referring to FIG. 95, an alternate isometric view of the complete two-wheeled vehicle is shown with embodiment 3 of the disclosed rear rotary suspension system in the compressed state, with the rear wheel removed for clarity. The alternate isometric perspective provides visibility of the rear suspension components from a different viewing angle when the suspension is in the compressed state, revealing the positions of the brake carrier linkage assembly and the wheel carrier bodies in the compressed configuration.

The rear wheel carrier on the drive side and the rear wheel carrier on the non-drive side are shown in their compressed state positions, pivotally connected to their respective rear suspension pivot structures about the rear suspension pivot axis. The rear wheel axis in the compressed state is positioned below the rear wheel axis in the extended state by the vertical rear wheel travel distance. The rear derailleur hanger is mounted to the rear wheel carrier on the drive side, and the rear wheel axle extends through the wheel carrier bodies on both sides of the suspension system.

With continued reference to FIG. 95, the brake carrier linkage assembly is visible on the non-drive side of the rear suspension system in the compressed state. The rear wheel brake carrier and the rear wheel brake link are shown in their compressed state positions, with the pivotal connections at opposite ends of the rear wheel brake link visible from this alternate viewing angle. The pivotal connection between the suspended body and the rear wheel brake link remains in a fixed position relative to the suspended body in the compressed state, as this pivotal connection represents a physical joint attached to the suspended body. The pivotal connection between the rear wheel brake carrier and the rear wheel brake link has moved relative to the suspended body as the rear wheel brake link has rotated about the pivotal connection between the suspended body and the rear wheel brake link during suspension movement from the extended state to the compressed state.

As further shown in FIG. 95, the rear wheel carrier fastener on the non-drive side secures the wheel carrier assembly on the non-drive side. The rear brake caliper is mounted to the rear wheel brake carrier via the rear brake caliper fasteners, with the brake caliper position in the compressed state determined by the positions of the pivotal connections of the brake carrier linkage assembly. The pivotal connection between the wheel carrier and the rear wheel brake carrier is coincident with the rear wheel axis, such that the rear wheel brake carrier rotates about the rear wheel axis relative to the wheel carrier as the suspension moves through the travel range.

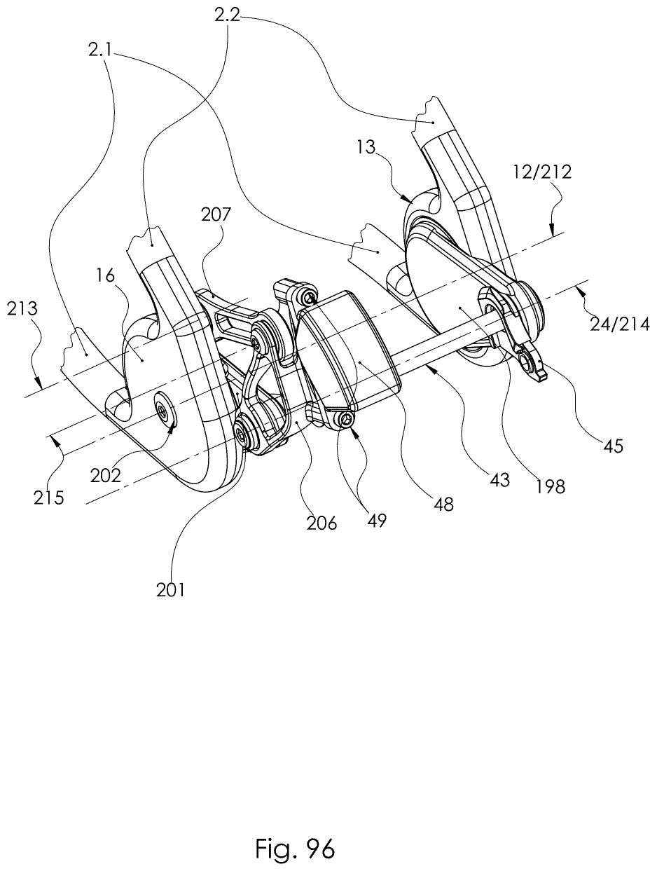

Referring to FIG. 96, a detail view of FIG. 95 is shown isolating the rear triangle to reveal structural features of the rear suspension pivot structures in the compressed state. The detail view provides visibility of the rear suspension pivot structure key feature when the suspension is in the compressed state, illustrating that the key feature maintains rotational alignment for the stator components throughout the suspension travel range.

The rear suspension pivot structure key feature is visible on the rear suspension pivot structure in the compressed state configuration. The rear suspension pivot structure key feature engages with corresponding key features on the damper stator and the spring stator to prevent relative rotation between the stator components and the suspended body regardless of the suspension position within the travel range. The engagement between the rear suspension pivot structure key feature and the stator key features maintains consistent alignment of the damper valves and the air spring chambers relative to the suspended body as the wheel carrier rotates about the rear suspension pivot axis during suspension movement.

With continued reference to FIG. 96, the chainstay and the seatstay are visible in this detail view, converging at the rear suspension pivot structures on both the drive side and the non-drive side. The rear suspension pivot structure on the drive side houses the damper assembly module, while the rear suspension pivot structure on the non-drive side houses the spring assembly module. The modular configuration of the damper assembly and the spring assembly allows these sub-assemblies to be built separately from the rest of the vehicle and then installed as modules into the rear suspension pivot structures. Various different modules may be exchanged within the vehicle frame to offer different riding experiences, with module sets providing different distances from the rear suspension pivot axis to the rear wheel axis, different suspension travel amounts, or different spring rate and damping properties.

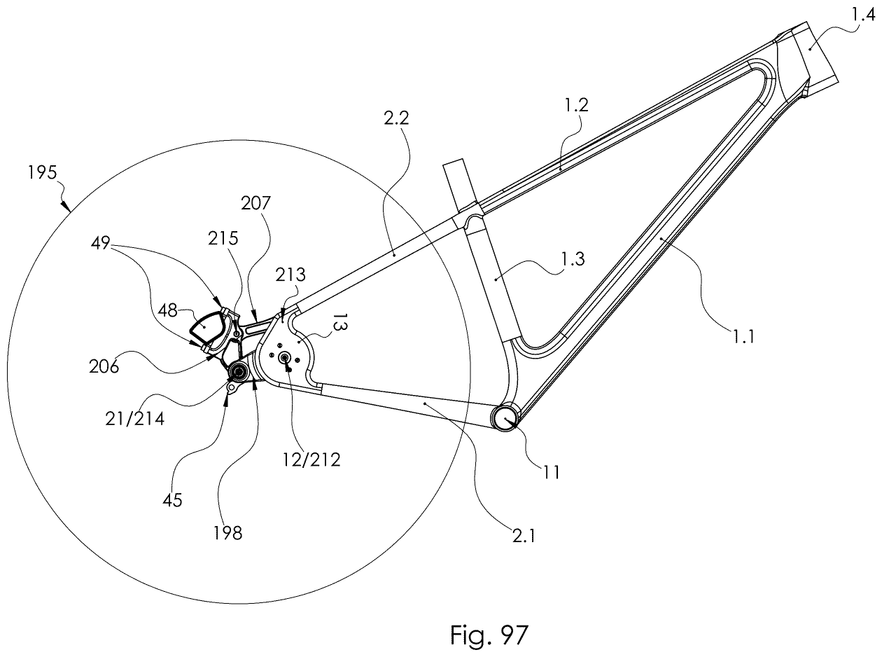

Referring to FIG. 97, a drive-side view of the complete two-wheeled vehicle is shown with embodiment 3 of the disclosed rear rotary suspension system in the extended state, with the rear wheel removed for clarity. The rear tire outer diameter 195 is shown as a circular outline indicating the position and size of the rear tire. The drive-side view provides visibility of the rear suspension components and the geometric relationships between the wheel carrier, the suspension pivot structures, and the brake carrier linkage assembly.

The Rear Wheel Carrier [Drive] [Embodiment-3] 198 is pivotally connected to the rear suspension pivot structure [Drive] 13 about the rear suspension pivot axis 12/212. A DIVC[A][1][2] [Embodiment-3] 212 represents the dynamic instantaneous velocity center of the wheel carrier relative to the suspended body, which is coincident with the rear suspension pivot axis 12/212. The DIVC[A][1][2] [Embodiment-3] 212 defines the acceleration response of the two-wheeled vehicle, as the wheel carrier rotates about this instantaneous velocity center during suspension movement.

With continued reference to FIG. 97, the IVC[2][3] [Embodiment-3] 214 is coincident with the rear wheel axis 21/214 in the extended state, representing the pivotal connection between the wheel carrier and the Rear Wheel Brake Carrier [Non-Drive][Embodiment-3] 206. The IVC[1][4] [Embodiment-3] 213 and the IVC[3][4] [Embodiment-3] 215 are visible on the brake carrier linkage assembly, defining the pivotal connections of the Rear Wheel Brake Link [Non-Drive] [Embodiment-3] 207 at opposite ends of the brake link body.

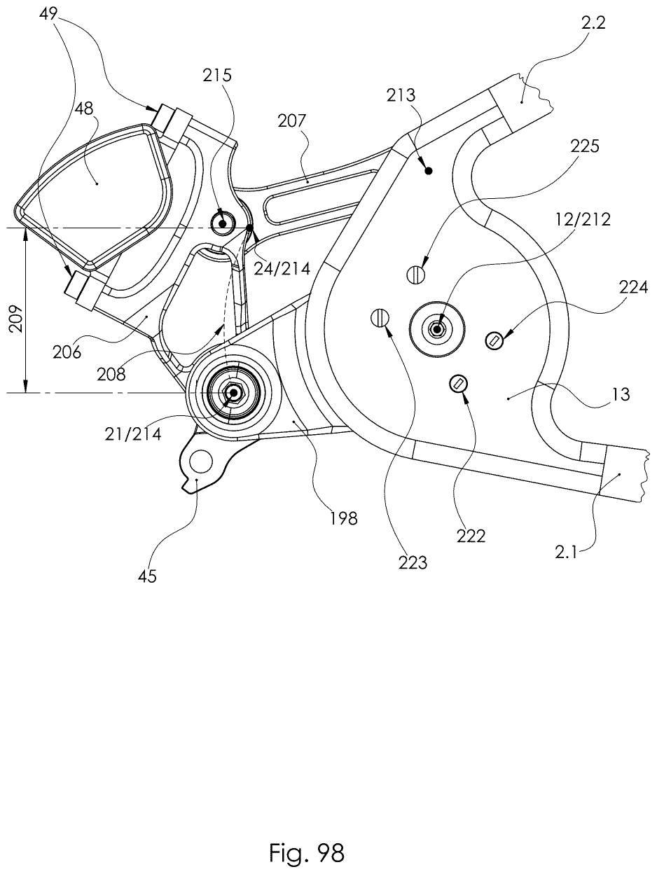

Referring to FIG. 98, a detail view of FIG. 97 is shown focused about the rear wheel axis 21/214 in the extended state. The detail view provides a closer examination of the damper valve components and the rear wheel axle path within the rear suspension system.

A Rear Wheel Axle Path [Embodiment-3] 208 illustrates the arc along which the rear wheel axis travels during suspension movement from the extended state to the compressed state. The Rear Wheel Axle Path [Embodiment-3] 208 is defined by the rotation of the Rear Wheel Carrier [Drive] [Embodiment-3] 198 about the rear suspension pivot axis 12/212. A vertical rear wheel travel [Embodiment-3] 209 indicates the vertical distance of wheel movement throughout the suspension travel range, measured as the vertical component of the Rear Wheel Axle Path [Embodiment-3] 208 from the extended state to the compressed state.

With continued reference to FIG. 98, a Damper Valve [Compression][Low Speed] [Embodiment-3] 222 is visible through the Damper Valve Access Feature [Compression][Low Speed] [Embodiment-3] 226 on the rear suspension pivot structure [Drive] 13. A Damper Valve [Compression][High Speed] [Embodiment-3] 223 is visible through the Damper Valve Access Feature [Compression][High Speed] [Embodiment-3] 227 on the rear suspension pivot structure [Drive] 13. A Damper Valve [Rebound][Low Speed] [Embodiment-3] 224 is visible through the Damper Valve Access Feature [Rebound][Low Speed] [Embodiment-3] 228 on the rear suspension pivot structure [Drive] 13. A Damper Valve [Rebound][High Speed] [Embodiment-3] 225 is visible through the Damper Valve Access Feature [Rebound][High Speed] [Embodiment-3] 229 on the rear suspension pivot structure [Drive] 13.

The Damper Valve [Compression][Low Speed] [Embodiment-3] 222 and the Damper Valve [Compression][High Speed] [Embodiment-3] 223 are sub-assemblies that control the flow of damper fluid within the damper mechanism in the compression direction, which is the direction from the extended state to the compressed state. The Damper Valve [Rebound][Low Speed] [Embodiment-3] 224 and the Damper Valve [Rebound][High Speed] [Embodiment-3] 225 are sub-assemblies that control the flow of damper fluid within the damper mechanism in the rebound direction, which is the direction from the compressed state to the extended state. The low speed valves provide damping resistance at low velocities of suspension movement, while the high speed valves provide damping resistance at higher velocities of suspension movement.

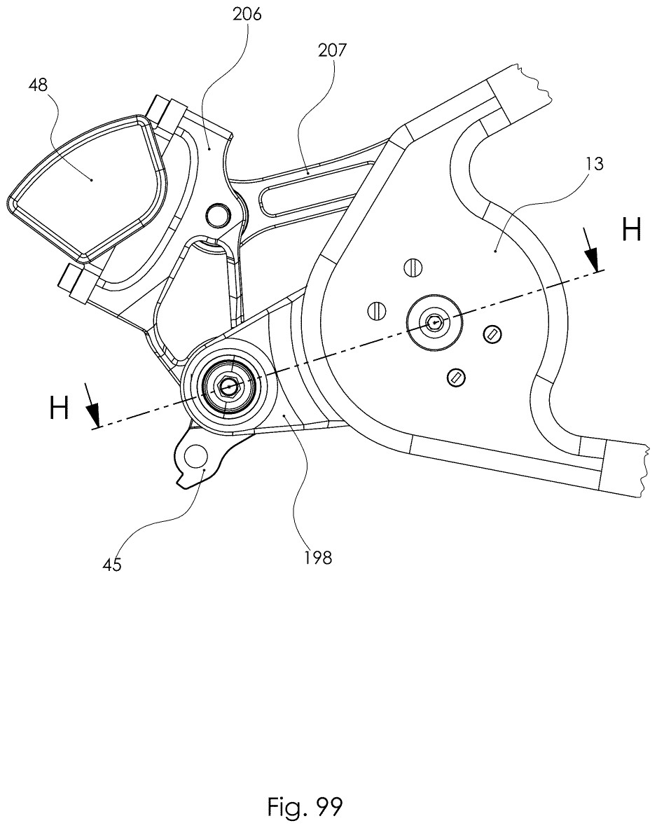

Referring to FIG. 99, a section line H-H is shown via a cropped drive-side view of embodiment 3 of the disclosed rear rotary suspension system. The section line H-H extends through the rear suspension pivot axis 12/212 and provides a reference for examining the internal arrangement of the damper assembly and the spring assembly installed within the rear suspension pivot structures on the drive side and the non-drive side of the two-wheeled vehicle.

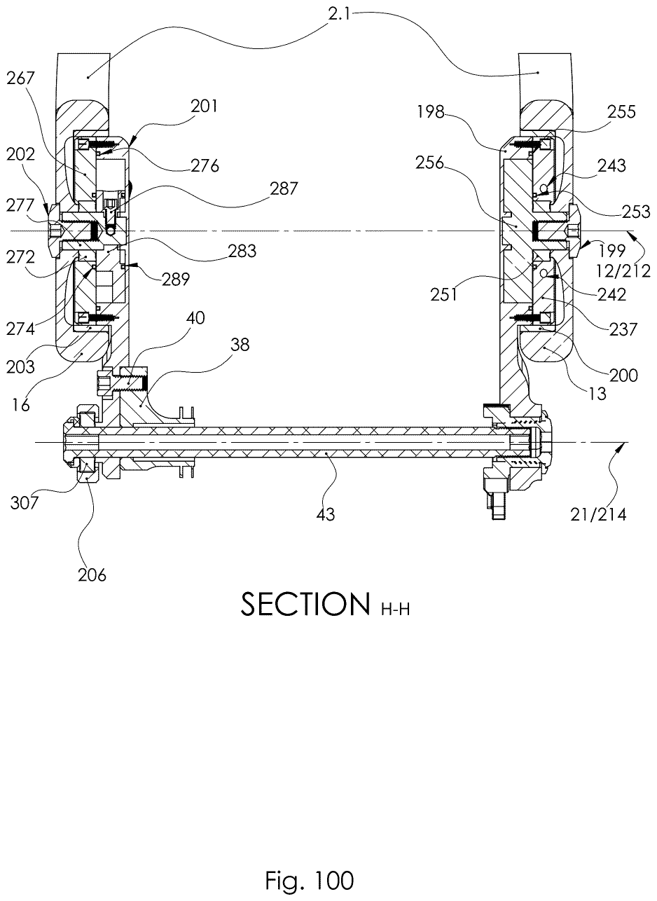

Referring to FIG. 100, a section view H-H is shown depicting both the damper assembly and the spring assembly installed into the suspended body. The section view reveals the internal arrangement of the rotary resistance mechanism components within the rear suspension pivot structures on both the drive side and the non-drive side of the rear suspension system.

On the drive side, a Rear Wheel Carrier Bushing [Drive] [Embodiment-3] 200 is installed into the rear suspension pivot structure [Drive] 13 to receive the Rear Wheel Carrier [Drive] [Embodiment-3] 198 and reduce rotational friction between the Rear Wheel Carrier [Drive] [Embodiment-3] 198 and the rear suspension pivot structure [Drive] 13. A Damper Cap [Embodiment-3] 237 is positioned at the outer portion of the damper assembly and provides a closure for the damper mechanism. A Damper Cap Port [Compression] [Embodiment-3] 242 is located on the Damper Cap [Embodiment-3] 237 and connects the high speed and low speed compression valves. A Damper Cap Port [Rebound] [Embodiment-3] 243 is located on the Damper Cap [Embodiment-3] 237 and connects the high speed and low speed rebound valves.

With continued reference to FIG. 100, a Damper Cap Bearing [Embodiment-3] 251 is installed within the Damper Cap [Embodiment-3] 237 to facilitate rotational movement between the Damper Cap [Embodiment-3] 237 and the wheel carrier components while reducing friction. A Damper Cap Bearing Seal [Embodiment-3] 253 provides sealing at the bearing interface to maintain fluid containment within the damper assembly. A Damper Main Seal [Rear Wheel Carrier] [Embodiment-3] 255 interfaces with the Rear Wheel Carrier [Drive] [Embodiment-3] 198 to maintain fluid separation between the damper chambers and the exterior of the damper assembly. A Damper Stator [Embodiment-3] 256 is positioned within the damper assembly and remains stationary relative to the suspended body throughout the suspension travel.

As further shown in FIG. 100, on the non-drive side, a Spring Cap [Embodiment-3] 267 is positioned at the outer portion of the spring assembly and provides a closure for the spring mechanism. A Spring Cap Bearing [Embodiment-3] 272 is installed within the Spring Cap [Embodiment-3] 267 to facilitate rotational movement between the Spring Cap [Embodiment-3] 267 and the wheel carrier components while reducing friction. A Spring Cap Bearing Seal [Embodiment-3] 274 provides sealing at the bearing interface to maintain pressure containment within the spring assembly. A Spring Main Seal [Rear Wheel Carrier] [Embodiment-3] 276 interfaces with the Rear Wheel Carrier [Non-Drive] [Embodiment-3] 201 to maintain pressure separation between the spring chambers and the exterior of the spring assembly. A Spring Stator [Embodiment-3] 277 is positioned within the spring assembly and remains stationary relative to the suspended body throughout the suspension travel.

An IVC[2][3] Bearing 307 is positioned at the rear wheel axis 21/214 and supports the pivotal connection between the wheel carrier and the Rear Wheel Brake Carrier [Non-Drive] [Embodiment-3] 206. The IVC[2][3] Bearing 307 reduces rotational friction at the pivotal connection as the Rear Wheel Brake Carrier [Non-Drive] [Embodiment-3] 206 rotates about the rear wheel axis 21/214 relative to the wheel carrier during suspension movement.

The spring and damper components are stand-alone sub-assemblies that may be built separately from the rest of the vehicle and then installed as modules into the rear suspension pivot structures. The modular configuration aids in manufacturability and assembly optimization since the damper assembly and the spring assembly may be assembled and tested as separate modules before installation into the vehicle frame. The suspended body, which includes the front triangle 1 and the rear triangle 2, may be made of composite material. When the suspended body is made of composite material, the Damper Stator [Embodiment-3] 256 and the Spring Stator [Embodiment-3] 277 may be integrated into the rear suspension pivot structures, eliminating the need for an alloy rear stator and further reducing weight of the two-wheeled vehicle.

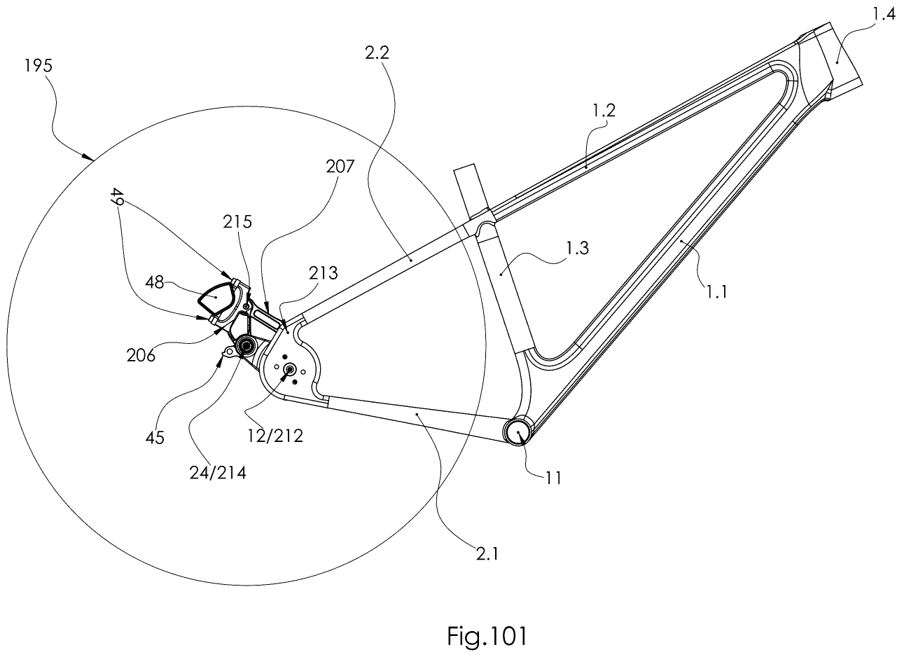

Referring to FIG. 101, a drive-side view of the complete two-wheeled vehicle is shown with embodiment 3 of the disclosed rear rotary suspension system in the compressed state, with the rear wheel removed for clarity. The rear tire outer diameter 195 is shown as a circular outline indicating the position and size of the rear tire in the compressed state. The rear wheel axis [Compressed] 24/214 indicates the position of the rear wheel axis when the suspension is in the compressed state.

The Rear Wheel Carrier [Drive] [Embodiment-3] 198 is shown in the compressed state position, pivotally connected to the rear suspension pivot structure [Drive] 13 about the rear suspension pivot axis 12/212. The Rear Wheel Brake Carrier [Non-Drive] [Embodiment-3] 206 and the Rear Wheel Brake Link [Non-Drive] [Embodiment-3] 207 are shown in their compressed state positions on the non-drive side of the rear suspension system. The rear brake caliper 48 is mounted to the Rear Wheel Brake Carrier [Non-Drive] [Embodiment-3] 206 via the rear brake caliper fasteners 49.

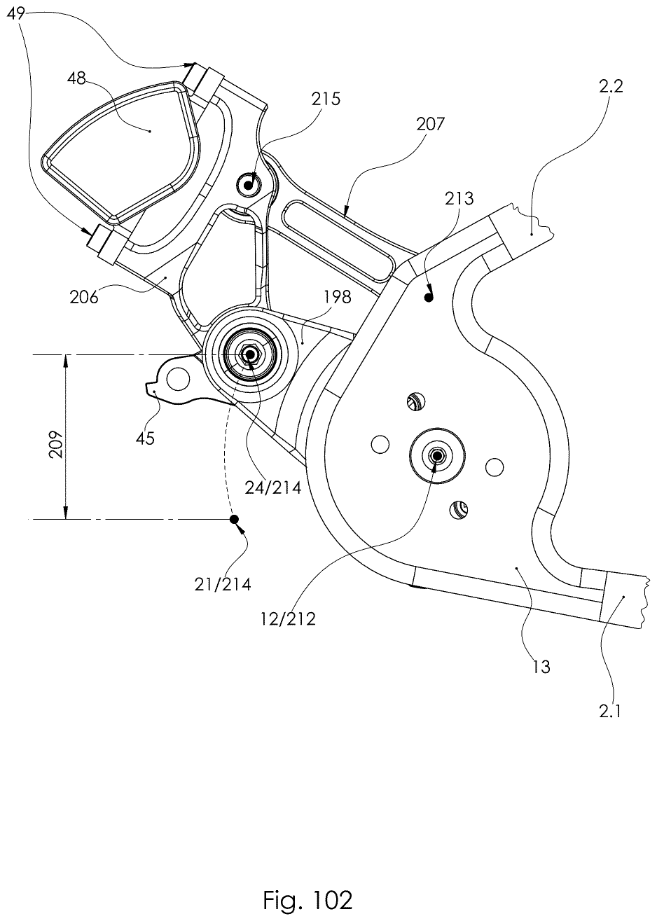

Referring to FIG. 102, a detail view of FIG. 101 is shown focused about the rear wheel axis [Compressed] 24/214 in the compressed state. The detail view provides a closer examination of the rear suspension components and the geometric relationships when the suspension is in the compressed state.

The Rear Wheel Axle Path [Embodiment-3] 208 illustrates the arc along which the rear wheel axis has traveled from the extended state to the compressed state. The vertical rear wheel travel [Embodiment-3] 209 indicates the vertical distance of wheel movement from the extended state to the compressed state, measured as the vertical component of the Rear Wheel Axle Path [Embodiment-3] 208. The IVC[1][4] [Embodiment-3] 213 remains in a fixed position relative to the suspended body in the compressed state, as the IVC[1][4] [Embodiment-3] 213 represents a physical joint attached to the suspended body. The IVC[3][4] [Embodiment-3] 215 has moved relative to the suspended body as the Rear Wheel Brake Link [Non-Drive] [Embodiment-3] 207 has rotated about the IVC[1][4] [Embodiment-3] 213 during suspension movement from the extended state to the compressed state.

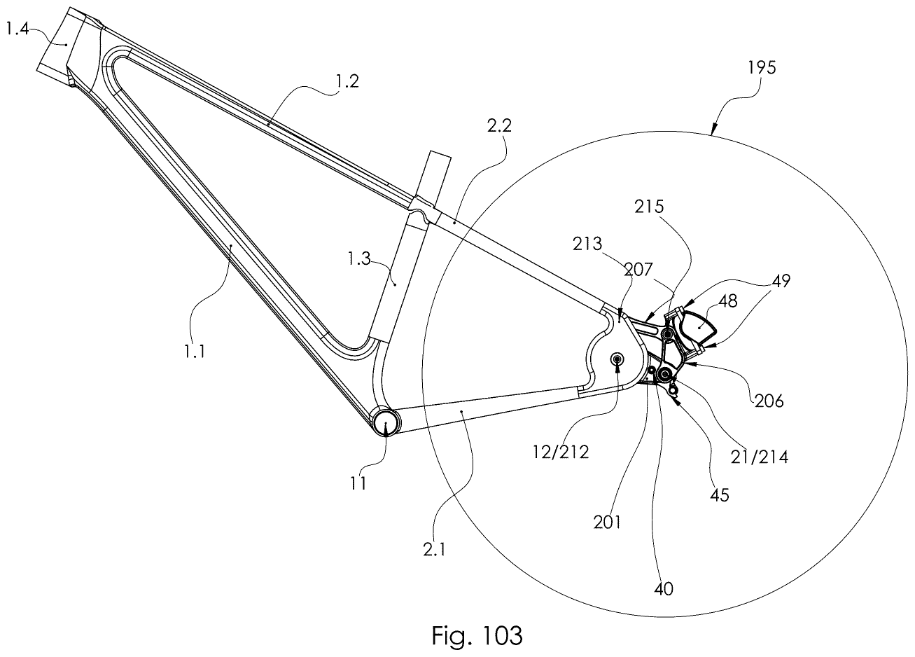

Referring to FIG. 103, a non-drive-side view of the complete two-wheeled vehicle is shown with embodiment 3 of the disclosed rear rotary suspension system in the extended state, with the rear wheel removed for clarity. The non-drive-side perspective provides direct visibility of the brake carrier linkage assembly components, which are positioned on the non-drive side of the rear suspension system.

The Rear Wheel Brake Carrier [Non-Drive] [Embodiment-3] 206 is visible in the extended state position, with the rear brake caliper 48 mounted to the Rear Wheel Brake Carrier [Non-Drive] [Embodiment-3] 206. The Rear Wheel Brake Link [Non-Drive] [Embodiment-3] 207 connects the Rear Wheel Brake Carrier [Non-Drive] [Embodiment-3] 206 to the suspended body through pivotal connections at opposite ends of the Rear Wheel Brake Link [Non-Drive] [Embodiment-3] 207. The IVC[1][4] [Embodiment-3] 213 represents the pivotal connection between the suspended body and the Rear Wheel Brake Link [Non-Drive] [Embodiment-3] 207, while the IVC[3][4] [Embodiment-3] 215 represents the pivotal connection between the Rear Wheel Brake Carrier [Non-Drive] [Embodiment-3] 206 and the Rear Wheel Brake Link [Non-Drive] [Embodiment-3] 207.

With continued reference to FIG. 103, the Rear Wheel Carrier [Non-Drive] [Embodiment-3] 201 is visible in the extended state position, pivotally connected to the rear suspension pivot structure [Non-Drive] 16 about the rear suspension pivot axis 12/212. The rear hub flange interconnect 38 is visible at the rear wheel axis position, and the rear hub flange interconnect fastener 40 secures the hub flange interconnect to the wheel carrier structure. A Rear Wheel Carrier Fastener [Non-Drive] [Embodiment-3] 202 secures the Rear Wheel Carrier [Non-Drive] [Embodiment-3] 201 to the rear suspension pivot structure [Non-Drive] 16. The rear tire outer diameter 195 is shown as a circular outline indicating the position and size of the rear tire in the extended state.

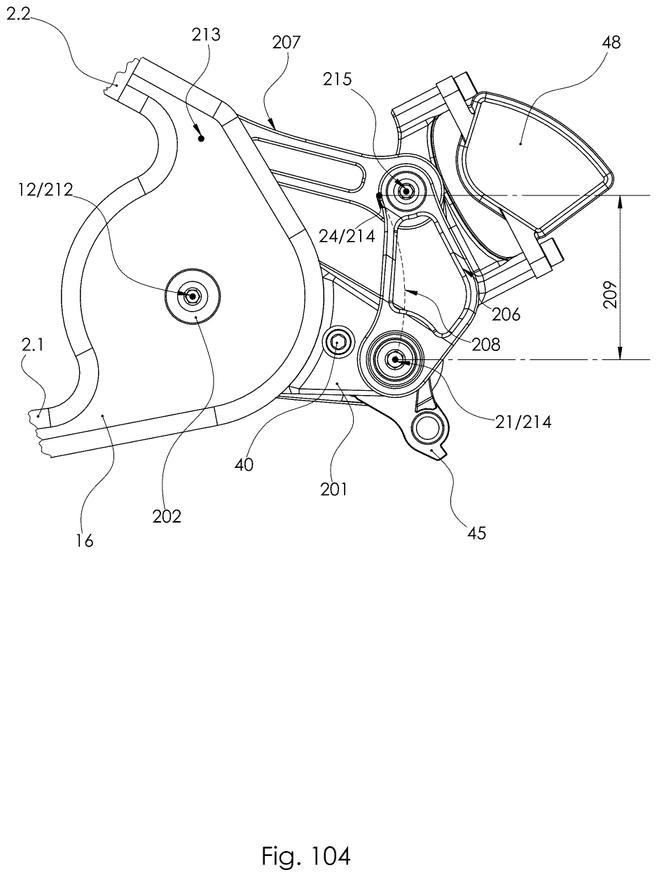

Referring to FIG. 104, a detail view of FIG. 103 is shown focused about the rear wheel axis 21/214 in the extended state. The detail view provides a closer examination of the brake carrier linkage assembly from the non-drive-side perspective, revealing the spatial relationships between the Rear Wheel Brake Carrier [Non-Drive] [Embodiment-3] 206, the Rear Wheel Brake Link [Non-Drive] [Embodiment-3] 207, and the Rear Wheel Carrier [Non-Drive] [Embodiment-3] 201.

The Rear Wheel Axle Path [Embodiment-3] 208 illustrates the arc along which the rear wheel axis travels during suspension movement from the extended state to the compressed state. A vertical rear wheel travel [Embodiment-3] 209 indicates the vertical distance of wheel movement throughout the suspension travel range, measured as the vertical component of the Rear Wheel Axle Path [Embodiment-3] 208 from the extended state to the compressed state.

With continued reference to FIG. 104, the IVC[1][4] [Embodiment-3] 213 is visible at the pivotal connection between the suspended body and the Rear Wheel Brake Link [Non-Drive] [Embodiment-3] 207. The IVC[3][4] [Embodiment-3] 215 is visible at the pivotal connection between the Rear Wheel Brake Carrier [Non-Drive] [Embodiment-3] 206 and the Rear Wheel Brake Link [Non-Drive] [Embodiment-3] 207. The rear brake caliper 48 is mounted to the Rear Wheel Brake Carrier [Non-Drive] [Embodiment-3] 206, with the brake caliper position in the extended state determined by the positions of the IVC[2][3] [Embodiment-3] 214 and the IVC[3][4] [Embodiment-3] 215. The rear derailleur hanger 45 is visible on the drive side of the rear suspension system, extending from the Rear Wheel Carrier [Drive] [Embodiment-3] 198.

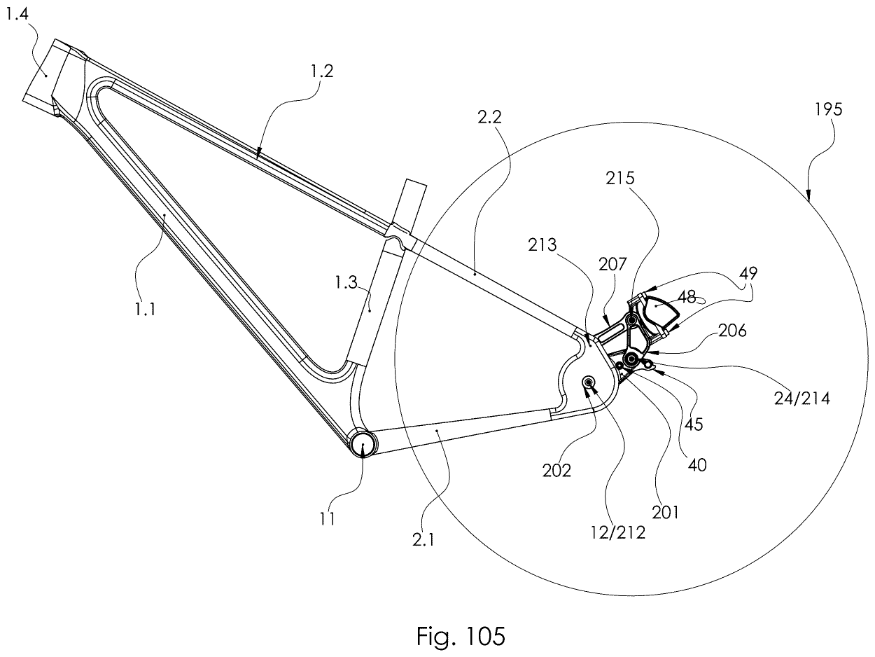

Referring to FIG. 105, a non-drive-side view of the complete two-wheeled vehicle is shown with embodiment 3 of the disclosed rear rotary suspension system in the compressed state, with the rear wheel removed for clarity. The non-drive-side perspective provides direct visibility of the brake carrier linkage assembly components when the suspension is in the compressed state.

The Rear Wheel Brake Carrier [Non-Drive] [Embodiment-3] 206 is shown in the compressed state position, with the rear brake caliper 48 mounted to the Rear Wheel Brake Carrier [Non-Drive] [Embodiment-3] 206. The Rear Wheel Brake Link [Non-Drive] [Embodiment-3] 207 is shown in the compressed state position, having rotated about the IVC[1][4] [Embodiment-3] 213 as the suspension moved from the extended state to the compressed state. The IVC[1][4] [Embodiment-3] 213 remains in a fixed position relative to the suspended body in the compressed state, as the IVC[1][4] [Embodiment-3] 213 represents a physical joint attached to the suspended body.

With continued reference to FIG. 105, the Rear Wheel Carrier [Non-Drive] [Embodiment-3] 201 is visible in the compressed state position, pivotally connected to the rear suspension pivot structure [Non-Drive] 16 about the rear suspension pivot axis 12/212. The Rear Wheel Carrier Fastener [Non-Drive] [Embodiment-3] 202 secures the Rear Wheel Carrier [Non-Drive] [Embodiment-3] 201 to the rear suspension pivot structure [Non-Drive] 16. The rear wheel axis [Compressed] 24/214 indicates the position of the rear wheel axis when the suspension is in the compressed state. The rear tire outer diameter 195 is shown as a circular outline indicating the position and size of the rear tire in the compressed state.

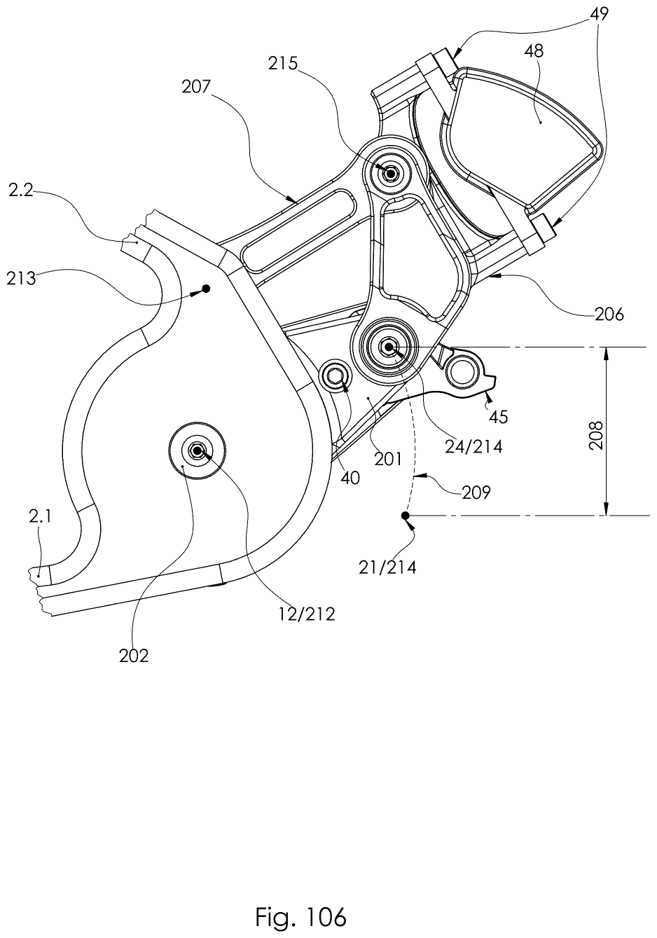

Referring to FIG. 106, a detail view of FIG. 105 is shown focused about the rear wheel axis [Compressed] 24/214 in the compressed state. The detail view provides a closer examination of the brake carrier linkage assembly from the non-drive-side perspective when the suspension is in the compressed state, revealing the positions of the pivotal connections and the brake carrier components.

The Rear Wheel Axle Path [Embodiment-3] 208 illustrates the arc along which the rear wheel axis has traveled from the extended state to the compressed state. The vertical rear wheel travel [Embodiment-3] 209 indicates the vertical distance of wheel movement from the extended state to the compressed state, measured as the vertical component of the Rear Wheel Axle Path [Embodiment-3] 208.

With continued reference to FIG. 106, the IVC[1][4] [Embodiment-3] 213 is visible at the pivotal connection between the suspended body and the Rear Wheel Brake Link [Non-Drive] [Embodiment-3] 207 in the compressed state. The IVC[3][4] [Embodiment-3] 215 has moved relative to the suspended body as the Rear Wheel Brake Link [Non-Drive] [Embodiment-3] 207 has rotated about the IVC[1][4] [Embodiment-3] 213 during suspension movement from the extended state to the compressed state. The rear brake caliper 48 is mounted to the Rear Wheel Brake Carrier [Non-Drive] [Embodiment-3] 206, with the brake caliper position in the compressed state determined by the positions of the IVC[2][3] [Embodiment-3] 214 and the IVC[3][4] [Embodiment-3] 215 in the compressed state configuration. The rear derailleur hanger 45 is visible on the drive side of the rear suspension system in the compressed state position.

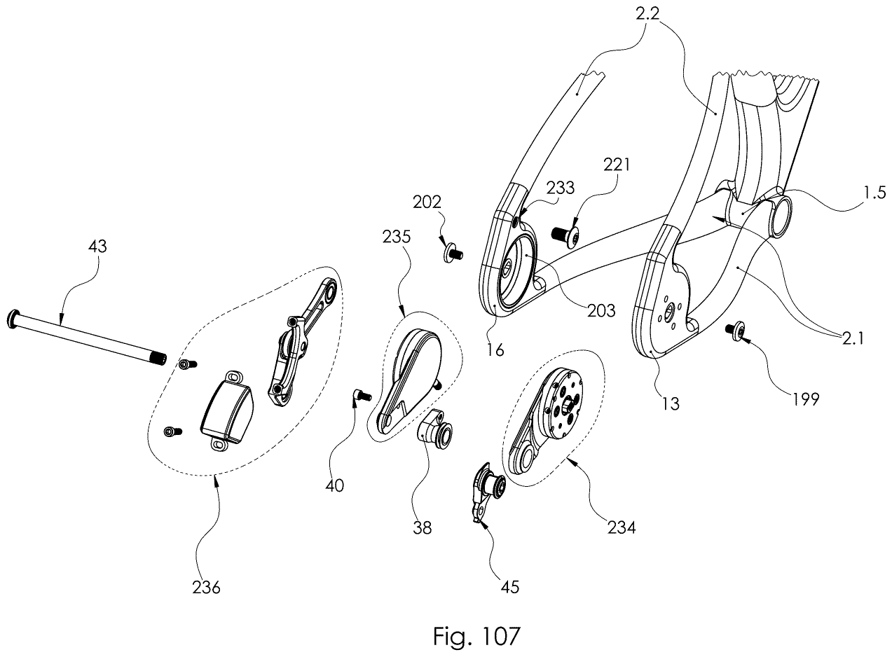

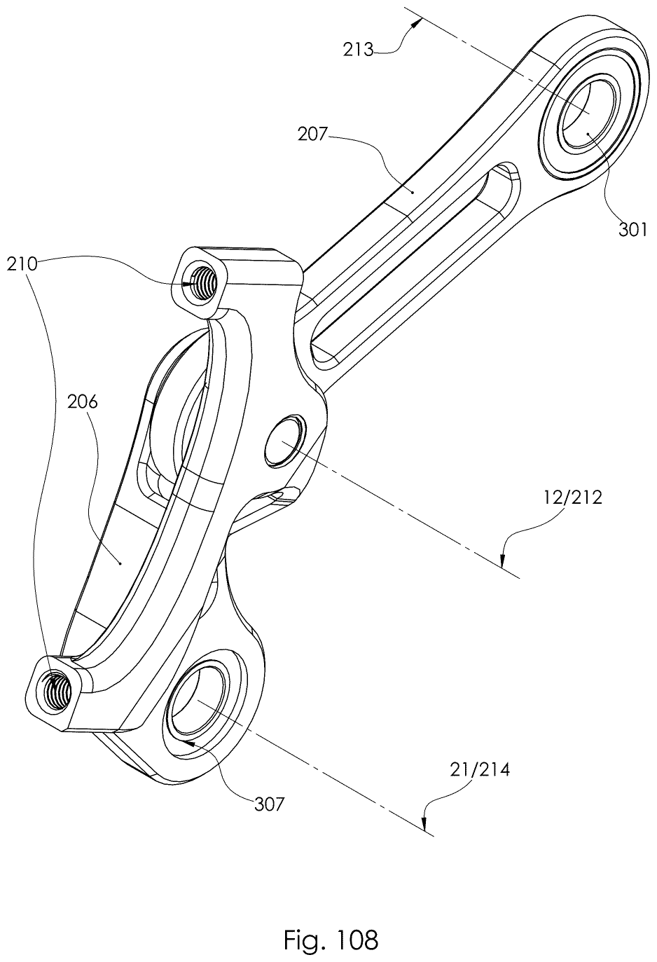

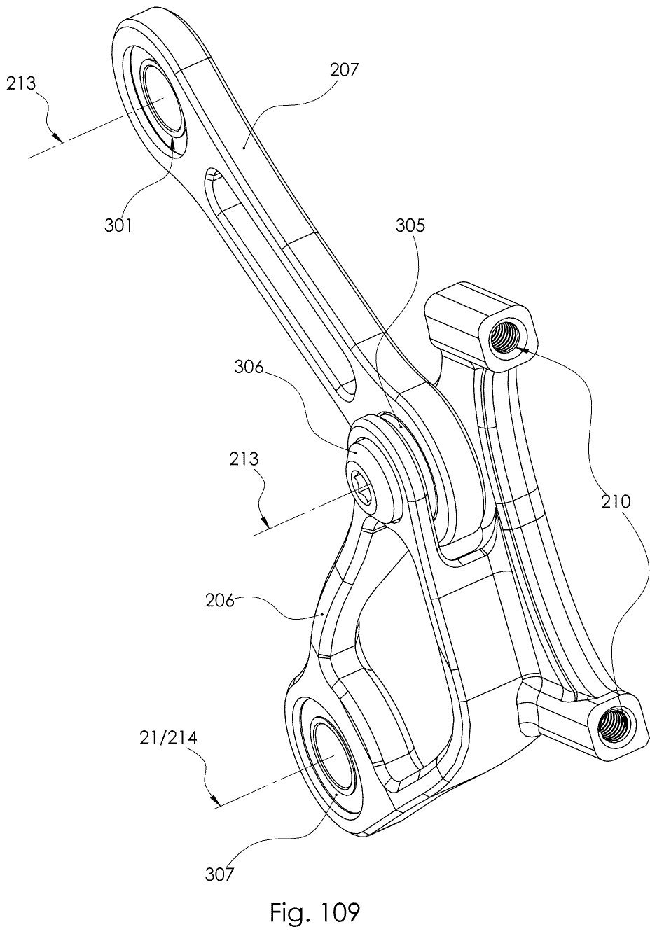

Referring to FIG. 107, an isometric exploded view of embodiment 3 is shown depicting a Damper Assembly [Embodiment-3] 234, a Spring Assembly [Embodiment-3] 235, and a Brake Carrier Linkage Assembly [Embodiment-3] 236 as modular sub-assemblies that may be installed into the rear suspension pivot structures of the two-wheeled vehicle. The exploded view illustrates the spatial relationships between the modular sub-assemblies and the rear triangle structure, including the chainstay 2.1 and the seatstay 2.2 that converge at the rear suspension pivot structure [Drive] 13 on the drive side and the rear suspension pivot structure [Non-Drive] 16 on the non-drive side.

The Damper Assembly [Embodiment-3] 234 is configured as a stand-alone sub-assembly that may be built separately from the rest of the vehicle and then installed as a module into the rear suspension pivot structure [Drive] 13. The Damper Assembly [Embodiment-3] 234 includes the Damper Cap [Embodiment-3] 237, the Damper Stator [Embodiment-3] 256, and the associated damper valve components including the Damper Valve [Compression][Low Speed] [Embodiment-3] 222, the Damper Valve [Compression][High Speed] [Embodiment-3] 223, the Damper Valve [Rebound][Low Speed] [Embodiment-3] 224, and the Damper Valve [Rebound][High Speed] [Embodiment-3] 225. The Rear Wheel Carrier [Drive] [Embodiment-3] 198 is shown in the exploded view with the Rear Wheel Carrier Bushing [Drive] [Embodiment-3] 200 positioned to be installed into the rear suspension pivot structure [Drive] 13.

With continued reference to FIG. 107, the Spring Assembly [Embodiment-3] 235 is configured as a stand-alone sub-assembly that may be built separately from the rest of the vehicle and then installed as a module into the rear suspension pivot structure [Non-Drive] 16. The Spring Assembly [Embodiment-3] 235 includes the Spring Cap [Embodiment-3] 267, the Spring Stator [Embodiment-3] 277, and the Air Spring Fill Valve [Embodiment-3] 230. The Rear Wheel Carrier [Non-Drive] [Embodiment-3] 201 is shown in the exploded view with a Rear Wheel Carrier Bushing [Non-Drive] [Embodiment-3] 203 positioned to be installed into the rear suspension pivot structure [Non-Drive] 16. The Rear Wheel Carrier Fastener [Non-Drive] [Embodiment-3] 202 secures the Rear Wheel Carrier [Non-Drive] [Embodiment-3] 201 to the rear suspension pivot structure [Non-Drive] 16.

As further shown in FIG. 107, the Brake Carrier Linkage Assembly [Embodiment-3] 236 includes the Rear Wheel Brake Carrier [Non-Drive] [Embodiment-3] 206 and the Rear Wheel Brake Link [Non-Drive] [Embodiment-3] 207. The Brake Carrier Linkage Assembly [Embodiment-3] 236 is configured to be installed on the non-drive side of the rear suspension system, with the IVC[1][4] Fastener [Embodiment-3] 221 securing the pivotal connection at the IVC[1][4] [Embodiment-3] 213 through the IVC[1][4] Fastener Interface [Embodiment-3] 233 on the rear suspension pivot structure. The rear hub flange interconnect 38 and the rear wheel axle 43 are shown in the exploded view, providing structural connection between the wheel carrier bodies on opposite sides of the suspension system. The rear derailleur hanger 45 is positioned on the Rear Wheel Carrier [Drive] [Embodiment-3] 198.

The modular configuration of the Damper Assembly [Embodiment-3] 234 and the Spring Assembly [Embodiment-3] 235 aids in manufacturability and assembly optimization since these sub-assemblies may be assembled and tested as separate modules before installation into the vehicle frame. Various different modules may be exchanged within the vehicle frame to offer different riding experiences. Module sets may provide different distances from the rear suspension pivot axis 12/212 to the rear wheel axis 21/214, changing the frame geometry and suspension travel characteristics. Modules may offer various travel amounts from Omm up, with various spring rate and damping properties that may be exchanged to accommodate different rider weights and riding conditions. A module set providing Omm of travel may result in a rigid rear end configuration where no relative motion occurs between the wheel carrier and the suspended body.

Referring to FIG. 108, an isometric view of the Brake Carrier Linkage Assembly [Embodiment-3] 236 is shown. The isometric perspective reveals the three-dimensional arrangement of the brake carrier linkage components, which are positioned on the non-drive side of the rear suspension system in entirety. The Brake Carrier Linkage Assembly [Embodiment-3] 236 includes the Rear Wheel Brake Carrier [Non-Drive] [Embodiment-3] 206 and the Rear Wheel Brake Link [Non-Drive] [Embodiment-3] 207, which are pivotally connected to one another and to the suspended body through pivotal connections at the IVC[1][4] [Embodiment-3] 213 and the IVC[3][4] [Embodiment-3] 215.

A Rear Wheel Brake Carrier [Caliper Fastener Interface] [Embodiment-3] 210 is visible on the Rear Wheel Brake Carrier [Non-Drive] [Embodiment-3] 206 and provides a mounting interface for securing a brake caliper to the Rear Wheel Brake Carrier [Non-Drive] [Embodiment-3] 206. The Rear Wheel Brake Carrier [Caliper Fastener Interface] [Embodiment-3] 210 includes threaded bores or other fastening features configured to receive brake caliper fasteners. The positioning of the Rear Wheel Brake Carrier [Caliper Fastener Interface] [Embodiment-3] 210 on the Rear Wheel Brake Carrier [Non-Drive] [Embodiment-3] 206 allows the brake caliper to move with the Rear Wheel Brake Carrier [Non-Drive] [Embodiment-3] 206 as the brake carrier linkage assembly moves relative to the suspended body during suspension travel.

With continued reference to FIG. 108, the IVC[2][3] Bearing 307 is positioned at the rear wheel axis 21/214 and supports the pivotal connection between the wheel carrier and the Rear Wheel Brake Carrier [Non-Drive] [Embodiment-3] 206. The IVC[2][3] Bearing 307 reduces rotational friction at the pivotal connection as the Rear Wheel Brake Carrier [Non-Drive] [Embodiment-3] 206 rotates about the rear wheel axis 21/214 relative to the wheel carrier during suspension movement. The pivotal connection at the IVC[2][3] [Embodiment-3] 214 allows the Rear Wheel Brake Carrier [Non-Drive] [Embodiment-3] 206 to move independently from the wheel carrier, enabling independent tuning of the deceleration response through the brake carrier geometry.

Referring to FIG. 109, an alternate isometric view of the Brake Carrier Linkage Assembly [Embodiment-3] 236 is shown. The alternate isometric perspective provides visibility of the brake carrier linkage components from a different viewing angle, revealing additional details of the pivotal connections and the bearing components within the Brake Carrier Linkage Assembly [Embodiment-3] 236.

The Rear Wheel Brake Carrier [Caliper Fastener Interface] [Embodiment-3] 210 is visible from this alternate viewing angle on the Rear Wheel Brake Carrier [Non-Drive] [Embodiment-3] 206. A Rear Brake Caliper Mounting Interface [Embodiment-3] 211 is positioned on the Rear Wheel Brake Carrier [Non-Drive] [Embodiment-3] 206 and provides a surface or structure for mounting the brake caliper to the Rear Wheel Brake Carrier [Non-Drive] [Embodiment-3] 206. The Rear Brake Caliper Mounting Interface [Embodiment-3] 211 may include alignment features or mounting surfaces that interface with corresponding features on the brake caliper to position the brake caliper relative to the brake rotor.

With continued reference to FIG. 109, an IVC[1][4] Bearing [Embodiment-3] 301 is visible at the IVC[1][4] [Embodiment-3] 213 and supports the pivotal connection between the suspended body and the Rear Wheel Brake Link [Non-Drive] [Embodiment-3] 207. The IVC[1][4] Bearing [Embodiment-3] 301 reduces rotational friction at the pivotal connection as the Rear Wheel Brake Link [Non-Drive] [Embodiment-3] 207 rotates about the IVC[1][4] [Embodiment-3] 213 relative to the suspended body during suspension movement. An IVC[3][4] Bearing Spacer [Outer] [Embodiment-3] 305 is visible at the IVC[3][4] [Embodiment-3] 215 and provides spacing between bearing components at the pivotal connection between the Rear Wheel Brake Carrier [Non-Drive] [Embodiment-3] 206 and the Rear Wheel Brake Link [Non-Drive] [Embodiment-3] 207. An IVC[3][4] Fastener [Embodiment-3] 306 secures the pivotal connection at the IVC[3][4] [Embodiment-3] 215.

As further shown in FIG. 109, the IVC[2][3] Bearing 307 is visible at the rear wheel axis 21/214, supporting the pivotal connection between the wheel carrier and the Rear Wheel Brake Carrier [Non-Drive] [Embodiment-3] 206. The brake carrier is located on one side of the rear wheel in entirety, with the Rear Wheel Brake Carrier [Non-Drive] [Embodiment-3] 206 and the Rear Wheel Brake Link [Non-Drive] [Embodiment-3] 207 positioned on the non-drive side of the rear suspension system. Two wheel carrier bodies, including the Rear Wheel Carrier [Drive] [Embodiment-3] 198 and the Rear Wheel Carrier [Non-Drive] [Embodiment-3] 201, undergo identical kinematic motion but are located on either side of the rear wheel respectively.

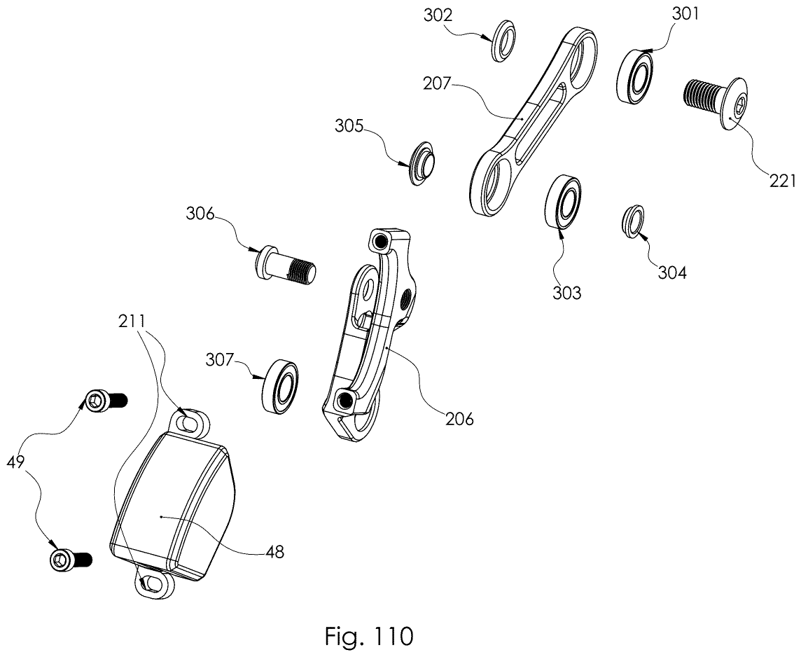

Referring to FIG. 110, an alternate isometric exploded view of the Brake Carrier Linkage Assembly [Embodiment-3] 236 is shown. The exploded view illustrates the spatial relationships between the individual components of the brake carrier linkage assembly and their assembly sequence.

The Rear Wheel Brake Carrier [Non-Drive] [Embodiment-3] 206 is shown with the Rear Brake Caliper Mounting Interface [Embodiment-3] 211 visible on the brake carrier body. The rear brake caliper 48 is shown in the exploded view, positioned to be mounted to the Rear Wheel Brake Carrier [Non-Drive] [Embodiment-3] 206 via the rear brake caliper fasteners 49 through the Rear Wheel Brake Carrier [Caliper Fastener Interface] [Embodiment-3] 210.

With continued reference to FIG. 110, the IVC[1][4] Bearing [Embodiment-3] 301 is shown in an exploded position relative to the Rear Wheel Brake Link [Non-Drive] [Embodiment-3] 207. An IVC[1][4] Bearing Spacer [Embodiment-3] 302 is positioned adjacent to the IVC[1][4] Bearing [Embodiment-3] 301 and provides spacing between the IVC[1][4] Bearing [Embodiment-3] 301 and adjacent components at the pivotal connection between the suspended body and the Rear Wheel Brake Link [Non-Drive] [Embodiment-3] 207. The IVC[1][4] Fastener [Embodiment-3] 221 is shown in the exploded view, configured to be installed through the IVC[1][4] Bearing [Embodiment-3] 301 and the IVC[1][4] Bearing Spacer [Embodiment-3] 302 to secure the pivotal connection at the IVC[1][4] [Embodiment-3] 213.

As further shown in FIG. 110, an IVC[3][4] Bearing [Embodiment-3] 303 is shown in an exploded position relative to the Rear Wheel Brake Carrier [Non-Drive] [Embodiment-3] 206 and the Rear Wheel Brake Link [Non-Drive] [Embodiment-3] 207. The IVC[3][4] Bearing [Embodiment-3] 303 supports the pivotal connection between the Rear Wheel Brake Carrier [Non-Drive] [Embodiment-3] 206 and the Rear Wheel Brake Link [Non-Drive] [Embodiment-3] 207 at the IVC[3][4] [Embodiment-3] 215. An IVC[3][4] Bearing Spacer [Inner] [Embodiment-3] 304 is positioned on one side of the IVC[3][4] Bearing [Embodiment-3] 303, and the IVC[3][4] Bearing Spacer [Outer] [Embodiment-3] 305 is positioned on an opposite side of the IVC[3][4] Bearing [Embodiment-3] 303. The IVC[3][4] Bearing Spacer [Inner] [Embodiment-3] 304 and the IVC[3][4] Bearing Spacer [Outer] [Embodiment-3] 305 provide spacing and alignment for the IVC[3][4] Bearing [Embodiment-3] 303 within the pivotal connection at the IVC[3][4] [Embodiment-3] 215. The IVC[3][4] Fastener [Embodiment-3] 306 is configured to be installed through the IVC[3][4] Bearing [Embodiment-3] 303, the IVC[3][4] Bearing Spacer [Inner] [Embodiment-3] 304, and the IVC[3][4] Bearing Spacer [Outer] [Embodiment-3] 305 to secure the pivotal connection at the IVC[3][4] [Embodiment-3] 215.

The IVC[2][3] Bearing 307 is shown in the exploded view at the rear wheel axis 21/214, positioned to support the pivotal connection between the wheel carrier and the Rear Wheel Brake Carrier [Non-Drive] [Embodiment-3] 206. The pivotal connections at the IVC[1][4] [Embodiment-3] 213, the IVC[2][3] [Embodiment-3] 214, and the IVC[3][4] [Embodiment-3] 215 allow the Rear Wheel Brake Carrier [Non-Drive] [Embodiment-3] 206 to move independently from the wheel carrier as the suspension travels through the travel range. The independent movement of the brake carrier relative to the wheel carrier enables the instantaneous velocity center of the brake carrier relative to the suspended body to migrate along a path that is different from the instantaneous velocity center of the wheel carrier relative to the suspended body, providing independent tuning of the anti-rise behavior of the two-wheeled vehicle.

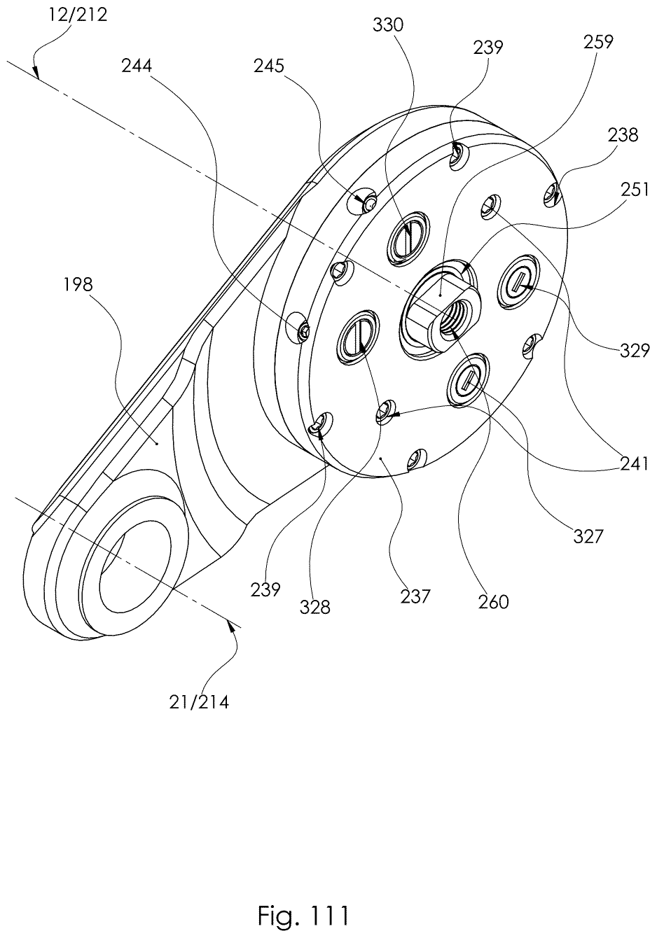

Referring to FIG. 111, an isometric view of the modular Damper Assembly [Embodiment-3] 234 is shown. The isometric perspective reveals the three-dimensional arrangement of the damper assembly components, which are configured as a stand-alone sub-assembly that may be installed into the rear suspension pivot structure on the drive side of the two-wheeled vehicle.

The Damper Cap [Embodiment-3] 237 is positioned at the outer portion of the damper assembly and includes a Damper Cap Fastener Interface [Embodiment-3] 238, which receives Damper Cap Fasteners [Embodiment-3] 239 for securing the Damper Cap [Embodiment-3] 237 to the Rear Wheel Carrier [Drive] [Embodiment-3] 198. Damper Cap Bleed Port Fasteners [Embodiment-3] 241 are positioned on the Damper Cap [Embodiment-3] 237 and provide access to bleed ports used during fluid filling and air removal procedures. Damper fluid may be added and bled to remove all air via the bleed ports during assembly and maintenance of the damper assembly.

With continued reference to FIG. 111, a Damper Cap Port Plug Fastener [Compression] [Embodiment-3] 244 is positioned on the Damper Cap [Embodiment-3] 237 and secures a plug at the Damper Cap Port [Compression] [Embodiment-3] 242. A Damper Cap Port Plug Fastener [Rebound] [Embodiment-3] 245 is positioned on the Damper Cap [Embodiment-3] 237 and secures a plug at the Damper Cap Port [Rebound] [Embodiment-3] 243. The Damper Cap Port [Compression] [Embodiment-3] 242 connects the high speed and low speed compression valves, while the Damper Cap Port [Rebound] [Embodiment-3] 243 connects the high speed and low speed rebound valves.

As further shown in FIG. 111, a Damper Valve Adjuster Feature [Compression][Low Speed] [Embodiment-3] 327 is positioned on the damper assembly and provides adjustment capability for the Damper Valve [Compression][Low Speed] [Embodiment-3] 222. A Damper Valve Adjuster Feature [Compression][High Speed] [Embodiment-3] 328 is positioned on the damper assembly and provides adjustment capability for the Damper Valve [Compression][High Speed] [Embodiment-3] 223. A Damper Valve Adjuster Feature [Rebound][Low Speed] [Embodiment-3] 329 is positioned on the damper assembly and provides adjustment capability for the Damper Valve [Rebound][Low Speed] [Embodiment-3] 224. A Damper Valve Adjuster Feature [Rebound][High Speed] [Embodiment-3] 330 is positioned on the damper assembly and provides adjustment capability for the Damper Valve [Rebound][High Speed] [Embodiment-3] 225. The damper valve adjuster features allow the interaction of the damper fluid and the valves to be tuned for various damping behaviors depending upon desired ride feel by turning the adjuster features to open or restrict fluid flow depending upon adjuster turns and turn direction.

A Damper Stator Key Feature [Embodiment-3] 259 is visible on the Damper Stator [Embodiment-3] 256 and provides rotational alignment to prevent relative rotation between the Damper Stator [Embodiment-3] 256 and the suspended body when installed. A Damper Stator Fastening Feature [Embodiment-3] 260 is positioned on the Damper Stator [Embodiment-3] 256 and provides attachment points for securing the Damper Stator [Embodiment-3] 256 within the damper assembly.

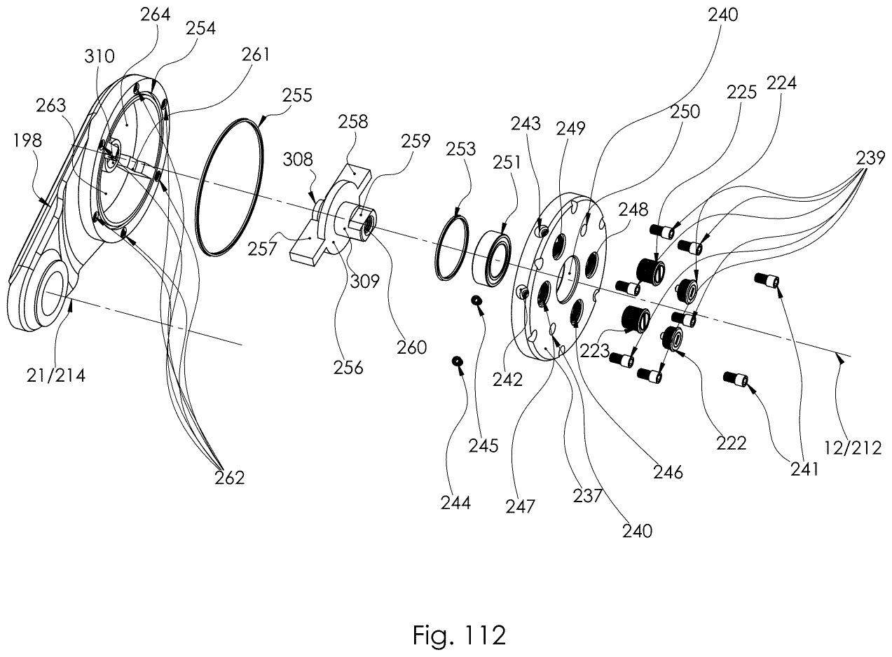

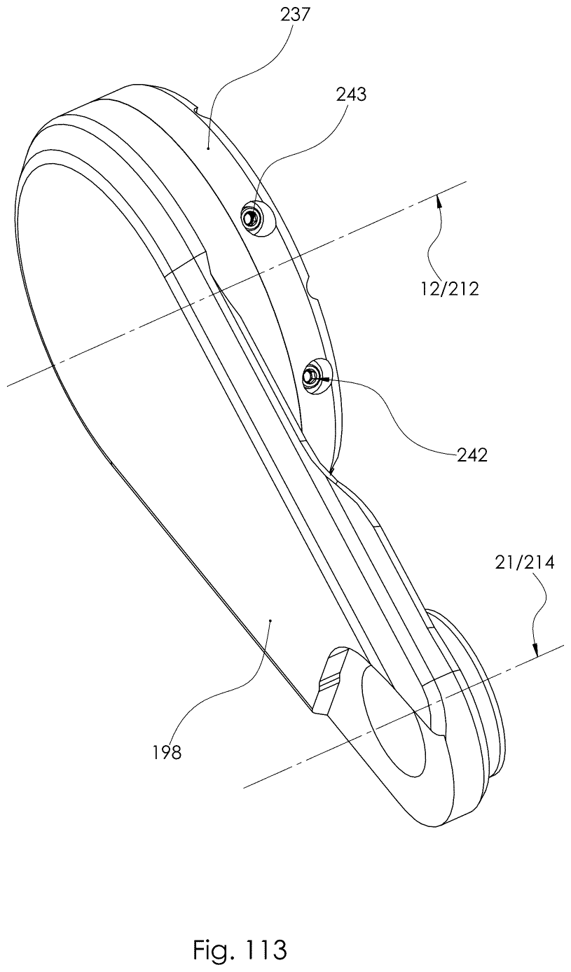

Referring to FIG. 112, an isometric exploded view of the modular Damper Assembly [Embodiment-3] 234 is shown. The exploded view depicts the individual components and their spatial relationships within the damper assembly, illustrating the assembly sequence and the interfaces between components.

The Rear Wheel Carrier [Drive] [Embodiment-3] 198 is positioned at one end of the assembly and includes a Damper Main Seal Interface [Rear Wheel Carrier] [Embodiment-3] 254, which receives the Damper Main Seal [Rear Wheel Carrier] [Embodiment-3] 255. The Damper Main Seal [Rear Wheel Carrier] [Embodiment-3] 255 provides sealing between the Rear Wheel Carrier [Drive] [Embodiment-3] 198 and the damper components during rotational movement about the rear suspension pivot axis 12/212. A Rear Wheel Carrier Fluid Barrier [Damper] [Embodiment-3] 261 extends from the Rear Wheel Carrier [Drive] [Embodiment-3] 198 and functions as a rotor blade that moves relative to the Damper Stator [Embodiment-3] 256 during suspension travel. A Damper Cap Fastener Interface [Rear Wheel Carrier] [Embodiment-3] 262 is positioned on the Rear Wheel Carrier [Drive] [Embodiment-3] 198 and provides mounting locations for securing the Damper Cap [Embodiment-3] 237 to the Rear Wheel Carrier [Drive] [Embodiment-3] 198.

With continued reference to FIG. 112, the Damper Stator [Embodiment-3] 256 is positioned within the assembly and includes a Damper Stator Blade [Compression] [Embodiment-3] 257 and a Damper Stator Blade [Rebound] [Embodiment-3] 258, which extend from the Damper Stator [Embodiment-3] 256 body. The Damper Stator Blade [Compression] [Embodiment-3] 257 and the Damper Stator Blade [Rebound] [Embodiment-3] 258 divide the internal volume of the damper assembly into a Damper Fluid Chamber [Compression] 263 and a Damper Fluid Chamber [Rebound] 264. The Damper Fluid Chamber [Compression] 263 and the Damper Fluid Chamber [Rebound] 264 contain damping fluid that is forced through the damper valves during suspension movement. The Damper Stator Key Feature [Embodiment-3] 259 is visible on the Damper Stator [Embodiment-3] 256, and the Damper Stator Fastening Feature [Embodiment-3] 260 provides attachment points for securing the Damper Stator [Embodiment-3] 256 within the assembly.

As further shown in FIG. 112, the Damper Cap [Embodiment-3] 237 includes a Damper Cap Bearing Interface [Embodiment-3] 250, which accommodates the Damper Cap Bearing [Embodiment-3] 251. A Damper Cap Seal Interface [Embodiment-3] 252 receives the Damper Cap Bearing Seal [Embodiment-3] 253 to provide sealing at the bearing interface. Damper Cap Bleed Port Features [Embodiment-3] 240 are positioned on the Damper Cap [Embodiment-3] 237 and provide access for adding damper fluid and bleeding air from the damper assembly. The Damper Cap Bleed Port Fasteners [Embodiment-3] 241 secure plugs at the bleed port features when the damper assembly is filled and bled.

The damper valve components are arranged on the Damper Cap [Embodiment-3] 237. A Damper Valve [Compression][Low Speed] 246, a Damper Valve [Compression][High Speed] 247, a Damper Valve [Rebound][Low Speed] 248, and a Damper Valve [Rebound][High Speed] 249 are sub-assemblies that control the flow of damper fluid within the damper mechanism. The Damper Valve [Compression][Low Speed] 246 and the Damper Valve [Compression][High Speed] 247 control fluid flow in the compression direction, while the Damper Valve [Rebound][Low Speed] 248 and the Damper Valve [Rebound][High Speed] 249 control fluid flow in the rebound direction.

A Spring Stator Bearing Interface [Stator] [Embodiment-3] 308 and a Spring Stator Bearing Interface [Spring Cap] [Embodiment-3] 309 are visible on the stator structure, providing bearing mounting locations. A Spring Stator Bearing Interface [Rear Wheel Carrier] [Embodiment-3] 310 is positioned on the Rear Wheel Carrier [Drive] [Embodiment-3] 198 and supports bearing components within the assembly. A Rear Brake Caliper Mounting Interface 211/214 is shown in relation to the damper assembly components.

Sealing between moving parts within the damper assembly may be accomplished through seals such as the Damper Main Seal [Rear Wheel Carrier] [Embodiment-3] 255 and the Damper Cap Bearing Seal [Embodiment-3] 253, or through small tolerances or gaps between moving parts that eliminate the need for seals.

Referring to FIG. 113, an alternate isometric view of the modular Damper Assembly [Embodiment-3] 234 is shown. The view depicts the Rear Wheel Carrier [Drive] [Embodiment-3] 198, which is pivotally connected to the rear suspension pivot structure about the rear suspension pivot axis 12/212. The Rear Wheel Carrier [Drive] [Embodiment-3] 198 extends from the suspension pivot region toward the rear wheel axis 21/214, where the rear wheel would be pivotally connected.

The Damper Cap [Embodiment-3] 237 is positioned at the outer portion of the damper assembly and includes the Damper Cap Port [Compression] [Embodiment-3] 242 and the Damper Cap Port [Rebound] [Embodiment-3] 243. The Damper Cap Port [Compression] [Embodiment-3] 242 facilitates fluid flow during compression movements when the suspension moves from the extended state toward the compressed state. The Damper Cap Port [Rebound] [Embodiment-3] 243 facilitates fluid flow during rebound movements when the suspension moves from the compressed state toward the extended state.

With continued reference to FIG. 113, the Rear Wheel Carrier [Drive] [Embodiment-3] 198 is configured to rotate about the rear suspension pivot axis 12/212 relative to the suspended body, with the damper assembly providing resistance to this rotational movement through the controlled flow of damper fluid through the compression and rebound ports. The rotary resistance mechanism resists relative motion between the suspension kinematic bodies about the rotation axis defined by the rear suspension pivot axis 12/212.

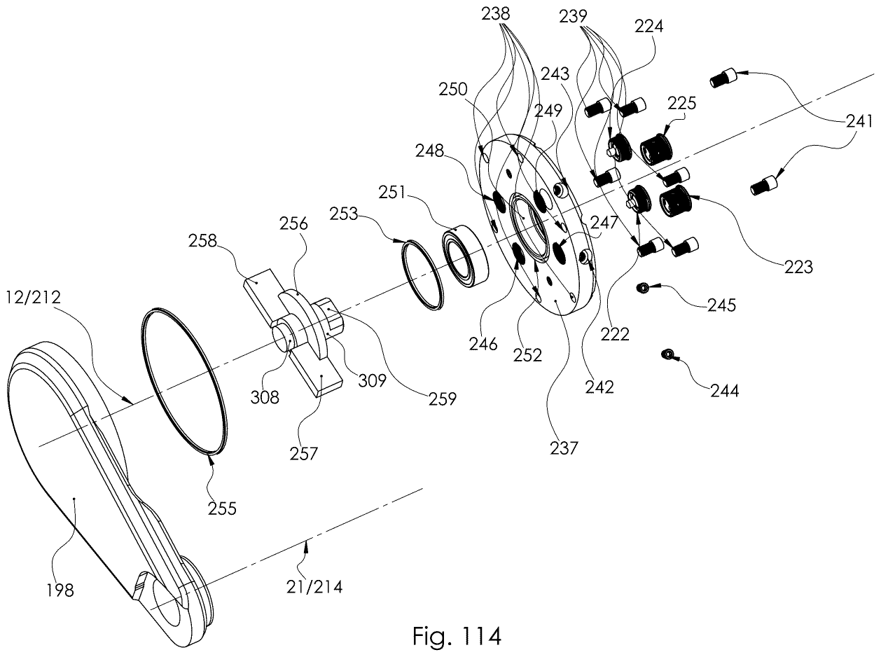

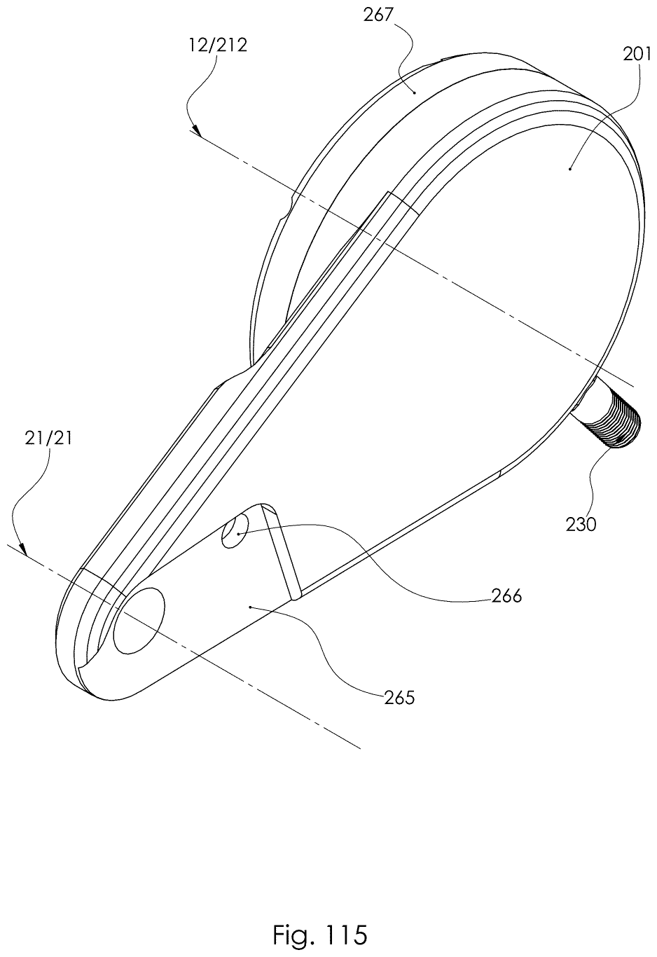

Referring to FIG. 114, an isometric exploded view of the modular Damper Assembly [Embodiment-3] 234 is shown from an alternate viewing angle. The exploded view depicts the individual components and their spatial relationships within the damper assembly, with the Rear Wheel Carrier [Drive] [Embodiment-3] 198 positioned at one end of the assembly and the rear wheel axis 21/214 located at the distal end of the Rear Wheel Carrier [Drive] [Embodiment-3] 198.

The Damper Main Seal [Rear Wheel Carrier] [Embodiment-3] 255 is shown in the exploded view, providing sealing between the Rear Wheel Carrier [Drive] [Embodiment-3] 198 and the damper components during rotational movement about the rear suspension pivot axis 12/212. The Damper Stator [Embodiment-3] 256 is positioned within the assembly and includes the Damper Stator Blade [Compression] [Embodiment-3] 257 and the Damper Stator Blade [Rebound] [Embodiment-3] 258, which extend from the Damper Stator [Embodiment-3] 256 body. The Damper Stator Key Feature [Embodiment-3] 259 provides rotational alignment to prevent relative rotation between the Damper Stator [Embodiment-3] 256 and the suspended body when installed.

With continued reference to FIG. 114, the Damper Cap [Embodiment-3] 237 is positioned at the outer portion of the assembly and includes the Damper Cap Fastener Interface [Embodiment-3] 238, which receives the Damper Cap Fasteners [Embodiment-3] 239 for securing the Damper Cap [Embodiment-3] 237 to the Rear Wheel Carrier [Drive] [Embodiment-3] 198. The Damper Cap Bearing Interface [Embodiment-3] 250 accommodates the Damper Cap Bearing [Embodiment-3] 251, which facilitates rotational movement between components. The Damper Cap Seal Interface [Embodiment-3] 252 receives the Damper Cap Bearing Seal [Embodiment-3] 253 to provide sealing at the bearing interface. The Damper Cap Bleed Port Fasteners [Embodiment-3] 241 are shown for accessing bleed ports used during fluid filling and air removal procedures.

The damper valve components are arranged on the Damper Cap [Embodiment-3] 237. The Damper Cap Port [Compression] [Embodiment-3] 242 connects the high speed and low speed compression valves, while the Damper Cap Port [Rebound] [Embodiment-3] 243 connects the high speed and low speed rebound valves. The Damper Cap Port Plug Fastener [Compression] [Embodiment-3] 244 and the Damper Cap Port Plug Fastener [Rebound] [Embodiment-3] 245 secure plugs at the respective ports.

As further shown in FIG. 114, the damper valves include the Damper Valve [Compression][Low Speed] [Embodiment-3] 222, the Damper Valve [Compression][High Speed] [Embodiment-3] 223, the Damper Valve [Rebound][Low Speed] [Embodiment-3] 224, and the Damper Valve [Rebound][High Speed] [Embodiment-3] 225, which are sub-assemblies that control the flow of damper fluid within the damper mechanism. Additionally, the Damper Valve [Compression][Low Speed] 246, the Damper Valve [Compression][High Speed] 247, the Damper Valve [Rebound][Low Speed] 248, and the Damper Valve [Rebound][High Speed] 249 are shown as components of the valve assemblies. The damper valves control fluid flow in both compression and rebound directions, with separate low speed and high speed tuning capabilities for each direction. The Spring Stator Bearing Interface [Stator] [Embodiment-3] 308 and the Spring Stator Bearing Interface [Spring Cap] [Embodiment-3] 309 are visible on the stator structure.

Referring to FIG. 115, an isometric view of the modular Spring Assembly [Embodiment-3] 235 is shown for a two-wheeled vehicle rear suspension system. The view depicts the spring assembly components and their spatial relationships from an angled perspective that reveals the three-dimensional arrangement of the assembly.

The Rear Wheel Carrier [Non-Drive] [Embodiment-3] 201 is shown as an elongated structural component that extends from a circular hub region toward a wheel mounting area. The circular hub region is configured to interface with the suspension pivot structure and is concentric with the rear suspension pivot axis 12/212. The rear wheel axis 21/214 is located at the distal end of the Rear Wheel Carrier [Non-Drive] [Embodiment-3] 201, where the rear wheel hub would be pivotally connected.

The Spring Cap [Embodiment-3] 267 is positioned at the outer portion of the spring assembly and provides a closure for the spring mechanism. The Air Spring Fill Valve [Embodiment-3] 230 is visible on the Spring Cap [Embodiment-3] 267, providing access for adjusting the air spring pressure within the rotary spring assembly. Air may be added or removed to the spring assembly via the Air Spring Fill Valve [Embodiment-3] 230 to allow for various spring forces depending upon rider weight and desired ride characteristics.

With continued reference to FIG. 115, a Rear Wheel Carrier Hub Interconnect Interface [Non-Drive] [Embodiment-3] 265 is located on the Rear Wheel Carrier [Non-Drive] [Embodiment-3] 201 and provides a geometric interface for receiving a hub flange interconnect component. A Rear Wheel Carrier Hub Interconnect Fastener Bore [Non-Drive] [Embodiment-3] 266 is positioned adjacent to the Rear Wheel Carrier Hub Interconnect Interface [Non-Drive] [Embodiment-3] 265 and is configured to receive a fastener that mechanically connects the hub flange interconnect to the wheel carrier. This arrangement aids in preventing relative motion between the wheel carrier components on the drive and non-drive sides of the suspension assembly, providing structural rigidity between the separated wheel carrier bodies.

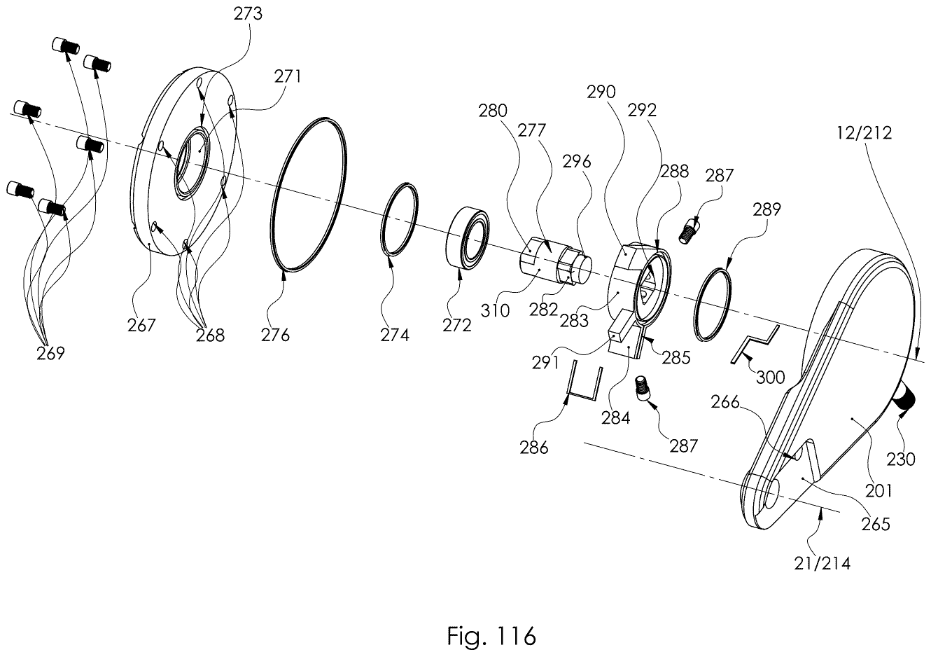

Referring to FIG. 116, an isometric exploded view of the modular Spring Assembly [Embodiment-3] 235 is shown. The exploded view depicts the individual components and their spatial relationships within the spring assembly, which is configured to be installed on the non-drive side of the rear suspension pivot structure.

The Rear Wheel Carrier [Non-Drive] [Embodiment-3] 201 is positioned at one end of the assembly and includes the Rear Wheel Carrier Hub Interconnect Interface [Non-Drive] [Embodiment-3] 265 and the Rear Wheel Carrier Hub Interconnect Fastener Bore [Non-Drive] [Embodiment-3] 266, which provide connection points for the hub flange interconnect. The rear wheel axis 21/214 defines the rotational axis of the rear wheel, while the rear suspension pivot axis 12/212 defines the axis about which the suspension components rotate relative to the suspended body.

The Spring Cap [Embodiment-3] 267 is positioned at the outer portion of the assembly and includes a Spring Cap Fastener Interface [Embodiment-3] 268, which receives Spring Cap Fasteners [Embodiment-3] 269. A Spring Cap Bearing Interface [Embodiment-3] 271 accommodates the Spring Cap Bearing [Embodiment-3] 272, which facilitates rotational movement between components. A Spring Cap Seal Interface [Embodiment-3] 273 receives the Spring Cap Bearing Seal [Embodiment-3] 274 to provide sealing between moving parts. The Spring Main Seal [Rear Wheel Carrier] [Embodiment-3] 276 interfaces with the Rear Wheel Carrier [Non-Drive] [Embodiment-3] 201 to maintain pressure within the spring chambers.

With continued reference to FIG. 116, the Spring Stator [Embodiment-3] 277 is positioned within the assembly and includes a Spring Stator Key Feature [Main] [Embodiment-3] 280, which provides rotational alignment with the suspended body structure. A Spring Stator Key Feature [Travel Stop] [Embodiment-3] 282 interfaces with travel stop components. A Spring Stator Bearing Interface [Stator] [Embodiment-3] 296 and a Spring Stator Bearing Interface [Rear Wheel Carrier] [Embodiment-3] 310 provide bearing mounting locations. The Spring Stator [Embodiment-3] 277 includes a Spring Stator Blade [Compression] [Embodiment-3] 278 and a Spring Stator Blade [Rebound] [Embodiment-3] 279, which extend from the Spring Stator [Embodiment-3] 277 body and divide the internal volume into positive and negative chambers.

As further shown in FIG. 116, a Spring Travel Stop [Embodiment-3] 283 includes a Spring Travel Stop Blade [Embodiment-3] 284, which extends into the spring chamber. A Spring Travel Stop Blade Seal Interface [Embodiment-3] 285 receives a Spring Travel Stop Blade Seal [Embodiment-3] 286 to maintain chamber separation. Spring Travel Stop Fastener(s) [Embodiment-3] 287 secure the travel stop assembly. A Spring Travel Stop Seal Interface [Embodiment-3] 288 accommodates a Spring Travel Stop Seal [Embodiment-3] 289. A Spring Travel Stop Feature [Compressed] [Embodiment-3] 290 and a Spring Travel Stop Feature [Extended] [Embodiment-3] 291 define the limits of suspension travel. A Spring Travel Stop Key Feature [Embodiment-3] 292 provides rotational alignment with the Spring Stator [Embodiment-3] 277.

A Spring Blade Seal [Rear Wheel Carrier][Non-Drive] [Embodiment-3] 300 provides sealing for the blade portion of the Rear Wheel Carrier [Non-Drive] [Embodiment-3] 201. The front hub flange interconnect 108 is shown in relation to the assembly, indicating the interface for maintaining alignment between the drive and non-drive side wheel carriers.

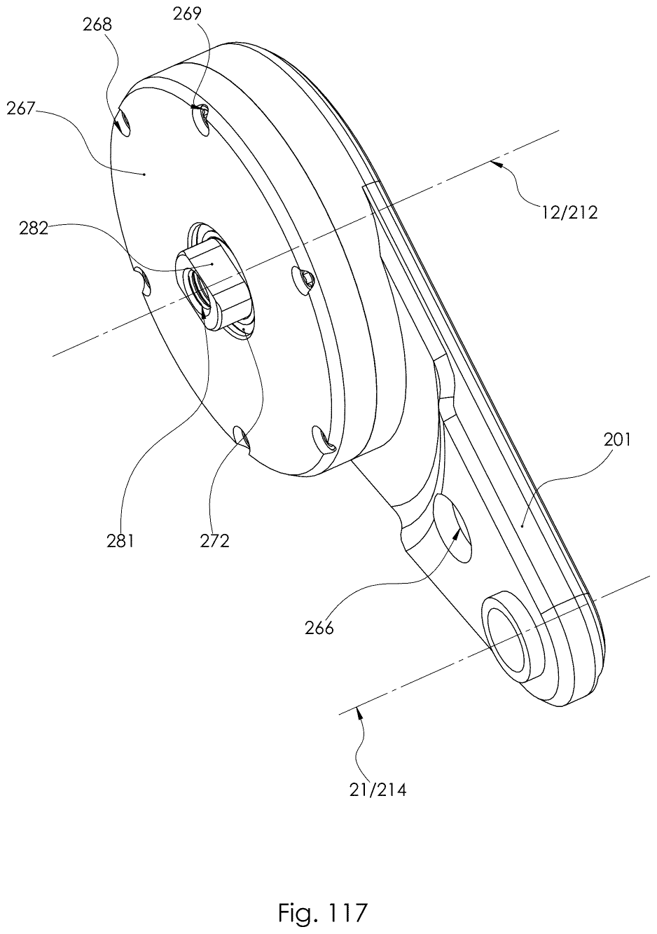

Referring to FIG. 117, an isometric view of the modular Spring Assembly [Embodiment-3] 235 is shown from an alternate viewing angle. The view depicts the spring assembly components and reveals the spatial relationships between the various elements of the rotary resistance mechanism.

The Rear Wheel Carrier [Non-Drive] [Embodiment-3] 201 is shown as the primary rotating component that pivots about the rear suspension pivot axis 12/212. The Rear Wheel Carrier [Non-Drive] [Embodiment-3] 201 includes the Rear Wheel Carrier Hub Interconnect Fastener Bore [Non-Drive] [Embodiment-3] 266, which provides a mounting location for securing the hub flange interconnect to maintain alignment between the drive and non-drive side wheel carriers. The rear wheel axis 21/214 is positioned at the lower portion of the Rear Wheel Carrier [Non-Drive] [Embodiment-3] 201, defining the rotational axis for the rear wheel.

The Spring Cap [Embodiment-3] 267 is positioned at the outer portion of the spring assembly and includes the Spring Cap Fastener Interface [Embodiment-3] 268, which receives the Spring Cap Fasteners [Embodiment-3] 269 to secure the Spring Cap [Embodiment-3] 267 to the rear wheel carrier structure. The Spring Cap Bearing [Embodiment-3] 272 is installed within the Spring Cap [Embodiment-3] 267 to facilitate rotational movement between the Spring Cap [Embodiment-3] 267 and the wheel carrier components while reducing friction.

With continued reference to FIG. 117, the spring stator components are visible in this view, including a Spring Stator Fastening Feature [Embodiment-3] 281, which provides attachment points for securing the Spring Stator [Embodiment-3] 277 within the assembly. The Spring Stator Key Feature [Travel Stop] [Embodiment-3] 282 is shown as a feature that interfaces with corresponding travel stop components to define the limits of suspension travel and provide alignment for the rotary spring mechanism.

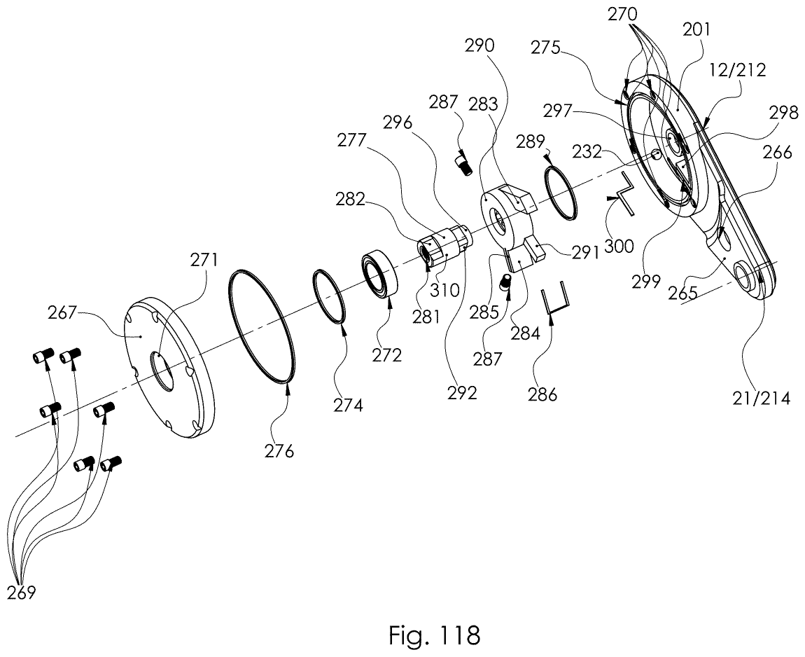

Referring to FIG. 118, an isometric exploded view of the modular Spring Assembly [Embodiment-3] 235 is shown from an alternate viewing angle. The exploded view depicts the spring assembly components arranged along the rear suspension pivot axis 12/212, with the rear wheel axis 21/214 positioned at the lower portion of the assembly.

The Rear Wheel Carrier [Non-Drive] [Embodiment-3] 201 is shown at one side of the exploded view and includes several interface features. The Rear Wheel Carrier Hub Interconnect Interface [Non-Drive] [Embodiment-3] 265 and the Rear Wheel Carrier Hub Interconnect Fastener Bore [Non-Drive] [Embodiment-3] 266 are positioned on the Rear Wheel Carrier [Non-Drive] [Embodiment-3] 201 to provide connection points for the hub flange interconnect. A Spring Cap Fastener Interface [Rear Wheel Carrier] [Embodiment-3] 270 receives fasteners to secure the spring cap assembly. A Spring Main Seal Interface [Rear Wheel Carrier] [Embodiment-3] 275 accommodates the Spring Main Seal [Rear Wheel Carrier] [Embodiment-3] 276, which provides sealing between the wheel carrier and the spring assembly components. The Spring Stator Bearing Interface [Rear Wheel Carrier] [Embodiment-3] 310 supports bearing components within the assembly. A Spring Blade [Rear Wheel Carrier][Non-Drive] [Embodiment-3] 298 extends from the Rear Wheel Carrier [Non-Drive] [Embodiment-3] 201 and interfaces with a Spring Blade Seal Interface [Rear Wheel Carrier][Non-Drive] [Embodiment-3] 299, which receives the Spring Blade Seal [Rear Wheel Carrier][Non-Drive] [Embodiment-3] 300.

With continued reference to FIG. 118, the Spring Cap [Embodiment-3] 267 is positioned at the outer portion of the exploded view and is secured by the Spring Cap Fasteners [Embodiment-3] 269. The Spring Cap Bearing Interface [Embodiment-3] 271 receives the Spring Cap Bearing [Embodiment-3] 272, which facilitates rotational movement between components. The Spring Cap Bearing Seal [Embodiment-3] 274 provides sealing at the bearing interface.

The Spring Stator [Embodiment-3] 277 is centrally positioned within the assembly and includes the Spring Stator Fastening Feature [Embodiment-3] 281 for attachment purposes. The Spring Stator Key Feature [Main] [Embodiment-3] 280 provides rotational alignment with the suspended body structure to prevent relative rotation between the Spring Stator [Embodiment-3] 277 and the suspended body when installed. The Spring Stator Key Feature [Travel Stop] [Embodiment-3] 282 provides alignment with the Spring Travel Stop [Embodiment-3] 283. The Spring Stator Bearing Interface [Stator] [Embodiment-3] 296 supports bearing components on the Spring Stator [Embodiment-3] 277.

As further shown in FIG. 118, the Spring Travel Stop [Embodiment-3] 283 includes the Spring Travel Stop Blade [Embodiment-3] 284, which interfaces with the Spring Travel Stop Blade Seal Interface [Embodiment-3] 285 and the Spring Travel Stop Blade Seal [Embodiment-3] 286. The Spring Travel Stop Fastener(s) [Embodiment-3] 287 secure the travel stop assembly. The Spring Travel Stop Seal [Embodiment-3] 289 provides sealing for the travel stop mechanism. The Spring Travel Stop Feature [Compressed] [Embodiment-3] 290 and the Spring Travel Stop Feature [Extended] [Embodiment-3] 291 define the limits of suspension travel in the compressed and extended directions respectively by interacting with features on the Rear Wheel Carrier [Non-Drive] [Embodiment-3] 201. The Spring Travel Stop Key Feature [Embodiment-3] 292 provides rotational alignment with corresponding features on the Spring Stator [Embodiment-3] 277.

An Air Spring Port [Embodiment-3] 232 is visible on the assembly, providing access for adjusting air spring pressure within the spring mechanism. Air may be added or removed through the Air Spring Port [Embodiment-3] 232 via the Air Spring Fill Valve [Embodiment-3] 230 to achieve various spring forces depending upon rider weight and ride characteristics. The front hub flange interconnect fastener interface 110 is also shown in relation to the assembly components.

The spring assembly includes a positive chamber, a negative chamber, and a positive/negative bypass feature. The positive chamber contains air that resists movement in the direction from the extended state to the compressed state. The negative chamber contains air that assists movement in the direction from the extended state to the compressed state. The volume and pressure of the negative chamber may be used to reduce friction and/or the positive spring force and may be position sensitive. The positive/negative bypass feature determines when the negative air spring will be effective within the travel range based on the position of the bypass feature in relation to the stator blades. The bypass feature allows air to move past sealing from the negative chamber to the positive chamber and vice versa, but in certain areas of the travel. A common application is to have the negative spring force be active at extension to around rider sag, and then to have the bypass allow for equalization of air pressure between the chambers to minimize this effect.

The Spring Travel Stop [Embodiment-3] 283 may be replaced with varying geometry of the Spring Travel Stop Blade [Embodiment-3] 284 and the Spring Travel Stop Feature [Compressed] [Embodiment-3] 290 and the Spring Travel Stop Feature [Extended] [Embodiment-3] 291 and when these features interact with features of the Rear Wheel Carrier [Non-Drive] [Embodiment-3] 201. This allows the travel to be adjusted, including increased travel, decreased travel, or no travel resulting in a rigid configuration. Replacement of the Spring Travel Stop [Embodiment-3] 283 with varying geometry also allows tuning of the bypass feature to achieve different negative spring characteristics throughout the suspension travel range.

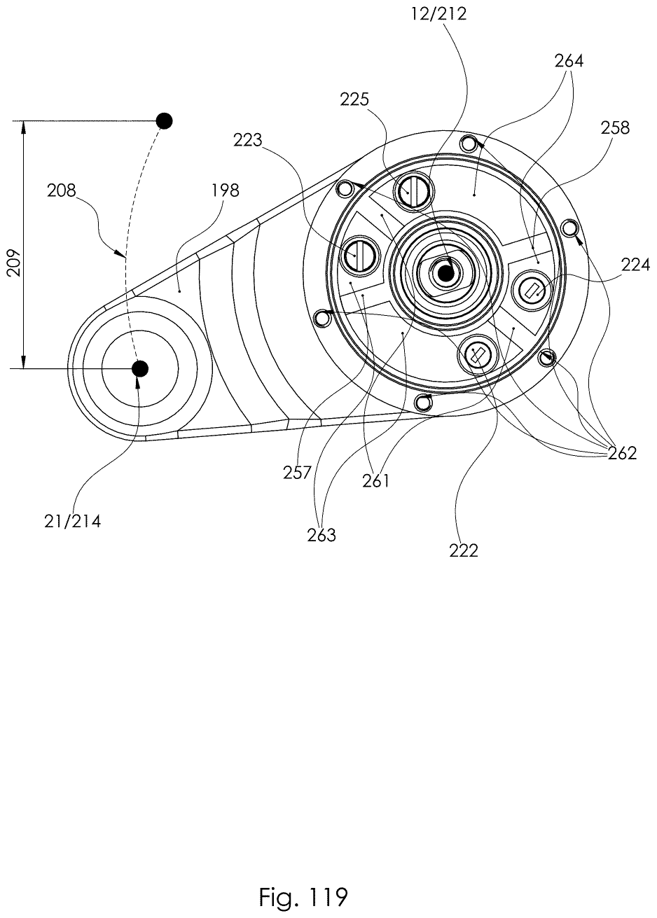

Referring to FIG. 119, a drive-side view of the modular Damper Assembly [Embodiment-3] 234 is shown in the extended state with the Damper Cap [Embodiment-3] 237 removed to reveal the internal components of the rotary damper mechanism. This view shows the arrangement of components within the damper assembly when the suspension is in the extended position.

The Rear Wheel Carrier [Drive] [Embodiment-3] 198 is positioned within the damper assembly and includes the Rear Wheel Carrier Fluid Barrier [Damper] [Embodiment-3] 261, which separates the fluid chambers within the rotary damper. The Rear Wheel Carrier Fluid Barrier [Damper] [Embodiment-3] 261 functions as a rotor blade that moves relative to the Damper Stator [Embodiment-3] 256 during suspension travel. The Damper Cap Fastener Interface [Rear Wheel Carrier] [Embodiment-3] 262 is visible on the Rear Wheel Carrier [Drive] [Embodiment-3] 198, providing mounting locations for securing the Damper Cap [Embodiment-3] 237 to the Rear Wheel Carrier [Drive] [Embodiment-3] 198.

With continued reference to FIG. 119, the damper stator components are shown in their fixed positions relative to the suspended body. The Damper Stator Blade [Compression] [Embodiment-3] 257 and the Damper Stator Blade [Rebound] [Embodiment-3] 258 extend into the damper chamber and interact with the Rear Wheel Carrier Fluid Barrier [Damper] [Embodiment-3] 261 to create resistance during suspension movement.

The Damper Fluid Chamber [Compression] 263 and the Damper Fluid Chamber [Rebound] 264 are visible in this view, showing the volumes of damping fluid on either side of the stator and carrier blades. In the extended state, the Damper Fluid Chamber [Compression] 263 and the Damper Fluid Chamber [Rebound] 264 have sizes determined by the positions of the Damper Stator Blade [Compression] [Embodiment-3] 257, the Damper Stator Blade [Rebound] [Embodiment-3] 258, and the Rear Wheel Carrier Fluid Barrier [Damper] [Embodiment-3] 261. The relative sizes of the Damper Fluid Chamber [Compression] 263 and the Damper Fluid Chamber [Rebound] 264 change as the suspension moves between extended and compressed states, forcing fluid through the damper valves.

As further shown in FIG. 119, four damper valves are shown mounted to the damper assembly. The Damper Valve [Compression][Low Speed] [Embodiment-3] 222 and the Damper Valve [Compression][High Speed] [Embodiment-3] 223 control fluid flow during compression movements at low and high velocities respectively. The Damper Valve [Rebound][Low Speed] [Embodiment-3] 224 and the Damper Valve [Rebound][High Speed] [Embodiment-3] 225 control fluid flow during rebound movements at low and high velocities respectively.

The rear suspension pivot axis 12/212 is indicated at the center of the rotary damper assembly, defining the axis about which the Rear Wheel Carrier [Drive] [Embodiment-3] 198 rotates relative to the suspended body. The rear wheel axis 21/214 is shown at the lower portion of the Rear Wheel Carrier [Drive] [Embodiment-3] 198, indicating the extended position of the wheel axis. The Rear Wheel Axle Path [Embodiment-3] 208 illustrates the arc along which the rear wheel axis travels during suspension movement, and a Vertical Rear Wheel Travel [Embodiment-3] 209 indicates the vertical distance of wheel movement from the extended state to the compressed state.

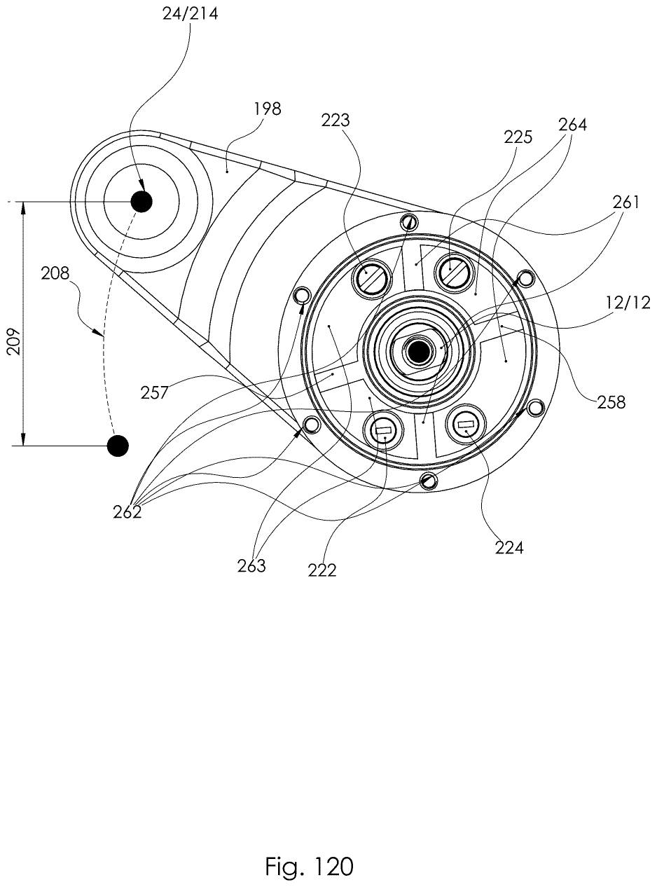

Referring to FIG. 120, a drive-side view of the modular Damper Assembly [Embodiment-3] 234 is shown in the compressed state with the Damper Cap [Embodiment-3] 237 removed so the internals of the assembly are shown. The view depicts the rotary damper mechanism components and their spatial relationships when the suspension is in the compressed position.

The Rear Wheel Carrier [Drive] [Embodiment-3] 198 is shown pivotally connected about a Rear Suspension Pivot Axis 12/12. The Rear Wheel Carrier [Drive] [Embodiment-3] 198 includes the Rear Wheel Carrier Fluid Barrier [Damper] [Embodiment-3] 261, which extends into the damper chamber and has rotated relative to the Damper Stator [Embodiment-3] 256 as the suspension moved from the extended state to the compressed state.

With continued reference to FIG. 120, the Damper Stator Blade [Compression] [Embodiment-3] 257 and the Damper Stator Blade [Rebound] [Embodiment-3] 258 are positioned within the damper assembly and remain stationary relative to the suspended body. The Damper Stator Blade [Compression] [Embodiment-3] 257 and the Damper Stator Blade [Rebound] [Embodiment-3] 258 divide the internal volume into the Damper Fluid Chamber [Compression] 263 and the Damper Fluid Chamber [Rebound] 264. In the compressed state, the sizes of the Damper Fluid Chamber [Compression] 263 and the Damper Fluid Chamber [Rebound] 264 have changed as a result of the rotational movement of the Rear Wheel Carrier Fluid Barrier [Damper] [Embodiment-3] 261 relative to the stator blades. The Damper Fluid Chamber [Compression] 263 has decreased in volume compared to the extended state, while the Damper Fluid Chamber [Rebound] 264 has increased in volume compared to the extended state.

The damper valve components are visible in this view, including the Damper Valve [Compression][Low Speed] [Embodiment-3] 222, the Damper Valve [Compression][High Speed] [Embodiment-3] 223, the Damper Valve [Rebound][Low Speed] [Embodiment-3] 224, and the Damper Valve [Rebound][High Speed] [Embodiment-3] 225. During compression movement from the extended state to the compressed state, damper fluid is forced from the Damper Fluid Chamber [Compression] 263 through the Damper Valve [Compression][Low Speed] [Embodiment-3] 222 and the Damper Valve [Compression][High Speed] [Embodiment-3] 223 to the Damper Fluid Chamber [Rebound] 264. During rebound movement from the compressed state to the extended state, damper fluid is forced from the Damper Fluid Chamber [Rebound] 264 through the Damper Valve [Rebound][Low Speed] [Embodiment-3] 224 and the Damper Valve [Rebound][High Speed] [Embodiment-3] 225 to the Damper Fluid Chamber [Compression] 263.

As further shown in FIG. 120, the Damper Cap Fastener Interface [Rear Wheel Carrier] [Embodiment-3] 262 is shown on the Rear Wheel Carrier [Drive] [Embodiment-3] 198, providing a mounting interface for securing the Damper Cap [Embodiment-3] 237 to the wheel carrier assembly.

The Rear Wheel Axle Path [Embodiment-3] 208 illustrates the arc along which the rear wheel axis has traveled from the extended state to the compressed state. The Vertical Rear Wheel Travel [Embodiment-3] 209 indicates the vertical distance of wheel movement throughout the suspension travel range. A Rear Wheel Axis [Compressed] 24/214 indicates the position of the wheel axis when the suspension is in the compressed state as shown in this view.

The rotary damper mechanism converts motion about the rear suspension pivot axis into heat through the controlled flow of damper fluid through the valves, orifices, or ports. As the Rear Wheel Carrier Fluid Barrier [Damper] [Embodiment-3] 261 moves with respect to the Damper Stator [Embodiment-3] 256, the chamber volumes decrease or increase, forcing damper fluid through the damper valves. The interaction of the fluid and the damper valves may be tuned for various damping behaviors depending upon desired ride feel by adjusting the damper valve adjuster features to open or restrict fluid flow.

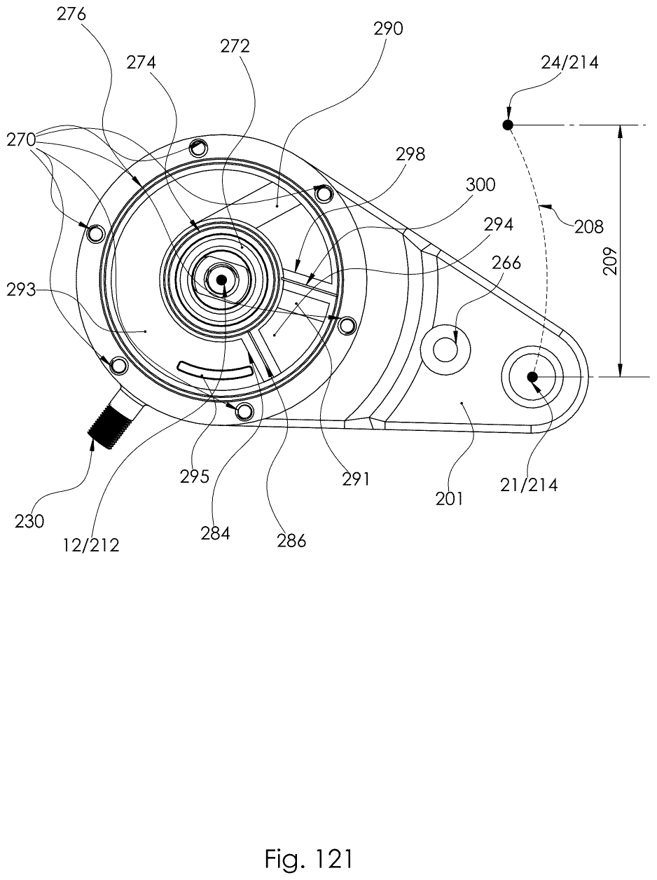

Referring to FIG. 121, a drive-side view of the modular Spring Assembly [Embodiment-3] 235 is shown in the extended state with the Spring Cap [Embodiment-3] 267 removed so the internals of the assembly are shown. This view depicts the internal arrangement of the air spring components within the rotary resistance mechanism of a two-wheeled vehicle rear suspension system.

The Rear Wheel Carrier [Non-Drive] [Embodiment-3] 201 is shown as the primary rotating component of the assembly, pivotally connected about the rear suspension pivot axis 12/212. The rear wheel axis 21/214 indicates the position of the wheel axis in the extended state, while the Rear Wheel Axis [Compressed] 24/214 shows the wheel position at full compression. The Rear Wheel Axle Path [Embodiment-3] 208 illustrates the arc along which the rear wheel axis travels during suspension movement, and the Vertical Rear Wheel Travel [Embodiment-3] 209 indicates the vertical distance of wheel movement throughout the suspension travel range.

With continued reference to FIG. 121, the Air Spring Fill Valve [Embodiment-3] 230 is positioned on the Rear Wheel Carrier [Non-Drive] [Embodiment-3] 201, providing access for adjusting the air spring pressure within the spring assembly. A Rear Wheel Carrier Hub Interconnect Fastener Bore [Non-Drive] [Embodiment-3] 205 is located on the Rear Wheel Carrier [Non-Drive] [Embodiment-3] 201 for securing the hub flange interconnect.

The spring assembly includes the Spring Cap Fastener Interface [Rear Wheel Carrier] [Embodiment-3] 270 for securing the Spring Cap [Embodiment-3] 267 to the Rear Wheel Carrier [Non-Drive] [Embodiment-3] 201. The Spring Cap Bearing [Embodiment-3] 272 facilitates rotational movement between components, with the Spring Cap Bearing Seal [Embodiment-3] 274 providing sealing between moving parts. The Spring Main Seal [Rear Wheel Carrier] [Embodiment-3] 276 interfaces with the Rear Wheel Carrier [Non-Drive] [Embodiment-3] 201 to maintain pressure within the spring chambers.

As further shown in FIG. 121, the Spring Travel Stop Blade [Embodiment-3] 284 extends from the travel stop mechanism, with the Spring Travel Stop Blade Seal [Embodiment-3] 286 providing sealing along the blade interface. The Spring Travel Stop Feature [Compressed] [Embodiment-3] 290 and the Spring Travel Stop Feature [Extended] [Embodiment-3] 291 define the limits of suspension travel by interacting with features on the Rear Wheel Carrier [Non-Drive] [Embodiment-3] 201.

The view reveals a Spring Positive Chamber [Embodiment-3] 293 and a Spring Negative Chamber [Embodiment-3] 294, which contain air that provides spring resistance during suspension movement. The Spring Positive Chamber [Embodiment-3] 293 contains air that resists movement in the direction from the extended state to the compressed state. The Spring Negative Chamber [Embodiment-3] 294 contains air that assists movement in the direction from the extended state to the compressed state. The volume and pressure of the Spring Negative Chamber [Embodiment-3] 294 may be used to reduce friction and/or the positive spring force and may be position sensitive.

A Spring Positive/Negative Bypass [Embodiment-3] 295 feature determines when the negative air spring will be effective within the travel range by allowing air to move between the Spring Positive Chamber [Embodiment-3] 293 and the Spring Negative Chamber [Embodiment-3] 294 in certain areas of the travel. The Spring Positive/Negative Bypass [Embodiment-3] 295 allows air to move past sealing from the Spring Negative Chamber [Embodiment-3] 294 to the Spring Positive Chamber [Embodiment-3] 293 and vice versa, but in certain areas of the travel based on the position of the Spring Positive/Negative Bypass [Embodiment-3] 295 in relation to the stator blades. A common application is to have the negative spring force be active at extension to around rider sag, and then to have the Spring Positive/Negative Bypass [Embodiment-3] 295 allow for equalization of air pressure between the chambers to minimize the negative spring effect.

A Spring Blade [Rear Wheel Carrier][Non-Drive] [Embodiment-3] 298 extends from the Rear Wheel Carrier [Non-Drive] [Embodiment-3] 201 and interfaces with the stator blades during suspension movement. The Spring Blade Seal [Rear Wheel Carrier][Non-Drive] [Embodiment-3] 300 provides sealing along the blade interface to maintain pressure separation between the Spring Positive Chamber [Embodiment-3] 293 and the Spring Negative Chamber [Embodiment-3] 294. In the extended state shown in FIG. 121, the Spring Positive Chamber [Embodiment-3] 293 and the Spring Negative Chamber [Embodiment-3] 294 have sizes determined by the positions of the Spring Stator Blade [Compression] [Embodiment-3] 278, the Spring Stator Blade [Rebound] [Embodiment-3] 279, and the Spring Blade [Rear Wheel Carrier][Non-Drive] [Embodiment-3] 298.

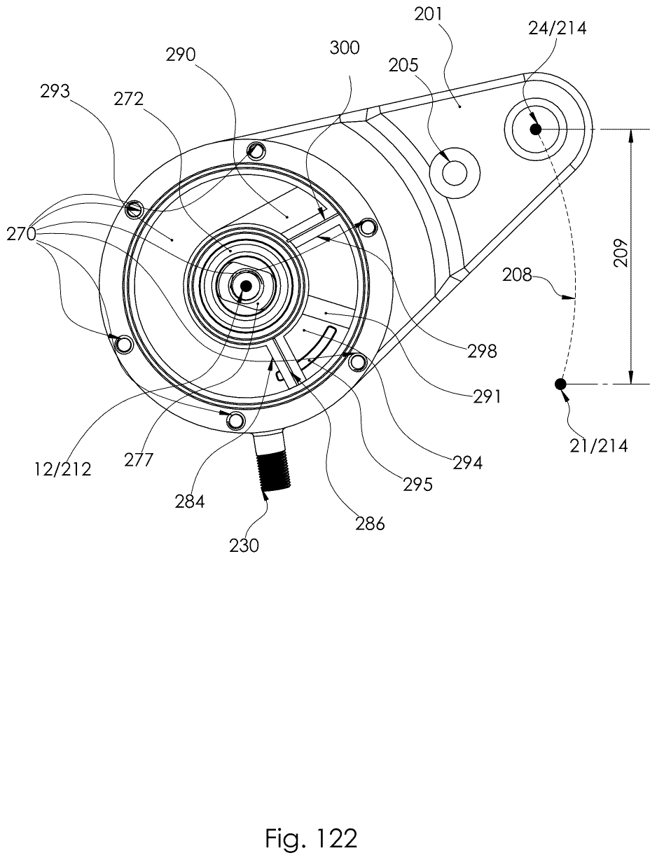

Referring to FIG. 122, a drive-side view of the modular Spring Assembly [Embodiment-3] 235 is shown in the compressed state with the Spring Cap [Embodiment-3] 267 removed so the internals of the assembly are shown. This view depicts the rotary air spring mechanism when the suspension is in the compressed position.

The Rear Wheel Carrier [Non-Drive] [Embodiment-3] 201 is shown in the compressed position, with the rear suspension pivot axis 12/212 defining the rotational center of the suspension system. The rear wheel axis 21/214 and the Rear Wheel Axis [Compressed] 24/214 indicate the wheel position in the compressed state. The Rear Wheel Axle Path [Embodiment-3] 208 illustrates the arc along which the rear wheel axis has traveled from the extended state to the compressed state, and the Vertical Rear Wheel Travel [Embodiment-3] 209 indicates the vertical distance of wheel movement throughout the suspension travel range.

With continued reference to FIG. 122, the Spring Stator [Embodiment-3] 277 is positioned within the assembly and remains stationary relative to the suspended body throughout the suspension travel. The Spring Travel Stop Blade [Embodiment-3] 284 extends from the travel stop mechanism and includes the Spring Travel Stop Blade Seal [Embodiment-3] 286 to provide sealing between moving components. The Spring Travel Stop Feature [Compressed] [Embodiment-3] 290 and the Spring Travel Stop Feature [Extended] [Embodiment-3] 291 define the limits of suspension travel by interacting with features on the Rear Wheel Carrier [Non-Drive] [Embodiment-3] 201.

The Spring Blade [Rear Wheel Carrier][Non-Drive] [Embodiment-3] 298 extends from the Rear Wheel Carrier [Non-Drive] [Embodiment-3] 201 and has rotated relative to the Spring Stator [Embodiment-3] 277 as the suspension moved from the extended state to the compressed state. The Spring Blade Seal [Rear Wheel Carrier][Non-Drive] [Embodiment-3] 300 maintains separation between the air chambers during this rotational movement.

As further shown in FIG. 122, the Spring Positive Chamber [Embodiment-3] 293 and the Spring Negative Chamber [Embodiment-3] 294 have changed in volume compared to the extended state shown in FIG. 121. In the compressed state, the Spring Positive Chamber [Embodiment-3] 293 has decreased in volume as the Spring Blade [Rear Wheel Carrier][Non-Drive] [Embodiment-3] 298 has rotated toward the Spring Stator Blade [Compression] [Embodiment-3] 278, compressing the air within the Spring Positive Chamber [Embodiment-3] 293 and increasing the spring resistance. The Spring Negative Chamber [Embodiment-3] 294 has increased in volume as the Spring Blade [Rear Wheel Carrier][Non-Drive] [Embodiment-3] 298 has rotated away from the Spring Stator Blade [Rebound] [Embodiment-3] 279.

The Spring Positive/Negative Bypass [Embodiment-3] 295 is visible in the compressed state, with the position of the Spring Positive/Negative Bypass [Embodiment-3] 295 relative to the stator blades determining whether air can flow between the Spring Positive Chamber [Embodiment-3] 293 and the Spring Negative Chamber [Embodiment-3] 294. When the suspension is in the compressed state as shown in FIG. 122, the Spring Positive/Negative Bypass [Embodiment-3] 295 may allow equalization of air pressure between the Spring Positive Chamber [Embodiment-3] 293 and the Spring Negative Chamber [Embodiment-3] 294, minimizing the negative spring effect in this portion of the travel range.

The Spring Cap Bearing [Embodiment-3] 272 is installed within the assembly to reduce rotational friction during suspension movement. The Spring Cap Fastener Interface [Rear Wheel Carrier] [Embodiment-3] 270 provides mounting points for securing the Spring Cap [Embodiment-3] 267 to the Rear Wheel Carrier [Non-Drive] [Embodiment-3] 201. The Air Spring Fill Valve [Embodiment-3] 230 is visible, providing access for adjusting the air spring pressure within the spring assembly. The Rear Wheel Carrier Hub Interconnect Fastener Bore [Non-Drive] [Embodiment-3] 205 is located on the Rear Wheel Carrier [Non-Drive] [Embodiment-3] 201 to receive a fastener for securing the hub flange interconnect.

The rotary air spring mechanism converts rotational motion about the rear suspension pivot axis 12/212 into spring resistance through the compression and expansion of air within the Spring Positive Chamber [Embodiment-3] 293 and the Spring Negative Chamber [Embodiment-3] 294. As the Spring Blade [Rear Wheel Carrier][Non-Drive] [Embodiment-3] 298 moves with respect to the Spring Stator [Embodiment-3] 277, the chamber volumes decrease or increase, providing spring resistance that varies throughout the suspension travel range. The Spring Positive/Negative Bypass [Embodiment-3] 295 provides position-sensitive control over the interaction between the Spring Positive Chamber [Embodiment-3] 293 and the Spring Negative Chamber [Embodiment-3] 294, allowing the negative spring characteristics to be tuned for different portions of the suspension travel.

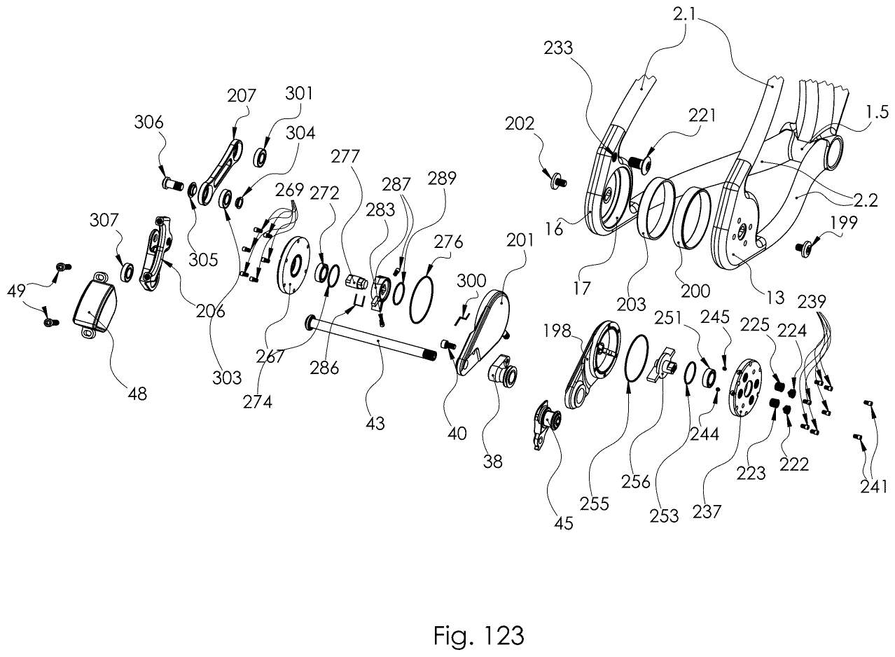

Referring to FIG. 123, a detailed isometric exploded view of embodiment 3 is shown depicting both the damper and spring sides of the rear suspension system with all components arranged to illustrate the complete assembly relationships. The exploded view reveals the spatial relationships between the frame structure, the wheel carriers, the brake carrier linkage assembly, the damper assembly, and the spring assembly as these components would be assembled into the rear triangle structure of a two-wheeled vehicle.

The upper portion of the exploded view shows the frame structure including the chainstay and the seatstay, which converge at the rear suspension pivot structure on the drive side and the rear suspension pivot structure on the non-drive side. The bottom bracket or drive unit interface or gearbox interface is visible at the forward end of the chainstay. The rear suspension pivot aperture/bore on the non-drive side is a feature of the rear suspension pivot structure on the non-drive side. The fastener interface for the pivotal connection between the suspended body and the brake link is located on the rear suspension pivot structure to receive the corresponding fastener.

With continued reference to FIG. 123, on the drive side, the damper assembly components are shown in exploded arrangement. The damper cap is positioned at the outer portion of the assembly and is secured by damper cap fasteners. Damper cap bleed port fasteners provide access for adding and bleeding damper fluid. Port plug fasteners for compression and rebound seal the respective fluid ports. The damper cap bearing and damper cap bearing seal facilitate rotational movement while maintaining fluid containment. The damper main seal interfaces with the wheel carrier. The damper stator is positioned within the assembly. The damper valve components include compression low speed, compression high speed, rebound low speed, and rebound high speed valves, which control fluid flow during compression and rebound movements at varying velocities. The rear wheel carrier on the drive side is shown in the exploded view with the rear wheel carrier bushing positioned to be installed into the rear suspension pivot structure on the drive side.

On the non-drive side, the spring assembly components are depicted in the exploded view. The spring cap is secured by spring cap fasteners. The spring cap bearing and spring cap bearing seal facilitate rotation while maintaining sealing. The spring main seal interfaces with the wheel carrier. The spring stator is positioned within the assembly. The spring travel stop is secured by spring travel stop fasteners, with the spring travel stop blade seal and spring travel stop seal providing sealing. The spring blade seal on the rear wheel carrier seals the wheel carrier blade interface. The rear wheel carrier on the non-drive side is shown in the exploded view with the rear wheel carrier bushing positioned to be installed into the rear suspension pivot structure on the non-drive side. The rear wheel carrier fastener on the non-drive side secures the rear wheel carrier to the rear suspension pivot structure.

As further shown in FIG. 123, the brake carrier linkage assembly includes the rear wheel brake carrier and the rear wheel brake link. The brake carrier linkage assembly is configured to be installed on the non-drive side of the rear suspension system, with the fastener securing the pivotal connection between the suspended body and the brake link through the fastener interface on the rear suspension pivot structure. The bearing at this pivotal connection supports the rotational movement of the brake link relative to the suspended body. The bearing at the pivotal connection between the brake carrier and the brake link is positioned with inner and outer bearing spacers, secured by the corresponding fastener. The bearing at the wheel axis supports the pivotal connection between the wheel carrier and the brake carrier. The rear brake caliper is mounted via rear brake caliper fasteners.

The rear hub flange interconnect and rear hub flange interconnect fastener interface with the rear wheel axle to provide structural connection between the wheel carrier bodies on opposite sides of the suspension system. The rear derailleur hanger is positioned on the rear wheel carrier on the drive side.

The drive side and non-drive side resistance mechanisms may be different from each other. In embodiment 3 as shown in FIG. 123, the damper assembly is positioned on the drive side while the spring assembly is positioned on the non-drive side. In other embodiments, these positions may be reversed, with the spring assembly positioned on the drive side and the damper assembly positioned on the non-drive side. The modular configuration of the damper assembly and the spring assembly allows various combinations of resistance mechanisms to be installed on the drive and non-drive sides depending upon the desired suspension characteristics and packaging requirements.

In some embodiments, an elastomer spring version of the resistance mechanism may be used on one side while a resistance-free bearing may be used on the other side. The resistance-free bearing configuration may provide rotational support at the suspension pivot axis without providing spring or damping resistance, allowing the resistance mechanism on the opposite side to provide the entirety of the spring and/or damping characteristics for the suspension system. This configuration may reduce weight and complexity while maintaining the structural support provided by the pivotal connection on both sides of the suspension system.

The modular configuration of the damper assembly and the spring assembly allows these resistance mechanisms to be installed into the suspension system as self-contained units. Each modular mechanism may be assembled, tested, and serviced independently from the vehicle frame. In some embodiments, a modular mechanism may provide a fixed suspension travel, wherein the travel range is determined by the geometry of the module components. A module set providing 0 mm of travel may result in a rigid rear end configuration where no relative motion occurs between the wheel carrier and the suspended body, effectively converting the suspension system to a rigid configuration through module selection.

The complete assembly of embodiment 3 demonstrates how the various sub-assemblies interface with the frame structure and with each other to form a functional rear suspension system. The damper assembly and the spring assembly are configured as stand-alone sub-assemblies that may be built separately from the rest of the vehicle and then installed as modules into the respective rear suspension pivot structures. The brake carrier linkage assembly provides independent movement of the brake carrier relative to the wheel carrier, enabling independent tuning of the deceleration response through the brake carrier geometry while the wheel carrier geometry determines the acceleration response.

In some two-wheeled vehicles, rear rotary suspension may be used without front rotary suspension. In such configurations, the front wheel may be supported by a rigid fork or by a conventional linear suspension fork while the rear wheel is supported by the rotary suspension system as described herein. In other two-wheeled vehicles, front rotary suspension may be used without rear rotary suspension. In such configurations, the rear wheel may be supported by a rigid rear triangle or by a conventional linear rear suspension system while the front wheel is supported by the rotary suspension system as described herein. The rotary suspension system may be applied to the rear suspension, the front suspension, or both the rear and front suspensions depending upon the design goals and the intended use of the two-wheeled vehicle.

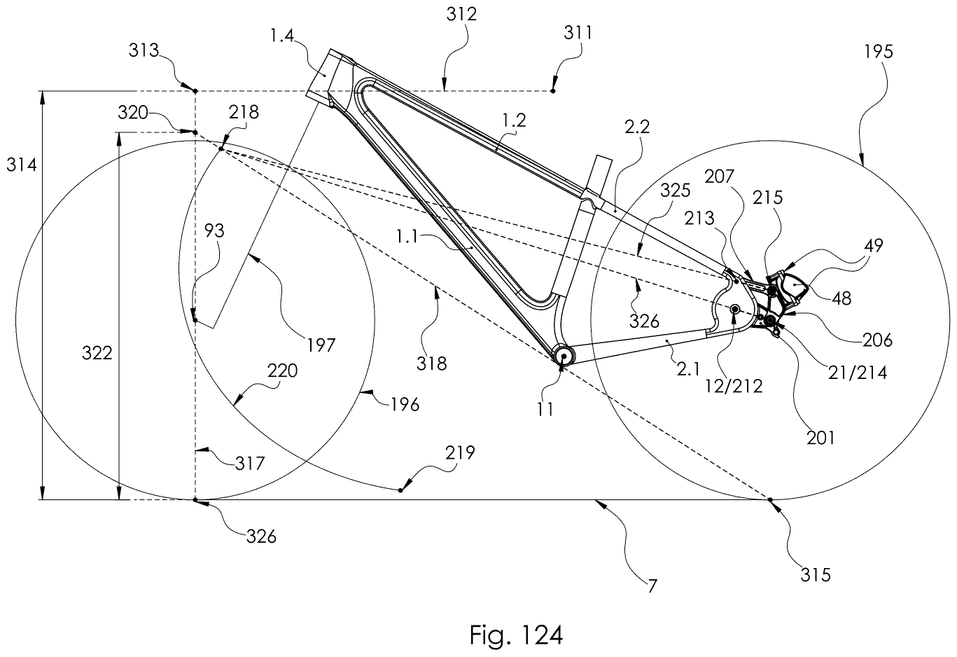

Referring to FIG. 124, a non-drive-side view of a complete two-wheeled vehicle is shown with embodiment 3 of the disclosed rear rotary suspension system in the extended state to illustrate the anti-rise behavior of the suspension system. The two-wheeled vehicle frame includes the front triangle comprising the down tube 1.1, the top tube 1.2, and the head tube 1.4. The rear triangle includes the chainstay 2.1 and the seatstay 2.2. A rear tire outer diameter 195 is represented as a circular outline indicating the position and size of the rear tire. The front portion of the two-wheeled vehicle is represented by a fork schematic 197 and a front tire outer diameter 196 shown as line diagrams for simplicity and clarity. The front wheel axis [Extended] 93 is indicated at the front of the two-wheeled vehicle. The crank axis 11 is shown at the bottom bracket area of the frame.

The Rear Wheel Carrier [Non-Drive] [Embodiment-3] 201 is pivotally connected to the rear suspension pivot structure about the rear suspension pivot axis 12/212. The rear wheel axis 21/214 defines the rotational axis of the rear wheel in the extended state. The Rear Wheel Brake Carrier [Non-Drive] [Embodiment-3] 206 and the Rear Wheel Brake Link [Non-Drive] [Embodiment-3] 207 form part of the Brake Carrier Linkage Assembly [Embodiment-3] 236 that allows independent movement of the brake carrier relative to the wheel carrier. The rear brake caliper 48 is mounted to the Rear Wheel Brake Carrier [Non-Drive] [Embodiment-3] 206 via the rear brake caliper fasteners 49.

With continued reference to FIG. 124, the IVC[1][4] [Embodiment-3] 213 represents the pivotal connection between the suspended body and the Rear Wheel Brake Link [Non-Drive] [Embodiment-3] 207, while the IVC[3][4] [Embodiment-3] 215 represents the pivotal connection between the Rear Wheel Brake Carrier [Non-Drive] [Embodiment-3] 206 and the Rear Wheel Brake Link [Non-Drive] [Embodiment-3] 207. An IVC[1][4]-IVC[3][4] Line [Embodiment-3] 324 is coincident to IVC[1][4] [Embodiment-3] 213 and IVC[3][4] [Embodiment-3] 215. An IVC[1][2]-IVC[2][3] Line [Embodiment-3] 325 is coincident to DIVC[A][1][2] [Embodiment-3] 212 and IVC[2][3] [Embodiment-3] 214.

The IVC[1][4]-IVC[3][4] Line [Embodiment-3] 324 intersects with the IVC[1][2]-IVC[2][3] Line [Embodiment-3] 325 at an DIVC[D][1][3][Extended] [Embodiment-3] 218, which represents a dynamic instantaneous velocity center of the brake carrier relative to the suspended body in the extended state. An DIVC[D][1][3] [Embodiment-3] 217 is a derived or virtual instantaneous velocity center that defines the relationship between the suspended body and the brake carrier. An IVC[2][4] [Embodiment-3] 216 is another derived instantaneous velocity center that defines the relationship between the wheel carrier and the Rear Wheel Brake Link [Non-Drive] [Embodiment-3] 207. An DIVC[D][1][3][Compressed] [Embodiment-3] 219 shows the position of the DIVC[D][1][3] [Embodiment-3] 217 in the compressed state, and an DIVC[D][1][3][Migration] [Embodiment-3] 220 illustrates the migration path of the DIVC[D][1][3] [Embodiment-3] 217 throughout the suspension travel range from the extended state to the compressed state.

As further shown in FIG. 124, a Center of Gravity [Embodiment-3] 311 represents the center of mass of the suspended body of the vehicle including the rider, passengers, and any cargo. A Center of Gravity Horizontal [Embodiment-3] 312 is a line drawn parallel to the ground through the Center of Gravity [Embodiment-3] 311. A Squat Layout Line [Embodiment-3] 317 extends from a Front Wheel Tire to Ground Tangent Point [Embodiment-3] 326 through the Center of Gravity [Embodiment-3] 311. A Center of Gravity Definition [Embodiment-3] 313 is the point where the Center of Gravity Horizontal [Embodiment-3] 312 intersects the Squat Layout Line [Embodiment-3] 317. A Center of Gravity Measured Distance [Embodiment-3] 314 is the perpendicular distance from the ground [Extended] 7 to the Center of Gravity Horizontal [Embodiment-3] 312.

A Rear Wheel Tire to Ground Tangent Point [Extended] [Embodiment-3] 315 indicates where the rear tire contacts the ground [Extended] 7 in the extended state. The Front Wheel Tire to Ground Tangent Point [Embodiment-3] 326 indicates where the front tire contacts the ground [Extended] 7.

With continued reference to FIG. 124, an Anti-Rise Force Vector [Extended] [Embodiment-3] 318 is a line that intersects the Rear Wheel Tire to Ground Tangent Point [Extended] [Embodiment-3] 315 and the IVC[1][3][Extended] [Embodiment-3] 218. An Anti-Rise Definition Point [Extended] [Embodiment-3] 320 is defined where the Anti-Rise Force Vector [Extended] [Embodiment-3] 318 intersects the Squat Layout Line [Embodiment-3] 317. An Anti-Rise Measured Distance [Extended] [Embodiment-3] 322 is the perpendicular distance from the ground [Extended] 7 to the Anti-Rise Definition Point [Extended] [Embodiment-3] 320.

The anti-rise percentage at extension is calculated using the following formula: anti-rise percentage at extension equals the Anti-Rise Measured Distance [Extended] [Embodiment-3] 322 divided by the Center of Gravity Measured Distance [Embodiment-3] 314, multiplied by 100 percent. This calculation determines the degree to which the suspension linkage geometry counteracts the tendency of the rear suspension to extend during deceleration events such as braking. Note if the Anti-Rise Definition Point [Extended] [Embodiment-3] 320 is below ground [Extended] 7, the anti-rise value is negative.

The position of the DIVC[D][1][3][Extended] [Embodiment-3] 218 relative to the Rear Wheel Tire to Ground Tangent Point [Extended] [Embodiment-3] 315 and the Squat Layout Line [Embodiment-3] 317 determines the anti-rise behavior of the suspension system in the extended state. The DIVC[D][1][3][Migration] [Embodiment-3] 220 shows how the DIVC[D][1][3] [Embodiment-3] 217 moves as the suspension travels from the extended state to the compressed state, which affects the anti-rise percentage throughout the suspension travel range. The separation of the brake carrier from the wheel carrier in embodiment 3 allows the DIVC[D][1][3] [Embodiment-3] 217 to be positioned independently from the DIVC[A][1][2] [Embodiment-3] 212, enabling independent tuning of the anti-rise behavior separate from the anti-squat behavior of the suspension system.

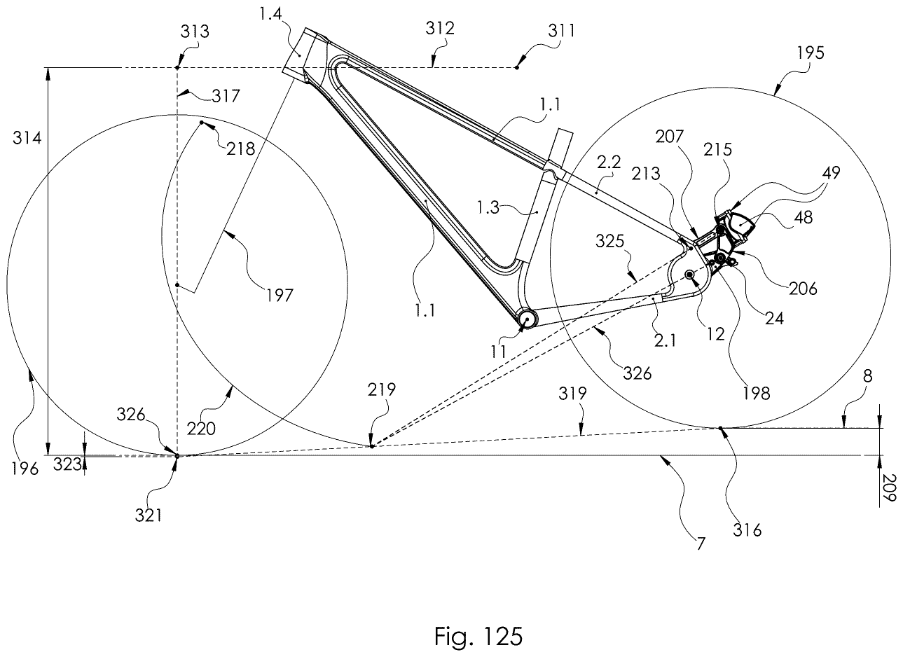

Referring to FIG. 125, a non-drive-side view of the complete two-wheeled vehicle is shown with embodiment 3 of the disclosed rear rotary suspension system in the compressed state to illustrate the anti-rise behavior. The two-wheeled vehicle frame includes the front triangle comprising the down tube 1.1, the seat tube 1.3, and the head tube 1.4. The rear triangle includes the chainstay 2.1 and the seatstay 2.2. The crank axis 11 is shown at the bottom bracket area of the frame. The rear suspension pivot axis 12 defines the rotational axis about which the suspension components pivot relative to the suspended body. The rear tire outer diameter 195 is represented as a circular outline indicating the position and size of the rear tire. The front tire outer diameter 196 and the fork schematic 197 are represented by line diagrams for simplicity and clarity.

The Rear Wheel Carrier [Drive] [Embodiment-3] 198 is pivotally connected to the rear suspension pivot structure about the rear suspension pivot axis 12. The Rear Wheel Brake Carrier [Non-Drive] [Embodiment-3] 206 and the Rear Wheel Brake Link [Non-Drive] [Embodiment-3] 207 form part of the Brake Carrier Linkage Assembly [Embodiment-3] 236. The rear brake caliper 48 is mounted to the Rear Wheel Brake Carrier [Non-Drive] [Embodiment-3] 206 via the rear brake caliper fasteners 49. The Rear Wheel Axis [Compressed] 24 indicates the position of the wheel axis in the compressed state. The Vertical Rear Wheel Travel [Embodiment-3] 209 represents the distance between the ground [Extended] 7 and the ground [Compressed] 8.

With continued reference to FIG. 125, the IVC[1][4] [Embodiment-3] 213 represents the pivotal connection between the suspended body and the Rear Wheel Brake Link [Non-Drive] [Embodiment-3] 207, while the IVC[3][4] [Embodiment-3] 215 represents the pivotal connection between the Rear Wheel Brake Carrier [Non-Drive] [Embodiment-3] 206 and the Rear Wheel Brake Link [Non-Drive] [Embodiment-3] 207. The IVC[1][2]-IVC[2][3] Line [Embodiment-3] 325 intersects with a line connecting the IVC[1][4] [Embodiment-3] 213 and the IVC[3][4] [Embodiment-3] 215 at the DIVC[D][1][3][Compressed] [Embodiment-3] 219. The DIVC[D][1][3][Extended] [Embodiment-3] 218 indicates the position of the DIVC[D][1][3] [Embodiment-3] 217 in the extended state, and the DIVC[D][1][3][Migration] [Embodiment-3] 220 shows the migration path of all instances of the DIVC[D][1][3] [Embodiment-3] 217 from the extended state to the compressed state.

As further shown in FIG. 125, a Rear Wheel Tire to Ground Tangent Point [Compressed] [Embodiment-3] 316 indicates where the rear tire contacts the ground [Compressed] 8 in the compressed state. An Anti-Rise Force Vector [Compressed] [Embodiment-3] 319 is a line that intersects the Rear Wheel Tire to Ground Tangent Point [Compressed] [Embodiment-3] 316 and the DIVC[D][1][3][Compressed] [Embodiment-3] 219. An Anti-Rise Definition Point [Compressed] [Embodiment-3] 321 is defined where the Anti-Rise Force Vector [Compressed] [Embodiment-3] 319 intersects the Squat Layout Line [Embodiment-3] 317. An Anti-Rise Measured Distance [Compressed] [Embodiment-3] 323 is the perpendicular distance from the ground [Extended] 7 to the Anti-Rise Definition Point [Compressed] [Embodiment-3] 321.

The Center of Gravity [Embodiment-3] 311 represents the center of mass of the suspended body of the vehicle including the rider, passengers, and any cargo. The Center of Gravity Horizontal [Embodiment-3] 312 is a line drawn parallel to the ground through the Center of Gravity [Embodiment-3] 311. The Center of Gravity Definition [Embodiment-3] 313 is the point where the Center of Gravity Horizontal [Embodiment-3] 312 intersects the Squat Layout Line [Embodiment-3] 317. The Center of Gravity Measured Distance [Embodiment-3] 314 is the perpendicular distance from the ground [Extended] 7 to the Center of Gravity Horizontal [Embodiment-3] 312. The Front Wheel Tire to Ground Tangent Point [Embodiment-3] 326 indicates the contact point between the front tire and the ground.

The anti-rise percentage at compression is calculated using the following formula: anti-rise percentage at compression equals the Anti-Rise Measured Distance [Compressed] [Embodiment-3] 323 divided by the Center of Gravity Measured Distance [Embodiment-3] 314, multiplied by 100 percent. This calculation determines the degree to which the suspension linkage geometry counteracts the tendency of the rear suspension to extend during deceleration events such as braking when the suspension is in a compressed state. Note if the Anti-Rise Definition Point [Compressed] [Embodiment-3] 321 is below ground [Extended] 7, the anti-rise value is negative.

The Rear Wheel Tire to Ground Tangent Point [Compressed] [Embodiment-3] 316 and the ground [Extended] 7 define the Vertical Rear Wheel Travel [Embodiment-3] 209. The position of the DIVC[D][1][3][Compressed] [Embodiment-3] 219 relative to the Rear Wheel Tire to Ground Tangent Point [Compressed] [Embodiment-3] 316 and the Squat Layout Line [Embodiment-3] 317 determines the anti-rise behavior of the suspension system in the compressed state.

The separation of the wheel carrier and the brake carrier bodies in embodiment 3 enables independent tuning of the anti-rise behavior. The DIVC[A][1][2] [Embodiment-3] 212 defines the acceleration response of the vehicle through the wheel carrier geometry, while the DIVC[D][1][3] [Embodiment-3] 217 defines the deceleration response through the brake carrier geometry. The IVC[1][3][Migration] [Embodiment-3] 220 demonstrates how the IVC[1][3] [Embodiment-3] 217 moves as the suspension travels from the extended state to the compressed state, which affects the anti-rise percentage throughout the suspension travel range.

Due to the position of the DIVC[A][1][2] [Embodiment-3] 212 with respect to the rear wheel axis, the anti-squat percentage as in embodiments 1 and 2 may be relatively high compared to conventional designs where the brake carrier is the same body as the wheel carrier. The increase of kinematic bodies in embodiment 3 allows for brake carrier movement wherein the anti-rise may be tuned into a range that differs from the anti-squat behavior. The anti-rise percentage may be within a range of +/−200% or +/−100% depending upon the IVC locations and link geometry. The anti-rise behavior is highly tunable depending upon desired ride qualities, and many anti-rise curves are possible depending upon the IVC location and link geometry of the Brake Carrier Linkage Assembly [Embodiment-3] 236.

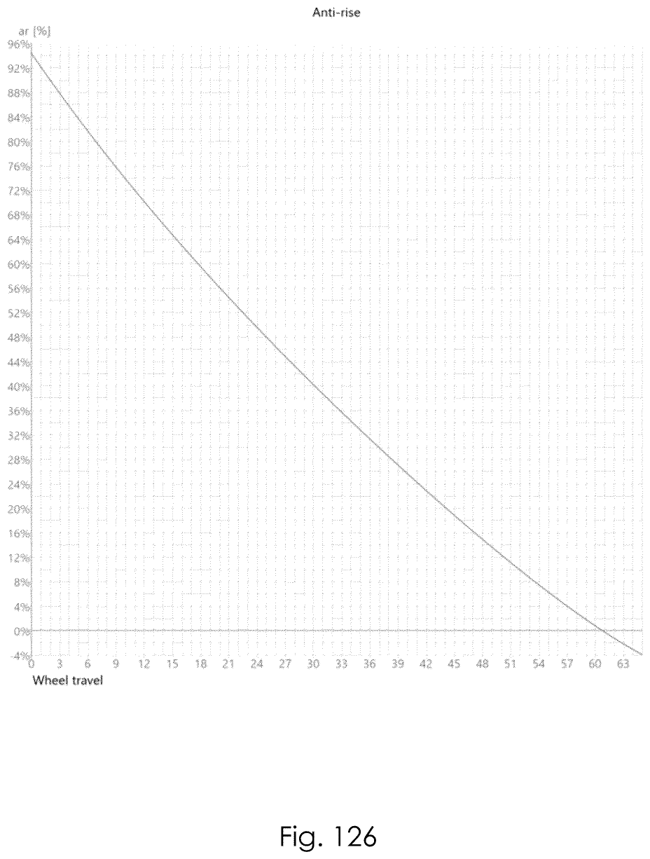

Referring to FIG. 126, an anti-rise percentage versus wheel travel plot is shown for embodiment 3 of the disclosed rear rotary suspension system. The vertical axis represents anti-rise percentage, ranging from negative four percent at the bottom to ninety-six percent at the top, with increments of four percent. The horizontal axis represents wheel travel, ranging from zero to sixty-three units, with increments of three units.

A single curve is plotted on the graph, starting at approximately ninety-two percent anti-rise at zero wheel travel and decreasing in a generally linear manner as wheel travel increases. The curve continues downward, passing through approximately fifty percent anti-rise at around thirty-three units of wheel travel, and reaches approximately zero percent anti-rise at around fifty-seven units of wheel travel. The curve extends slightly below zero percent anti-rise as wheel travel approaches the maximum value shown on the horizontal axis.

With continued reference to FIG. 126, the plot illustrates the anti-rise behavior of embodiment 3 throughout the suspension travel range, demonstrating that the anti-rise percentage decreases from a high value near full extension to approximately zero percent at full compression. The anti-rise percentage at the extended position is approximately ninety-two percent, and the anti-rise percentage at the compressed position is approximately zero percent where the vertical wheel travel is equal to approximately sixty-five millimeters.

The four-bar linkage arrangement of embodiment 3 enables tuning of the anti-rise into a range that differs from embodiments where the brake carrier is the same body as the wheel carrier. In embodiments 1 and 2, where the brake carrier is the same body as the wheel carrier, the anti-rise percentage may be relatively high throughout the suspension travel range due to the position of the dynamic instantaneous velocity center of the wheel carrier relative to the suspended body with respect to the rear wheel axis. The separation of the brake carrier from the wheel carrier in embodiment 3 allows the instantaneous velocity center of the brake carrier relative to the suspended body to be positioned independently, enabling the anti-rise to be tuned into a more traditional range of approximately zero percent to one hundred percent.

The anti-rise behavior shown in FIG. 126 demonstrates that the suspension system provides approximately one hundred percent anti-rise near the extended position, where the anti-rise force is approximately equal and opposite to the load transfer force due to deceleration, resulting in minimal suspension rise during braking events. As the suspension compresses, the anti-rise percentage decreases toward zero percent at full compression, where there is minimal anti-rise force to counteract the load transfer. This configuration may provide improved traction during braking events while maintaining geometry stability during deceleration, with the anti-rise percentage remaining within a range that balances these characteristics throughout the suspension travel.

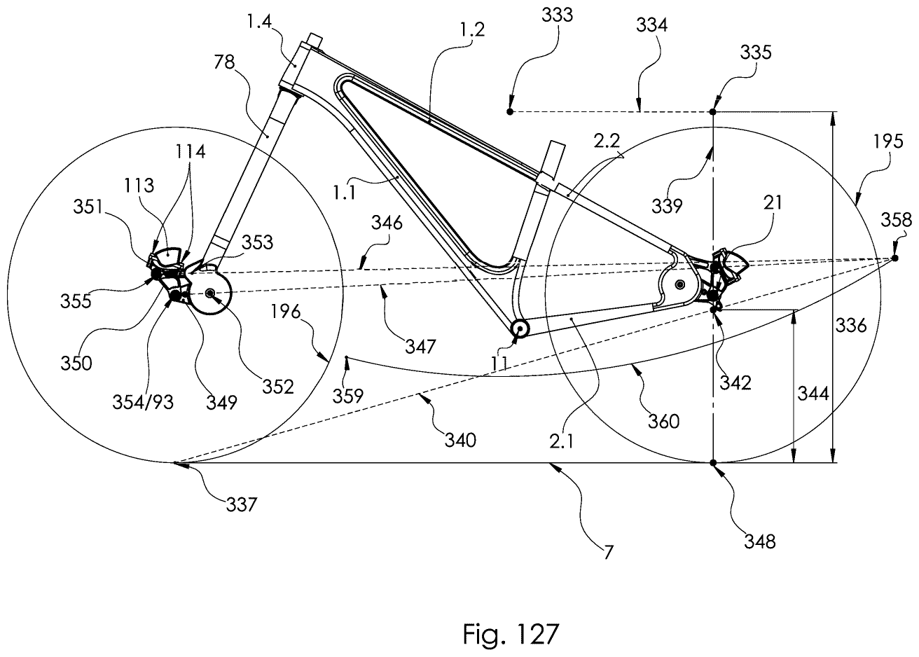

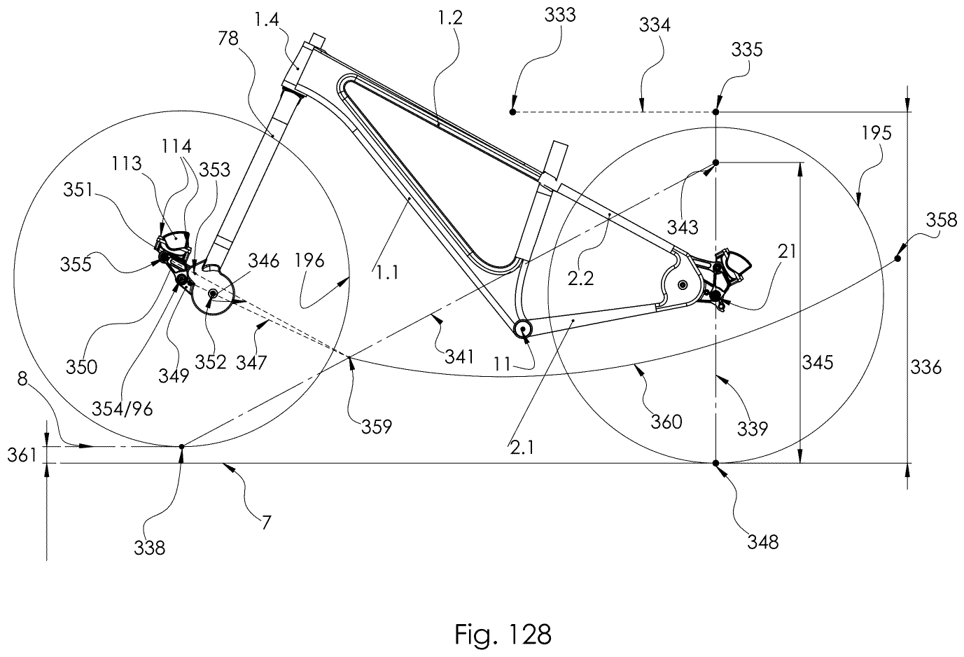

FIGS. 127 and 128 show a non-drive-side view of the two-wheeled vehicle of embodiment 4, in the extended and compressed states of the fork respectively of the disclosed rear rotary suspension system, while the suspended body remains stationary. In many configurations, there is no DIVC[A] associated, but rather a DIVC[D] for a fork as in many configurations the rear wheel is driven. Similar to how the DIVC[D] for a rear suspension defines the anti-rise behavior of the vehicle, the DIVC[D] for a front suspension defines the anti-dive behavior, or the pitch behavior of the vehicle with respect to the front suspension when decelerating (braking). The brake carrier may be configured to have a stationary DIVC[D], or a migrating DIVC[D] depending on the anti-dive performance characteristics desired. Embodiment 4 is an example of a migrating DIVC[D]. Compared to a traditional telescoping or linear fork, this layout offers greater tunability of the anti-dive. In particular, nearly all telescoping forks result in a negative anti-dive curve (where the DIVC[D] is located below the ground [Extended] 7) in at least a portion of the suspension travel. This behavior may not be desirable as it may cause the vehicle to pitch forward during braking causing instability. Using a fork that utilizes radial joints vs telescoping, or a migrating DIVC[D] allows for greater tunability, including positive anti-dive values. This configuration may preserve the chassis geometry during braking allowing the rider to have more control.

Referring to FIG. 127, a non-drive-side view of a complete two-wheeled vehicle is shown with embodiment 4 of the disclosed front rotary suspension system in the extended state to illustrate the anti-dive behavior of the front suspension system. The two-wheeled vehicle frame includes the front triangle comprising the down tube 1.1, the top tube 1.2, and the head tube 1.4. The rear triangle includes the chainstay 2.1 and the seatstay 2.2. A rear tire outer diameter 195 is represented as a circular outline indicating the position and size of the rear tire. The front suspension of the two-wheeled vehicle with fork upper 78 and a front tire outer diameter 196 shown as line diagrams for simplicity and clarity. The front wheel axis [Extended] 93 is indicated at the front of the two-wheeled vehicle. The crank axis 11 is shown at the bottom bracket area of the frame. The rear wheel axis 21 defines the rotational axis of the rear wheel in the extended state.

With continued reference to FIG. 127, the IVC[1][4] [Embodiment-4] 353 represents the pivotal connection between the suspended body and the Front Wheel Brake Link [Non-Drive] [Embodiment-4] 351, while the IVC[3][4] [Embodiment-4] 355 represents the pivotal connection between the Front Wheel Brake Carrier [Non-Drive] [Embodiment-4] 350 and the Front Wheel Brake Link [Non-Drive] [Embodiment-4] 351. An IVC[1][4]-IVC[3][4] Line [Embodiment-4] 346 is coincident to IVC[1][4] [Embodiment-4] 353 and IVC[3][4] [Embodiment-4] 355. An IVC[1][2]-IVC[2][3] Line [Embodiment-4] 347 is coincident to IVC[1][2] [Embodiment-4] 352 and IVC[2][3] [Embodiment-4] 354. The IVC[1][4]-IVC[3][4] Line [Embodiment-4] 346 intersects with the IVC[1][2]-IVC[2][3] Line [Embodiment-4] 347 at a DIVC[D][1][3][Extended] [Embodiment-4] 358, which represents a dynamic instantaneous velocity center of the brake carrier relative to the suspended body in the extended state. A DIVC[D][1][3] [Embodiment-4] 357 is a derived or virtual instantaneous velocity center that defines the relationship between the suspended body and the front brake carrier. An IVC[2][4] [Embodiment-4] 356 is another derived instantaneous velocity center that defines the relationship between the wheel carrier and the Front Wheel Brake Link [Non-Drive] [Embodiment-4] 350. A DIVC[D][1][3][Compressed] [Embodiment-4] 359 shows the position of the DIVC[D][1][3] [Embodiment-4] 357 in the compressed state, and an DIVC[D][1][3][Migration] [Embodiment-4] 360 illustrates the migration path of the DIVC[D][1][3] [Embodiment-4] 357 throughout the suspension travel range from the extended state to the compressed state.

As further shown in FIG. 127, a Center of Gravity [Embodiment-4] 333 represents the center of mass of the suspended body of the vehicle including the rider, passengers, and any cargo. A Center of Gravity Horizontal [Embodiment-4] 334 is a line drawn parallel to the ground through the Center of Gravity [Embodiment-4] 333. A Squat Layout Line [Embodiment-4] 339 extends from a Rear Wheel Tire to Ground Tangent Point [Embodiment-4] 348 through the Center of Gravity [Embodiment-4] 333. A Center of Gravity Definition [Embodiment-4] 335 is the point where the Center of Gravity Horizontal [Embodiment-4] 334 intersects the Squat Layout Line [Embodiment-4] 339. A Center of Gravity Measured Distance [Embodiment-4] 336 is the perpendicular distance from the ground [Extended] 7 to the Center of Gravity Horizontal [Embodiment-4] 334.

A Rear Wheel Tire to Ground Tangent Point [Extended] [Embodiment-4] 348 indicates where the rear tire contacts the ground [Extended] 7 in the extended state. The Front Wheel Tire to Ground Tangent Point [Extended] [Embodiment-4] 337 indicates where the front tire contacts the ground [Extended] 7.

With continued reference to FIG. 127, an Anti-Dive Force Vector [Extended] [Embodiment-4] 340 is a line that intersects the Front Wheel Tire to Ground Tangent Point [Extended] [Embodiment-4] 337 and the DIVC[1][3][D][Extended] [Embodiment-4] 358. An Anti-Dive Definition Point [Extended] [Embodiment-4] 342 is defined where the Anti-Dive Force Vector [Extended] [Embodiment-4] 340 intersects the Squat Layout Line [Embodiment-4] 339. An Anti-Dive Measured Distance [Extended] [Embodiment-4] 344 is the perpendicular distance from the ground [Extended] 7 to the Anti-Dive Definition Point [Extended] [Embodiment-4] 342.

The anti-dive percentage at extension is calculated using the following formula: anti-dive percentage at extension equals the Anti-Dive Measured Distance [Extended] [Embodiment-4] 344, divided by the Center of Gravity Measured Distance [Embodiment-4] 336, multiplied by 100 percent. This calculation determines the degree to which the suspension linkage geometry counteracts the tendency of the front suspension to compress during deceleration events such as braking. Note if Anti-Dive Definition Point [Extended] [Embodiment-4] 342 is below ground [Extended] 7, the anti-dive value is negative.

The position of the DIVC[D][1][3][Extended] [Embodiment-4] 358 relative to the Front Wheel Tire to Ground Tangent Point [Extended] [Embodiment-4] 337 and the Squat Layout Line [Embodiment-4] 339 determines the anti-dive behavior of the suspension system in the extended state. The DIVC[D][1][3][Migration] [Embodiment-4] 360 shows how the DIVC[D][1][3] [Embodiment-4] 357 moves as the suspension travels from the extended state to the compressed state, which affects the anti-dive percentage throughout the suspension travel range. The separation of the brake carrier from the wheel carrier in embodiment 4 allows the DIVC[D][1][3] [Embodiment-4] 357 to be positioned independently from the IVC[1][2] [Embodiment-4] 352, enabling independent tuning of the anti-dive behavior separate from the wheel carrier behavior of the suspension system.

Referring to FIG. 128, a non-drive-side view of the complete two-wheeled vehicle is shown with embodiment 4 of the disclosed front rotary suspension system in the compressed state to illustrate the anti-dive behavior. The two-wheeled vehicle frame includes the front triangle comprising the down tube 1.1, the seat tube 1.3, and the head tube 1.4. The rear triangle includes the chainstay 2.1 and the seatstay 2.2. The crank axis 11 is shown at the bottom bracket area of the frame. The rear tire outer diameter 195 is represented as a circular outline indicating the position and size of the rear tire. Also shown is the front tire outer diameter 196.

The Front Wheel Carrier [Non-Drive] [Embodiment-4] 349 is pivotally connected to the front suspension pivot structure about IVC[1][2] [Embodiment-4] 352. The Front Wheel Brake Carrier [Non-Drive] [Embodiment-4] 350 and the Front Wheel Brake Link [Non-Drive] [Embodiment-4] 351 form part of the Front Brake Carrier Linkage Assembly [Embodiment-4] The front brake caliper 113 is mounted to the Front Wheel Brake Carrier [Non-Drive] [Embodiment-4] 350 via the rear brake caliper fasteners 114. The Front Wheel Axis [Compressed] 96 indicates the position of the wheel axis in the compressed state. The Vertical Front Wheel Travel [Embodiment-4] 361 represents the distance between the ground [Extended] 7 and the ground [Compressed] 8.

With continued reference to FIG. 128, the IVC[1][4] [Embodiment-4] 353 represents the pivotal connection between the suspended body and the Front Wheel Brake Link [Non-Drive] [Embodiment-4] 351, while the IVC[3][4] [Embodiment-4] 355 represents the pivotal connection between the Front Wheel Brake Carrier [Non-Drive] [Embodiment-4] 350 and the Front Wheel Brake Link [Non-Drive] [Embodiment-4] 351. The IVC[1][2]-IVC[2][3] Line [Embodiment-4] 347 intersects with a line connecting the IVC[1][4] [Embodiment-4] 353 and the IVC[3][4] [Embodiment-4] 355 at the DIVC[D][1][3][Compressed] [Embodiment-4] 359. The DIVC[D][1][3][Extended] [Embodiment-4] 358 indicates the position of the DIVC[D][1][3] [Embodiment-3] 357 in the extended state, and the DIVC[D][1][3][Migration] [Embodiment-4] 360 shows the migration path of all instances of the DIVC[D][1][3] [Embodiment-4] 357 from the extended state to the compressed state.

As further shown in FIG. 128, a Front Wheel Tire to Ground Tangent Point [Compressed] [Embodiment-4] 338 indicates where the front tire contacts the ground [Compressed] 8 in the compressed state. An Anti-Dive Force Vector [Compressed] [Embodiment-4] 341 is a line that intersects the Front Wheel Tire to Ground Tangent Point [Compressed] [Embodiment-4] 338 and the DIVC[D][1][3][Compressed] [Embodiment-4] 359. An Anti-Dive Definition Point [Compressed] [Embodiment-4] 343 is defined where the Anti-Dive Force Vector [Compressed] [Embodiment-4] 341 intersects the Squat Layout Line [Embodiment-4] 339. An Anti-Dive Measured Distance [Compressed] [Embodiment-4] 345 is the perpendicular distance from the ground [Extended] 7 to the Anti-Dive Definition Point [Compressed] [Embodiment-4] 345.

The Center of Gravity [Embodiment-4] 333 represents the center of mass of the suspended body of the vehicle including the rider, passengers, and any cargo. The Center of Gravity Horizontal [Embodiment-4] 334 is a line drawn parallel to the ground through the Center of Gravity [Embodiment-4] 333. The Center of Gravity Definition [Embodiment-4] 335 is the point where the Center of Gravity Horizontal [Embodiment-4] 334 intersects the Squat Layout Line [Embodiment-4] 339. The Center of Gravity Measured Distance [Embodiment-4] 336 is the perpendicular distance from the ground [Extended] 7 to the Center of Gravity Horizontal [Embodiment-4] 334. The Rear Wheel Tire to Ground Tangent Point [Embodiment-4] 348 indicates the contact point between the rear tire and the ground.

The anti-dive percentage at compression is calculated using the following formula: anti-dive percentage at compression equals the Anti-Dive Measured Distance [Compressed] [Embodiment-4] 345 divided by the Center of Gravity Measured Distance [Embodiment-4] 336, multiplied by 100 percent. This calculation determines the degree to which the suspension linkage geometry counteracts the tendency of the front suspension to compress during deceleration events such as braking when the suspension is in a compressed state. Note if Anti-Dive Definition Point [Compressed] [Embodiment-4] 343 is below ground [Extended] 7, the anti-dive value is negative.

The Front Wheel Tire to Ground Tangent Point [Compressed] [Embodiment-4] 338 and the ground [Extended] 7 define the Vertical Front Wheel Travel [Embodiment-4] 361. The position of the DIVC[D][1][3][Compressed] [Embodiment-4] 359 relative to the Front Wheel Tire to Ground Tangent Point [Compressed] [Embodiment-4] 338 and the Squat Layout Line [Embodiment-4] 339 determines the anti-dive behavior of the suspension system in the compressed state.

The separation of the wheel carrier and the brake carrier bodies in embodiment 4 enables independent tuning of the anti-dive behavior. IVC[1][2] [Embodiment-4] 352 defines the front wheel carrier movement, while the DIVC[D][1][3] [Embodiment-4] 357 defines the deceleration response through the brake carrier geometry. The DIVC[D][1][3][Migration] [Embodiment-4] 360 demonstrates how the DIVC[D][1][3] [Embodiment-4] 357 moves as the suspension travels from the extended state to the compressed state, which affects the anti-dive percentage throughout the suspension travel range.

Due to the position of the DIVC[D][1][3] [Embodiment-4] 357 with respect to the front wheel axis, the anti-dive percentage in embodiment 4 may be lower than in embodiments 1 and 2 where the brake carrier is the same body as the wheel carrier. The increase of kinematic bodies in embodiment 4 allows for brake carrier movement wherein the anti-dive may be tuned differently. The anti-dive percentage may be within a range of +/−200% or +/−100% depending upon the IVC locations and link geometry. The anti-dive behavior is tunable depending upon desired ride qualities, and many anti-dive curves are possible depending upon the IVC locations and link geometry of the Brake Carrier Linkage Assembly [Embodiment-4] 362.

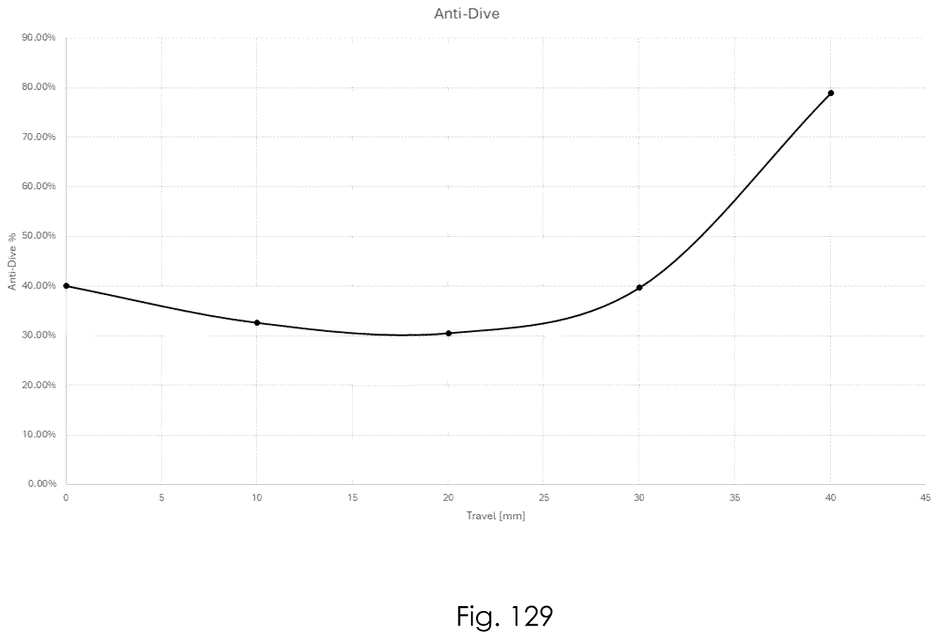

Referring to FIG. 129, an anti-dive percentage versus wheel travel plot is shown for embodiment 4 of the disclosed rear rotary suspension system. The vertical axis represents anti-dive percentage, ranging from zero percent at the bottom to ninety percent at the top, with increments of ten percent. The horizontal axis represents wheel travel, ranging from zero to forty mm, with increments of five units.

A single curve is plotted on the graph, starting at approximately forty percent anti-dive at zero wheel travel and decreasing slightly and then increasing as wheel travel increases. The anti-dive curve remains positive throughout the suspension travel range shown in this example.

The four-bar linkage arrangement of embodiment 4 enables tuning of the anti-dive into a range that differs from embodiments where the brake carrier is the same body as the wheel carrier. In embodiments 1 and 2, where the brake carrier is the same body as the wheel carrier, the anti-dive percentage may be relatively high throughout the suspension travel range due to the position of the dynamic instantaneous velocity center of the wheel carrier relative to the suspended body with respect to the front wheel axis. The separation of the brake carrier from the wheel carrier in embodiment 4 allows the dynamic instantaneous velocity center of the brake carrier relative to the suspended body to be positioned independently, enabling the anti-dive to be tuned into a more traditional range of approximately 0 percent to 200 percent.

The anti-dive behavior shown in FIG. 129 demonstrates that the suspension system provides approximately forty percent anti-dive near the extended position, where the anti-dive force is lower than but opposite to the load transfer force due to deceleration, resulting in some suspension dive (but less than a typical telescoping fork since the anti-dive values are positive) during braking events. This configuration may provide improved traction during braking events while maintaining geometry stability during deceleration, with the anti-dive percentage remaining within a range that balances these characteristics throughout the suspension travel.

The rotary resistance mechanism may be associated with a bore interface that defines a portion of the rotary mechanism. The bore interface may correspond to the rear suspension pivot aperture/bore [Drive] 14 (shown for example in FIGS. 10, 11, 13, 21, 45, 51, and 94), the rear suspension pivot aperture/bore [Non-Drive] 17 (shown for example in FIGS. 11, 13, 17, 18, 19, 45, 89, and 123), the front suspension pivot aperture/bore [Drive] 84 (shown for example in FIGS. 10, 11, 36, and 84), or the front suspension pivot aperture/bore [Non-Drive] 87 (shown for example in FIGS. 11, 36, 39, 40, and 41). The rotary mechanism may apply torque about the IVC axis defined by the kinematic joint between two linkage bodies. When viewed from a plane defined by the IVC axis, there may be an intersection between the projections of the bore interface, the rotary mechanism interface, or the rotary mechanism and a braking mechanism during at least a portion of a travel of the suspension. The intersection between the bore interface and the braking mechanism is shown in FIGS. 17-19 for the rear suspension, where the rear brake caliper 48, the rear brake rotor 50, and the rear wheel carrier and brake carrier caliper mounts [Non-Drive] [Embodiment-1] 61 are shown within the projection of the rear suspension pivot aperture/bore [Non-Drive] 17, and in FIGS. 39-41 for the front suspension, where the front brake caliper 113, the front brake rotor 115, and the front wheel carrier and brake carrier caliper mounts [Non-Drive] [Embodiment-1] 128 are shown within the projection of the front suspension pivot aperture/bore [Non-Drive] 87. In some embodiments, the rotary mechanism may include a rotary fluid damper that applies torque about the IVC axis through controlled flow of damping fluid within the mechanism, as shown in FIGS. 62-65 for the rotary cartridge embodiments and in FIGS. 111-114 and 119-120 for the Damper Assembly [Embodiment-3] 234. The intersection between the bore interface and a cassette is shown in FIG. 21, where the rear driven cassette 44 is within the projection of the rear suspension pivot aperture/bore [Drive] 14. The rotary fluid damper may be modular, wherein the modular rotary fluid damper provides a fixed suspension travel determined by the geometry of the module components.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims. From the foregoing it will be appreciated that, although specific embodiments of the invention have been described herein for purposes of illustration, various modifications may be made without deviating from the spirit and scope of the invention. The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. As used herein and unless otherwise indicated, the terms “a” and “an” are taken to mean “one,” “at least one,” or “one or more”. Unless otherwise required by context, singular terms used herein shall include pluralities and plural terms shall include the singular. Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below,” and words of similar import, when used in this application, shall refer to this application as a whole and not to any particular portions of the application. All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims. Of course, it is to be appreciated that any one of the examples, embodiments or processes described herein may be combined with one or more other examples, embodiments and/or processes or be separated and/or performed amongst separate devices or device portions in accordance with the present systems, devices and methods. Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A two-wheeled vehicle suspension comprising:
a suspended body;
a kinematic joint between two linkage bodies defining an instantaneous velocity center (IVC) axis;
a braking mechanism; and
a rotary mechanism that applies torque about the IVC axis; wherein when viewed from a plane defined by the IVC axis there is an intersection between projections of the rotary mechanism and the braking mechanism during at least a portion of a travel of the suspension.

2. The two-wheeled vehicle suspension of claim 1, wherein the kinematic joint is operably connected to a rear wheel, wherein the rear wheel defines a rear wheel axis.

3. The two-wheeled vehicle suspension of claim 1, wherein the kinematic joint is operably connected to a front wheel, wherein the front wheel defines a front wheel axis.

4. The two-wheeled vehicle suspension of claim 3, further comprising a front wheel axis, wherein the IVC axis is located rearward of the front wheel axis.

5. The two-wheeled vehicle suspension of claim 1, wherein the kinematic joint defines a dynamic IVC DIVC[C] or a dynamic IVC DIVC[E].

6. The two-wheeled vehicle suspension of claim 5, wherein:
the DIVC[C] comprises a DIVC[A] or a DIVC[AD];
the DIVC[E] comprises a DIVC[D] or the DIVC[AD], and as the suspension cycles, at least one of the DIVC[A], the DIVC[D], or the DIVC[AD] is stationary relative to the suspended body.

7. The two-wheeled vehicle suspension of claim 5, wherein:
the DIVC[C] comprises a DIVC[A] or a DIVC[AD];
the DIVC[E] comprises a DIVC[D] or the DIVC[AD], and as the suspension cycles, at least one of the DIVC[A], the DIVC[D], or the DIVC[AD] migrates relative to the suspended body.

8. The two-wheeled vehicle suspension of claim 1, wherein the IVC axis is not associated with a DIVC.

9. The two-wheeled vehicle suspension of claim 2, wherein a cassette is operably connected to the rear wheel, and there is an intersection between projections of the rotary mechanism and the cassette during at least the portion of the travel of the suspension.

10. A two-wheeled vehicle suspension comprising:
a plurality of linkage bodies including a suspended body;
a plurality of kinematic joints each defining an instantaneous velocity center (IVC) axis;
a wheel defining a wheel axis;
a tire mounted to the wheel defining a tire outer diameter; and
a rotary mechanism that applies torque about at least one of the IVC axes; wherein when viewed from a plane defined by the wheel axis, projections of the kinematic joints are located within the tire outer diameter during at least a portion of a travel of the suspension.

11. The two-wheeled vehicle suspension of claim 10, wherein a linkage body is a wheel carrier.

12. The two-wheeled vehicle suspension of claim 10, wherein a linkage body is a brake carrier.

13. The two-wheeled vehicle suspension of claim 11, wherein the wheel carrier is independent from a brake carrier.

14. The two-wheeled vehicle suspension of claim 10, wherein there are at least four kinematic joints.

15. The two-wheeled vehicle suspension of claim 10, wherein there are at least seven kinematic joints.

16. The two-wheeled vehicle suspension of claim 10, wherein at least one of the kinematic joints defines a dynamic instantaneous velocity center (DIVC), and as the suspension cycles, the DIVC is stationary relative to the suspended body.

17. The two-wheeled vehicle suspension of claim 10, wherein an IVC is a DIVC as the suspension cycles a DIVC migrates relative to the suspended body.

18. A two-wheel vehicle suspension comprising:
a suspended body;
a plurality of kinematic joints each defining an instantaneous velocity center (IVC) axis;
a wheel defining a wheel axis;
a tire mounted to the wheel defining a tire outer diameter; and
a rotary fluid damper that applies torque about at least one of the IVC axes; wherein when viewed from a plane defined by the wheel axis, projections of the kinematic joints are located within the tire outer diameter during at least a portion of a travel of the suspension.

19. The two-wheeled vehicle suspension of claim 18, wherein at least one of the kinematic joints defines a dynamic instantaneous velocity center (DIVC), and as the suspension cycles DIVC is stationary relative to the suspended body.

20. The two-wheeled vehicle suspension of claim 18, wherein at least one of the kinematic joints defines a dynamic instantaneous velocity center (DIVC), and as the suspension cycles DIVC migrates relative to the suspended body.
